(19) United States
(12) Patent Application Publication
(10) Pub. No.: US 2022/0413166 A1
(43) Pub. Date: Dec. 29, 2022

(54) SCATTERING FIELDS IN A MEDIUM TO REDIRECT WAVE ENERGY ONTO SURFACES IN SHADOW

(71) Applicant: Luminated Glazings, LLC, Montville, NJ (US)

(72) Inventor: Robert Saccomanno, Montville, NJ (US)

(21) Appl. No.: 17/833,047

(22) Filed: Jun. 6, 2022

Related U.S. Application Data
(60) Provisional application No. 63/196,819, filed on Jun. 4, 2021.
(60) Provisional application No. 63/197,349, filed on Jun. 5, 2021.
(60) Provisional application No. 63/190,139, filed on May 18, 2021.

(51) Int. Cl. G01T 1/02

(52) U.S. Cl. CPC G01T 1/02

(57) ABSTRACT

Fluence non-uniformities across a surface portion of a target (organism or inanimate object) due to inherent non-uniformities in the irradiation beam and/or shadowed target surfaces, are known to limit the effectiveness of target kinetic processes responsive to wave energy irradiation (electromagnetic, EM, elastic, EL, and/or quantum particle, QP). A field of scattering particles (e.g., bubbles in water, aerosols such as dry fog, powders, etc.) is constructed spatially/temporally in the vicinity of the target and in the path of propagating wave energy to improve the fluence coverage and thereby enhance the overall effectiveness of the kinetic process. The scatterers can be added to an existing irradiation system (retrofit application) or added to the design of a new system (forward fit). Novel dosimeters and methods of dosimetry are also disclosed to more accurately characterize the fluence received over complex surfaces.

### CROSS-REFERENCE TO RELATED APPLICATIONS

This application claims the benefit of U.S. Provisional Patent Application No. 63/196,819, filed 4 Jun. 2021, and U.S. Provisional Patent Application No. 63/197,349, filed 5 Jun. 2021, each incorporated herein by reference.

### FIELD OF THE INVENTION

The invention relates generally to injecting scattering elements between a source of EM/EL/QP wave energy and one or more target surfaces to increase the dosage to surfaces in shadow, which can also improve the dosage uniformity over large surface areas of the target. The invention also discloses novel dosimeters for testing shadowed surfaces, called ‘dosimetric avatars.’

### BACKGROUND OF THE INVENTION

“The earliest scientific observations of the germicidal effects of ultraviolet radiation began with Downes and Blunt (1877) who reported that bacteria were inactivated by sunlight, and found that the violet-blue spectrum was the most effective.” (Ultraviolet Germicidal Irradiation Handbook, ISBN 978-3-642-01998-2)

Even so, it has been shown that the effective use of Ultraviolet Germicidal Irradiation (UVGI) on complex surfaces is still inadequate 144 years after the germicidal effects of UV were first discovered. As well, shadows created by objects in the path of direct UV cause inadequate disinfection of surfaces.

It is also important to note that the technologies of UVC and sprays/vapor/bubbles crossed paths, and yet there are no references to using an aerosol (including using an inert, pure water aerosol) to scatter UVC for solving the shadowing problem.

The issue of shadows in UVGI has been known for more than 80 years, i.e., a long-felt but unsolved need.

Accordingly, it may be possible to achieve incremental log-reduction in disinfection that is important enough in terms of human illness or economic impact to make a change to an existing approach.

Also, it is well known that there is no standard test for UVC dosimetry of shadowed/shielded surfaces. Traditional dosimeters are flat, and at-best have been used as appliques on complex surfaces, although this does not account for microtextured surfaces like that of a strawberry, for example.

Inoculation of actual microtextured surfaces has been utilized to test fluence, but this is time consuming, expensive, and requires a certain level of expertise in microbiology.

### SUMMARY OF THE INVENTION

A concise summary can be found in Applicant's presentation at the 7 Jun. 2021 IUVA 2021 World Congress conference, incorporated in the '349 provisional application filed on 5 Jun. 2021. The presentation is entitled Increasing UV Dosage on Surfaces in Shadow Using a Dry Fog of Water Droplets as a Light Scatterer. IUVA is the International Ultraviolet Association (Bethesda, Md.).

The instant invention comprises two primary embodiments. One embodiment teaches the use of scattering particles to improve wave energy dosage uniformity, including reaching surfaces in shadow and compensating for non-uniform illumination. Another embodiment relates to the construction and use of 3D surface dosimeters, called ‘dosimetric avatars’, that better characterize the dose received by actual 3D objects. Applications include 3D dosimeters (of different levels of complexity) that look and act like strawberries or other objects that historically have been difficult to treat with UVGI due to their surface texturing/shadowing. The 3D dosimetry provides, e.g., feedback for optimizing fluence for existing disinfection/non-disinfection systems and the scattering approach taught herein, as well as providing quality control checks along a production line. Both primary embodiments are contemplated for use in any phase/state of matter, including in gaseous media (e.g., droplet/particle scattering) as well as liquid media (e.g., bubble/particle scattering).

### BRIEF DESCRIPTION OF THE DRAWINGS

A concise set of drawings are presented herein, selected from a much larger set filed in the provisional applications.

FIG. 1 shows a UVC tunnel application disinfecting strawberries with dry fog injected from the top of the unit towards the conveyor belt.

FIG. 2 shows microorganisms, ‘fluence multiples’, and rate constant comparison for Water, Surface, Air-Lo RH and Air-Hi RH.

FIG. 3 shows Monte Carlo multiparticle scattering simulations for a 4.85″ thick cloud of dry fog at a concentration of 100,000 droplets per cm³ for four different droplet sizes, each at vacuum wavelengths of 222 nm (far-UVC) and 730 nm (far-red).

FIG. 4 shows Monte Carlo simulations at the germicidal vacuum wavelength of 254 nm for 5μ droplets and at fog thicknesses of 3.85″ and 5.85″, each at four different dry fog concentrations.

FIG. 5 was created to show a microbe in a canyon (not to scale), without fog, having no direct line-of-sight to the rays from any of the UVC lamps that line the top of the drawing.

FIG. 6 shows the microbe in FIG. 5 using exemplary MontCarl ray trace renderings from FIG. 4, with UVC lamps/rays in the extended field of view.

FIG. 7 shows a UVC transmissive rectangular box that contains dry fog and objects to be disinfected, riding through a UVC tunnel.

FIG. 8 shows a food powder (e.g., wheat flour) being treated with UVC using dry fog isolated from the powder.

FIGS. 9a and 9b show UV grade optical fibers/rods (e.g., end-emitting or side-emitting depending upon the application) formed in a thin sheet interspersed with manifolds fitted with nozzles/perforations to emit scattering elements.

FIG. 10 shows the visible light fog chamber setup (cross sectional elevation view).

FIG. 11 shows visible red laser light scattering measured in the chamber of FIG. 10, compared to Monte Carlo results.

FIG. 12 shows MontCarl Monte Carlo scattering results for a 635 nm 1° HWHM laser, with a 385 mm scattering field length, using 1.8μ radius droplets from concentrations between 0 and 1E5 mm−3 (1E8 cm⁻³).

FIG. 13 shows the same as FIG. 12 except that the concentration varies from 1E5 mm⁻³ (1E8 cm⁻³) and 1E6 mm⁻³ (1E9 cm⁻³).

FIG. 14 shows visible light scattering measurements for various fog thicknesses (based on different positions of the 4″ PVC telescoping tube with a black inner lining) with one width of black vinyl tape used to shadow the sensor.

FIG. 15 shows the visible light fog chamber setup (cross sectional elevation view) for cross-illumination measurements.

FIG. 16 shows cross-wise visible light dry fog scattering at a fixed 10¼″ distance to determine scattering sensitivity to the position of the black-lined 4″ PVC tube.

FIG. 17 shows the effects of air pressure and flow rate on fog scattering from measurements with the HEART® nebulizer.

FIG. 18 shows plots from calculations of ultrasonic water droplet size vs. piezoelectric frequency.

FIG. 19 shows plots from calculations of water droplet evaporation time as a function of droplet diameter and relative humidity.

FIG. 20 shows cross-wise visible light dry fog scattering at a fixed 10¼″ distance to determine scattering sensitivity to the fog exit apertures using the setup of FIG. 15.

FIG. 21 shows the same as FIG. 20 except the secondary vertical scale is changed.

FIG. 22 shows the visible light fog chamber setup (cross sectional elevation view) for measuring vertical fog height effects in the cross-illumination setup.

FIG. 23 shows visible light scattering variations as a function of vertical height using the setup of FIG. 22.

FIG. 24 shows results from a custom CFD simulation of dry fog concentrations after exiting a pipe at time t=5.080 seconds.

FIG. 25 shows the UVC test setup in the HomeSoap® unit modified for use with and without dry fog.

FIG. 26 shows a MontCarl ray trace extracted from FIG. 4 superimposed on a detail of the modified HomeSoap® UVC test setup to demonstrate how scattered light rays reach the shadowed upper UVC sensor.

FIG. 27 shows UVC ‘shadow’ measurements with and without fog from the modified HomeSoap® UVC test setup of FIG. 25.

FIG. 28 shows UVC ‘direct-view’ measurements with and without fog from the modified HomeSoap® UVC test setup of FIG. 25.

FIG. 29 shows the temporal effects from both cold-start and warm-start cycles measured from the bottom UVC lamp in the modified HomeSoap® UVC test setup of FIG. 25.

FIG. 30 shows the temporal effects of fog scattering measurements using the upper UVC sensor facing the upper UVC lamp at a distance of 8.25″, with fog injected at the 6 minute mark in 1 cold-start and 3 warm-start 10-minute cycles in the modified HomeSoap® UVC test setup of FIG. 25.

FIG. 31 shows a block diagram that encompasses features discussed in the instant invention and is adaptable for use with EM, EL, and QP wave energy scattering in gas and liquid media.

FIG. 32 shows parts to a Carel ‘humiSonic’ ultrasonic humidifier with 14 directable outputs.

FIG. 33 shows the operating principles for the unit in FIG. 32.

FIG. 34 shows the part numbering (with options) and the ‘basic parameters’ for the unit of FIG. 32.

FIG. 35 shows the ‘service parameters’ for the unit of FIG. 32.

FIG. 36 shows parts to a Carel ‘humiSonic Compact’ ultrasonic humidifier with a single output connected to a hose and a distribution manifold.

FIG. 37 shows installation guidelines and a fan-shaped output diffuser for the unit of FIG. 36.

FIG. 38 shows the alarms for the unit of FIG. 36.

### DETAILED DESCRIPTION

This invention relates to improvements in wave energy irradiance systems for use in dosing objects (organisms and inanimate objects) that possess kinetic processes responsive to fluence (or dose), i.e., the combination of irradiation over time. This is found in ultraviolet light germicidal irradiation (UVGI) systems (radiolysis, ultrasonication, etc.) for the purpose of disinfection or decontamination by reducing the number of pathogens by damaging DNA, proteins, etc. and limiting photo-repair/dark-repair). UVGI will be referenced in the bulk of this filing. Other exemplary applications that respond to the combination of irradiation over time include photosynthesis (increasing growth in response to visible and far-red irradiation over time), photocuring/photopolymerization (UVA and other wavelengths) and light-activated tooth whitening. Many of these processes can be generalized under the categories of photochemistry (including microwave chemistry) and photophysics, See, e.g., Photochemistry and Photophysics—Concepts, Research, Applications (ISBN 978-3-527-33479-7), Category Photochemistry—Wikipedia.

Wave energy as used herein includes irradiation from electromagnetic, EM (e.g., UV and visible light), elastic, EL (e.g., ultrasonics in fluids), and/or quantum particle, QP sources (e.g., electron beams), all of which can be scattered. Disinfection applications also use radiolysis via gamma rays (EM) and electron beams (QP), and cavitation via ultrasonication (EL).

For the purposes herein, the terms of dose and fluence will be used synonymously as the combination of irradiance over time (unless defined otherwise in a particular context) applied to kinetic processes of objects (organisms and inanimate objects) responsive thereof. Objects having kinetic processes responsive to wave energy fluence are known to have kinetic rates that change with different levels dosing and/or irradiance, some due to damage at high fluences, some due to shadows, some due to more nuanced effects.

The field of invention relates to the overarching tenets of Process Intensification (PI), namely via more effective use of one or more of EM/EL/QP wave energy fluence to improve a kinetic process via efficient wave energy scattering onto surfaces (optionally in combination with other non-photochemical/photophysical modalities with kinetic effects such as chemical, heat, etc.). The invention also teaches the construction and use of novel dosimeters called dosimetric avatars to characterize wave energy fluence received over smooth and/or complex surfaces. Note that PI relates to those processes that are desirable to intensify, although improvements may come with undesirable side effects (e.g., a slight reduction in the quality of certain foods from UVGI).

Note that surfaces receiving the fluence range from microscopic (viruses) to macroscopic (a plant leaf), as well as microscopic surfaces on macroscopic objects (microbial pathogens on either a spinach leaf, the textured surface of a strawberry, or a particle of wheat flour). Further, the wave energy may penetrate to some distance below the surface to have their effect on a kinetic process (DNA in a microbial pathogen within a biofilm attached to a strawberry, chloroplasts in photosynthetic cells within a leaf, adhesive molecules in a 3D adhesive-cured printed part). In most UVGI embodiments herein, the instant invention improves the fluence distribution across macroscopic object surfaces in order to irradiate microscopic surfaces that may be hiding due to surface complexity (e.g., the ‘canyon wall effect’) and/or to homogenize non-uniform illumination. This is consistent with the use of ‘surface disinfection’ when compared to air- and water disinfection.

As an aside, a quick primer on UVGI can be found in Inactivation of microorganisms by newly emerged microplasma UV lamps (2020), “In principle, irradiated UV photons prevent microorganisms from replication and survival, so-called inactivation, by changing their genetic nucleic acid structure [4], either ribonucleic acid (RNA) or deoxyribonucleic acid (DNA). In practice, however, two types of microorganisms have challenged the further globalization of the currently available UV sources: microorganisms with (i) UV-resistant genomic structure and (ii) effective post-irradiation repair mechanisms for nucleic acid lesions, which are designated hereafter by UV-resistant microorganisms (URMs) and effectively repairable microorganisms (ERMs), respectively. These microorganisms lead to a higher required UV-dose regulated by global environmental protection agencies for adequate disinfection by UV sources, which, in turn, results in higher energy consumption and lower process efficiency. Further, the regulations sometimes require the addition of chemical disinfectants, such as chlorine and ozone, as supplementary disinfectants, defecting the purpose of the sustainable “chemical-free” UV treatment. Sensitivity of nucleic acid protection and viral proteins in URMs for UV with below 240 nm photons, known as far-UVC radiation [5] (see Scheme 51 for partitioning of UV radiation), can be the key to increasing susceptibility by inducing damage to these components. In ERMs, the repair mechanism to maintain genome integrity consists of two main phenomena: intrinsic nucleotide excision repair [6] and light-initiated [7] repair, which are known as dark repair and photoreactivation, respectively. In photoreactivation, the repair is performed by an enzyme, called photolyase [8], which reverses UV-induced damage in nucleic acids. In dark repair, the damage is reversed by the action of a number of different enzymes. All of these enzymes are activated by an energy source which could be photons mainly in the wavelength range of 300-500 nm for photoreactivation, or existent nutrients within the cell for dark repair [9]. Inactivating radiation at a broad range of UVCs has been claimed to be effective for reducing subsequent reactivation of microorganisms [7,8].”

“UVGI is also used to distinguish air and surface disinfection applications from those in water (CIE 2003) . . . . The design of UV systems for water disinfection differs from that of air and surface disinfection applications and therefore the cumulative knowledge accrued in the water industry is of limited direct use for air and surface disinfection applications. UV rays are attenuated in water and this process has no parallel in air disinfection, even with saturated air. The attenuation of UV irradiance in water occurs within about 15 cm and this necessitates both higher UV power levels and closely packed arrays of UV lamps. The estimates of UV doses required for water disinfection are on the order of ten times higher than those needed in air disinfection applications, and this difference distorts any attempt to use water UV system sizing methods to design air disinfection systems. Furthermore, the array of particular microorganisms of concern in the water industry differs considerably from those found in air and therefore water-based UV rate constants are of use only where the microbial agent is both airborne and waterborne (i.e. Legionella), or is also surface-borne, and for theoretical analysis. Some overlap in waterside and airside UV applications also exists in the area of foodborne pathogens, where certain foodborne pathogens may become airborne, and where they may exist as surface contamination amenable to UV disinfection. Although the UV exposure dose in air is a simple function of airflow and exposure time, and the UV irradiance field in air is not too difficult to define, the susceptibility of airborne microbes is a complex function of relative humidity and species-dependent response. It has often been thought that the UV susceptibility of microbes in air at 100% relative humidity (RH) should correspond to their susceptibility in water, but this proves to be overly simplistic and it can only be said that UV susceptibility at high RH approaches that in water. As a result of these various differences between water-based UV disinfection and UVGI air and surface disinfection, research into the former provides limited benefits to research into air-based disinfection, and the subject of water disinfection is not addressed in this book except insofar as it has some specific impact on air and surface disinfection and in the matter of their common theoretical aspects . . . . One of the main differences between air and surface disinfection with UV is that the relevant UV rate constants differ under these two types of exposure—airborne rate constants tend to be higher in air, under normal humidity. That is, microbes are more vulnerable in air, whereas microbes on surfaces appear to have a certain degree of inherent protection. Although the matter remains to be resolved by future research, the available database for UV rate constants for microbes on surfaces is useful as a conservative estimate of airborne rate constants, as are water-based rate constants, whenever airborne rate constant studies do not exist . . . An alternate or additional explanation for the decrease in UV rate constants with RH observed for some microbes is that the absorption of water and the layers of bound water that form at high RH produces a protective effect due to the increased scattering of UV light waves. Higher RH may also increase clumping, which may also impact light scattering as well as provide photoprotection to internal cells. For a particle that is already near the size range for Mie scattering, any increase in the size of an airborne microbe, whether due to swelling from water absorption or from clumping could cause a major change in the amount of absorbed UV radiation” (Ultraviolet Germicidal Irradiation Handbook UVGI for Air and Surface Disinfection, ISBN 978-3-642-01998-2)

An exemplary (and non-limiting) application discussed throughout this application relates to ultraviolet (UV) light germicidal irradiation (UVGI) for the reduction of pathogens. Ultraviolet light is characterized in three wavelength bands—A, B, C, and are referenced throughout as UVA, UVB, and UVC, respectively. Most references to UVGI cite UVC (generally between about 220 nm and 280 nm), although germicidal action has been noted into the longer wavelengths of the visible spectrum as well, albeit at lower efficacies.

“The earliest scientific observations of the germicidal effects of ultraviolet radiation began with Downes and Blunt (1877) who reported that bacteria were inactivated by sunlight, and found that the violet-blue spectrum was the most effective.” (Ultraviolet Germicidal Irradiation Handbook, ISBN 978-3-642-01998-2)

“It is well documented that impinging on simpler-to-profile smoother surfaces, like stainless steel or packaging, germicidal light at a specific wavelength can achieve 3- to 5-log reductions depending on the target organisms and dosages applied. But under same conditions for complex mixed material food surfaces, only a range of 0.5- to 2.5-log microbial reductions tend to be achieved.” (Bayliss, et al, UVA Food and Beverage Safety Working Group, Are Food Contact Surfaces Seeing the Light?, UV Solutions Q1 2021 magazine, pgs. 12-13, Peterson Publications Inc., Topeka, Kans.).

“UV-C is a line of sight technology; it will not penetrate deep into crevices or layered surfaces. Workarounds for surface disinfection could include moving the UV source to avoid shadowing, unfolding portable reflectors, or installation of multiple sources. In commercial buildings, UV-C has been used successfully for decades to disinfect moving air, both in HVAC ducts and in upper room applications.” Seeking New Weapons Against Microbial Foes (Brons, et al, LD+A Magazine, 2021 April, pgs. 58-61, Illuminating Engineering Society, New York, N.Y.)

Thus, the effective use of UVGI on surfaces is still inadequate 144 years after the germicidal effects of UV were first discovered.

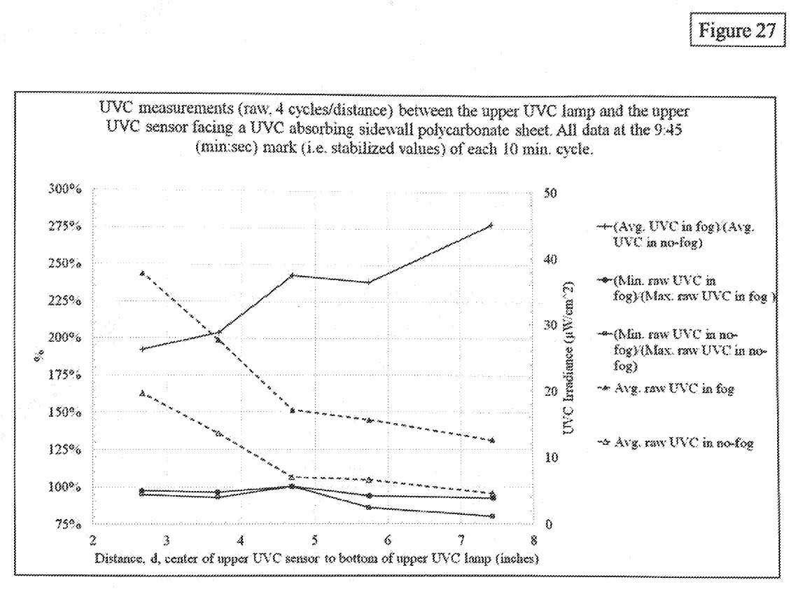

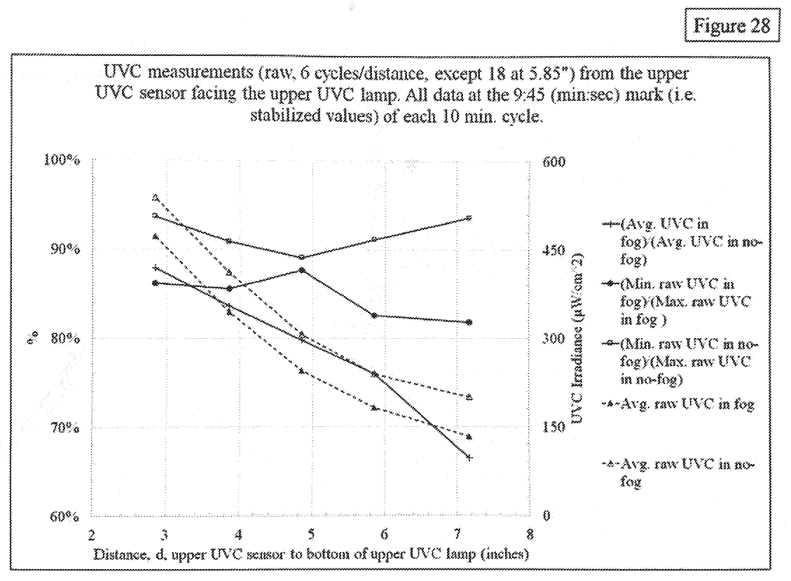

The technologies of UVC (and other wave energy), scattering, and aerosols/bubbles/fogs/sprays/vapor have crossed paths as will be shown in what follows. An aerosol is a field of fine solid particles or liquid droplets in air or another gas. The breadth of these references is not meant to suggest that one of skill in the art would have known to even search for many of these. Most of these references were found after substantial learning about the complex subject of scattering as it applies to the instant invention. An objective method towards gauging this complexity is to review the 1000+ pages of provisional filings in the instant invention (vis-à-vis the absence of much of the information in the following references), as it relates to the theory, simulation, build, and optimization in order to practice the invention, and then arrive at the test results disclosed, e.g., where in one exemplary test, the UVC irradiance at a surface in shadow (indirect irradiance) received 242% more UVC when using dry fog scattering than when using no dry fog scattering (FIG. 27), while maintaining a high level of direct view irradiance (FIG. 28).

UV with scattering bubbles (e.g. CO₂) for liquid/water treatment: EP2443066A1 Method and device for treatment of water by exposure to UV radiation, DE102006009351B3 Device for processing and discharge of fresh water and water comprises a storage tank, a sterilization zone, a switch valve unit that can be switched between beverage discharge and feedback states, and a beverage dispensing point and pump, JP2018192451A Sterilizing apparatus and hot water supply apparatus, WO2018037938A1 Running water sterilization device and running water sterilization method, JP2012040505A Liquid treatment device, Comparative study of PFAS treatment by UV, UV ozone, and fractionations with air and ozonated air, Decomposition Rate Of Volatile Organochlorines By Ozone And Utilization Efficiency Of Ozone With Ultraviolet Radiation In A Bubble-Column Contactor.

Scattering due to bubbles for other applications: Effect of air bubble size on cavitation erosion reduction, Experimental study of aerated cavitation in a horizontal venturi nozzle, Laser Scattering of Bubble in Water, The Volume Scattering Function and Models for Scattering, Ozone chemistry in aqueous solution—Ozone decomposition and stabilization, Quantifying The Effect Of Humidity On Aerosol Scattering With A Raman Lidar, Non-line-of-sight ultraviolet single-scatter propagation model.

Humidifiers with a UVC source to disinfect the source water prior to dispersal as humidified air into the environment: U.S. Pat. No. 9,482,440 Humidifier with ultraviolet disinfection, U.S. Pat. No. 7,540,474 UV sterilizing humidifier, US20100133707 Ultrasonic Humidifier with an Ultraviolet Light Unit, STULZ Ultrasonic Humidification & EC Fan Retrofit Kit, Implementation and impact of ultraviolet environmental disinfection in an acute care setting. Decorative illumination of mist/fog/smoke emission: U.S. Pat. No. 6,301,433 Humidifier with light, U.S. Pat. No. 7,934,703 Mist generator and mist emission rendering apparatus, Theatrical smoke and fog—Wikipedia, US20170079110 Led module for aerosol generating devices, aerosol generating device having an led module and method for illuminating vapour.

UVGI and humidity: Effects of Relative Humidity on the Ultraviolet Induced Inactivation of Airborne Bacteria, Far-UVC light—A new tool to control the spread of airborne-mediated microbial diseases.

UV to gel droplets expelled from an atomizer apparently for use on the skin of patients: US20170274159 Fluid delivery devices and methods.

Plasma in a vapor, with electrons and UV from the plasma used for disinfection: Features of Sterilization Using Low Pressure DC Discharge Hydrogen Peroxide Plasma, Cold plasma decontamination of foods (Annual review of food science and technology 3 (2012): 125-142)

Bioreactors using light scattering schemes such as wave guiding structures and bubbles: Engineered surface scatterers in edge-lit slab waveguides to improve light delivery in algae cultivation, Photon management for augmented photosynthesis, Bioreactors for Microbial Biomass and Energy Conversion (ISBN 978-981-10-7676-3).

UV and disinfectant sprays/fogging, but not cited as being performed simultaneously, or involving scattering: COVID-19—JLM Environmental, Dry Fog and UVC light Disinfection Robot: SIFROBOT—6.62; An overview of automated room disinfection systems—When to use them and how to choose them, Implementation and impact of ultraviolet environmental disinfection in an acute care setting, Evaluation of 6 Methods for Aerobic Bacterial Sanitization of Smartphones, AOP for Surface Disinfection of Fresh Produce From Concept to Commercial Reality»UV Solutions, Innovative application of ultraviolet rays and hydrogen peroxide vapor for decontamination of respirators during COVID-19 pandemic—An experience from a tertiary eye care hospital, U.S. Pat. No. 8,084,394 Method for the control of harmful micro-organisms and insects in crop protection with means of dipole-electrical air-jet spray-technology, ozonated water and UV-C irradiation, OmniAire 1200PAC, (Puro Bot) (Sani Bot), United Now Cleaning Flight Decks with UVC Lighting—Aug. 6, 2020, US20200405895A1 Device for disinfecting pipelines, containers and structures.

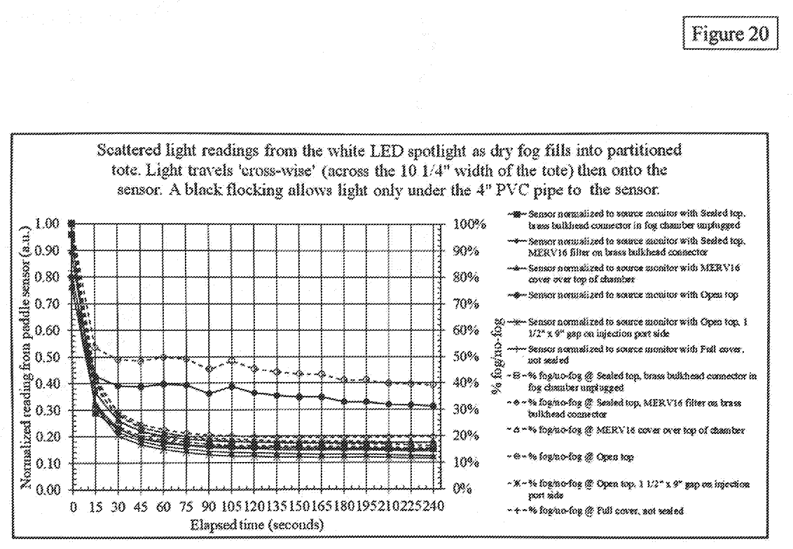

UVGI with scattering from solid/encapsulated surfaces: Ultraviolet Germicidal Irradiation Handbook UVGI for Air and Surface Disinfection (ISBN 978-3-642-01998-2) FIG. 20.5 and associated text, U.S. Pat. No. 7,511,281 Ultraviolet light treatment chamber, US20190047877 A fluid purification system and method, U.S. Ser. No. 10/517,974 Ultraviolet surface illumination system U.S. Ser. No. 10/604,423 Method, system and apparatus for treatment of fluids, U.S. Pat. No. 9,259,513 Photocatalytic disinfection of implanted catheters.

Scattering in (UV activated) photocatalytic and bubble column reactors: JP2001269541A Photocatalytic treatment device, Photocatalytic Reactor Design—Guidelines for Kinetic Investigation, Bubbles scatter light, yet that doesn't hurt the performance of bubbly slurry photocatalytic reactors (ABSTRACT), Design of Photocatalytic Reactors—see Chapter 3, apparently the same as the above paper Bubbles scatter light, yet that doesn't hurt the performance of bubbly slurry photocatalytic reactors (a common author), Monte Carlo simulation of the light distribution in an annular slurry bubble column photocatalytic reactor, CFD Analysis of the Radiation Distribution in a New Immobilized Catalyst Bubble Column Externally Illuminated Photoreactor, A Review of Physiochemical and Photocatalytic Properties of Metal Oxides Against Escherichia Coli.

UV scattering due to water film/droplets on a surface: U.S. Pat. No. 9,044,521 UV sterilization of containers.

Scattering as a function of relative humidity (RH): Measurement of relative humidity dependent light scattering of aerosols

Long-felt but unsolved need—As shown below, the issue of shadows on surfaces in UVGI goes back at least as early as in U.S. Pat. No. 2,231,935 Sterilizing cabinet for glasses, dishes, and the like (filed August-1938, Col. 1/1-3 and Col. 4/48-54): “My invention relates to a cabinet designed and adapted to sterilize glasses, dishes and the like by means of ultra-violet radiation . . . whereas if any elements capable of casting a shadow were in contact with the lip area of the glass they would not only intercept the effective action of the bactericidal rays thereon, but by contact therewith would prevent the glass becoming completely sterile at that point.”

More than 80 years later, shadows are still an issue: “Significant complexity is introduced when developing validation protocols for UV disinfection of surfaces due to the wide array of potential surface textures and/or geometries of items that commercial and consumer UV disinfection products are used to disinfect. Original research presented by Jaffe et al. at the 2020 IUVA Americas Conference demonstrated the “Canyon Wall Effect.” Consider a minimally textured surface with “valley” depths only 1/10th of a human hair, or about 10 microns. The size of the SARS-CoV-2 virus is 0.15 microns. This is the equivalent of a supine person sunbathing in a canyon with 1,000-foot walls. Just as the morning sun cannot reach the canyon floor, UV applied perpendicular to the surface will not reach into the crevices of a textured surface, allowing germ survival . . . . Ultimately, the dose distribution will govern the efficacy of any UV disinfection system. For air disinfection, this will be governed by the interplay between fluid mechanics and the fluence rate field. For surface disinfection, the interplay of the fluence rate field, the optical properties of the surface material, and surface texture (“shadowing”) are likely to govern the dose distribution.” Validation Needed for UV Surface Disinfection Applications (2 Dec. 2020, UV Solutions Magazine)

“The problem is illustrated by what's called the “canyon wall” effect. To bacteria and viruses, textural features on common surfaces can be like 100-meter-deep canyons would be to us. In experiments with surfaces having submillimeter texture, UV-C's kill rate against the bacteria Staphylococcus aureus varied as much as 500-fold depending on the angle at which the mercury lamp's light fell. That dependence on angle is why it typically takes three UV systems to disinfect a hospital room, according to Marc Verhougstraete, assistant professor of public health at the University of Arizona. Even then, there are still unexposed areas. So for that application, UV-C surface sanitizers should be part of a system that includes routine surface disinfection, hand hygiene, and air treatment, he says.” (Anderson, M. “The ultraviolet offense: Germicidal UV lamps destroy vicious viruses. New tech might put them many more places without harming humans.” IEEE Spectrum 57.10 (2020): 50-55).

Currently, methods to address the shadowing issue are as follows:

The first approach is to change the angles of the light that reach the surface, i.e., by inducing relative movement between the source of wave energy and the target surfaces (without the use of scattering). This surely can be helpful, but is not always sufficient, it risks damaging the product (e.g., see ‘Bruising’ below), and not everything to be disinfected (processing equipment & product) can be easily rotated. With some products, even if they are rotated, there are still shadows. “ . . . to enhance avoidance of shadowing, vibration or rotation of the objects may be used during the exposure, aiming to shake the target surface further into the line of sight of the sources. However, if the surfaces being treated are small enough—such as yogurt cups—solution engineers instead opt to pass them through a relatively slowly moving UV-C tunnel conveyor system as a technique to overcome the amount of shadowing present on the target surface due to static methods.” (Bayliss, et al, IUVA Food and Beverage Safety Working Group, Are Food Contact Surfaces Seeing the Light?, March-2021, UV Solutions Q1 2021 magazine, pgs. 12-13, Peterson Publications Inc., Topeka, Kans.).

Bruising—“The uniformity of the UV-C dose distribution is also an important factor for the successful implementation of UV-C treatment. Many researchers ensured the uniformity of the dose distribution by employing manual rotation of fruits. However, this method is not suitable for strawberries, which have a soft surface, because it may cause bruising.” Simulation of UV-C Dose Distribution and Inactivation of Mold Spore on Strawberries in a Conveyor System, citing Simulation of UV-C Intensity Distribution and Inactivation of Mold Spores on Strawberries. “Ideally, fruit should be rapidly and randomly rotated in multiple planes, allowing all surface exposure from multiple directions and angles of the UV light . . . applicable to other geometrically round fruit, such as peaches, apricot, orange etc. as long as the fruit can be rapidly and randomly rotated in multiple planes without causing mechanical damage . . . roller conveyers where fruit are rapidly rotated. Whether currently-used packing lines are capable of generating enough rotation to ensure uniform UV exposure needs further evaluation” Radiochromic film dosimetry for UV-C treatments of apple fruit, also stating

The second approach: “Water-assisted UV-C treatment, two-sided and tumbling UV-C apparatus may minimize the shadowing effect. Future research may focus on commercial applicability of the technology for food surface decontamination with efforts to reduce dose variation and shadowing effect.” (Fan, et al, Application of ultraviolet C technology for surface decontamination of fresh produce, Trends in Food Science & Technology 70 (2017): 9-19).

“ . . . microorganisms on a food surface must directly face a UV lamp to be inactivated (Shama, 1999). To overcome this UV limitation, a water-assisted UV system was developed in this study where blueberry samples were immersed in agitated water during UV treatment. The blueberry samples could randomly move and rotate in the agitated water, thus allowing all blueberry surfaces to be exposed to UV light and receive more uniform UV exposure. In the meantime, the vigorously agitated water would wash off microorganisms on blueberry surfaces into water (Pangloli and Hung, 2013), which could be easily killed by UV light since UV can penetrate well in clear liquid.” However, “Water-assisted UV treatment was generally more effective in inactivating MNV-1 skin-inoculated onto blueberries than the dry UV treatment. The water-assisted UV treatments were more effective than or as effective as the 10-ppm chlorine washing. MNV-1 skin-inoculated onto blueberries was easier to be inactivated than that calyx-inoculated onto the berries. The presence of 2% blueberry juice in wash water provided protection for MNV-1 from both water-assisted UV and chlorine wash treatments.” (Liu, et al, Application of water-assisted ultraviolet light processing on the inactivation of murine norovirus on blueberries, International journal of food microbiology 214 (2015): 18-23).

So organic material from the targets entering the wash water, like blueberry juice in the above example, can actually lower the efficacy of disinfection. Yet another risk is that “Pathogens can transfer from contaminated to uncontaminated produce, and pathogens can be spread among batches if wash waster is reused and no proper invention is employed (21).” (Guo, et al, Evaluating a combined method of UV and washing for sanitizing blueberries, tomatoes, strawberries, baby spinach, and lettuce, Journal of food protection 82.11 (2019): 1879-1889.) “In fact, one of the challenges of the produce industry in the U.S. has been monitoring the effective sanitation of product wash water.” Microbial Safety of Fresh Produce (Institute of Food Technologists Series, ISBN 978-0-8138-0416-3).

Even with the advantages of product movement in wash water, surface texture can have shielding effect: “We found that the levels of bacterial reduction due to WPL treatment varied with different topographies of berry surface (Tables 1-4). The presence of achenes of strawberries and the drupelets of raspberries can potentially shield microorganisms from the PL beams, leading to only partial decontamination. A similar phenomenon has also been observed in many other studies (Belliot et al., 2013; Bialka & Demirci, 2008; Fino & Kniel, 2008).” (Huang, et al, Inactivation of Escherichia coli 0157: H7, Salmonella and human norovirus surrogate on artificially contaminated strawberries and raspberries by water-assisted pulsed light treatment, Food Research International 72 (2015): 1-7., WPL=“water-assisted pulsed light.”). Moreover, with respect to UVC using wash water, certain dry food items requiring disinfection are not amenable to moisture. See, e.g., Persistence and survival of pathogens in dry foods and dry food processing environments.

The third approach is to utilize an additional non-photochemical/photophysical modality with kinetic effects, such as chemical disinfectants, in addition-to UVC. This can be efficacious if the risks/concerns of using chemicals are considered. Other modalities that have been combined with UVGI include temperature/heat-processing, pressure, ultrasound either simultaneously or sequentially, RF/pulsed electric field, ozone, etc. Note that not all modality combinations referenced above are found to be synergistic, where the sum is more than the parts. Note that the use of the scattering of the instant invention can enhance (or be enhanced) by the use of one or more additional modalities (e.g., using H₂O₂ in the scattering source water), whether used simultaneously and/or sequentially (pre and/or post). The proper use of chemical agents is referenced, e.g., in Refer to Guideline for Disinfection and Sterilization in Healthcare Facilities, 2008, Cleaning in place (CIP) in food processing, Fresh-cut product sanitation and wash water disinfection: Problems and solutions.

A fourth approach is to increase the dosage by elevating irradiation intensity and/or extending irradiation time. Generally, this also helps, however too high a fluence can lead, e.g., to damage to the quality of fruits and vegetables. See, e.g., Use of UV-C light to reduce Botrytis storage rot of table grapes. Also, in certain applications, an increase of power does not always lead to a commensurate increase in efficacy due to ‘shoulder’ and/or ‘tailing’ effects, or photosaturation in photosynthetic plants. Added time under irradiation has the downside of affecting factory throughput.

Incomplete disinfection in the food industry has both financial impact (productivity losses from remediations/recalls, yield loss due to fruit spoilage and plant disease) and human impacts. Parasitic disease yield losses for specific fruits and vegetables are cited in Reduction of losses in fresh market fruits and vegetables. Enumeration of the financial impact (in the $ billions for all loss-mechanisms including ‘microbial growth’ and the costs of pesticide use) of fruit and vegetable losses (from 2008) are discussed The Value of Retail- and Consumer-Level Fruit and Vegetable Losses in the United States. Annual financial losses due to pathogens in the grape industry are discussed in Result of a Survey on Grape Breeder's Perceived Priorities in Grape Genetics Research (2012). “US estimate is that there are 76 million foodborne illnesses annually, resulting in 325,000 hospitalizations and 5200 deaths . . . total cost estimates for STEC O157 (i.e., Shiga toxin-producing Escherichia coli O157) . . . average cost for STEC 0157 is $6256 per case.” The Economics of Enteric Infections: Human Foodborne Disease Costs.

A fifth approach is the strategic placement of reflectors—“It is difficult to get uniformed UV-C doses for all surfaces of fruit when fruit are static even with the use of reflective material. Reflecting materials such as aluminum foil could increase irradiation doses on certain area on the surface of apples by reflecting UV-C light. However, the reflection is limited in terms of the amount and direction.” Radiochromic film dosimetry for UV-C treatments of apple fruit

Failure of others—Below are shown excerpts from recent publications citing the failure of others to find a solution to the limitations of shadows and shielding (emphases added): “The designed system can treat any object which fits inside a sphere with a diameter of 250 mm, as long as its shape does not induce any shadows on other part of the structure (e.g., holes or pockets), irradiation times have been optimized for spherical targets and might require correction for objects with different shapes if the required fluence is not met on a specific area of the target.” Inactivating SARS-CoV-2 Using 275 nm UV-C LEDs through a Spherical Irradiation Box—Design, Characterization and Validation, April-2021. “Pulsed light (PL) technology is a green, novel non-thermal technology that has huge potential to be employed for decontaminating food- and food-contact surfaces as well as packaging materials . . . . However, PL cannot be used to sterilize food products due to their non-uniform surfaces and opacity, except to reduce their microbial load. Nevertheless, PL is one such technology, which has the capacity to tackle the undesirable effects of conventional thermal processing. PL is an apt method of decontamination for the surface of foods, packaging materials, equipment, and clear liquids. However, a challenge lies in the processing of particulate foods like grains, spices, and products having highly uneven surface due to the ‘shadowing’ of microorganisms.” (Mandal, Ronit, et al., Applications of pulsed light decontamination technology in food processing: an overview., Applied Sciences 10.10 (2020): 3606). “While PL was highly effective at reducing both viruses and bacteria in PBS suspension, its inactivation effectiveness varied with different topographies of berry surface and microorganisms (Table 2). In general, PL treatment at fluence of 5.9, 11.4 and 22.5 J/cm² were not significantly different in reducing microorganisms on strawberries, which suggested that shielding effect is the main factor that limit the inactivation.” (Huang, et al., Pulsed light inactivation of murine norovirus, Tulane virus, Escherichia coli 0157: H7 and Salmonella in suspension and on berry surfaces, Food microbiology 61 (2017): 1-4). “The difference in efficacy of PL treatment against bacterial cells inoculated on blueberry skin and calyx in our study was probably due to the different surface structures of those two sites. Compared with blueberry skin, the calyx has a much rougher surface structure, which potentially allows more shielding/shadowing of microorganisms inside surface details. It is known that PL has a very limited penetration depth (w2 mm) in nontransparent media (Wallen et al., 2001) and is only capable of targeting superficial microorganisms. Therefore, bacterial cells hiding in the sub-surface of the calyx were probably protected from PL. Similar findings were reported by other researchers. Kim and Hung (2012) observed a persistent higher population of E. coli O157:H7 recovered from the blueberry calyx than from the skin after UV treatment. Sapers et al. (2000) found a higher survival of E. coli in the calyx and stem areas of inoculated apples than the skin after a washing treatment. Woodling and Moraru (2005) studied the influence of surface topography of stainless steel coupon on the effectiveness of PL treatment and indicated a complex effect of various surface properties on inactivation. Han et al. (2000) reported that E. coli O157:H7 preferentially attached to coarse and porous intact surfaces and injured surfaces of peppers. Similar phenomena were also exhibited by raspberries and strawberries (Sy et al., 2005). Indeed, higher levels of bacteria were reported to be found in the calyx of naturally contaminated apples (Riordan et al., 2001). The surface structure of fresh produce is usually complex and bacterial cells may lodge in surface irregularities or crevices, i.e., calyx, therefore, reducing the efficacy of PL by preventing the highly directional, coherent PL beam from reaching its target (Lagunas-Solar et al., 2006). Hence, great care must be taken in selecting the representative inoculation site in a microbial challenge study.” (Huang, et al, A novel water-assisted pulsed light processing for decontamination of blueberries, Food microbiology 40 (2014): 1-8).

Skepticism of experts—the lossy effect of scattering in the field of UVC disinfection as cited by experts: “UVC energy follows the same inverse square law for intensity as visible energy and other electromagnetic sources: the amount of energy at the surface is measured in proportion to the square of the distance from the energy's source (UVC lamp), assuming no loss through scattering or absorption.” (Chapter 62-Ultraviolet Air And Surface Treatment (p/o 2019 ASHRAE Handbook—HVAC Applications (SI), ISBN 978-1947192133). “Transmittance decreases in the presence of UV absorbing substances and particles that either absorb or scatter UV light. This results in a reduction of available UV energy for disinfection.” (Trojan UV3000Plus Reference Documents—City of Healdsburg). “Turbidity is cloudiness or haziness in water that's caused by particles that are generally invisible to the naked eye (such as organics, minerals, or chemicals). This will prevent the UV light from reaching microbes because these substances can absorb or scatter UV light.” (UV Pre-Treatment— VIQUA).

Teaching against—“It matters not whether the UV-C or PX-UV light is produced by Xenex, Tru-D or Clorox, they are all hampered by the same laws of physics and limitations, such as: Diminishing power over increasing distance, Angle of the exposed surfaces, Surface shadowing” (The UV Light Deception—Altapure). “Environmentally friendly & Biodegradable, when using a PAA agent . . . . Altapure's patented technology produces a dense cloud of ultra small/sub-micron aerosolized droplets along with an active and constantly replenished vapor phase. The technology combines with the ability to achieve quick kill times within a window of less than forty-five (45) minutes start to finish (common patient room), while leaving no residue, and with only oxygen, water vapor, and vinegar vapor, as the end products . . . . Low %: Only 0.88% H2O2 & 0.18% PAA . . . Non-Corrosive: safe for all electronics . . . 100,000+ Hospital Deploys With No Equipment Damage.” (Technology Background—Altapure) See the Altapure, LLC (Mequon, Wis.) website for more information.

Other background information that will be discussed relates to fogs and to dosimetry.

Fog background: Atmospheric fog and haze have been reported to cover a range of droplet sizes from about 0.1μ to 20μ in diameter, and droplet number concentrations (N_{d}) from about 10/cm³ to 10⁴/cm³ (Haze and Fog Aerosol Distributions). Droplet sizes in the micron range can be found in steam/steam-sterilizers, chemical foggers, humidifiers, fogponics/aeroponics, and fog-based projection screens. Dry fog is generally considered to comprise droplets less than about 10μ in diameter. Sources of dry fog include impingement devices (using compressed air and/or water, found in medical nebulizers and used in mining for dust suppression) and ultrasonic atomizers (e.g., operating in the MHz region, also used in medical nebulizers and humidifiers). Note that some impingement nozzles are characterized as ultrasonic (e.g., HART Environmental's-035H pneumatic ‘ultrasonic’ impingement nozzle with a resonator cap), and ultrasonic devices, when looked at microscopically, can be considered to cause a type of impingement as the transducer surface slaps at the water more than a million times a second.

Dosimetry background: It is well known that there is no standard test for UVC dosimetry of shadowed/shielded surfaces. Traditional dosimeters are flat, e.g., electrooptical pucks and photochromic indicators (stickers/cards), and at-best have been used as appliques on complex surfaces, although this does not account for microtextured surfaces like that of “cantaloupe, strawberry and raspberry”, Application of ultraviolet C technology for surface decontamination of fresh produce. Microbial inoculation of actual microtextured surfaces has been utilized to test fluence but this is time consuming, expensive, and requires a certain level of expertise in microbiology. Sources of supply are disclosed herein. Below find references to dosimetry.

Traditional chemicals used in actinometry: See Polychromatic UV Fluence Measurement Using Chemical Actinometry, Biodosimetry, and Mathematical Techniques, IUPAC Technical Report, Use of Potassium Iodide as a Chemical Actinometer, and Validation of Large-Scale, Monochromatic UV Disinfection Systems for Drinking Water Using Dyed Microspheres.

Dosimetry based on paper/cardboard and plastic decals/substrates/films: UVC100-TRI dosimeter cards and UVC100-DOTS from Intellego

Technologies (Stockholm, Sweden), Quantitative UV-C dose validation with photochromic indicators for informed N95 emergency decontamination, 3D Printed Hydrogel-based Sensors for Quantifying UV Exposure, Radiochromic film dosimetry for UV-C treatments of apple fruit.

3D volumetric dosimeters: HEA-PVA gel system for UVA radiation dose measurement, Modus-QA-Product-Data-Sheet-ClearView-3D-Dosimeter, Ultraviolet Light And The Imperfect Biological Indicator, UV intensity measurement and modelling and disinfection performance prediction for irradiation of solid surfaces with UV light, CN104877147B The preparation method and application of PVA HEA ultraviolet 3-dimensional dose meters (incl. EPO English translation), US20040184955 Moisture resistant dosimeter, US20070020793 Three-dimensional shaped solid dosimeter and method of use, U.S. Pat. No. 4,668,714 Molded dosimeter containing a rubber and powdered crystalline alanine, U.S. Pat. No. 5,633,584 Three-dimensional detection, dosimetry and imaging of an energy field by formation of a polymer in a gel, U.S. Pat. No. 6,218,673 Optical scanning tomography for three-dimensional dosimetry and imaging of energy fields, U.S. Pat. No. 6,787,107 Element with coated dosimeter, U.S. Pat. No. 6,979,829 Devices and methods for determining the amount of energy absorbed during irradiation, U.S. Pat. No. 7,098,463 Three-dimensional dosimeter for penetrating radiation and method of use.

Electrooptical radiometers: UV Cure Check and the Power Puck II (CureUV, Delray Beach, Fla.), UV512C(General Tools & Instruments, New York, N.Y.), UV Clean (Apprise Technologies, Inc., Duluth, Minn.).

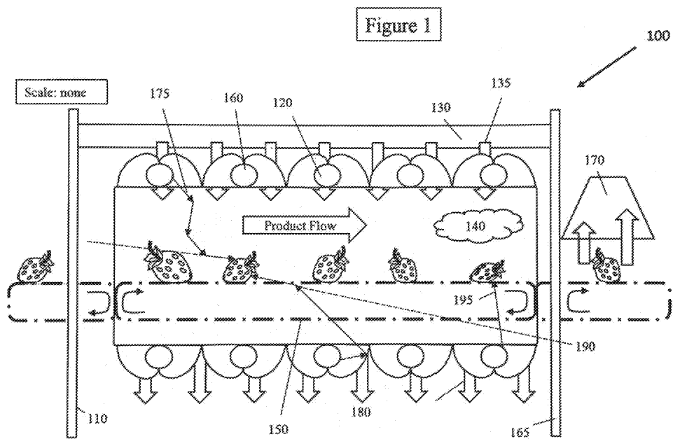

In FIG. 1, strawberries ride along a conveyor belt inside a ‘UV tunnel’ that contains many UVC lamps illuminating them from above and below. UV tunnels are taught, e.g., in U.S. Pat. No. 6,894,299 Apparatus and method for treating products with ultraviolet light, US20120141322 Uv sanitization and sterilization apparatus and methods of use. UV tunnels adaptable for the instant invention are available from JenAct Ltd (Whitchurch, Hampshire, United Kingdom), see UV Torpedo® Conveyor: Increasing product shelf life of fresh salmon fillets, as well as from UV Light Technology (Birmingham, England), Dinies Technologies GmbH (Villingendorf, Germany), and ClorDiSys Solutions Inc (Somerville, N.J.).

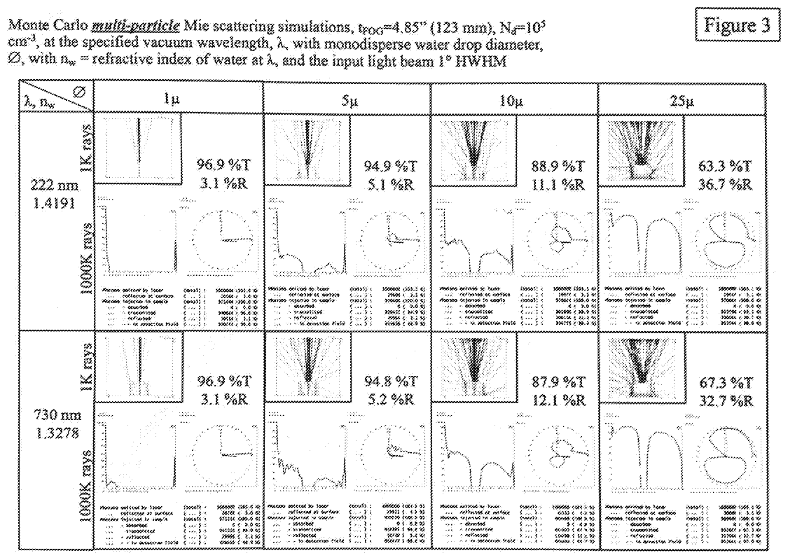

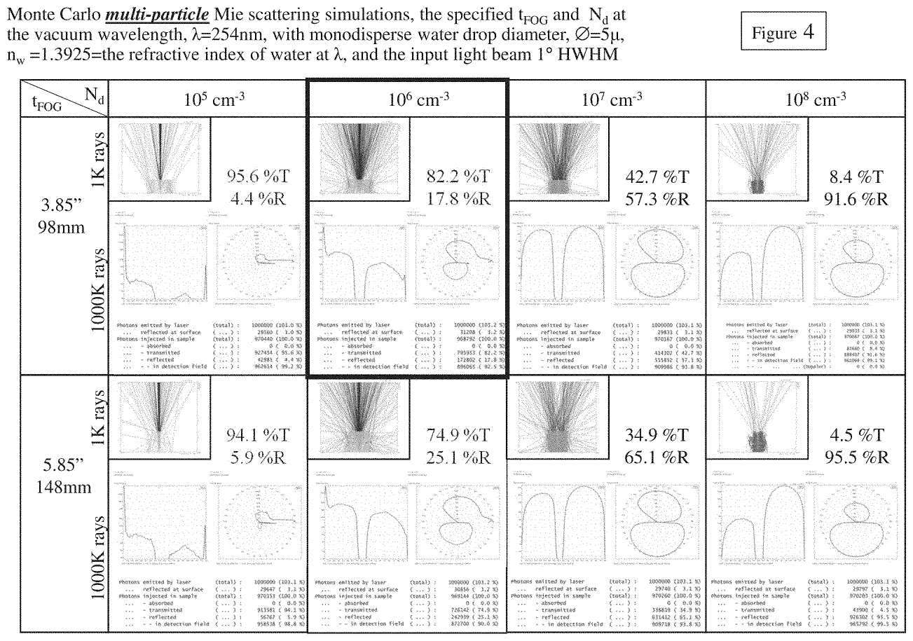

Referring back to FIG. 1, dry fog is injected into the tunnel, and the resultant scattering illuminates the strawberries from a wider range of angles than if without fog. This can be seen by looking at the final angle of the two light rays that strike the strawberry on the left. The dashed lines trace back to locations that could not have come from a lamp directly, and that is how this technology reaches the shadows. Direct rays are available both with and without dry fog—see FIGS. 3 and 4, where in a fog, especially at lower number concentrations, some rays are not scattered but travel along the original light source trajectory. Due to the scattering action, a dry fog need only be ‘radiantly connected’ between the source and target in order for the target to receive scattered rays. Here ‘radiantly connected’ means that wave energy irradiation received at the target passed through some portion of the scattering field. Note that the dry fog injection is roughly between the lamps and the targets (strawberries). Stated differently, it can be said to be in the ‘vicinity’ of the target surface, meaning the fog field can be in straight line between wave energy source and the target surface (employing forward scattering) and/or the fog can be near the target surface, such as off to the side or behind and not in a straight line path between the wave energy source and the target surface (e.g., employing the use of side scattering or backscatter). Thus, the vicinity means that the fog can be radiantly connected to a target (and there can be gaps of low concentration near the targets due to ambient air flow and/or isolation layers). In some applications, the distance from wave energy source to the target may be a foot or so (e.g., in a UV tunnel), in others much longer (e.g., irradiating grape vines with UV in a vineyard, or irradiating plants with UV and far-red light in a greenhouse). In each case, the dry fog concentration can be adjusted to optimize the scattered light that reaches the targets over a given distance. As an aside, in a conveyor system, the target can be a strawberry, but the conveyor belt itself is also disinfected, whether intentionally or not, and thus both are in the vicinity of the dry fog.

To explain this, note first that the fog field is amorphous (unless contained mostly or totally by one or more walls such as an isolation barrier, the enclosure of a UV tunnel, air curtains, etc.) and can flow in sometimes unpredictable ways (e.g., due to unforeseen air currents, which can also change the concentration spatially/temporally). Second, depending on the target surface characteristics, a given application may benefit from injecting fog only along the sides of an object (e.g., a smooth topped object with textured sidewalls) with some even behind an object (e.g., to backscatter the underside of an object on a wire link conveyor belt). Third, in a retrofit application, there may be structural limitations as to where fog can be injected, e.g., when disinfecting objects randomly placed in a hospital room or stimulating plants in a greenhouse with various building-related structural elements blocking portions of a fog field. In fact, portions of fog fields may never receive wave energy, e.g., at the spatial perimeters of the fog field where the concentration tapers-off into the atmosphere and thus no wave energy is directed there, or on a conveyor where wave energy is only directed in the vicinity of objects while the fog field is deposited across the entire conveyor belt for simplicity. Also, as will be discussed, it need not touch the lamps or targets (it can be isolated). The scattering aerosol field (also true for bubble field) is stochastic by nature, and as the Monte Carlo simulations here show, some rays pass through without being deflected by a scattering element (e.g., a dry fog droplet), while other rays deflect once, and yet others more than once. As such, not every scattered ray will strike the target, and some portion of the rays that strike the target will not reach a surface in shadow. In fact, in some applications, targets may be flat and smooth, without shadows. Here the scattering action, if the atomizer feature is engaged for these targets (a programmable version), provides enhanced fluence uniformity. In one set of embodiments, the system is adaptable (in fog field concentration/geometry and/or wave energy beam intensity/geometry, spatially and/or temporally) based on one or more of a simple user switch, identification of the objects input via a touchscreen to the control system, and/or in-situ surface analyses using machine vision. As an aside, the scattering system need not be physically connected to the wave energy portion of the enhanced dosing system. For example, in a UV tunnel application, it can be housed in a unit separate from the tunnel, with a scattering discharge hose that injects fog but does not touch the tunnel. In another exemplary application, a robotic system can be deployed with two separate robots, one to discharge scatterers, and the other to provide the visible and far-red wave energy to plants in a greenhouse.

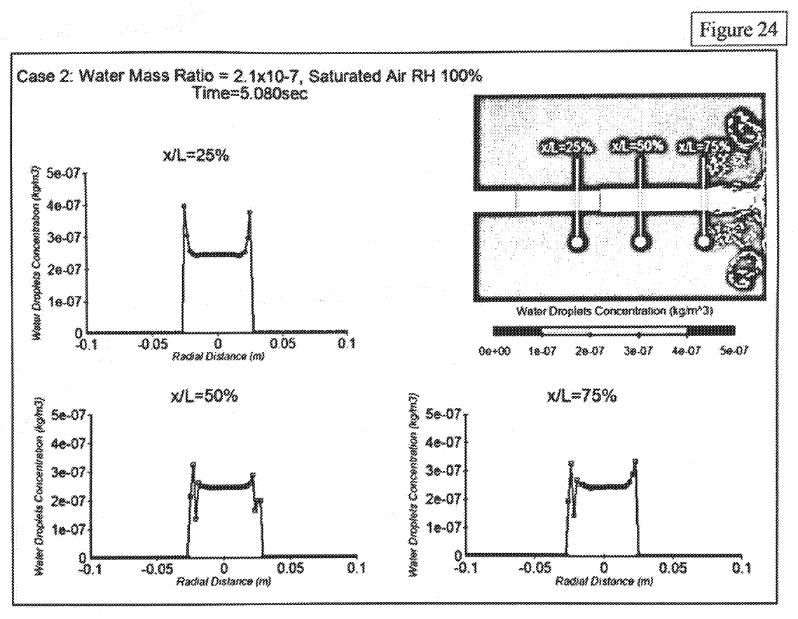

The field can be viewed as a fluid, so it can be turbulent, laminar, have characteristics of both in different spatial locations (e.g., local eddies), and can be directed along swirling or other types of paths as described herein. In the case of dry fog, the droplets are subject to evaporation, coalescence, gravity, etc. as described herein. With all of this, there will be spatial and temporal number concentration gradients. See, e.g., the CFD simulation in FIG. 24. In an exemplary approach, the scattering field is engineered to meet certain ranges of parametric requirements by adjusting its flow, the ambient temperature and RH, the number of atomizers, etc. In exemplary arrangements, the field is changed spatially and/or temporally.

In one exemplary embodiment, puffs or continuous streams of dry fog are injected in front of the strawberries as they travel along a conveyor system, such that the strawberry first receives direct irradiation, and then as is passes through the scattering field, it receives more and more indirect scattered irradiation. In another exemplary embodiment, the strawberries never touch the dry fog puff/stream but pass near or next to it (adjacent), so it receives direct irradiation from some lamps, and indirect from others. The dry fog field and the lamp(s)/target(s) can be touching, not touching, periodically touching, in contact with a different concentration than another part of the dry fog field, etc. It is important to realize that the fog field has a stochastic nature, and thus there is some amorphous quality that must be considered when trying to describe the geometric arrangement between the wave energy source(s), the dry fog (or other scattering) field, and the target(s).

Note also that the dry fog scattered UV also disinfects the conveyor belt itself. Conveyor belt sterilization is disclosed in paragraph [0026] of US20100243410 Method and apparatus for cleaning and sanitizing conveyor belts, U.S. Pat. No. 8,624,203 Conveyor sterilization and U.S. Ser. No. 10/933,150 Conveyor belt sterilization apparatus and method.

Shadows are caused at both the microscopic level comprising cracks/crevices and surface textures. Individual viruses/bacteria/spores range in size from ˜0.02μ to ˜17.3μ, with collections of these individuals in a matrix called biofilms. Biofilms are called sessile when stationary and attached to a surface. They can also become planktonic or free-floating, which happens, for example, when they grow so large that a portion easily breaks off. Shadows also form at the macroscopic level via larger surface obstructions (textured surfaces and larger objects obscuring others). As an aside, unless otherwise specifically defined in a particular context/reference, the term ‘macroscopic’ will be defined as ‘visible to the naked eye’, where the term ‘microscopic’ will be defined as ‘invisible to the naked eye.’ Adult visual acuity>˜29μ, (a human hair is ˜75μ), thus, individual viruses/bacteria/spores are microscopic. See What's the smallest size a human eye can see—Biology Stack Exchange. Biofilms can be microscopic or macroscopic depending upon the number of microbes and the amount of extracellular polymeric substance (EPS) that surrounds them (Materials and surface engineering to control bacterial adhesion and biofilm formation—A review of recent advances). Flour particles appear to be macroscopic (Particle Size Analysis Of Two Distinct Classes Of Wheat Flour By Sieving).

The non-uniformities are due to uneven illumination resulting from reactor optical design and variations along lamp lengths and between lamps, with variations increasing as they age (mercury lamps tend to darken with age). Where visible light diffusers are inexpensive and available in large sizes (polymer based, used in LCDTV backlights), UVC-transmitting optical diffusers tend to be small-in size and (very) costly, partly due to lower market demand, and partly due to the lack of low cost materials that efficiently transmit UVC. Commercially available UVGI luminaires have not been found with UVC transmitting diffusers.

The instant invention teaches the use of dry fog scattering as an efficient UVC transmitting diffuser (fogs based on larger wetting droplets can be used if suitable for a given application, but for UVGI, dry fog will be considered), lowering the peak intensities and raising the valleys. The term ‘dry fog’ is used when the droplet sizes have a diameter of less than about 10μ. When the dry fog is directed to surround an object to be disinfected, it forces a change in the angular profile of the UVC as seen from the surface of the object, reaching the shadows as shown in FIGS. 1, 6, and 26. Note that a volume of dry fog is generally >99% air: (% Air in a fog field)=1−(# of drops/volume)*(volume of a single drop). For example, at a number concentration, N_{d} of 1E7 droplets/cm³, the % air=99.999%, 99.934%, and 99.476% for 1μ, 5μ, and 10μ diameter monodisperse, i.e., single size droplets, respectively. Moreover, both water droplets (e.g., deionized, distilled, tap) of these sizes, and air over reasonable distances, are very transmissive to UVC.

Key scattering parameters are dry fog droplet size, fog concentration (which as will be shown may vary for a number of reasons), and fog thickness (often herein the generic word fog will be used instead of dry fog). The results of many Monte Carlo scattering simulations (using the program MontCarl as cited in detail in the IUVA presentation) will be shown to demonstrate the range of scattering angles and the transmittance and reflectance of the fog field to UVC (and other wavelengths).

In a baseline configuration, the dry fog is generated using pure water (no chemicals) and works for visible light as well. As will be discussed, the water can be deionized, distilled/demineralized, or simply potable tap water (with its minerals and any residual disinfectants used by the water company, or further treated at the user's facility). Dry fogs have been used for years in humidifiers & disinfectant foggers where ‘wetting’ is a concern.

Chemicals can be use instead-of or in-addition-to the water. The EPA has recently listed three COVID-19 Disinfectants suitable for fogging, all based on H₂O₂ (see ‘List N Tool: COVID-19 Disinfectants’ on the EPA website, and search for the word ‘log’ to receive the latest update). One of these is discussed herein as it relates to cold plasma. Many other disinfectants are used, e.g., in outdoor agricultural foggers as well as in food processing plants and are also contemplated for use with the instant invention. Note that the effect of additives on droplet evaporation time should be considered.

Dry fog is one to two orders of magnitude smaller than mists, drizzles, and raindrops. Note that fog atomizers (dry fog or other) tend not to be monodispersed (single diameter), but polydispersed, comprising a distribution of diameters. As an aside, a more generic term for the artificial creation of scattering elements (dry fog or other) would be a generator. Note that ‘artificial’ is used to distinguish from scattering found in nature, e.g., atmospheric fog or bubbles in a crashing ocean wave. Artificial generators also supply, e.g., powder-type scatterers and bubbles from bubblers or via cavitation, e.g., from ultrasonic transducers or propellors). Dry fogs predominantly consist of droplet diameters <10μ, although some distributions with tails out to ˜50μ are still considered dry fog if the amount beyond 10μ is a small % of the overall output.

Based on the Monte Carlo simulations shown in FIG. 3, a wide variety of EM light sources can be used to scatter dry fog, including from the far UVC (200˜230 nm) out to the far-red (sometimes called the near infrared, ˜730 nm), both narrowband (e.g., Excimer lamp, LEDs, LP mercury lamps) and broadband sources (fluorescent lamps, pulsed Xenon lamps, and MP mercury lamps). This was a very surprising and unobvious result.

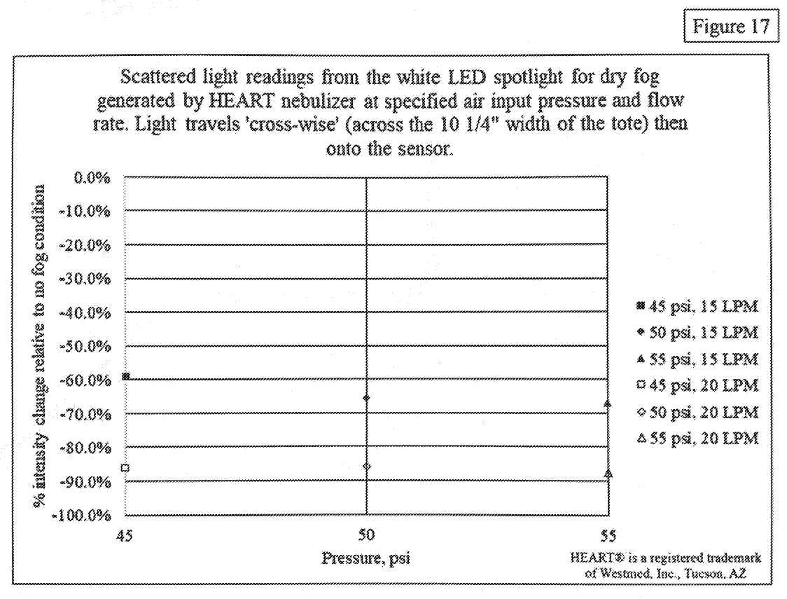

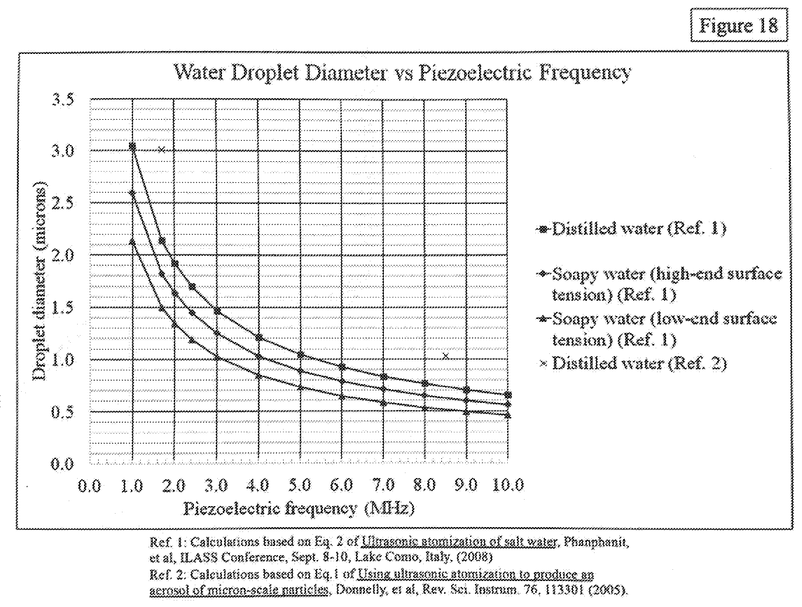

A key characteristic of fog is its droplet number concentration (sometimes called number density or particle concentration), referred to herein as Na, which for standard medical nebulizers are on the order of 10⁶ or 1-million dry fog droplets per cm³. There are two basic dry fog atomizer technologies—impingement (colliding pressurized air with water, with different air flows and pressures as shown in FIG. 17, termed herein a pneumatic atomizer, or by colliding two pressurized water streams) and ultrasonic using piezoelectric transducers (in the MHz region as shown in FIG. 18). Pneumatic dry fog atomizers are generally used for dust suppression, industrial/commercial humidification, and medical nebulizers (for inhalation of certain medications). Piezoelectric/ultrasonic atomizers are generally used for residential/commercial humidification and medical nebulizers. There are many more fogger technologies, some of which generating droplets larger than 10 microns (where dry fog is not necessary), such as some used for wetting leaves with pesticides.

Atomizer Source Water Composition

Dry fog source water can have different effects depending upon its composition. For example, as shown in FIG. 18, droplet size is smaller when surfactants are added (to make soapy water) when compared to distilled water. Minerals in tap water do not evaporate like water, and the residual can be a health concern, and so often distilled water is recommended for use in portable humidifiers, especially around children as the minerals are of a size that is easily deposited in the lungs. Chemical disinfectants can be added to the source water, such as food-safe grades of H₂O₂ (“Hydrogen peroxide, well known as an ingredient in disinfectant products, is now also approved for controlling microbial pests on crops growing indoors and outdoors, and on certain crops after harvest . . . . Agricultural pesticide products usually contain no more than 35% hydrogen peroxide, which is then usually diluted to 1% or less when applied as a spray or a liquid”, Hydrogen peroxide(Hydrogen dioxide)(000595) Fact Sheet (EPA)), to provide additional germicidal action through radicals. Deionized water has high resistivity, making it appear to be a better option for use around electronic components, however, it is also known to be corrosive to certain materials. Some non-obvious properties of tap water and deionized water are cited below.

Tap water—“For tap water, the peak diameters of the mist droplets were in a larger range with much higher number concentrations compared with pure water. Because tap water contains inorganic salts, ion-induced nucleation occurs, increasing the number concentrations of nanosized mist. Shimokawa et al. reported that ultrasonic mist generated from high-purity water has a negative charge [16], whereas the mist generated from low-purity water, such as tap water, has no charge. Therefore, the mist does not grow via mist droplets coalescing because of the electric repulsion between the negatively charged droplets, and the mist becomes stable according to the degree of super saturation. However, for tap water, the mist droplets collide and coalesce because the mist droplets generated from tap water have no charge. This explains why tap water had two peaks in the size distribution of the smaller range.” (Kudo, et al. Effect of ultrasonic frequency on size distributions of nanosized mist generated by ultrasonic atomization, Ultrasonics sonochemistry 37 (2017): 16-22.)

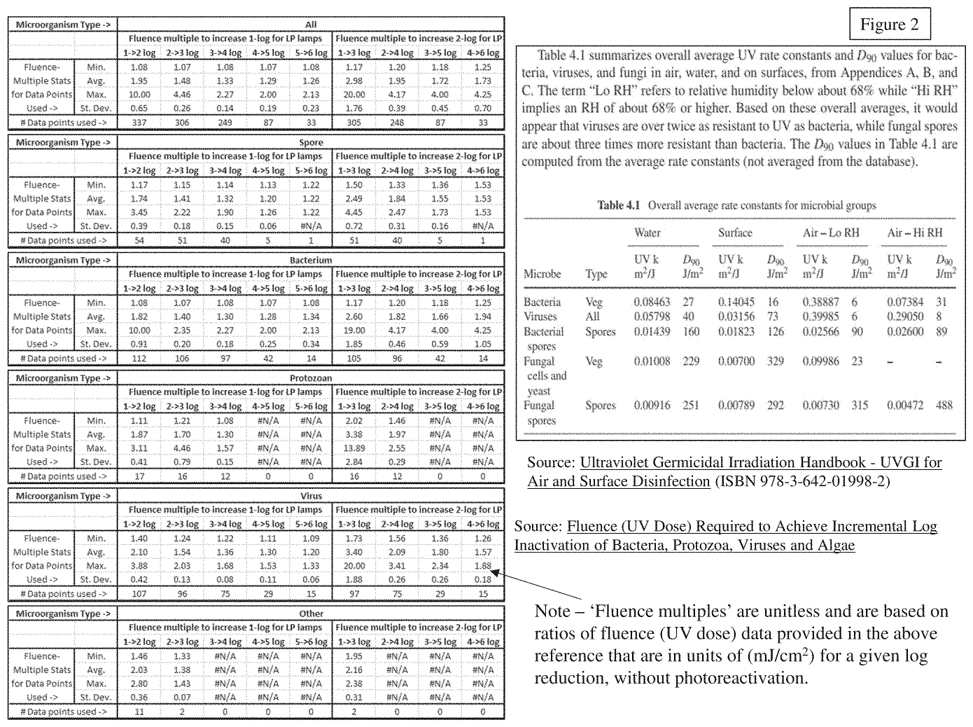

“This study investigated the spatial distributions, concentrations, and metal and mineral composition of aerosols emitted when an ultrasonic humidifier was filled with deionized water (DI), low mineral tap water (LL), high total dissolved solids (TDS)/high hardness water (HH), and high TDS/low hardness water (HL) . . . indoor air μg/m³ concentrations for particles emitted from ultrasonic humidifiers filled with tap water containing minerals exceed ambient air concentrations for PM2.5 and/or PM10. When inhaled during an 8-hr exposure time, and depending on mineral water quality, humidifier aerosols can deposit up to 100 s of μg minerals in the human child respiratory tract and 3-4.5 times more μg of minerals in human adult respiratory tract. Water quality has the greatest impact on the size and concentration distribution of emitted particulates from an ultrasonic humidifier. Water with higher total dissolved solids produced more and larger particles from ultrasonic humidifiers than waters with lower TDS. The HL water produced had more TDS than the HH water, hence why it produced larger and more particles. Distance in the plume from point of emission has a minor effect and only results in a significant difference in particle concentration distributions closer to the humidifier outlet in the plume, while particle distributions in the plume and about a meter below the plume were the same. Higher TDS results in greater lung dose of particles, especially for children. Distilled water should be used whenever possible to prevent respiratory irritation . . . ” FIG. 2. shows the “Particle size distribution for each water quality at 0.3 m in plume and above floor, 1.5 m in plume and above floor, and mean values across all sampling locations in plume and above floor.” The highest mineral particle concentration is shown to be just under 4E5/cm³ (0.3m in the plume) for particles 400 nm and smaller. (Yao, et al., Human exposure to particles at the air-water interface: Influence of water quality on indoor air quality from use of ultrasonic humidifiers, Environment International 143 (2020): 105902.)

“Fine particulates and aerosols emitted by commonly used, room-sized ultrasonic humidifiers may pose adverse health effects to children and adults. The literature documents adverse effects for children exposed to minerals emitted from humidifiers. This study performs novel and comprehensive characterization of bivariate particle size and element concentrations of emitted airborne aerosols and particles from ultrasonic humidifiers filled with tap water, including size distribution from 0.014 to 10 μm by scanning mobility particle sizer and AeroTrak; corresponding metal and elemental concentrations as a function of particle size by inductively coupled plasma mass spectrometer; and calculations of deposition fraction in human lungs for age-specific groups using the multi-path particle dosimetry model (MPPD). Deposition fraction is the ratio of mass deposited to total mass inhaled. When filled with tap water, water evaporated from emitted aerosols to form submicron particles that became essentially “dried tap water” with median size 146 nm and mean concentration of 211μ g-total elements/m³-air including 35 μg-calcium/m³-air in a room of 33.5 m³ and air exchange rate at ˜0.8 hr⁻¹. Approximately 90% of emitted particles deposited in human lungs were <1 μm as shown by MPPD model. The smaller particles contained little water and higher concentration of minerals, while larger particles of >1 μm consisted of lower elemental concentrations and more water due to low evaporation . . . . A commercially available portable ultrasonic humidifier with water consumption rate at 0.21 L/h and run time of about 14 h was placed at the corner of an unoccupied dorm room on a stand of 0.9 m height, and maximum output setting was chosen to represent high-humidity scenario . . . . [test instruments] were placed 1.5 m away from humidifier outlet in the path of the emitted aerosols/particles . . . The particles reached “steady-state” in the room after 2 h’ operation as the size distribution of emitted particles did not change significantly after 2 h and at 8 h (FIG. 2). Particle number concentration and mass concentration were constant approximately at 56,500 particles/cm³ and 320 μg/m³, reported by SMPS . . . . SMPS measures submicron particles (0.014-0.750 mm), AeroTrak measures larger particles (1-10 μm), and the impactor collects particles in 5 size bins (<0.25 μm, 0.25-0.50 μm, 0.50-1 μm, 1-2.5 μm, >2.5 μm). The particle sizers take measurements every 6 min during the 8-h humidifier operation . . . . At steady-state, indicated by the 8th hour data, 95% of particles fell into the size range of 51-424 nm. Large particles of size 1 μm, 2.5 μm, 5 μm, and 10 μm were measured by the AeroTrak and had significantly lower concentrations than the 0.014-0.750 μm particles measured by SMPS.” An overlooked route of inhalation exposure to tap water constituents for children and adults—Aerosolized aqueous minerals from ultrasonic humidifiers.

Deionized (DI) water—An advantage to DI water is that conductivity can be lowered to a level such that electrical-shorts and the like can be avoided. However, DI water can lead to corrosion, although to minimize this, surfactants (e.g., food safe and/or non-ionic) can be added. Corrosion can also be limiting by raising the pH, which is shown in Potential-pH or Pourbaix diagrams (Principles of Corrosion Engineering and Corrosion Control, ISBN 0750659246), and in addition by removing carbonates as shown in the ‘Baylis Curve’ (Causes of Corrosion) in order to also prevent scale forming. CO₂ is also a source of corrosion problems, as it “dissolves in any water present to form carbonic acid H₂CO₃.” (Effect of demineralized water on carbon steel and stainless steel). Thus, the removal/avoidance of CO₂ will also help avoid/minimize corrosion. For example, bulk water for use in dry fogging can be shipped in containers that fill air space with nitrogen. Similarly, CO₂ can be excluded/minimized from inside a UVC tunnel via scrubbers and/or displacing with a positive pressure of nitrogen, noble gas or other.

Dry Fog Atomizers/Nebulizers

a) Dry fog characteristics—Note that many (not all) technical references tend to relate ‘dry fog’ to droplet diameters of 10μ and less and/or provide a qualitative description. In Humidification and ventilation management in textile industry (ISBN 978-81-908001-2-9), it states: “small droplets rebound from an object, but large droplets get burst and wet the object. This is just like how soap bubbles do. That is why the dry fog does not wet the object . . . Dry fog condition: Maximum droplet diameter 50μ or less and mean droplet diameter 10μ or less.”

A more analytic approach is discussed, e.g., in Fine Sprays for Disinfection within Healthcare, citing Development of Methodology for Spray Impingement Simulation. In fact, the first reference cites a Sauter Mean Diameter (SMD) of between 10 and 25 microns that ‘is not “wet”’ (SMD and other particle measurement standards are defined in The Mechanics of Inhaled Pharmaceutical Aerosols—An Introduction, ISBN 0-12-256971-7). The references describe the characteristic phenomena of droplet impingement on surfaces, also citing critical ‘Weber numbers’ to determine rebounding and attaching and splashing on a wetted surface “a droplet which hits the wall is assumed to suffer one of the two consequences: namely rebound or breakup, depending on the impact energy. The transition criterion between these two regimes is described by a critical Weber number”. Knowledge of the factors that go into wetting is of use in the instant invention for optimizing parameters in a given application, especially for dry foods where wetting is undesirable. Note below T_{W}=‘wall temperature’, T_{PA}=‘pure adhesion temperature’ below which adhesion occurs at low impact energy; T_{PR}=‘pure rebound temperature’, above which bounce occurs at low impact energy. Notice that a ‘dry wall’ is distinguished from a ‘wetted wall’, and so for the instant invention, the calculations and parameter adjustments must accommodate this difference. In one embodiment, the surface is a ‘dry wall’ (a loaf of bread being disinfected), and the intent is to keep it dry.

“1. ‘Stick’—in which the impinging droplet adheres to the wall in nearly spherical form. This occurs when the impact energy is very low and the wall temperature T_{W} is below a characteristic temperature, T_{PA}, which will be defined shortly.

2. ‘Spread’—where the droplet impacts with a moderate velocity onto a dry or wetted wall and spreads out to form a wall film for a dry wall, or merges with the pre-existing liquid film for a wetted wall.

3. ‘Rebound’—in which the impinging droplet bounces off the wall after impact.

This regime is observed for two cases: (i) on a dry wall when T_{W}≥T_{PR}, another characteristic temperature to be defined later, in which case contact between the liquid droplet and the hot surface is prevented by the intervening vapor film; (ii) on a wetted wall, when the impact energy is low, and the air film trapped between the droplet and the liquid film causes low energy loss and results in bouncing.

4. ‘Rebound with break-up’—where the droplet bounces off a hot surface (T_{W}≤T_{PR}), accompanied by breakup into two or three droplets.

5. ‘Boiling-induced breakup’—in which the droplet, even at very low collision energy, disintegrates due to rapid liquid boiling on a hot wall whose temperature lies near the Nakayama temperature T_{N}.

6. ‘Break-up’—where the droplet first undergoes a large deformation to form a radial film on the ‘hot’ surface (T_{W}≥T_{PA}), then the thermo-induced instability within the film causes the fragmentation of the liquid film in a random manner.

7. ‘Splash’—in which, following the collision of a droplet with a surface at a very high impact energy, a crown is formed, jets develop on the periphery of the crown and the jets become unstable and break up into many fragments.”

The second reference goes on to cite the parameter space for determining the type of impingement: “The existence of these impingement regimes is governed by a number of parameters characterising the impingement conditions. These include incident droplet velocity, size, temperature, incidence angle, fluid properties such as viscosity, surface tension; wall temperature, surface roughness, and, if present, wall film thickness and gas boundary layer characteristics in the near-wall region.”

With respect to the incidence angle, see Impaction of spray droplets on leaves: influence of formulation and leaf character on shatter, bounce and adhesion (2015), citing/interpreting Spread and Rebound of Liquid Droplets upon Impact on Flat Surfaces, the former stating, “Mundo et al. (1995), who proposed the relation K=Weₙ^{1/2} Reₙ^{1/4}; (1) where Weₙ=ρVₙ²D/σ and Reₙ=ρVₙD/μ are the dimensionless Weber and Reynolds numbers computed with the component of velocity normal to the impacted surface Vₙ=(V sin α); (2) Here a is the angle between the leaf surface and the incoming trajectory of impact (0<α≤90°). Thus (1) is valid for both normal and oblique impactions. A droplet is predicted to shatter on impact if K>K_{crit} (3) where K_{crit} is a critical value related to the properties of the surface being impacted . . . . Note that as the angle of impact a decreases, Vₙ will in turn decrease, leading to a smaller calculated value of K. The implication of this trend is that shatter becomes less likely with a smaller impact angle . . . . Note that as the angle of impact a decreases, Vₙ will in turn decrease, leading to a smaller calculated value of K. The implication of this trend is that shatter becomes less likely with a smaller impact angle . . . . A successful bounce is indicated by a positive value of an ‘excess rebound energy’: E_{ERE}>0. If E_{ERE}<0, then the droplet is predicted to adhere to the substrate . . . ”, where E_{ERE}=[(π/4) Dₘₐⱼₒᵣ² (1−cos θₑ)+(2/3)π(D³/Dₘₐⱼₒᵣ)]σ

−0.12πD²σ(Dₘₐⱼₒᵣ/D)^{2.3}(1−cos θₑ)^{0.63}−πσD² and D=droplet diameter before impact, Dₘₐⱼₒᵣ=major diameter of the resultant elliptical droplet formed at the surface during impact, σ=surface tension of the droplet, and θₑ the equilibrium contact angle. The value of Dₘₐⱼₒᵣ is determined by solving two cubic equations, numbers (5) and (7) as defined in the paper (including the calculation of Dₙₒᵣₘₐₗ in order to calculate Dₘᵢₙₒᵣ, then finally Dₘₐⱼₒᵣ), and then the ‘excess rebound energy’ is calculated to determine if the droplet striking a surface at an oblique angle bounces or adheres. Note that Dₘₐⱼₒᵣ is dependent on θₑ, the Weber and Reynolds numbers, (We, Re) using the normal velocity, Vₙ. Laboratory measurements are presented for water (and other liquids with different surface tensions) at normal incidence and at 45 degrees, both on wheat and cotton leaves. The authors acknowledge scatter in the test results, owing to a number of factors, e.g., the complexity of using real leaves, non-monodisperse droplets, surfaces are not always dry, etc. Nonetheless, this information establishes a good baseline of the factors influencing wetting for the instant invention, and test procedures, both in the paper and in the references.

A dry-fog can extend beyond 10μ diameter droplets when considering the wide range of free variables described above. Note, however, that the application cited in the above required some amount of adhesion of the droplet to the wall, since chemical contact was required, which is not a basic requirement for the certain embodiments in the instant invention.

From a practical perspective, each application of the instant invention will occupy a parameter space (with spatial and temporal variations), e.g., on number concentration layer thickness, and droplet sizes that provide desirable scattering profile, as well as bounds on the allowable amount wetting (which may be 0 or close to 0 for some applications, and larger for others, e.g., in greenhouses where the fog can also be used to hydrate the plants) which is a function not only of droplet sizes, but as disclosed herein, many other parameters as well. In addition, there are other considerations, e.g., (a) the effect of irradiation as a function of moisture content and/or wetness of the product(s) being irradiated (see, e.g., Optimization of UV irradiation conditions for the vitamin D2-fortified shiitake mushroom (Lentinula edodes) using response surface methodology and Inactivation of Listeria and E. coli by Deep-UV LED—effect of substrate conditions on inactivation kinetics), (b) the degree to which the processing equipment (e.g., UVC tunnel) and/or ancillary equipment (e.g., hospital EKG machine next to a patient's bed to be disinfected with UVC dry fog scattering, or greenhouse ventilation fans in a room with Visible/NIR dry fog scattering, etc.) in/near the treatment area can handle wetness over time (e.g., re: corrosion), (c) whether there is a drying process step after any wetting imparted during the dry fog scattering of UV (or Visible/NIR, etc.), (d) whether a small number concentration of ‘wet’ droplet diameters can be accommodated due to the tradeoffs when choosing an atomization approach (see, e.g., the distributions in FIG. 4.23 in Humidification and ventilation management in textile industry), (e) whether the large droplets impinge on a surface and break up and/or work to increase the humidity in support of minimizing evaporation of the sub-10μ droplets, (f) whether a demister/separator is used to remove certain droplet sizes, etc.

So, the efficacy of the instant invention, inter alia, requires a fog whose degree of dryness is based on the management of droplet sizes to balance scattering vs. wetness.

One then can characterize the dry fog as comprising a droplet distribution based on diameter, volume, mass, etc., (where the distribution can be monodispersed or polydispersed) of a range of thicknesses meeting predefined light scattering (relative to one or more wavelengths) and wetness criteria (with or without any wetting, the latter true, e.g., of a 3.6μ diameter monodispersed concentration of water droplets).

These dry fogs can further be characterized as produced by one or more artificial atomizers, such as one or more of the types cited herein, e.g., pneumatic, or piezoelectric/ultrasonic (as opposed to a natural fog due to weather conditions), where a collection of atomizers can be of the same type or a mixture of types.

Piezoelectric Ultrasonic atomizers—these use high frequency (often MHz, sometimes kHz) electrical excitation to deflect a transducer causing ejection of droplets, and can be found in a wide variety of applications, including those that are generally enclosed and packaged as medical nebulizers, theatrical fog effects, residential/commercial/industrial humidification, etc. Specialty ‘mesh’ type ultrasonic transducers can be found in the I-neb Adaptive Aerosol Delivery (AAD) System from Philips Respironics (Murrysville, Pa.). Simpler devices are available in single transducer kit form, e.g., from Best Modules Corp. (Science Park, Hsinchu, Taiwan) as used herein to evaluate the particle number concentration using three of their 10 watt transducers. It was found that for this configuration, in a closely packed triangular array, a 635 nm laser beam could not visually traverse the fog blanket they created in an ˜8″×10″ container, suggesting these devices are suitable for use in the instant invention, as the fog field can be easily diluted to get a wide range of forward scattering distributions. Multi-element transducer modules are available, e.g., from The House of Hydro (Fort Myers, Fl). These types of arrays can be found, e.g., in turnkey products such as that detailed in Ultrasonic Humidifier System—Jiangsu Shimei Electric Manufacturing Co. This shows a fan blowing air into the unit, around a baffle, and then directs the dry fog generated from an array of ultrasonic atomizers (e.g., each operating at 1.7 MHz, submerged under water) out of the unit through one or more exit holes (higher wattage systems have more than one hole) that are constructed to receive a specific diameter PVC pipes. The dry fog exiting the PVC pipes can be directed into a UV tunnel from the entrance and/or exit sides, or into a manifold with a plurality of ports to distribute the dry fog over a target area. This fog delivery approach can be seen as a fog injector, or simply an injector that injects the fog between the UV source and the target surfaces, including those in shadow. In one preferred embodiment, the dry fog is directed at the top surface of a conveyor belt, forming a layer thickness/distribution that is optimized for a given object. Note that the transducers are submerged in the source water with a preferred amount of water column above them. In one embodiment, baffles are added in the source water to minimize sloshing that would vary the height of the water column. Note also that these transducers each create a small fountain at the water surface. If this is impeded (as was found in the inventor's own early testing), the fog will not generate or will be suppressed.

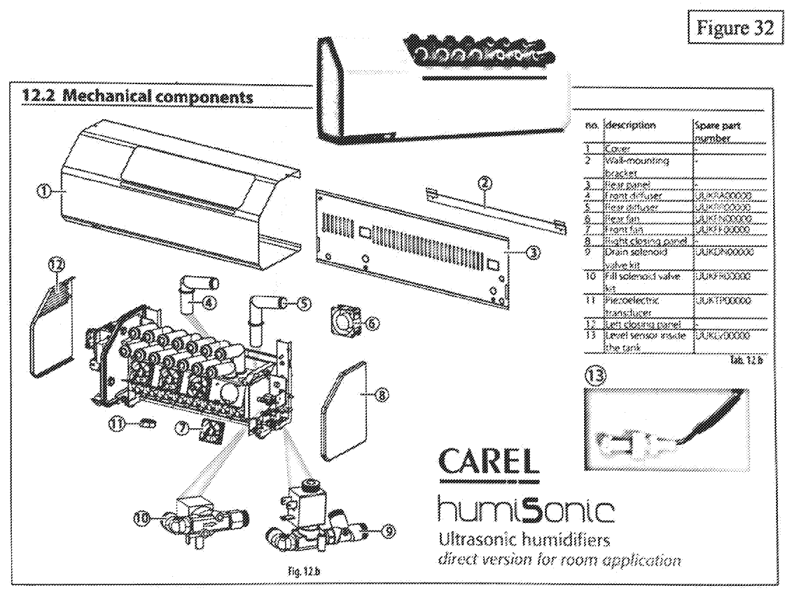

The ultrasonic systems using the trade name ‘humiSonic’ from Carel (see FIGS. 32˜38) are described in technical detail herein. These systems in a sense are more sophisticated due to their extensive network interface and onboard computerized control system.

As an aside, also recall the use of dry fog in a greenhouse for scattering (a) visible/NIR light to promote photosynthetic plant, and/or (b) UVC/B/A light to curtail bacterial/viral/fungal growth on plants. In these instances, the dry fog can be applied via stationary foggers with PVC pipe routing as needed and/or via mobile foggers, with the appropriate light source(s) fixed and/or mobile as desired for the application.

To accurately model scattering using optical ray tracing, it is beneficial to obtain droplet size distributions. This is shown for piezo-type ultrasonic transducers using both pure water and tap water in Effect of ultrasonic frequency on size distributions of nanosized mist generated by ultrasonic atomization. The y-axis can be understood by reading Aerosol Statistics Lognormal Distributions And dN_dlogDp, which includes the explanation that the y-axis is not simply the number concentration, N, because of how differing binning can make similar data look different. This is useful to understand as some data is only provided in this format. See also section ‘1.1 Size Distribution’ of Some Useful Formulae for Aerosol Size Distributions and Optical Properties. Note that tap water has mineral content, and while water evaporates, minerals do not.

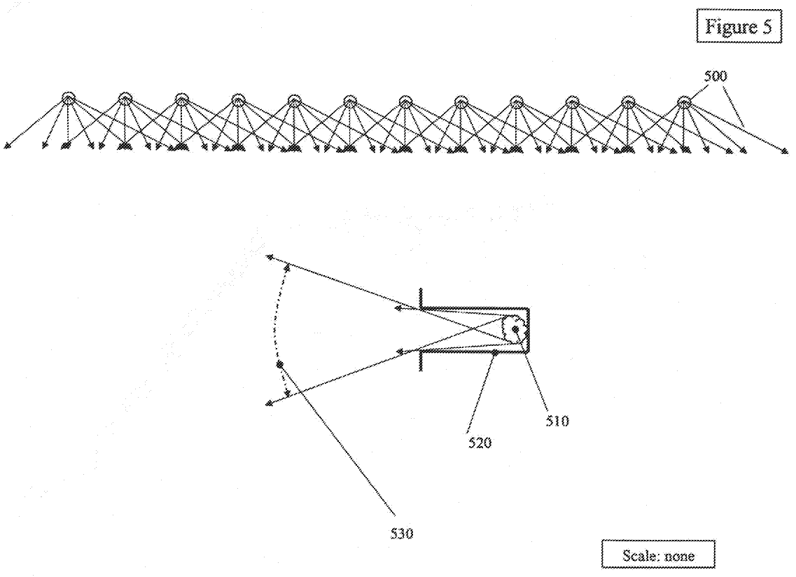

See FIG. 18 for plots of fog droplet sizes based on frequency for distilled and hi/lo soapy water surface tensions (droplet sizes decreased using surfactants in comparison to distilled water). See also FIG. 5b in Size distributions of droplets produced by ultrasonic nebulizers re: a droplet size distribution for a 1.7 MHz ultrasonic (piezoelectric) ‘Mist maker’ atomizer, normalized to the median size, <d>, of 5.6 μm.

The water layer thickness above the piezo element also has an effect on overall performance and is typically specified 3.0˜4.5 cm and may be affected by the radius of curvature for focused transducers. “In the simplest design, the liquid to be nebulized comes into contact with a flat transducer, oscillating at the desired frequency. In this arrangement the energy is termed unfocused. The arrangement allows all of the liquid to eventually be aerosolized from the surface without much change in the aerosol characteristics. A second design curves the transducer to produce a focused point of energy in much the same fashion as a concave mirror focuses light at a single point. This arrangement is capable of producing a finer aerosol; however, as the liquid level drops in the nebulizer cup, the surface of the fluid moves below the focal point and the efficiency of the device decreases. Ultrasonic nebulizers with focused transducers require a separate continuous-feed mechanism to maintain the liquid level at the appropriate height above the transducer. The sonic energy decreases with increasing distance from the focal point (18). Devices employing flat transducers are preferred for administration of small volumes of drug (13). In some devices, the solution to be nebulized comes into direct contact with the transducer or a bonded surface above the transducer. In others, a liquid interface acts as a couplant between the transducer and the base of the nebulizer cup. This couplant, usually water (for safety reasons), allows the base of the nebulizer cup to be shaped for more efficient transfer and focusing of the energy.” Chapter 10, ‘Ultrasonic and Electrohydrodynamic Methods for Aerosol Generation’, Inhalation Aerosols—Physical and Biological Basis for Therapy, Second Edition ISBN 978-0-8493-4160-1. Note that this textbook contains a wealth of information on all aspects of droplet formulation, evaporation, coagulation, etc. A Third Edition is available, ISBN 978-1-1380-6479-9, with additional content. See also U.S. Pat. No. 8,001,962 Nebulizing and drug delivery device and U.S. Pat. No. 9,339,836 Ultrasonic atomization apparatus.

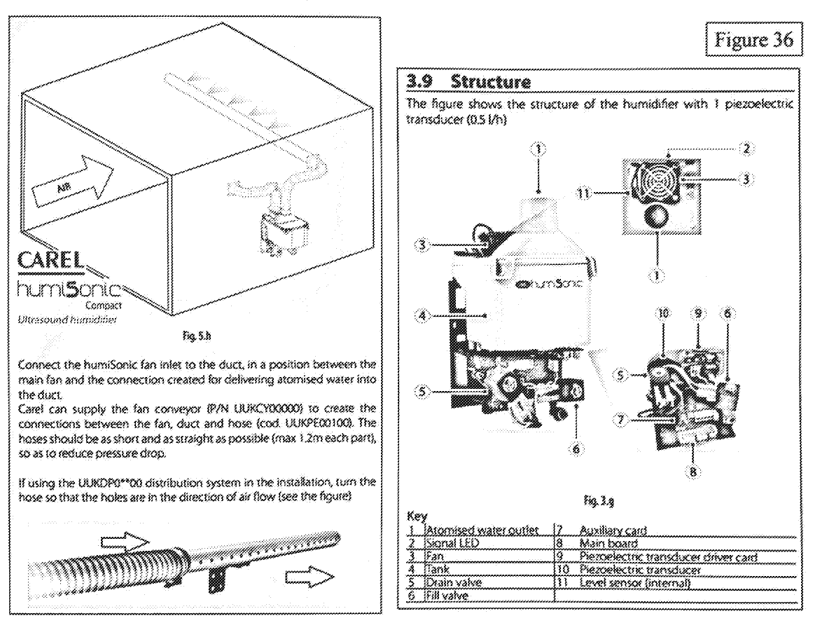

Sophisticated complete ultrasonic humidifier systems are available from Carel humiSonic (Carel Industries S.p.A., Padova, Italy), including serial communications for control, monitoring, and networking more than one unit. Salient details are provided in FIGS. 32˜38. In one embodiment, an array of Carel humiSonic compact ultrasonic dry fog humidifiers (Carel Industries S.p.A., Padova, Italy) is aligned along the length of a UV Tunnel, with a hose from each unit directing fog within the tunnel (individual units up to 1 kg/h humidified air at 110 watts). Operational and system-level details are provided in Carel humiSonic Compact Manual, comprising a single output port, although the manual shows how to connect to a manifold distributor with multiple ports. Details are provided in FIGS. 36˜38. These systems periodically drain to provide a washing function to minimize scale build-up, flush residual dirt, and remove stale water to avoid hazardous microbial growth. An RS-485 serial link provides communication to/from the unit. The system can be configured for proportional control using an external signal. See also Carel humiSonic Direct User Manual (up to 8 kg/h humidified air at 690 watts) comprising multiple output ports, parts of which are replicated in FIGS. 32˜35. These manuals provide a wealth of detailed information, including RS-485 command structure for system parameters (referenced below) that can be exchanged over the link. RS485 controllers can be purchased, e.g., from the industrial automation group of Siemens (Nuremberg, Germany and Alpharetta, Ga.), which includes their SIMATIC line of controllers as well as from NI (formerly National Instruments Corporation, Austin, Tex.), which includes their LabVIEW graphical programming language suitable for use with their industrial controllers.

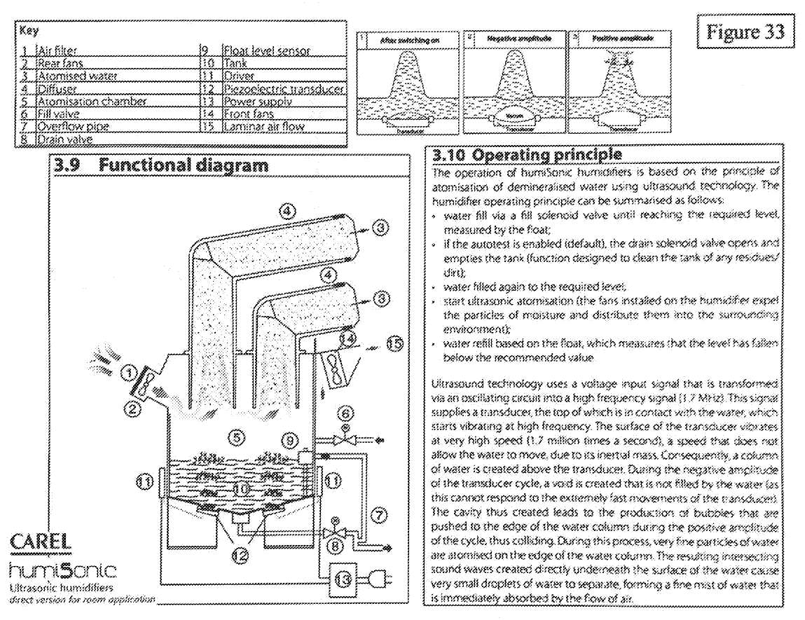

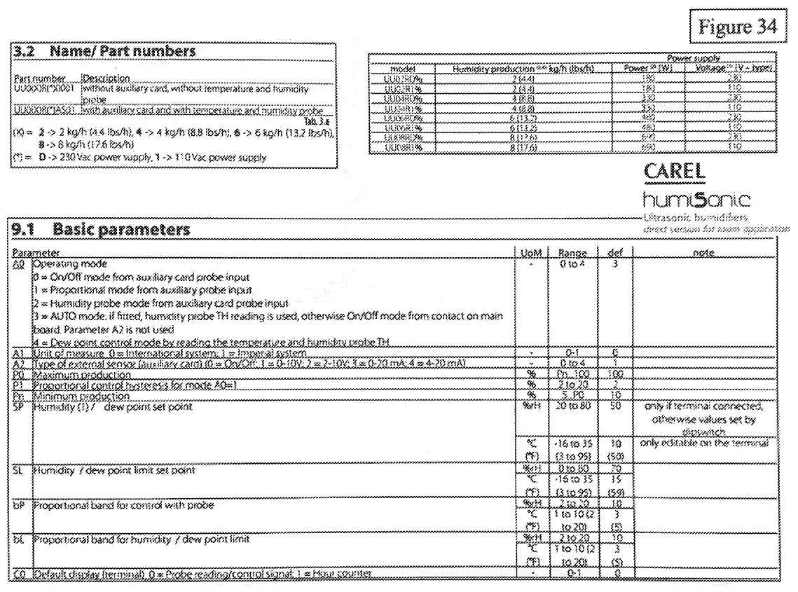

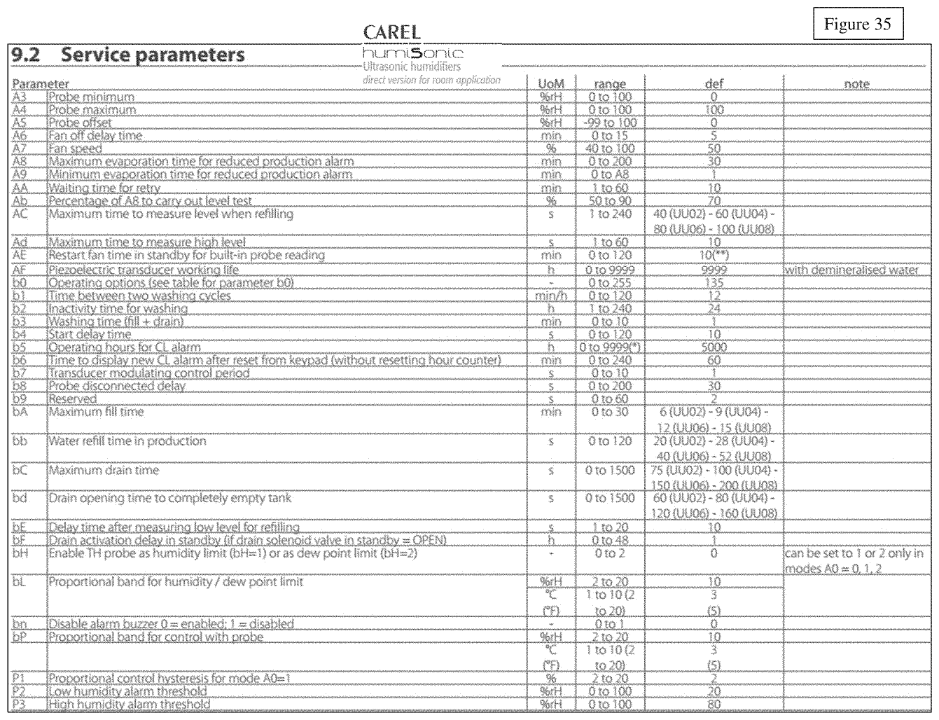

FIG. 32 shows an isometric picture and exploded view of the Carel humiSonic ultrasonic humidifier. Part numbers are shown in FIG. 34. Note the diffusers, 4 and 5, for directing the flow as required. Note the fan, 7, that is used to push out the atomized air created by the ultrasonic transducer, 11, from its section of the fog chamber into its four respective diffusers. The unit comprises a fill solenoid, 10, a drain solenoid, 9, and a level sensor, 13 that feeds into the control system. FIG. 33 shows the operating principals of the atomizer, including 1.7 MHz ultrasonic transducers, 12, operating on water in a tank, 10, with an atomization chamber, 5, assisted by a rear fan, 2, for pushing out the atomized air, and a front fan, 14, providing laminar air flow adjacent to the atomized water, 3, exiting the unit. FIG. 34 identifies the basic parameters of the system, including units of measure (UoM), the parameter range, the default values (def), and notes. FIG. 35 describes service parameters in a similar way. These parameters are communicated to other units and a system controller via serial communication links. See the manual for more details.

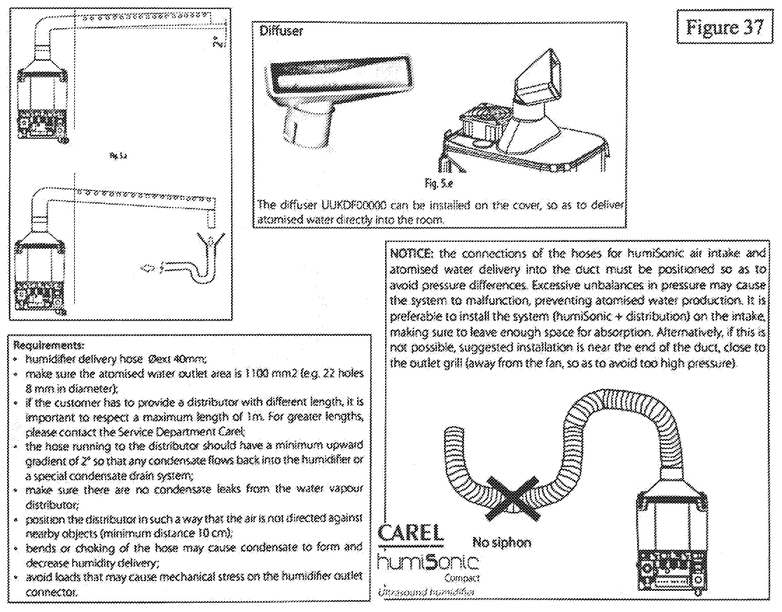

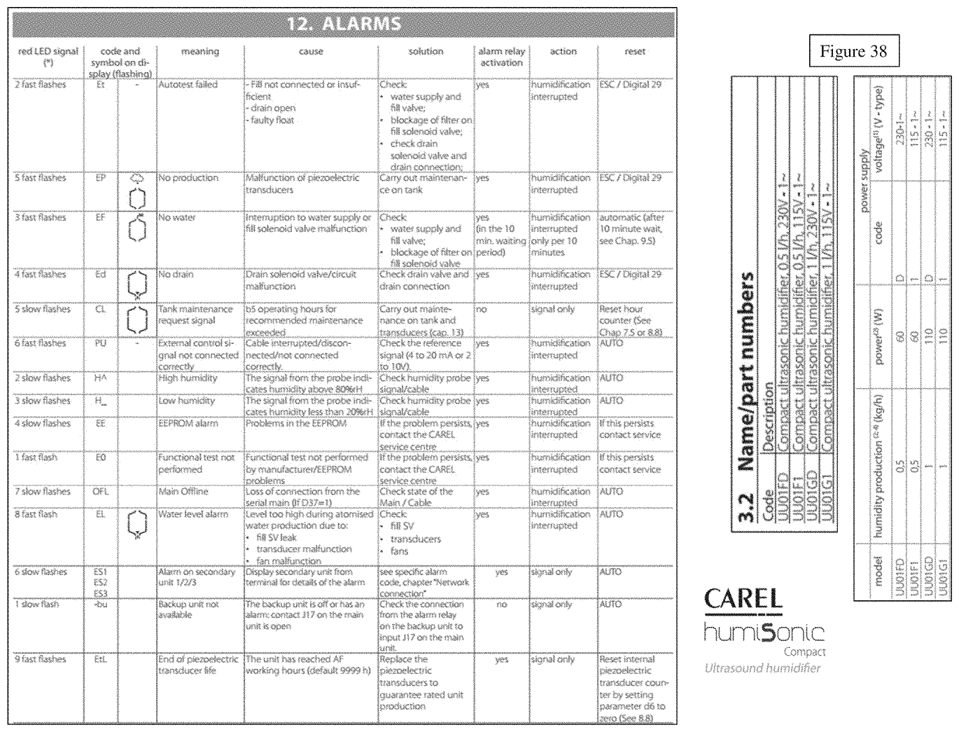

FIG. 36 shows the ‘Compact’ or modular ultrasonic humidifier from Carel, with part numbers shown in FIG. 38. The unit can be fitted with one or two ultrasonic transducers. As shown in FIG. 36, the unit can be fitted with a hose and manifold distribution system. The structure is similar to a single section of the larger unit shown in FIGS. 32-35, and thus will not be repeated. FIG. 37 details requirements relative to hose size and length, as well as maintaining a 2° gradient (relative to the water line) for proper condensate drainage (either back to the unit for recycling, or to an external drain). A diffuser accessory is shown for configurations where a manifold is not suitable. A NOTICE is provided to avoid pressure-related flow issues or creating a goose-neck section in the hose that could lead to siphoning (or a water trap from condensate that can clog the flow over time). The parameters are similar to that in FIGS. 34 and 35, so they will not be repeated. FIG. 38 shows the alarms (similar to that of the larger unit in FIG. 32), e.g., related to no-water, high/low humidity, water-level, self-test, transducer end of life (9,999 hours using demineralized water per the note in FIG. 35), etc. Alarm notifications activate an LED indicator and energize relays for immediate control.

Note that the Carel documentation does not specify N_{d}, and thus testing is required to understand the number of ultrasonic transducers are required for a given scattering application.

In a preferred embodiment, additional commands and alarms are added to the suite defined by the Carel humiSonic product. Examples of commands would be: read scatterometer sensor(s), constant/open-loop N_{d} mode(s), set N_{d} to a fixed value in layer number ‘n’, read internal wind velocity, read external wind velocity, read UV intensity source monitor sensor(s), read UV intensity at target location(s), tent/tunnel speed relative to the ground, set fan/blower speed for controlling N_{d} of injected fog, etc. Examples of alarms would be: unable to reach N_{d}, UV lamp failure(s), lamp temperature exceeded, etc.

Note also that the HEART® nebulizer used for measurements herein receives power from an air compressor rated at 495 watts, which cycled on/off during testing roughly 60 seconds-on and 30 seconds-off, or a duty cycle of 60/(60+30)=67%. The average power is then roughly 67%*495 watts=331 watts. This nebulizer, according to the datasheet, has a “High aerosol output (up to 50 mL/hr)”. Note that 1 liter of water weighs 1 kg, so 50 mL is equivalent to (50/1000)=0.05 kg of humidified air. To (very) rough order, the efficacy of this approach is therefore 0.05 kg/hr @ 331 watts=1.51E-4 kg/hr-watt. The Carel Compact unit outputs 1 kg/hr @ 110 watts for an efficacy of 9.09E-3 kg/hr-watt, and the larger Carel unit outputs 8 kg/hr @ 690 watts for an efficacy of 1.15E-2 kg/hr-watt. Note that an hr-watt (or watt hour) is a joule. So, the HEART outputs 1.51E-4 kg/J, and the Carel units output 9.09E-3 kg/J and 1.15E-2 kg/J, respectively. Therefore, the ultrasonic based Carel units are 9.09E-3/1.51E-4=60 and 1.15E-2/1.51E-4=76 times higher in efficacy than the pneumatic HEART nebulizer (assuming all else is roughly equal, like the particle size distributions, and that the compressor that was used has reasonable efficiency).

Pneumatic atomizers—there are two main groups that use impingement of water to create dry fog droplets. One type uses compressed air impingement on still water, e.g., used in a medical nebulizer cup such as the HEART® nebulizer used for testing herein. Another uses one of a variety of impingement nozzles that use one or more of a pressurized air stream against, a pressurized water stream, and a specially fabricated impingement surface. A HART Environmental nozzle using pressurized air and water streams was evaluated for the instant invention. These are used in dust suppression, commercial/industrial humidification, and even aircraft environmental testing as will be disclosed below.

i) Nebulizers of the type typically used for drug delivery are, e.g., the B&B HOPE NEBULIZER™ from B&B Medical Technologies (Carlsbad, Calif.) and HEART® nebulizers from Westmed, Inc. (Tucson, Ariz.). These devices tend to be designed to eliminate particles large enough to cause wetting, generating particles small enough to ensure they make it into the lungs. The HEART® nebulizer specifies ‘2-3μ particles’ and is rated at aerosol flow rates ‘up to 50 mL/hr’ which is equivalent to 0.0083 liters/min (LPM). The instructions state to set an airflow flowmeter to a flow rate of 15 liter/minute at 50 psi into the nebulizer and the output flow rate will be 50 ml/min (±20%). Note that the water resides in the integral container, and no external source of water pressure is needed. For insight into the number concentration available from nebulizers, see, e.g., Dynamics of aerosol size during inhalation—Hygroscopic growth of commercial nebulizer formulations, and Characterization of aerosol output from various nebulizer compressor combinations. The first reference contains a chart citing the number concentrations for various commercially available nebulizer/compressor combinations, i.e., pneumatic nebulizers.

ii) Nozzles traditionally used for dust suppression, e.g., Dust Solutions, Inc. (Beaufort, S.C.), Hart Environmental, Inc. (Cumming, Ga.), and for control of humidity, applying chemicals, disinfection, cooling, and static control, are available e.g., from Sealpump Engineering Limited (Redcar, England), Koolfog, (Thousand Palms, Calif.), and Ikeuchi USA, Inc. (Blue Ash, Ohio).

The Sealpump Engineering 035H Ultrasonic Spray Nozzle specifies at 5 bar air (72 psi) and 0.5 bar liquid (7.2 psi) it is rated at 1.2 liters per hour, or 0.02 LPM—roughly 2.4 times the output of the HEART® nebulizer, although the droplet size distributions of both are not published by the manufacturers. The 035H droplet size is stated as ‘3-5 micron droplets’. Note the term ‘ultrasonic’ in this context is described on the Sealpump Engineering site as follows: “Ultrasonic fogging nozzles are twin fluid type spray nozzles, usually using compressed air and water to create a finely atomised water droplet, typically this nozzle range produces droplets from 3 to 10 micron. This ultra-fine droplet is created through its unique nozzle design compressed air passes through the nozzle at high velocities and expands into a resonator cavity where it is reflected back to complement and amplify the primary shock wave. The result is an intensified field of sonic energy focused between the nozzle body and the resonator cap. Any liquid capable of being pumped into the shockwave is vigorously sheered into fine droplets by the acoustic field. The droplets have low mass and low forward velocity with low impingement characteristics. Fine atomisation ensures uniform distribution of the liquid with minimum of overspray and waste.” See also Sealpump Spray Technology for the Food & Bakery Industries, describing ‘Ultra-fine fogs down to only 1 micron (0.001 mm)’ for the bakery industry, where ‘systems can be supplied with humidity sensors and full control package’.

This type of dry fog nozzle is marketed, e.g., for dust suppression. See also Dust Solutions, Inc. (Beaufort, S.C.) and JD UltraSonics—Product and Information Catalogue (also includes system connection diagrams and associated components). The nozzles are inserted into a nozzle adapter that routes the air and water to the appropriate inlets.

Additional details of the 035H and similar nozzles can be found in Spray Nozzle Designs for Agricultural Aviation Applications, Nozzle Type Evaporative Cooling System in the Greenhouse, Using Agglomerative Dust Suppression and Wind Breaks for Fugitive Dust Abatement, Dust Control Handbook for Industrial Minerals Mining and Processing, as well as Micron Droplet Dust Suppression Proves Out in Variety of Fugitive Dust Applications (5th Symposium on Fugitive Emissions—Measurement and Control).

The design (including CFD analyses) and use of a venturi fitted on the output of such a nozzle to direct the spray pattern is discussed in Design and field trials of water-mist based venturi systems for dust mitigation on longwall faces. Such an approach would be useful for directing fog in outdoor applications such as farms and vineyards.

Pressurized water for an 035H nozzle can be derived via regulating municipal water, or by using a pressure pot like those used in spray painting—just use water instead of paint, where the compressed air feeding the pressure pot will force water out of the pressure pot under pressure, which can then be fed through a pressure regulator. Pressure pots are available from, e.g., TCP Global (San Diego, Calif.). Note that water-siphoning can occur once the compressed air is removed, and so a shutoff (or anti-siphon) valve on the water supply may be needed to avoid water streaming/dripping from the nozzle for those applications that are sensitive to water (like bread during UVC exposure).

The requirements for dust suppression allow for larger particle diameters than medical nebulizers. Removal of larger particle sizes (to ensure a level of fog ‘dryness’ suitable for the application requires demisting (via mist eliminators) as previously cited. A good summary, can also be found in AMACS Mist Eliminator Brochure, stating in part “Mechanisms of Droplet Removal—Droplets are removed from a vapor stream through a series of three stages: collision & adherence to a target, coalescence into larger droplets, and drainage from the impingement element. Knowing the size distributions . . . is important because empirical evidence shows that the target size—important in the first step of removal—must be in the order of magnitude as the particles to be removed.” See also the mist elimination technologies/products in the Koch-Otto York Product Catalog.

Droplet diameter distribution data was obtained from Dust Solutions, Inc., Beaufort, S.C.), based on internal laser diffraction testing of an −052 type nozzle (P/N DSN-3) showed the median droplet size of 1˜3μ and almost nothing greater than 45μ.

Qualitative testing for the instant invention was performed on a 035H nozzle from Hart Environmental Inc. (Cumming, Ga.). Compressed air was generated in on/off cycles by a 490 watt compressor (0.6 HP Rated/Running, 1.2 HP Peak, 1.60 CFM @ 40 PSI, 1.20 CFM @ 90 PSI) with an integral 1 gallon tank, P/N 1P1060SP from California Air Tools (San Diego, Calif.), passed through a secondary 3 gallon storage tank, routed through a pressure regulator, and was connected to the air-port of the nozzle. Instead of using a pressure regulator connected to a pressurized domestic water source (e.g., city water or pumped well water), the same compressed air was connected to a pressure regulator fitted to a 2 liter VEVOR Pressure Pot Tank purchased via Amazon and filled with tap water, where the pressurized water output was connected to the liquid port of the nozzle. This allows a greater range of pressures, including negative pressures by shutting air pressure to the pressure pot, and allowing the nozzle to suck water from the pot via the air connection to the nozzle. The air and water pressures were varied per the manufacturer's instructions and monitored via pressure gauges.

The fog dispersal patterns and apparent ‘dryness’ were qualitatively evaluated. The dispersal pattern was sensitive to pressure changes. The volume of fog was significantly more than the HEART® nebulizer, but the fog was also much wetter when a hand is placed in front of the nozzle when compared to the HEART® nebulizer (or when a hand is dipped into the piezoelectric ultrasonic fog field). Note that the manufacturer cautioned that placing a hand in front of the spray will cause impingement and thus larger droplets.

At 48 psi air, and with about 10 psi water, the spray tends to focus and is relatively uniform, but it was wetter than the output of the HEART® nebulizer. Then by lowering the water pressure, the spray seemed dryer, but the spray appeared to be lower in volume, and also started to exhibit wider lobes. Per the manufacturer, the maximum droplet size can be seen at 62 psi air and 20 psi water, with smaller droplet sizes achieved using 47 psi air and 0 psi water, where the water is drawn from the pressure pot, through the hose connected to the nozzle's water port, via the air that flows through the nozzle. The smallest droplet sizes are said to be generated at 44 psi air and −2 psi water. A piece of open cell foam was used to filter out the larger droplets via impingement. A dry fog similar to the output of the HEART® nebulizer was visible on the output side of the open celled foam. Note that disclosed previously herein are additional methods for separating larger droplets from smaller ones.

For use in the instant invention, in an exemplary embodiment, a ‘spray bar’ would be mounted inside a UVC tunnel. For applications where ‘dryness’ is extremely important (e.g., UVC irradiation of bread), larger droplets are removed via impingement (or other method as cited in these patent filings) with the water collected and routed to a drain or back to the supply source for recycling. For applications where some wetness is not a concern (e.g., UVC irradiation of fish fillets, or visible/NIR irradiation of plants in a greenhouse), the large droplet removal feature may be unnecessary if testing proves the scattering/system efficacy is sufficient to achieve the log reductions (UVC) or photosynthetic growth (visible/NIR)

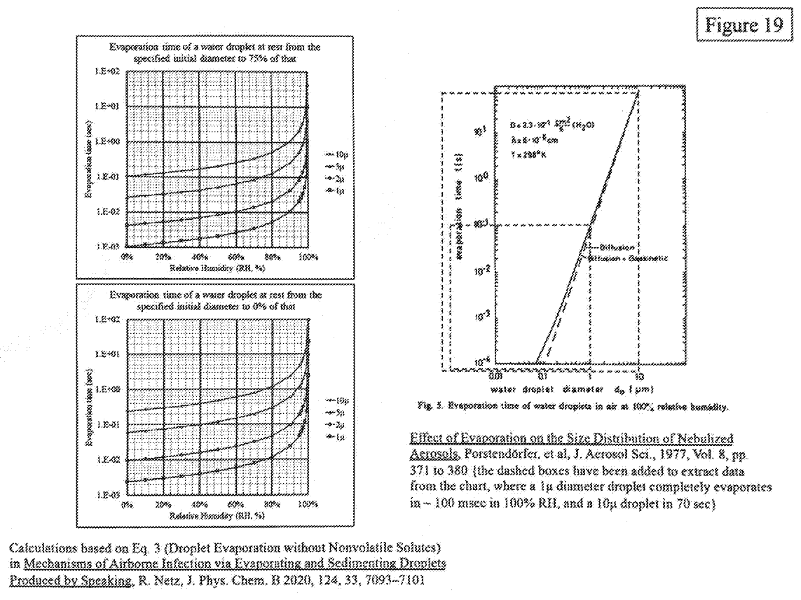

Dry fog characteristics—Dry fog droplets can evaporate quickly as disclosed in FIG. 19. On the left hand side of FIG. 19, there are two charts modeled after Equation 3 in the cited reference. The model for the equation assumes no evaporation at 100% humidity. The upper chart represents the evaporation time or a water droplet at rest from the specified initial diameter to 75% of that, for diameters of 1μ, 2μ, 5μ, and 10μ respectively at various relative humidities at 25° C. The lower chart is similar except the evaporation time encompasses complete evaporation (to 0% of the initial diameter). The chart on the right is based on a different model that describes complete evaporation in 100% relative humidity (RH), also at 25° C. Regardless of the model, the charts imply that increasing RH increases prolongs the life of a droplet, and that smaller droplets evaporate more quickly.

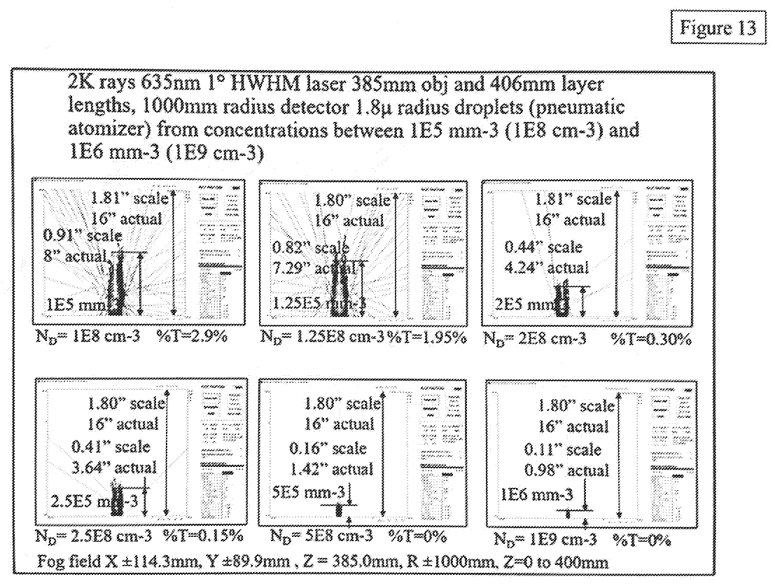

Droplet size modelling is surprisingly complicated as it includes things like the following: “ . . . corrections for the Fuchs effect, the Kelvin effect, and droplet temperature depression . . . . For water droplets less than 50 μm in aerodynamic diameter, the evaporation rate is increased less than 10% by the “wind” velocity effect . . . . As with growth by condensation we must take into account the effect evaporation has on the droplet temperature T_{d}. Here, the droplet is cooled by the heat required for evaporation. This cooling lowers the partial pressure of vapor at the droplet surface, p_{d} and the rate of evaporation, d(dp_{d})/dt . . . . Although relative humidity can affect droplet lifetimes by a factor of 10-1000, ambient temperature has a much smaller effect, as shown by the dashed lines for 10 and 30° C. in FIG. 13.11a.” (Ch. 13 Condensation and Evaporation, Aerosol Technology: Properties, Behavior, and Measurement of Airborne Particles, 2nd Edition, William C. Hinds, ISBN: 978-0-471-19410-1, January 1999).

The management and control of droplets of the sizes in a dry fog field involves other factors disclosed in Applicant's IUVA presentation cited herein. For example, dry fog droplet sedimentation or settling due to gravity, is often said in the literature to take hours to days, although the rapid evaporation of these small droplets is not mentioned. Coalescence (droplets combining) and impaction (droplets striking something) will change the size distribution, which may also compensate to some degree for evaporation and can also lead to larger diameter drops that cause wetting and changes to the scattering profile. Demisting can be used to remove larger droplet sizes. Considerations including condensation/wetting, films vs. drops, rate effects as a function of surface inclination, vapor pressure, impaction/impingement velocity (speed & direction relative to the impinged surface normal), surface/air temperature differences, and non-condensable gases are cited in the presentation.

When using dry fog, especially in high RH environments, the effect of the sorption of water on/in targets must be considered. In the food industry, “Water activity (a_{w}) is a measure of the availability of water for biological functions and relates to water present in a food in “free” form . . . . Water activity of pure water is 1.0, a completely dehydrated food is 0 . . . . Water activity requirements of various microorganisms vary significantly. In the vital range of growth, decreasing a_{w} increases the lag phase of growth and decreases the growth rate.” Food Microbiology—Principles into Practice (ISBN 9781119237761)

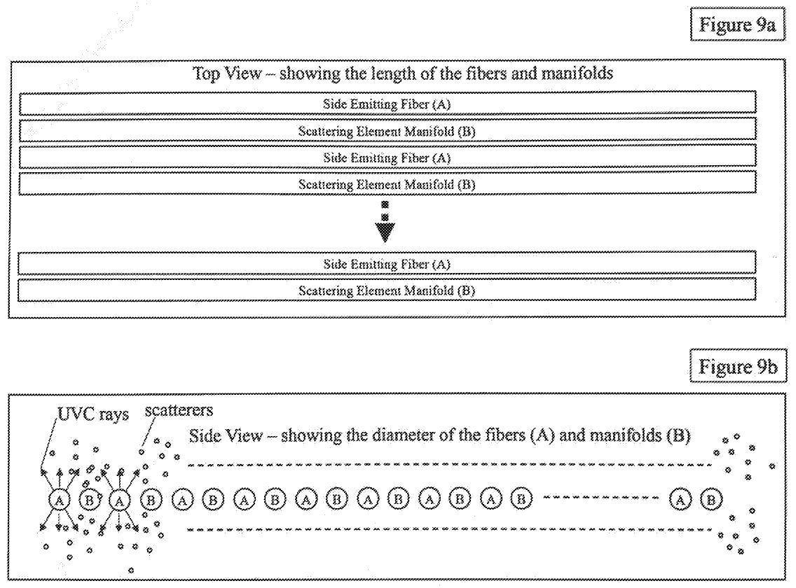

The Dust Solutions website states “Dry Fog works very well in below freezing conditions. Fog droplets lack sufficient mass to freeze. This phenomenon is known as Cloud Physics. The system components can be protected via insulated enclosures with self-regulating heaters and heat tracing as well as an automatic purge system upon system shutdown.” See also FIG. 1 from A Laboratory Investigation Of Droplet Freezing which summarizes pure water droplet freezing temperatures from a number of studies, indicating that temperatures below −35° C. are required to freeze dry fog droplet sizes. See also Exploring an approximation for the homogeneous freezing temperature of water droplets. This phenomenon is quite unexpected and not obvious. Thus, for the instant invention, scattering operation extends well below freezing temperatures (useful to curb microbial growth), but of course is also dependent upon, e.g., number concentration, fog thickness, relative humidity, and temperature fields in the treatment zone. It is also known that wetting is dependent upon viscosity. The viscosity of supercooled water is provided in Viscosity of deeply supercooled water and its coupling to molecular diffusion, FIG. 1 in this reference shows that the viscosity of water increases from about 0.001 Pa-s (N-s/m²) at 25° C. (298° K) to about 0.016 Pa-s (N-s/m²) at −34° C. (239° K). The density of water is 1 g/mL at 25° C., and at −34° C. (supercooled) it drops slightly to 0.9975 g/mL as shown in Table II of The density of supercooled water. II. Bulk samples cooled to the homogeneous nucleation limit. The surface tension of water is shown in FIG. 9 of Surface Tension of Supercooled Water—Inflection Point-Free Course down to 250K Confirmed Using a Horizontal Capillary Tube, increasing from about 0.075 N/m at 0° C. to ˜0.079 N/m at −25° C. (248° K). Note that by adding a surfactant to make soapy water, the surface tension drops to 0.0250-0.0450 at 20° C. per the website Engineering ToolBox. Also, in Surface tension of supercooled water nanodroplets from computer simulations, there is an analysis that looks at the surface tension of curved (γₛ) vs planar (γₚ) surfaces down into the supercooled region, albeit for nanometer sized droplets, “Moreover, assuming the validity of thermodynamic route, for Rₑ≥1 nm we can ignore the curvature correction and use the planar surface tension to estimate the Laplace pressure inside water nanodroplets to within 15% down to 180 K” where “Rₛ is the radius of the so-called \surface of tension” [10]. For macroscopic droplets, the width of the molecular interface is negligible compared to the droplet dimensions, and Rₛ is simply the radius of the droplet. However, for nanoscale droplets, the interfacial width is significant compared to the size of the droplet itself, and various definitions for the radius of the droplet are possible. It has long been understood that the surface tension of a curved interface deviates from that of a planar interface. For a curved surface, such as that of a droplet, the Tolman length δ quantifies how γs deviates from the planar surface tension γₚ as a function of Rₛ, via the expression [11], γₛ=γₚ (1+2δ/Rₛ): (2) The magnitude of δ is generally found to be 10-20% of the molecular diameter” and “Rₑ is the radius of a sphere that has a uniform density equal to that of the interior part of the droplet and that has the same number of molecules as the droplet.” So, for purposes of the instant invention with Rₑ>>1 nm, the planar surface tension values will be used.

Per A Spray Interaction Model with Application to Surface Film Wetting, “Much of the behavior of impinging droplets can be characterized by the Weber number. The droplet Weber number (We), representing the ratio of inertial to surface tension forces, is given as We=ρV_{I;n}² d_{I}/σ (6) where V_{I;n} is the surface-normal incident velocity of the impinging droplet. For We<We_{c}, a droplet will adhere to the dry wall. For We>We_{c} the droplet impingement will result in a splash. ∧_{wet} represents the roughness of the surface, La is the droplet Laplace number, and denotes the ratio of surface tension force to viscous force in the droplet, La=ρσd_{I}/μ² . . . where ρ is the liquid density, σ is the surface tension, d_{I} is the impinging droplet diameter, and μ is the liquid viscosity.” Table 2 therein shows ‘adhesion’ for Weber numbers below 1, ‘bouncing’ for Weber numbers between about 1 and 20, adhesion again for Weber numbers between 20 and (∧_{wet}·La^{-0.183}), and ‘splashing’ for numbers greater than (∧_{wet}·La^{-0.183}). From Development of Methodology for Spray Impingement Simulation, values of ∧_{wet} as a function of surface roughness rₛ (μm) are as follows in pairs (rₛ, ∧_{wet}): (0.05, 5264), (0.14, 4534), (0.84, 2634), (3.1, 2056), (12, 1322).

The formula for the Weber number suggests higher velocities and larger droplets have higher Weber numbers, and thus a greater likelihood of bouncing. The data gathered for water density shows little change from −34° C. to +25° C., while the surface tension for water is markedly higher at −34° C. compared to 25° C., and since the Weber number is inversely proportional to surface tension, higher temperatures increase the chance of bouncing (all other things being equal). Using water droplets at −34° C. may have other benefits, e.g., slowing the diffusion of water through bread (see, e.g., Diffusion of water in food materials—a literature review discussed herein), slowing the evaporation of droplets (see the discussion herein re: the vapor pressure of water being lower at colder temperatures, with lower vapor pressures resulting in lower evaporation), and raising the critical RH for mold growth (see, e.g., Eq. 6.4 in Predicting the Microbial Risk in Flooded London Dwellings Using Microbial, Hygrothermal, and GIS Modelling).

Biological Stressors:

Hormesis “a biological phenomenon, where a biological system stimulates beneficial responses at low doses of stressors that are otherwise harmful to that system.” Postharvest pathology of fresh horticultural produce (ISBN 9781138630833). In an exemplary embodiment, this approach is used in plants to combat pathogens in combination with the scattering approach of the instant invention.

The opposite, and perhaps more common effect, is where stressors are actually harmful to a system. For example, certain stressors applied to microbes minimize their growth rate and increase the microbial lag.

It is suggested that UV-B may be a stressor for fungi. See, e.g., Ultraviolet Radiation From a Plant Perspective: The Plant-Microorganism Context. Thus, in one exemplary embodiment, UV-B is used before, during, and/or after UVC treatment to stress microbes to minimize growth. Characterization of damage on Listeria innocua surviving to pulsed light—Effect on growth, DNA and proteome cites a 13-fold increase in microbial lag after certain exposure to UVC.

“Many authors studied the effect of stress factors, i.e., pH, temperature, etc., on the distribution of individual cell lag times (Me'tris et al., 2002; Smelt et al., 2002; Francois et al., 2003b). They observed that when stress factors increase, the mean lag time is higher and the distribution becomes broader (increasing variability).” Predictive modelling of the microbial lag phase: a review.

One embodiment of the instant invention is to therefore change the pH of the source water to the atomizer away from neutral to stress the microbes. The pH level can be adjusted in many ways, including with food safe additives (baking powder to increase the pH, and lemon juice to decrease it). Thus, in preferred embodiments, microbes are stressed before, during, and/or after UVC dry fog scattering treatments to retard growth.

“Recently advanced oxidation processes (AOPs) have been widely investigated to develop effective treatment processes for the removal of emerging aqueous pollutants including natural organic matters (NOMs), disinfection by-products (DBPs), endocrine disrupting compounds (EDCs), pharmaceuticals and personal care products (PPCPs), and heavy metals [1-15] . . . AOPs can also effectively degrade other conventional recalcitrant pollutants such as phenols, dyes, and chlorinated compounds [16-29]. Highly reactive oxidizing species such as hydroxyl radical (.OH), perhydroxyl radical (.OOH), and hydrogen peroxide (H2O2) generated in AOPs are enable to effectively degrade and mineralize the above aqueous pollutants due to their high oxidation potentials as shown in Table 1 [30]. AOPs are divided into three categories. The first category is the chemical-based processes which include ozonolysis (O3) and Fenton's oxidation (Fe2+ and H2O2). These chemical-based processes are considered as early-stage AOPs and involve the use of oxidizing chemicals and reactive radicals. The second category is the wave-energy-based processes, namely, photolysis (ultraviolet, UV), photocatalysis (UV/TiO2), UV/H2O2 processes, sonolysis (ultrasound, US), and microwave (MW) processes. The third category is the combined processes of AOPs including sonophotolysis (UV/US), sonophotocatalysis (UV/US/TiO2), UV/ozone processes, UV/Fenton processes, and US/Fenton processes. These combined AOPs can be synergistically effective in terms of reaction efficiency, input chemical consumption, energy consumption, and reaction time. Table 2 shows degradation/radical oxidation reaction mechanisms in various AOPs [2, 4, 16, 18, 28, 30-37]. . . . As Pétrier et al. [68] briefly summarized, it is believed that volatile compounds undergo direct pyrolysis inside the cavitation bubble, while less volatile compounds are degraded by highly reactive radical species such as OH radical on the bubble surface (FIG. 4).” (Son, Advanced Oxidation Processes Using Ultrasound Technology for Water and Wastewater Treatment, p/o Handbook of Ultrasonics and Sonochemistry, 2016, ISBN 978-981-287-277-7). Thus, AOP activity can be induced by the UVC (or other) in the fog liquid, adding a second mechanism to stress/kill microbes in addition to the UVC directly damaging the DNA (and other structures). AOP can also be added as a separate step of the germicidal process. “A treatment chamber based on spraying peroxide on produce whilst under constant illumination by UV-C(254 nm) was assessed for inactivating human pathogens (E. coli O157:H7; Salmonella) and spoilage bacteria (Pectobacterium, Pseudomonas) introduced on and within a range of fresh produce (Hadjok, Mittal & Warriner, 2008). It was found that a treatment using 30-second UV-C, 1.5% hydrogen peroxide at 50° C. resulted in >4 log cfu eduction of Salmonella on and within shredded lettuce. It was found that using hydrogen peroxide or UV alone supported 1 to 2 log cfu reduction, as did applying the AOP at 20° C. compared to 50° C. (Hadjok et al., 2008). This demonstrated that using a combination of UV-C and peroxide at 50° C. provided synergistic decontamination efficiency.” AOP for Surface Disinfection of Fresh Produce From Concept to Commercial Reality»UV Solutions.

The growth of microorganisms in food can lead to extremes such as spoilage (e.g., mold) on one end, and toxic effects (from the pathogen and/or its secretions/byproducts) on the other, e.g., listeria, E. coli O157:H7 and Salmonella, and many others. Toxic effects are characterized by the ratings for severity: (i) fatality, (ii) serious illness, (iii) product recall, (iv) customer complaint, and (v) not signifcant. See Rahman, Miss. (eds), Handbook of Food Preservation, 3rd ed., CRC Press; 2020, ISBN 978-1-4987-4048-7. Thus, the goal for acceptable levels in germicidal disinfection is to stay in category (v).

“The most common foodborne infections causing gastrointestinal disturbances are due to the pathogens such as Salmonella, Novovirus, Staphylococcus aureus, Shigella, and Campylobactor. The foodborne illnesses caused by Clostridium botulinum, pathogenic Escherichia coli O157:H7 and O104:H4, Listeria spp., and Vibrio spp. have been reported to be much more severe, causing symptoms extending from bloody diarrhea to neonatal death and fatality in some acutely infected adults (Callejon et al., 2015; Kirk et al., 2015).” Bhilwadikar, et al, Decontamination of microorganisms and pesticides from fresh fruits and vegetables: a comprehensive review from common household processes to modern techniques, Comprehensive reviews in food science and food safety 18.4 (2019): 1003-1038, that also cited appropriate UVC dosage for specific log reductions of many microorganisms.

When exposing an object, e.g., food, to high RH (such as during dry fog scattering), the thought of promoting mold (fungal) growth comes to mind. The temporal effect of high RH relative to mold growth has been discussed in a number of models, including “Time of Wetness” or ‘TOW’, which has also been used to cite bacterial (and other) growth as well. In fact, the teachings herein should be considered with all microbes, including pathogens. The research/models generally relate to high RH on the order of hours and days, and some, like TOW, are based on high-RH cycles. Note that the specific microbe, the growth medium, and other factors as will be discussed play roles in interpreting existing data for use in the instant invention. However, there are trends that are important to understand. Note that references to TOW is not meant to promote the specific TOW model for mold growth (there are many different models, as cited below). It is being used because it is descriptive and meant herein to generically encompass mold growth models.

Unlike mold growth in the cyclic TOW model, in an exemplary embodiment of the instant invention, a single high-RH cycle would span seconds or minutes (typical time spans that food articles spend in UV tunnels). However, the testing and modeling of TOW and related research are instructive in performing mold-related risk assessments for the instant invention, including model development. Such a model could inform the necessary irradiance required to reach a desired fluence as described below.

In an exemplary embodiment, a food processing facility uses a UVC tunnel to disinfect certain food products. In order to derive the necessary operating parameters for the UVC tunnel with dry fog, the following exemplary tests are conducted in accordance with good Design of Experiment} and biological testing procedures. Note that for brevity, intermediate cleaning of the processing equipment is not cited below.

1) Coupons inoculated with various microbiota are prepared and one set of samples are taken, cultured, and data is recorded. The microbiota should be those expected to be found at food processing facilities (both on the food and in the local environment, including mold spores), or suitable surrogates.

2) Another sample of coupons is run through the tunnel with UVC and without dry fog, and at several belt speeds. Cultures are obtained and data is recorded.

3) Another sample of coupons are run through the tunnel without UVC, but this time with dry fog at several concentrations, and at the above belt speeds. Cultures are obtained and data is recorded.

4) The same test directly above is run, this time the coupons are dried after running through the tunnel. Cultures are obtained and data is recorded.

5) Yet another sample of coupons is run through the tunnel, this time with both UVC and dry fog, at the belt speeds and dry fog concentrations used in the previous tests, and at different intensities as measured by dosimeter pucks on the belt (e.g., by varying lamp power and/or moving the lamps at different distances to the products). Cultures are obtained and data is recorded.

6) Further testing can be conducted to understand the effects such as stressing the microbiota before and/or after UVC/dry-fog, or combining UVC with synergistic non-photochemical/photophysical modality with kinetic effects, as described in this application and related applications of the instant invention, as well as those known in the art.

7) A model is constructed that isolates the effects of dry fog on the growth of different types of microbes, if any, based on the variables cited above.

8) The intensity of irradiation is then defined to ensure the TOW is below the threshold (if any) while meeting the fluence required to achieve the necessary log reduction requirements for the microbes of interest in the food processing facilities.

A method to avoid the effects of RH is to isolate the fog chamber from the food products. Several UVGI applications require very dry conditions, e.g., to prevent clumping in powders like flour.

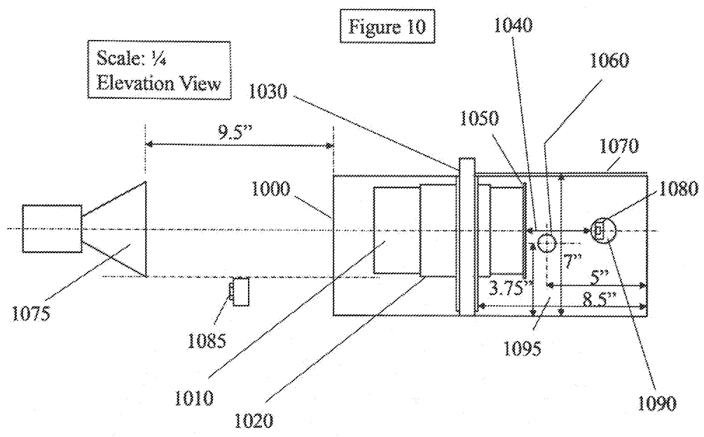

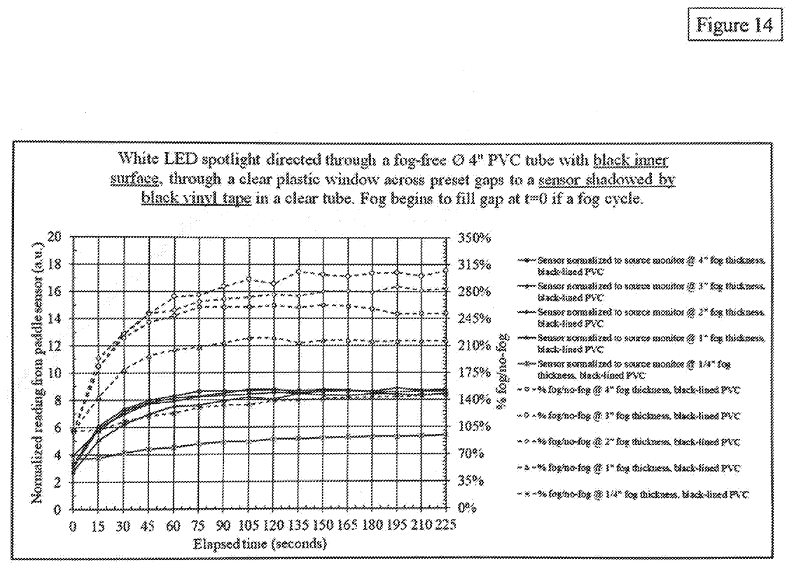

FIG. 10 shows such an arrangement resulting, with the test data shown in FIG. 14. Here the visible light sensor was placed inside a polycarbonate tube that was wrapped with one winding of black vinyl tape, shadowing the sensor. The inside of the tube, including the shadowed visible sensor inside, was isolated from the fog that surrounded it (the ends of the tube protruded through bulkhead connectors seal to the chamber walls, thus exposing the inside of the tube to ambient air and not dry fog, and the wire from the sensor exiting one end of the tube). This clearly demonstrates the ability of scattered light to reach an isolated target (the sensor) when shadowed (here by black tape around the tube).

Another embodiment for avoiding wetness includes the use small dry-ice crystals for use as scatterers, which then sublimates, instead of condensing.

In another embodiment, the use of air currents/curtains keep dry fog from touching products. A scattering fog formed into an air current sheet for use as a projection screen is taught using an array of straws in Rakkolainen, et al, Walk-thru screen, Projection Displays VIII. Vol. 4657, International Society for Optics and Photonics, 2002). Air currents are contemplated as an approach to force away moisture, as dry fog can be easily moved by air currents. For example, a loaf of bread can be surrounded at each corner by small diameter tubing with nozzles optimized to push away (or vacuum locally or create local vortices to keep the moisture airborne) dry fog that comes near its immediate surface, but minimally effecting the dry fog number concentration (needed for scattering) more than say one centimeter away.

In another embodiment, targets are electrostatically charged (or comprise a net charge during processing) and the scattering fog is charged to the same polarity such that the dry fog droplets are repelled as they approach the target. Note that “Shimokawa et al. reported that ultrasonic mist generated from high-purity water has a negative charge . . . ” Effect of ultrasonic frequency on size distributions of nanosized mist generated by ultrasonic atomization, and thus the use of high-purity water for the dry fog would be repelled from a negatively charged target.

“Water has a polar molecular structure and has a large value of electric dipole moment due to hydrogen covalent bonds. The electron-pair forming covalent bond gets attracted towards the oxygen atom and as a result, oxygen side gets slight negative polarity and hydrogen side gets positive polarity and It produce an electric dipole moment inside the water molecule. according to the electrochemistry of polar molecules, fine water droplets can be charged electrostatically.” Economical Way of Appling Pesticides Through Electrostatic Sprayer. Thus, a product can be charged (or it can be surrounded by a charged wire/mesh) with the same polarity as the water droplets, thus repelling water droplets from landing on the product. The strength of the charges can be adjusted to optimize an overall system efficacy metric, which can be defined as some formula whose factors include electrical power consumption, log reduction of pathogens, factory production rate, maintenance costs, etc. Note for safety the wires/mesh can be charged to a potential only within the UVC tunnel.

In another embodiment, charged food-safe powders can be used for the scattering field. After irradiation, the powder residue can be washed-off (if desired) in a liquid solution that also neutralizes the surface charge(s). The powder can also form a desirable coating that is left on the food article.

As cited e.g., in Effects of charging voltage, application speed, target height, and orientation upon charged spray deposition on leaf abaxial and adaxial surfaces, fogging systems have successfully used electrostatics to enhance the attachment of spray bubbles to targets (e.g., produce) including the underside of leaves (a surface in shadow). So, if a fog bubble can reach a surface in shadow, then there exists a trajectory for UVC rays to reach the same surface hopping from bubble to bubble.

If using electrostatic sprays, a number of parameters must be selected, such as the choice of charge(s) of the spray and the target(s), i.e., positive, negative, or neutral, the relative and absolute amplitudes of the charges, their spatial and temporal variations, and spray distances. The effects of charge vs particle size as it relates to ‘wrap-around’, as well as other parameters can be found in Effects of charging voltage, application speed, target height, and orientation upon charged spray deposition on leaf abaxial and adaxial surfaces, Real-Time Control of Spray Drop Application, Effects of electrode voltage, liquid flow rate, and liquid properties on spray chargeability of an air-assisted electrostatic-induction spray-charging system, Penetration Of N95 Filtering Facepiece Respirators By Charged And Charge-Neutralized Nanoparticles, Bacterial Attachment to Meat Surfaces. A baseline spray distance for maximum front-side and back-side coverage is on the order of 400 mm to 500 mm or roughly 15″ to 20″. The Experimental study of the spray distance electrostatic spray. The optimum for a given application requires testing as the cited study was for one basic ‘paper-card’ test configuration, thus not covering all the possible variables such as airflow, target charge(s), etc.; however, the paper helps define a repeatable testing procedure. Note also that electrostatic sprayer manufacturers also provide guidelines, e.g. for the PX200ES (Protexus PX200ES Brochure, EarthSafe, Braintree, Mass.), the recommended distance is 3 ft to 6 ft.

Where moisture is not an issue, an attractive approach to electrostatics is to facilitate scattering particles getting close to the targets, which are oppositely charged. Also, e.g., after irradiation, a puff of a neutralizing medium can be directed at the food surfaces to minimize electrostatic attraction from pathogens and detritus.

Electrostatics is used, e.g., in agricultural pesticide spraying and PPE decontamination, but it can also cause bacterial attachment to meat surfaces and hydrophobic/hydrophilic surfaces. Detailed design criteria for electrostatic spraying are also referenced, e.g., in Effects of charging voltage, application speed, target height, and orientation upon charged spray deposition on leaf abaxial and adaxial surfaces, The Experimental study of the spray distance electrostatic spray, Influence of droplet size, air-assistance, and electrostatic charge upon the distribution of ultralow-volume sprays on tomatoes.

For some exemplary applications, static charges may need to be eliminated before/during/after UVC dry fog scattering. An exemplary neutralizer is MSP Model 1090 Electrical Ionizer from MSP Corporation (Shoreview, Minn., a division of TSI Inc.). For other exemplary applications, a scattering aerosol may need to be neutralized if the target is charged and thus prevents scattering particles from getting near the surface. See, e.g., U.S. Pat. No. 8,605,406 Apparatus and methods for altering charge on a dielectric material.

Discussions of charges in water are found in Water with Excess Electric Charge and Can Water Store Charge. The effect of humidity on charge is discussed in Atmospheric humidity and particle charging state on agglomeration of aerosol particles discusses.

In yet another exemplary embodiment, the powder particles themselves can be used to scatter UVC to other particles by creating a cloud of particles at a sufficient number concentration, assuming the reflectance is high enough to meet practical efficacies for a given application.

Like most materials, UVC reflectance of certain powders can be quite low. See ‘reflection absorbance spectra of flours’ in Front-Surface Absorbance Spectra of Wheat Flour—Determination of Carotenoids. It appears the cited flours have a front-surface ‘reflection absorbance’ (at a 30° angle of incidence) of ˜0.8 to 0.85 in the UVC wavelength range around 275 nm, yielding reflectance values between about 10^{(-0.85)}=14.1% to 10^{(-0.85)}=15.8%. Note, “However, it must be emphasized that in the front-surface reflectance measurements the light path length is not clearly defined as in transmittance spectroscopy where this length is generally coincident with the distance between the windows of the sample cell. In fact, in the case of powders, each photon passes through an extremely heterogeneous sample and its path length depends on the scattering processes it encounters; thus, only an average path length can be defined, which, unfortunately, cannot be measured or calculated in a simple way.”

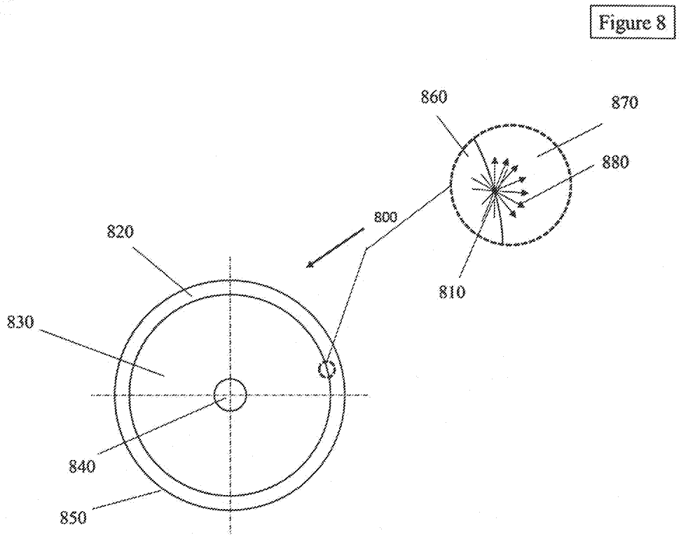

Fog isolated from products—FIG. 8 details another exemplary embodiment, where the dry fog and the powders are isolated within concentric cylinders. The visible light dry fog testing herein proved that dry fog can be isolated from a surface and yet still provide effective illumination of surfaces in shadow (recall the paddle of the visible laser power meter, UT385, within the polycarbonate tube). As shown in FIG. 8, the fog cloud efficiently moves the emission of UVC rays from an exemplary LP mercury lamp to the exterior of the inner UV transmissive cylinder, acting almost like a relay lens. See the Figure for other details. A suitable baseline cylindrical UVC LED reactor is described in US20200247689 Method, System and Apparatus for Treatment of Fluids (produced commercially by Typhon Treatment Systems Ltd., Penrith, England), which can then surround the inner UV transmissive cylinder (both scaled in diameter as appropriate).

In FIG. 8, UVC transmissive (e.g., UV grade fused silica or UVGFS) concentric tubes are utilized with a tubular low pressure (LP) mercury lamp at the center. UVC from the lamp (itself isolated from the fog using FEP/UVGFS tubing like LP lamps isolated from water in UVGI disinfection systems) passes through a scattering dry fog within the middle cylindrical section and forward scatters to the dry powder that is isolated in the outer cylindrical section. Every point on the circumference of the UV transmissive inner cylinder receives scattered rays from the dry fog over a wide range of angles, effectively creating a larger diffuse emitter surface that directs UVC into the powder.

Any UVC that passes through the power then passes through the outer wall of another UVC transmissive tube which has been surrounded with a high reflective diffuse UVC reflector such as Porex Virtek® Reflective PTFE (Porex Corporation, Fairburn, Ga.), causing the UVC to bounce back over a range of angles for a chance to strike more powder. UVC that makes it past the powder will be re-scattered by the fog field to begin the cycle again.

This is a very efficient process because the Porex reflector has an average reflectivity of 97% at 254 nm, and the fog has effectively no absorption when the source water has been adequately filtered from absorbing particulates. Monte Carlo scattering simulations and optical ray tracing (the latter including the effects of reflector absorbance and lamp plasma absorbances as described in Validation of Discrete Ordinate Radiation Model for Application in UV Air Disinfection Modeling) can be used to define the maximum water absorbance based on overall system efficacy requirements. Water absorbance is discussed, e.g., in Christensen, et al., How particles affect UV light in the UV disinfection of unfiltered drinking water, Journal-American Water Works Association 95.4 (2003): 179-189.

Note that the gap size of the annular region within which the dry powder flows is chosen based on the needs of the application, weighting such factors as (a) low pressure drop, (b) high dosage uniformity, (c) power efficacy, (d) product throughput, etc. Air flow of the appropriate humidity (to prevent clumping) can be introduced to swirl the powder (e.g., flour) for better dosage uniformity. Swirling is done in UVC water treatment systems to improve fluence coverage, and also in the swirl-drying of coal, see Simanjuntak, et al, Experimental Study on The Effect of Angle of Blade Inclination on Coal Swirl Fluidized Bed Drying, ARPN J. Eng. Appl. Sci 11.2 (2016): 12499-12505., and powder-like foods such as wheat grains, see Özbey, et al, Effect of swirling flow on fluidized bed drying of wheat grains, Energy conversion and management 46.9-10 (2005): 1495-1512.

Alternate embodiments can be constructed via UVC LEDs and planar vessels for the fog and the powder. Whether cylindrical, planar, or other, this approach provides a modular construction technique that can be arranged in geometric shapes such as arrays of cylinders (including nested cylinders, or arrays such as are found in electric car battery packs) and layers of planar vessels (alternating fog vessels and powder vessels). Optimization of reactor geometry for a given product flow rate can be performed by Design of Experiments (DOE) using both simulations and lab testing. See, e.g., Design and Analysis of Experiments, ISBN 978-3-319-52248-7.

In another embodiment of an isolated system, dry fog is used (or bubbles in water) to determine the necessary scattering to disinfect food powders, seeds, etc. The number concentration and fog thicknesses are determined, and an equivalent scattering profile (or one that is reasonably close) is fabricated on-or-in a highly UVC transmissive material (surface scattering vs volume scattering). Thus, the dry fog (or bubble) scattering is used for guiding the fabrication of a scattering element that is then used in an isolated system. An example of the design of a volume scattering material for visible light is cited herein, Horibe, et al, Brighter Backlights Using Highly Scattered Optical Transmission Polymer, SID Symposium Digest, Vol.26. pp. 379-381, 1995. See also Research of diffusing plates for LCD backlights, and Design guidance of backlight optic for improvement of the brightness in the conventional edge-lit LCD backlight, Engineered surface scatterers in edge-lit slab waveguides to improve light delivery in algae cultivation. Of course, there are advantages of using the dry fog, in that the concentration can be modified as needed based, e.g., using adaptive feedback to optimize the scattering with changes in the flow and the properties of the powder-like material to be disinfected.

Fog isolated from the UV source (and other processing equipment) such as in UV tunnel retrofit/forward-fit applications:

Another exemplary embodiment is a UVC transmissive rectangular box (made from FEP and/or UVGFS in UVC compatible frames) that contains objects to be disinfected and rides through a UV tunnel, either directly on the conveyor belt, or along rails that pass through the tunnel. This approach can be used in both retrofit or forward-fit applications.

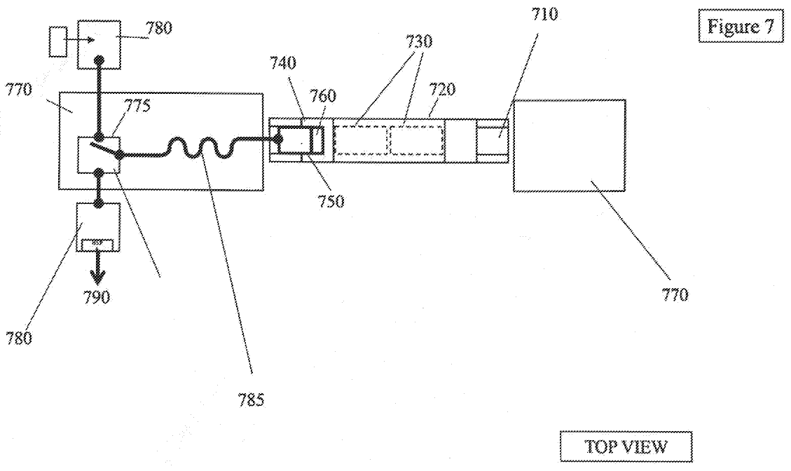

In one embodiment, dry fog is generated within the box structure. In another embodiment, as shown in FIG. 7, dry fog is routed to the box via one or more sanitary conduits whose external material is compatible with intense UVC. In one embodiment, the conduit can be one or more sanitary hoses of sufficient diameter to supply the box with a fog concentration sufficiently high to meet scattering requirements. Sanitary (and other) large/small diameter hoses and fittings are available, e.g., from United States Plastic Corporation (Lima, Ohio) with varying degrees of UV resistance. To achieve long life in the high intensity UV tunnel environment, the hose can be fabricated from PTFE, aluminum, stainless steel, UVC resistant polypropylene, or custom fabricated from a polymer with a high degree of UVC absorbing material. Alternatively, the hose can be coated/painted or surrounded by protective flexible sleeving such as Thermashield from Techflex, Inc. (Sparta, N.J.). Fiberglass insulation or forced cool air can be interjected between the hose and sleeving to further minimize dry fog evaporation as the hose passes near the hot UVC lamps within the tunnel. The box can also comprise double walls and/or active or passive cooling towards this end as well. In one embodiment, the UV tunnel is fitted with forced ambient air or forced cooling air to minimize dry fog evaporation in the hoses and box.

A 3-way valve can be used to switch from the dry fog generation system to the evacuation system (a vacuum/negative-pressure system and/or via purging the contents with clean dry air/gas in a flow-through arrangement, not shown). Large diameter plastic 3-way valves are available, e.g., from FibroPool (St. Louis, Miss.), and in stainless steel (sanitary) from Valtorc International (Kennesaw, Ga.). Flow-through designs ensures that fog that has been used is removed and not recycled (in case it gets contaminated akin to UVC-based wash-water disinfection systems).

In another exemplary embodiment, the box rides on stainless steel rails that run along opposing sides inside the tunnel. The rails are made of hollow pipe through which dry fog is mounted. In one embodiment, one rail carries the dry fog to the box, the other rail is used to evacuate the fog from the box. Paddles (UVC compatible material) connected to the conveyor belt push the box along the rails. In an exemplary embodiment, the paddles are U-shaped to prevent the box from skewing and jamming in the tunnel as it is being pushed, while minimizing any shadowing of the UVC.

In yet another embodiment, the box is self-contained with an ultrasonic atomizer attached to the side of the fog chamber portion. Within the fog chamber portion, the UVC transparent windows are tilted a few degrees so that condensate can drip towards a channel or moat along the bottom. This prevents pooling in the path of central region of the box, potentially adding variability to the fluence depending upon environmental conditions. Fresh film can also be dragged across the box as described in applicant's U.S. Pat. No. 6,485,164 Lighting device with perpetually clean lens. It is important to note that the fog is constantly irradiated with UVC, and in one embodiment is recycled via condensation for continual use. In another embodiment, customers may have concern that the fog condensate may trap pathogens. In this case, the fog is safely disposed after irradiation (e.g. via a HEPA-equipped wet/dry vacuum). Note also that the fog evacuation/drying can start during different phases of the cycle. For example, it can start at the tail-end of the irradiation cycle and completed before irradiation ceases to illuminate the target. This is an extra precaution to minimize the risk that the fog carries pathogens.

The box is fitted with one or more scatterometers. For example, a disclosed herein, one or more lasers directing their beam(s) into the box through a region of fog, and corresponding sensors at a fixed distance away to measure the transmittance to compare with fog-free values, where this data is compared to Monte Carlo scattering simulations as disclosed herein to arrive at an approximate concentration to provide feedback to the control system to regulate the dry fog concentration. A thorough discussion of mathematical modeling of intensity vs scattering over distance using an adaptation of the Beer-Lambert law via correction factors can be found in Laser light scattering in turbid media Part I—Experimental and simulated results for the spatial intensity distribution, Laser light scattering in turbid media Part II: Spatial and temporal analysis of individual scattering orders via Monte Carlo simulation.

So, in an exemplary embodiment, the size distribution of a dry fog generated by a 1.7 MHz ultrasonic transducer array is characterized by a precision instrument, e.g., the Spraytec laser diffraction system from Malvern Panalytical Inc. (Westborough, Mass.) that is specified to detect sizes down to 0.1 micron. The measurement is performed either in-situ (e.g., within a UVC tunnel), or in a controlled experiment that emulates a similar aerosol environment (accounting for RH, temperature, geometry size/obstructions, and the effects of evaporation, coalescence, and the like). The number concentration, N_{d}, is computed as described in Measuring resolution degradation of long-wavelength infrared imagery in fog.

The particle distribution is then input in a Monte Carlo simulation program such as MontCarl. A large number of simulations are run to characterize the effects of N_{d}, wavelength, and layer thickness on transmission through the fog, as well on the scattering profiles and parametrics (e.g., μs, μa, path length, etc.) as needed for augmenting the Beer-Lambert equation. Two wavelengths of interest would be simulated for the case of both the UVC treatment wavelength (depending upon whether 254 nm sources are used, or UVC LEDs are used in the region between about 265 nm and 280 nm) and a proxy wavelength for a solid state laser (e.g., 635 nm) to characterize the fog field as disclosed herein (i.e., disclosed in one or more of the applications related to the instant invention). As an aside, Far UV-C radiation can also be used in the embodiments herein, see e.g., 222 nm KrCl lamps as cited in Far UV-C Radiation—Current State-of Knowledge, 2021. The proxy wavelength should be chosen to have similar scattering characteristics through the dry fog as the UVC. Once a proxy wavelength has been chosen, the Monte Carlo simulation data is reviewed to determine one or more suitable locations for measuring the proxy scattering intensity. During initial testing, the collection angle of the proxy sensor(s) should be established that ensure healthy signal to noise ratios, while addressing the concerns as cited in the above reference articles. Initial testing must also determine the number of proxy sensors and their spatial distance/orientation relative to the beam angle from the solid state light source in order to provide an estimate of the N_{d} of the fog in situ, which is needed to ensure the appropriate level of scattering to reach surfaces in shadow. In certain exemplary embodiments, the N_{d} value will be used to regulate the distance of the UVC source(s) to the products (and change conveyor belt speed as necessary) to maintain the proper dosage. In some applications, better discrimination can be afforded by measuring optical power at two or more angles, computing the relative power ratios at different angles relative to the axis of the proxy beam without fog, and comparing the results to predictions from Monte Carlo simulations. Each application may have unique requirements due to, e.g., geometric limitations in the available space to incorporate the invention. The extent of the teachings herein provides one of skill in the art overarching guidance to resolve implementation issues, whether directly or by providing leads to authors in relevant papers or other third parties that can provide support via theory/analytics/simulation and/or experimentation. Further reference for problem solving and creating a robust deign is made to Design and Analysis of Experiments (ISBN 978-3-319-52248-7).

In the exemplary embodiment, the transmittance through a distance of the dry fog (and through the same distance without the dry fog) is measured using a 635 nm solid state laser light source, 3 mW, available from Roithner Lasertechnik GmbH (Vienna, Austria), P/N LDM635/3LJ. The power is measured using a silicon PIN photodiode designed for optical power meters, such as the Hamamatsu Photonics, K.K(Hamamatsu City, Japan) P/N S3994-01, which is also fitted with a glass window for protection and thus can be sealed to avoid any concerns of dry fog effects on electronics. A pinhole aperture can be used to limit the field of view of the sensor. The sensor can also be optically filtered to avoid contamination by the UVC sources, ambient light, etc. and then generating/or (b) estimating as cited herein by measuring the intensity of a source at different angles through the dry fog and then comparing results to a database constructed from Monte Carlo simulations.

With the system constructed as discussed, calibration testing can begin using at first UVC dosimeters to ensure the dosing of surfaces not in shadow meets the requirements. Then the dosimetric avatars, as explained herein, can be used to test the surfaces in shadow. Note that 3D surface disinfection modelling is described in UV intensity measurement and modelling and disinfection performance prediction for irradiation of solid surfaces with UV light. See also U.S. Pat. No. 9,555,144 Hard surface disinfection system and method. Once confirmed, the appropriate feedback control elements can be used to test for sensitivities in design parameters, and the closed loop control system can be implemented in hardware/software (see, e.g., Feedback Control of Dynamic Systems, ISBN 978-0-13-349659-8). Environmental and other product development testing can be conducted (see, e.g., Next generation HALT and HASS robust design of electronics and systems (ISBN 978-1-118-70023-5), and then trial runs with real products can be conducted over a range of throughput rates in laboratory and factory settings. For UVC treatment systems, lab testing will include actual pathogen testing (see, e.g., Ultraviolet Light in Food Technology-Principles and Applications, ISBN 978-1-138-08142-0).

In another exemplary embodiment, the UVC source itself (i.e., no proxy source) can be used to determine the scattering profiles. For example, one sensor can be placed adjacent to a UVC source (with the appropriate filtering to avoid oversaturation and contamination from other light sources) and one or more in the far field, where all other UVC sources other than the one with the sensor can be pulsed off so that the UVC sensor can be correlated to the appropriate source (not all sources in an array, for example, will be at the same inherent intensity). See also the instant inventor's U.S. Pat. No. 8,937,443 Systems and methods for controlling light sources, that discusses how to measure multiple light sources and control their emittance, especially suitable in the instant application for an array of UVC LEDs. For example, the '443 discloses in claim 8 “A method for controlling light output of an array comprising a plurality of series-connected of light sources by a controller while maintaining a desired operating emittance of the array, the method comprising: during a first time period, pulsing current to a light source, wherein the light source is pulsed at a higher emittance; sampling the light of the array by an optical sensor during the first time period and during a second time period when the current is not increased; determining a difference in luminance between the first and second time periods; comparing the difference in luminance to an emittance value stored in a memory associated with the shunted light source; and subsequently controlling the current based on the comparison, wherein the subsequent controlling produces the desired operating emittance of the array.” Claim 13 uses a ramp instead of a pulse. These techniques were used to avoid visual artifacts during normal operation in the '443, whereas in the instant invention, UVC is invisible, although it still can be used, and in fact these techniques can be used for a visible proxy in the instant application, or for the Vis/NIR scattering application for greenhouses as disclosed herein.

Now, turning back to the isolated box in a UV tunnel, by using rails, one or more boxes can operate simultaneously. In one embodiment, the rail is fitted with a brush seal along one face that contains the fog within the rail. A hollow member on the box protrudes through the bristles locally, allowing fog to enter the box. See, e.g., the brush bristles as taught in U.S. Pat. No. 8,769,890 Device for feeding one or more lines through an opening in a wall or a floor. The construction materials must ensure the bristles do not rapidly degrade in UVC, nor trap detritus that could lead to microbial growth. See also claim 18 of U.S. Ser. No. 10/493,176 Curtain sanitizer device and method of using the same, citing brush seals that blocks UVC. Alternatives to brush seals are also contemplated, such as an accordion-style magnetic seal like what is used on refrigerator doors, PTFE foam, air curtains, strip seals, zipper arrangements, and the like. In one embodiment, a magnetic door gasket is fabricated, and are available in custom form from TRICOMP, INC. (Pompton Plains, N.J.). The protruding tube from the box is thin with a triangular-like cross section to lift (and release) the seal locally with a small displacement to minimize gaps in the seal between rail and box to avoid dumping dry fog into the tunnel.

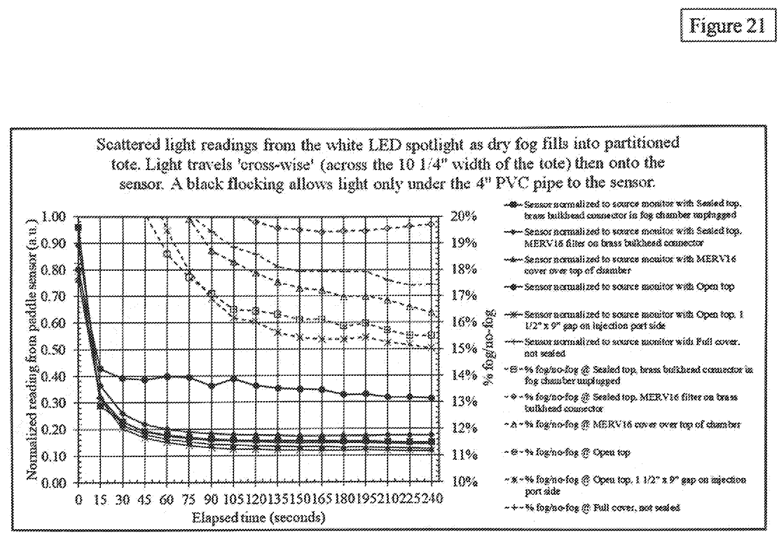

In any enclosed box configuration, an optional HEPA filter (e.g., Nilfisk Flat PTFE-coated filter, P/N 107413540) is attached to the box to allow air to pass through, but not the desired range of droplet sizes (or other solid scatterers if used). This prevents backpressure from building that would limit the fog mover from building up sufficient dry fog concentration in the box. The PTFE provides protection against the intense UVC in the tunnel. These specific filters are sold for the Nilfisk Pty Ltd. (Arndell Park, Australia) Attix 33/44 line of wet/dry vacuum cleaners. The operation is akin to the use of the MERV 16 filter cited herein with reference to FIGS. 20 and 21. The HEPA filter is also used when evacuating the box, enabling (dry) ambient filtered air into the box for an effective flushing action. The ambient air in and around the tunnel can be kept at a low RH to promote an effective flushing/drying process. The output side of the HEPA filter (furthest from the box interior) can also be fitted with a desiccant or other drying means. Desiccants are available, e.g., from Multisorb Filtration Group (Buffalo, N.Y.).

Note also “Since water particles present in visible vapor range from 2 to 40 microns, these particles are trapped by high efficiency filters. Some types of filters absorb moisture and expand, reducing air flow through the filter material. As a result, the static pressure in the duct rises from normal (about 1” water gauge) to as high as 40″ wg. When the filter absorbs moisture, it also releases the latent heat of condensed steam into the duct air. When a humidifier manifold is located too close to an absolute filter, the filter collects water vapor, preventing the moisture from reaching the space to be humidified. Placing the humidifier manifold farther upstream allows the water vapor to change into steam gas, which will pass unhindered through an absolute filter. Under most circumstances, the water vapor will dissipate properly if the humidifier manifold is located at least 10 feet ahead of the final filter . . . , Foggers may be applied in air handlers or ducts where the air velocity is less than 750 FPM. For duct applications, if the air velocity is in excess of the recommended maximum, a fogging chamber with fog eliminator and drain pan should be considered. When a fogging system cannot be practically applied to the existing mechanical system, a Direct Area Discharge Fogging System (DDF) might be the logical alternative. The “DDF” designation indicates that foggers are individually located within an enclosed area such as a warehouse or factory floor, and fog is directly discharge into the open space.” Humidification (Armstrong Flow Control). As an aside, this is an excellent reference on the principles of humidity and covers some aspects of wetting.

The Nilfisk filter is designed, however, for use in wet/dry vacuums (likely the reason for using a PTFE coating). Further, in fog applications, the flow rates are much lower than what would be found in a wet/dry vacuum cleaner (shop-vac). However, high velocities are described herein to achieve a high enough Weber number to cause bouncing of micron-sized dry fog droplets instead of adhesion on dry surfaces, but then the droplets would also bounce-off at least parts of the filter surface.

Many other tunnel/box connections are possible, such as using one hose to feed dry fog, and another to prevent backpressure and then remove dry fog after UVC irradiation is completed. A flushing approach can be used whereby the dry fog feeding hose is switched to feeding dry air while the other hose evacuates, or check valves mounted to the box open to the ambient drier air when negative pressure is applied by the evacuation system. Note that Nilfisk makes a line of wet/dry vacuums suitable for health and safety applications, as well as vacuums for food and pharma. A suitable check valve is the ‘Thin Swing Check Valve—Stainless Steel, Series 9300’, available from J&S Valve (Huffman, Tex.). The valves are sized from 2″ to 24″ and comprise a ‘resilient seat’ that ‘allows for seating at low differential pressure.’ Note that the torsional spring in the valve may need to be optimized for a given pressure differential. Note also that valves like this can also be made from polymeric materials to reduce cost.

In one exemplary embodiment, the products are placed on trays or food racks and then slid into one of a number of slots within the box that allows different fog thicknesses above and below the products. Trays can be fabricated from stainless steel wire belt material used for food conveyors such as Flexx Flow belting from Lumsden Belting Corp. (Lancaster, Pa.) The belt material is tightly strung in a stainless steel frame, making a type of food rack that would be used in an oven. The intent here is to keep the wires relatively thin to minimize equipment-induced shadows, while being able to maintain product weight without blocking too much UVC. A tight wire-to-wire spacing (e.g., 72 wires per linear foot, each wire 0.050″ in diameter) also allows support for small diameter foods, e.g., blueberries and the like. Alternatively, various box heights can be used to ensure equal fog thicknesses on top and bottom of the products. This can also be accomplished by adjusting the position of the top and/or bottom UVC transmissive plates relative to the position/slot where the products are positioned. Note also that the food tray/rack has apertures for the UVC to pass, however, some percentage of UVC is blocked. In addition, the conveyor belt itself that the box sits above also has similar apertures, whereas there are no obstructions above the products, and thus this imbalance in irradiation must be considered when adjusting lamp power from above and below.

Note also that the box need not be used with a tunnel. For example, the box can be stationary, with the sop, bottom, and/or sides fitted with UVC lamps, such as UVC LED arrays. Of course, reflectors having very high UVC reflectance can be used on one or more sides, including between/behind lamps, e.g., Porex Virtek® Reflective PTFE (Porex Corporation, Fairburn, Ga.).

As in all UVC irradiation systems, rotating the product to be disinfected greatly aids dosage uniformity. Powders can be swirled in a similar fashion as detailed herein in the family of patent applications for the instant invention, see, herein the discussion of turbulence, swirl, jets, etc.’

Ultimately, the isolated scattering approach is very efficient, because regardless of whether the scattered rays transmit-through or reflect-from the fog, they still head toward the powder, assuming the absorbing lamp plasma occupies a small volume.

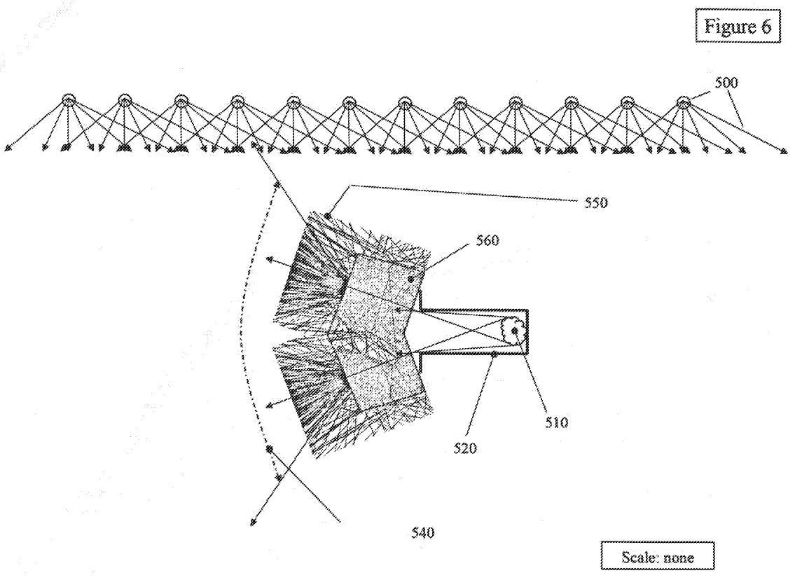

A similar embodiment would be items that are wrapped with UVC transmissive material (e.g., FEP shrink wrap) that maintains isolation (mostly or totally) between a food product and the dry fog. The shrink wrap allows the dry fog to come extremely close to the surface, which has a benefit as shown in FIG. 6.

As an aside, one should consider the effects (good and bad) of condensation on the shrink-wrapped package (and any windows, light sensors, etc.), causing diffusion of light (a useful thing to simulate in optical ray tracing) as taught e.g., in, Pollet, et al, Diffusion of radiation transmitted through dry and condensate covered transmitting materials, Solar Energy Materials and Solar Cells 86.2 (2005): 177-196. For example, sensors can be biased as a result of condensation. Light from certain angles may be refracted away from the target, although for certain angles it may aid the scattering performance. Approaches that use collimated light sources may be extremely sensitive to the condensation-induced diffusion.

Another embodiment to minimize any deleterious effects of water on a target (food), would be to remove residual fog and humidity from the target after UVC irradiation like the vacuum/exhaust hood and dryer as shown in FIG. 1. Dryers include the use of desiccants, dry air, infrared and other heaters, and the like.

In non-isolated systems, as mentioned previously, the degree of wetness/condensation is a function of a number of variables as taught previously in the discussion on the critical Weber number, and the like.

In one group of embodiments, a control system monitors condensate and adjusts parameters to minimize condensate while maintaining an adequate scattering profile for a given target. Thus, an exemplary target here is to meet the scattering profile while not oversaturating the air with dry fog, minimizing impaction-induced wetting, and avoiding having the surface of the food product at or below the dew point (e.g., by using certain surfaces of a UV tunnel as temperature-controlled programmable condensing spots to avoid condensing on food items). The following greenhouse control systems provide a somewhat analogous application for food products (and a closely analogous approach for the visible/NIR dry fog scattering enhancement to photosynthesis as described herein): “In this paper, we have designed and implemented a system that can understand the greenhouse environment and the state of crops by using sensors and optimize crop growth conditions with emphasis on the dew point condition. An automatic dew condensation control system combined with a WSN was realized, which utilizes the dew point condition to prevent the dew condensation phenomenon on the leaf surfaces of crops that is believed to be decisive in the outbreak of crop diseases. Also, a model similar to an actual greenhouse environment was made to verify the performance of the system presented and the model was operated and monitored by applying the automatic dew condensation control system. It can also cope with exceptional situations by providing the greenhouse environment and information about a device's operating state to users every certain time. The topic to be researched in the future is the optimal sensor deployment in a real greenhouse for the automatic dew condensation control system. To apply the automatic dew condensation control system to an actual greenhouse environment, we will have to gather more data about the real conditions and refine our system. Additionally, the building blocks composing the automatic dew condensation control system should be extended so that it can be applied to various situations that can occur in the actual greenhouse environment.” Park, et al, Wireless sensor network- based greenhouse environment monitoring and automatic control system for dew condensation prevention, Sensors 11.4 (2011): 3640-3651.

See also Shamshiri, et al, A review of greenhouse climate control and automation systems in tropical regions, J. Agric. Sci. Appl 2.3 (2013): 176-183., Ma, et al, An algorithm to predict the transient moisture distribution for wall condensation under a steady flow field, Building and environment 67 (2013): 56-68., Klingshirn, et al, Test design for condensate analysis in refrigerator vegetable drawers, Home Economics and Science 68 (2020) ISSN 2626-0913. DOI: 10.23782/HUW_18_2019, (published on Mar. 11, 2020).

In another exemplary embodiment, a control strategy is modeled after the use of ‘vapor pressure deficit’ (VPD) as disclosed in Shamshiri, et al, Membership function model for defining optimality of vapor pressure deficit in closed-field cultivation of tomato, III International Conference on Agricultural and Food Engineering 1152. 2016: “Greenhouse climate control and management begins with accurate understanding of the crop growth environment. According to the food and agricultural organization (FAO, 2002) guidelines for crop evapotranspiration (ET), major climatic factors influencing crop growth and photosynthesis in greenhouse production are air temperature (T), relative humidity (rH), and vapor pressure deficit (VPD), CO₂ and light. Since alone cannot measure dryness of the air (ASHRAE, 2010), calculation of a more accurate indicator, VPD, is of interest. This parameter can be used to estimate ET, and is defined as the difference between saturation vapor pressure (VPₛₐₜ) and actual vapor pressure (VPₐᵢᵣ) at a known T and rH . . . . VPD provides a better indication of the evaporation potential than rH and is capable of better reflecting how plant feels. It can be used to predict how close a plant production environment is to saturation in order to avoid condensation problems . . . . In tropical lowland environments (Shamshiri and Ismail., 2013 and Ismail et al., 2015), a high rH of the greenhouse air leads to condensation dripping from the cover, causing fungal spores besides appearing mineral deficiencies due to low sap movement in the plant. Pathogens develop and infect plants in these environments. Prenger and Ling, (2011) recommended that the VPD of greenhouse air should be kept above 0.20 kPa. The optimal values according to this reference are reported in the range of 0.5 to 1.0 kPa . . . . Fungal pathogens and mineral deficiency symptoms appear below VPD value of 0.43 kPa. Disease infection can be most damaging below VPD value of 0.2 kPa.”

In exemplary embodiments of the instant invention, the VPD control approach is used to model the vapor pressure deficit of the target food item to reflect the risk of microbial growth resulting from the dry fog during the UVC treatment. Note that additional testing is required for accurate modeling given that the UVC dry fog scattering time periods are much shorter than growth cycle of plants.

Additional modelling for use in control strategies in the instant invention can be found in prediction of moisture content in grain silos. “After harvesting, grain is normally stored for a period of time. To maintain grain quality during storage, grain must be protected from the growth and reproduction of insects, mites and fungi [1,2]. Storage temperatures lower than 15° C. can prevent insect development [3,4]. Therefore, temperature is one of the most important thermodynamic variables in storage that determine stored grain quality and their commercial value [5]. The aeration is an effective and economical way to improve storage conditions [4,6]. It is used to remove some of the heat accumulated and the excess of moisture produced by respiration of grains [5,7]. The process of respiration continues during storage for a long period, and the interaction between air humidity and temperature is important [8]. When the moisture of stored grain is more than 15%, grain respires faster than dry grain and forms hot areas that are favourable for fungal growth and insect attacks. Many studies have been conducted to predict the temperature and moisture content variation in conventional storage system [9-12]. Mathematical model of convective drying of wheat is reported by Aregba et al. [13]. A coupled heat and mass transfer model is used by Hemis et al. [14] to predict drying characteristics of wheat under convective air drying . . . A mathematical model based on heat and mass balances was developed. The grain temperature and moisture content are of major importance to preserve a safe storage of wheat under critical climatic conditions.”, Hammami, et al, Modelling and simulation of heat exchange and moisture content in a cereal storage silo, Mathematical and Computer Modelling of Dynamical Systems 22.3 (2016): 207-220. Drying methods for the instant invention are also discussed, e.g., in Design And Construction Of A Tunel Dryer For Food Crops Drying and Energy-efficient Industrial Dryers of Berries.

Of course, the sorption properties of grains as described above is different than that of many other foods. Further support for modelling a variety of foods is understood by examining the difference in the sorption properties of different food items, e.g., as described in Lind, et al, Sorption isotherms of mixed minced meat, dough, and bread crust, Journal of Food Engineering 14.4 (1991): 303-315, “The equilibrium water content and the water activity of a foodstuff at a given temperature and pressure are related by the sorption isotherm. When a food is exposed to an atmosphere of a given relative humidity and temperature, it can be deduced from the sorption isotherm whether water will evaporate or be absorbed at the surface. Szuhnayer (1973) discussed the use of the sorption isotherm to calculate the moisture exchange between the air and the food, and between foods with different sorption characteristics. If the driving force for mass transfer at the product surface is assumed to be the difference in partial vapour pressure of water between the surface of the food and the air, the sorption isotherm can be used in the calculation of mass transfer rates. The sorption isotherms determined during desorption and adsorption, respectively, often differ, showing a hysteresis effect. The hysteresis effect of non-mixed meat is small. Additives, such as salt, may strongly affect the sorption isotherm and may cause hysteresis (Lioutas et al., 1984). The content of other constituents, such as starch and fat, can also affect the sorption behaviour (Motarjemi, 1988). The sorption isotherm is affected by the temperature at which it is determined, and in general the hygroscopicity decreases when the temperature is increased (Labuza, 1968; Loncin & Weisser, 1977). The sorption isotherm can be determined either gravimetrically or by measuring the water activity at different water contents of the food. The gravimetric determination means that the water content of the sample is brought into equilibrium in an atmosphere of a certain relative humidity, and that the loss or uptake of water is measured by weighing the sample . . . . Meat—The time to reach equilibrium was 3 weeks and mould was not detected by visual inspection, except at the highest humidity at 20C, where a small amount of mould was found at the time of the final weighing . . . . Dough—The equilibrium time for dough was 4 weeks at 6° C. and 3 weeks at 30° C. At 6″C, a very small amount of mould was seen at the highest humidity at the last weighing . . . . Crust—The moisture equilibrium of the crusts was reached within 17 days at 30° C. and within 14 days at 90° C.”

The kinetic (temporal) equation for moisture relates to the sorption isotherms of the food product, the temperature and RH: “Changes in grain moisture and temperature of stored wheat were investigated for three different relative humidities. These experiments aimed to determine influence of low relative humidity aeration on the wheat moisture content. In summer, the average ambient temperature is about 30° C. This temperature will be operated to cool the stored wheat mass. Wheat temperature is varying between 32° C. and 42.9° C. and the inlet air relative humidity of 40%, 50% and 60%. Results indicate the significant influence of blown air dehumidification on decreasing relative humidity of interstitial air and wheat moisture content . . . . Microorganisms are unable to multiply when interstitial air relative humidity is below 65% [4]. For that reason, the preservation of wheat quality is related to the safe moisture content of the grain. Low-cost aeration systems have therefore the potential to provide the necessary flexibility for temporarily grain storing and cooling [3]. Some authors have developed and validated mathematical models to predict mass and heat transfer of stored grain during the aeration process [4, 5, 6, 7]. Few studies have focused on the use of dehumidifier during the aeration process of stored grain and the impact of this method on the grain's moisture and the product quality [7, 8]. Reference [9] reported the potential using of low temperature and low relative humidity RH to dry rough rice without affecting product quality and showed that drying duration can be shortened by reducing the RH . . . . The modified Henderson equation (2) was used to predict equilibrium moisture content for temperature of 30° C. and at different relative humidity (40%, 50% and 60%) . . . . The air-grain mass transfer is described by a kinetic equation [3, 7]. The reduction of grain moisture content until safe level of storage involves simultaneously heat and mass transfer processes, which can change grain quality . . . . Equilibrium relative humidity was predicted using wheat sorption isotherms. For 12% and 14% wet basis initial moisture content, safe storage conditions equilibrium RH<70% hold from summer to winter [11] . . . .” Hammami, et al, Influence of relative humidity on changes in stored wheat moisture and temperature, Journées Tunisiennes des Ecoulements et Transferts—JTET2016, Hammamet—Tunisie, December.

A further dive into the physics of moisture migration into foods relates to the diffusion of the fog environment (gaseous water vapor and liquid condensate) into solids vs. exposure time as discussed, e.g., in Diffusion of water in food materials—a literature review. “Central to understanding the effect of moisture on interfacial adhesion is to first identify the rate at which moisture is delivered to the interface. The three primary parameters that have the greatest effect on diffusion rates are the size of the diffusing particles, temperature, and viscosity of the environment . . . . and increase in temperature will produce a higher kinetic energy yielding an increase in velocity, thus particles will diffuse more rapidly at elevated temperatures.” The Effect of Moisture on the Adhesion and Fracture of Interfaces in Microelectronic Packaging.

Thus, increases and decreases of food moisture content can be predicted via mathematical models as described above. Interstitial spacing between food items, the thermal environment of the UV tunnel, RH, the initial moisture content of the food items, and any subsequent fog-evacuation/drying must also be incorporated into the model after correlating with actual measurements. Ultimately, this will inform the process engineers the degree to which moisture will enter the food during the process under different ambient (T, RH) conditions, and if the moisture must be removed post UVC dry fog scattering treatment, and the possible moisture removal rates based on kinetic modeling of the removal process to inform factory production rates and whether there are any resultant negative effects on food quality.

Testing can be performed via actual food products, but also via surrogates/proxies whose sorption and transpiration are similar to the actual food product(s). In fact, the proxies can be used as sensors much like the wireless UVC dosage pucks that are used in UV tunnels. As a rough example, a sponge can be fitted with moisture/rH/T sensors to inform the control system as bread runs through a UV tunnel in order to minimize the risks of pathogenic microbial growth (and to set alarms if exceeding the control authority). After passing through the UV tunnel, the sponge can be heated to adjust moisture content of bread as it enters the UV tunnel, and to expel moisture so that it can be used again in the UV tunnel. In a preferred embodiment, a generic surrogate is used that can be adjusted depending upon the food product.

A surrogate can be created by adjusting the compression/decompression of a piece of foam so that its sorption/desorption can be varied as disclosed in Glenn, et al, Sorption and vapor transmission properties of uncompressed and compressed microcellular starch foam, Journal of agricultural and food chemistry 50.24 (2002): 7100-7104.

Other surrogates/proxy arrangements can be devised to mimic the sorption effects of variable porosity, e.g., via variable apertures between chambers. To avoid microbial growth in the surrogate/proxy device (important for reusable devices), the arrangement should be fabricated, at least in part, of UV transmissive material such as FEP/UVGFS such that the UVC rays in a UV tunnel can penetrate the device so that it is continually disinfected as it passes through the UV tunnel. Note that the surrogates/proxies can utilize sensors that change their electrical properties, chromatic properties, or other to indicate moisture content of food products (or non-food products) that are treated with UVC dry fog scattering, be it a UV tunnel, an enclosed disinfection box, or the like.

When considering the injection of dry fog, e.g., into a UV tunnel, one must consider fixed/variable fog dispersal manifolds and spray bars, e.g., in UV tunnels with reference to those used with dry fog in dust suppression as shown in Fugitive Dust Control Using “UltraFine Fog”. Headers and manifolds for distributing the dry fog and supplying nozzles are discussed, e.g., in Considerations in Selection of Fogging Systems (Armstrong International, Three Rivers, Mich.) and U.S. Pat. No. 5,893,520 Ultra-dry fog box.

In order to achieve a desired amount of scattering, it is important that the thickness and number concentration of the dry fog are appropriate between a target surface and the UVC rays from the light source(s). Optical ray tracing simulation software such as TracePro (Lambda Research Corporation, Littleton, Mass.) that account for bulk scattering can be used to optimize the fog thickness and concentration for a given reactor geometry (fog chamber and UVC absorbance/transmittance/reflectance/scatter of surfaces, light source locations and ray angles) in order to optimize the fluence at surface portions of a target for a given application. CFD and multiphysics simulation software are also viable options.

FIG. 24 is a snapshot of a custom simulation constructed to understand how fog concentrations change in space both axially and radially, when directed laterally in the air using CFD. The example shown is for a very low concentration, using the following conditions: Operating Temperature=25° C., Operating Pressure=1atm, Air properties (assumed RH 100%, fully saturated): Density, ρₐ=1.17 kg/m³, Dynamic viscosity, μₐ=1.86×10⁻⁵ kg/m-s, Velocity, vₐ=0.5 m/s. Water Droplet properties: Density, ρ_{w}=997 kg/m³, Dynamic viscosity, μ_{w}=0.001 kg/m-s, Diameter, d_{w}=3.8×10⁻⁶m, Concentration=10 droplets/cm³, Velocity, v_{w}=0.5 m/s, Mass flow rate (hand-calculated)=2.39×10⁻¹⁰ kg/s. Static Pressure=ρg(z0−z) (where g=9.81 m/s²). The figure shows the concentrations at 25%, 50% and 75% of the distance between the pipe exit and the opposing wall (no crosswinds).

This type of spatial/temporal plot is especially instructive for applications where the UVC dry fog scattering system is moving. It indicates the expected number concentrations at various distances for a given fog concentration and exit velocity. It thus provides feedback to the designer as to what can be expected, and the adjustments necessary to reach required design specifications (when correlated to actual measurements), which include the suitable distances over which the concentration is viable for the scattering performance when combined with the light source geometry. Further CFD analyses can then be run with crosswinds that are to be expected based, e.g., on site-surveys. Note that crosswinds can be considered as fluid motion of the medium adjacent to the scattering field. Abatement of crosswinds include wind breakers, like the tent coverings (which is just another type of UV tunnel, and conversely, factory conveyor-type UV tunnels can/do function as wind breakers) used in the new nighttime mobile UVC disinfection of crops as described in A shot in the dark—Nighttime applications of ultraviolet light show promise for powdery mildew control.

In one embodiment, dry fog is (optionally chilled) and injected below a UVC transparent FEP film that is suspended just above strawberry plants in a field. The film can be planar (parallel to the ground), curved, or in any other shape that maximizes system efficacy. The film resides within a tent or tunnel that is pulled behind a tractor as discussed herein, within which resides an array of UVC lamps with their light directed at the plants. The film helps to prevent the fog from dispersing, especially in response to ambient winds and pressure changes. This enables the fog to be at a therapeutic concentration. In one embodiment, fog is injected onto the plants at the front of the tent/tunnel if the evaporation rate is low enough to maintain the therapeutic concentration at the speed the tent/tunnel is being pulled at. In another embodiment, fog is injected along both sides of the plants. Note that multiple FEP films can be employed to generate different strata of scattering fields to enhance efficacy. For example, in one embodiment, higher concentrations may be desirous on the sides of the plants than the tops of the plants. One film can be shaped to corral the fog with thicker fog sections along the side of the plants than on the top. In another embodiment, different FEP films are used to trap fog fields of different concentrations—to satisfy a desired spatial profile of scattering vs homogenization. Alternatively, one strata layer is empty with fog added only when the adaptive system demands additional scattering/homogenization, after which it is evacuated. In yet another alternative, one film is used, and one strata layer is formed below the FEP film, and another above the FEP film, as needed.

The tent structure can also be fitted with skirts and baffles to minimize the effects of cross-winds and the like. Skirts (fixed and/or adjustable) that isolate air flow are known in the automotive/trucking industry, e.g., U.S. Pat. No. 8,899,660 Aerodynamic skirts for land vehicles, U.S. Ser. No. 10/457,340 Adjustable body skirting assembly and a vehicle. Skirts are also used in hovercraft, e.g., U.S. Pat. No. 5,560,443 Hovercraft having segmented skirt which reduces plowing and other flexible/segmented skirts in US Class B60V1/16. Lightweight and flexible/segmented skirts in the instant invention also help in avoiding damage to the plants. Air curtains, brush seals, and vinyl strips, as discussed herein, are also contemplated for use around the exterior of the tent/tunnel to aid in isolating the fog from the external environment. In one embodiment, a cape-like cover is dragged over the plants behind the tent/tunnel to further prevent air entering/leaving the tent at high enough velocities to materially affect the fog distribution such that there isn't sufficient authority in the adaptive system to compensate. A similar cover can be dragged atop the plants by the tractor in front of the tent/tunnel.

The skirting above can be considered akin to wind baffles that are used in HVAC systems, e.g., US20210063029 Wind baffle with multiple, variable air vents for an air-conditioner, in heating devices, e.g., U.S. Pat. No. 6,125,838 Gas grill with internal baffles for use in high wind conditions, U.S. Pat. No. 4,893,609 Wind-resistant outdoor heating appliance, U.S. Pat. No. 7,252,503 Wind-proof venturi tube. In one embodiment, such baffles are deployed within the tent/tunnel to break up air currents and are made out of UVC transmissive FEP or highly reflective PTFE in order to minimize UVC absorption. In another embodiment, baffles are placed around the outside shape of the tent to spoil the flow of incoming wind and redirect it away from the interior of the tent/tunnel. Also see FIG. 1 of the '071 application, which shows a cart structure which directs radiation away from the cart to vines on either side.

In one set of embodiments, scatterometers (in combination with wind & pressure sensors) are deployed to test for effects of wind and pressure on the concentration and uniformity of the fog field and adjust the deployment of fog (and skirts/baffles) in an adaptive fashion. For example, a variable speed fan/blower is used in an embodiment to direct the fog away from the piezoelectric elements into the desired fog field location. Slower speeds will allow more fog to evaporate and drop back into the source water pool, thus lowering Na. Many other ways of changing N_{d} are contemplated, such as partially closing a gate valve that feeds a mixing box which then feeds a manifold. Alternatively, a percentage of solenoid valves at the manifold exit holes can be opened. In any arrangement, care must be taken to ensure the proper mixing of the fog (to ensure homogenization around the target objects) and speed of the fog (also effects homogenization as well as evaporation and coagulation). Finally, as mentioned herein, (fluorescent) tracer particles are used in the agricultural industry to track how (disinfectant) fog fields move after (crop duster) deployment in the field. Such tracers are contemplated for use with the instant invention.

Collection and distribution of dry fog—In an exemplary embodiment, dry fog is first collected in a box and then uniformly distributed as shown, e.g., using a manifold, a mesh filter for trapping larger droplets, and a box with a drain as in U.S. Pat. No. 5,893,520 ('520) Ultra-dry fog box. The dry fog can be generated by any of the disclosures cited herein and the associated patent applications. The slotted output disclosed in the '520 can be used to lay down a layer of dry fog across fruits and vegetables as they enter a UVC tunnel. The placement of dry fog can be considered the task of a ‘director’, i.e., directing the dry fog (or scatterers in the generic sense) into the desired location(s). The director can be anything from an ultrasonic atomizer whose natural exit flow is placed in a predefined location, or an open-ended pipe from an atomizer into a UV tunnel, or a simple connector into a box (e.g., like the connector installed on the HomeSoap® unit), or a hole in the bottom of a manifold for dry fog to fall in response to gravity, or any of the myriad of flow shaping/control geometries cited herein and the references. The scattering generator and director can be custom fabricated, ordered from stock items, or constructed at least in part by tapping into an existing system. The drain can direct the condensate into the sewer treatment system or back into the dry fog source water reservoir to recycle, as appropriate.

Previous references have been made to diffusers, including the use of vortices to distribute the dry fog most effectively for the application. Diffusers used in HVAC systems, are e.g., discussed in technical detail in Air distribution engineering guide (Price Industries, Inc., Suwanee, Ga.) describing terms of art such as air pattern, throw, drop, and spread, as well as registers, grills, louvers, etc. A simple application would be the placement of an air distribution device on the output of dry fog bulkhead connectors of the instant application in order to achieve a desired concentration profile. Of course, one must be mindful of the effects of using such as device, e.g., increased pressure drop, backpressure effects on the efficacy of the fog generator, droplet coalescence due to impingement, creation of concentration spatial/temporal non-uniformities, incremental evaporation and changes in droplet size due to increased droplet airspeed as cited, e.g., in How far droplets can move in indoor environments—revisiting the Wells evaporation—falling curve. Other technical analyses of diffusers are described, e.g., in Experimental Study of Vortex Diffusers, Simplified Numerical Models for Complex Air Supply Diffusers, Air flow characteristics of a room with air vortex diffuser, A simplified approach to describe complex diffusers in displacement ventilation for CFD simulations.

Dry fog retention with a UVC tunnel or the like—

a) Dry fog can be trapped between one or more UVC transparent sheet members (FEP, UV grade fused silica and the like), within which a conveyor belt operates. One member may be sufficient if the conveyor belt is solid and does not allow fog to pass through. A second member may be needed below the conveyor belt if the belt is porous, such as a wire link belt, which are used in some instances to irradiate the foodstuffs from the bottom as well as from the top (and sides). The sheet member(s) that contain the fog also aid in keeping the relative humidity at a high level to minimize dry fog evaporation. The dry fog can be injected between the sheet(s) and the belt at one or more locations along the path of the conveyor belt, as necessary to maintain the desired level of UV scattering to optimize the dosage. It may be desirable to maintain a consistent level of dry fog concentration along the length of the conveyor belt, but that need not be desirable for all applications. For some applications, it may be beneficial to have low/no scattering for a portion of the travel through the tunnel to maximize the dosage to certain surfaces. For some applications, testing may reveal that the fog is best created in multiple sections along the belt separated from each other. For example, a product turning device may be used at the half-way point to rotate the product for better UVC surface coverage, and so fog would be injected on either side of the turning device (perhaps with little or no fog before entering/leaving the turning device). Of course, the height of the sheet member above the conveyor must allow passage of the products.

b) Dry fog height span must accommodate differences in product sizes. For example, a strawberry may be one or two inches tall, whereas a loaf of bread may be four of five inches tall. Bluewater Technologies Group, Inc. (Wixom, Mich.) makes UVC sanitization tunnels that accommodate up to 30 shopping carts. Therefore, in order to achieve the proper UVC dosage, scattering fog fields (in conjunction with the coupled UVC source) of the instant invention are contemplated to be sized accordingly, whether to envelop an entire product and/or irradiate the product in sections.

c) In an exemplary embodiment, a UV tunnel irradiates strawberries by filling a UVC tunnel with a sufficient flow rate of dry fog to create a six inch thickness dry fog field, half above a wire-link conveyor belt and half below. The fog field is kept from sinking further than three inches below the belt by a transparent UV grade fused silica (UVGFS) plate, below which are UVC light sources directing rays to scatter up through the fog field and through the wire-link belt onto the strawberries. The UVGFS plate(s) are slightly angled to allow any condensate to run off into a drainage system. In this embodiment, no plate is placed above the three inch thickness of fog extending above the wire-link belt. The UVC tunnel has sidewalls (or optionally the belt is configured with vertical compartments) that prevents the fog field from spilling over the sides and on to the floor. A vacuum system is placed after the tunnel exit to remove any residual moisture.

d) In the next exemplary embodiment, modeled after the previous one for strawberries, the dry fog flow-rate is high enough such that no lower UVGFS plate would be necessary, with the fog field continuously dropping vertically through the tunnel as shown in FIG. 1 and described below:

i) Referring now to FIG. 1, a UVC tunnel 3700 comprises a wire-link belt, above and below which are UVC lamps directed at strawberries supported by the top of the belt, each lamp surrounded by a highly UVC-reflective aluminum (e.g., 4400UVC MIRO® 4 from ALANOD GmbH & Co. KG, Ennepetal, Germany) cusp reflector. See, e.g., the discussion of cusp-reflectors in U.S. Pat. No. 7,195,374 Luminaires for artificial lighting including FIG. 3 therein, and U.S. Pat. No. 6,948,832 Luminaire device including FIG. 10 therein, and in both the applicant is a cited inventor. The '374 cites the need for the cusp reflector: “U.S. Pat. No. 4,641,315, “Modified Involute Flashlamp Reflector”, granted on Feb. 3, 1987 and assigned to The Boeing Company. This patent discloses a set of parametric equations that can be used to define the shape of cusp reflectors that project light emitted by tubular cylindrical lamps without directing any reflected light back to the cylindrical surface of lamp envelopes. Avoiding back-reflections to the lamp reduces light absorption by the lamp. Accordingly, this improves efficiency by increasing the amount of light flux projected out from a cusp reflector/lamp fixture for a given electrical power input.” The '832 also shows the use of a cusp reflector with an integrated collimator structure, useful for the instant invention. Note that the lamps can also be partially surrounded by other high efficiency reflector arrangements as is known in the art instead of the cusp reflectors shown in FIG. 1 of the instant invention. In some instances, a combination of two reflectors (e.g., a specular reflector backing a diffuse reflector) are useful in providing high efficacy and a suitable degree of homogenization, see, e.g., WO1995002785A1 Backlight apparatus with increased reflectance. For UVC systems, a diffuse reflector suitable for use in UVC systems is from Porex Corporation (Fairburn, Ga.), see Ultraviolet Reflectance of Microporous PTFE. Note that UVC LEDs project only in the forward direction, obviating the need for a cusp reflector.

ii) The UVC lamp/reflector assemblies are optionally sealed to a UV grade fused silica (UVGFS) window (for ease of cleaning and to avoid any warranty issues regarding lamp/reflector exposure to dry fog). The window is spaced from the center of the average strawberry height based on simulation and then optimized further in-situ, based on dosimetric measurements of real strawberries/products using applicable pathogens (and/or use of the dosimetric avatars as cited herein), dry fog flow rates (whether from a nebulizer array or a piezo array, or other), the number of lamps (their power, the reflector geometry, etc.), the conveyor belt speed, temperature/humidity inside and outside of the UVC tunnel, etc. Note that UVC lamps can be placed closer to irradiation targets under dry fog conditions since the dry fog scattering will tend to eliminate the high intensity hot spots that may be detrimental in a no-fog condition since the dry fog acts like an optical homogenizer for the UVC field and thus lowers the hot spots. An exemplary application includes the use of dry fog scattering of UVC to prevent the overheating of fish fillets as described in traditional pulsed UVC treatment in Inactivation of Escherichia coli 0157_H7 and Listeria monocytogenes inoculated on raw salmon fillets by pulsed UV-light treatment and Intense light pulses decontamination of minimally processed vegetables and their shelf-life.

(1) The UVC tunnel entrance and exit doors are designed to minimize the leakage of dry fog outside the system. Such doors are designed to avoid product damage and meet the necessary product flow rate through the tunnel. Non-limiting exemplary door technologies are cited herein, e.g., vinyl strip like curtain doors or automated mechanical doors fabricated from (or covered with) UVC- and food-compatible materials. Note also that air curtains can be considered as previously cited. A slight negative pressure inside the tunnel can also be considered to contain the dry fog, so long as the relative humidity is maintained within the tunnel at sufficiently high levels to minimize dry fog evaporation, and its impact on the ambient air surrounding the tunnel is also considered. Test data will be shown herein that a tight seal of the fog within the irradiation chamber may not provide much benefit when compared with a slightly leaky seal.

(2) An exhaust/vacuum hood or the like is positioned outside the exit door in order to remove residual fog and excess moisture from the exiting product and from any leakage through the door. Note, however, for some products, e.g., salmon fillets, moisture removal may not be needed (or as complete) as in other products, e.g., bread. A similar vacuum hood may be placed near the entrance door (or above the entire system including both the entrance and exit) to capture dry fog leakage and maintain the desired relative humidity in the area of the tunnel and/or without overly taxing the existing HVAC system. Sensors can be used as known in the art to run the motorized exhaust at only the necessary power level to meet the requirements, thereby minimizing energy costs (and audible noise). See, e.g., VHB Series Type II exhaust hoods (used for condensation or heat removal applications, not grease laden vapor) from CaptiveAire (Raleigh, N.C.), which can be coupled to one of their air movers specified for the airflow as determined by CFD and verified through testing. Note that the exhaust/vacuum system need not vent outside of the facility as the fog can be condensed, collected, and routed to the sewer system or recycled as appropriate. Incremental increases in relative humidity can be treated with a dehumidifier or via the building's HVAC system.

(3) The dry fog is generated by 1.7 MHz piezoelectric ultrasonic transducers in a dry fog atomizer selected, e.g., from the SM-xxB product line manufactured by Jiangsu Shimei Electric Manufacturing Co., Ltd. (Jiangsu Province, China), where ‘xx’ defines the wattage, in hundreds of watts, in seven different models from 300 watts to 3200 watts. Based on the desired UVC tunnel size and product flow rate, the appropriate aerosol generated model is chosen, where higher wattage generates a higher flow rate of aerosol. The units consume water from plastic jugs or can be plumbed into a domestic water system. The water quality should be food grade, and the mineral content of the water can be adjusted to meet the dry fog generation needs as discussed elsewhere herein, as minerals can affect dry fog particle size and evaporation rates, as well as deposits of scale that build up over time, potentially clogging the manifold ports, reducing interior UVC reflectance, and narrowing the gaps between wire-links to name a few. Distilled and deionized water are also options as discussed in the related applications of the instant invention. The dry fog generators feed up to three 110 mm output ports, which are connected to one or more manifolds within the UVC tunnel. The number concentration can be varied by adjusting the wattage and/or diluting the output (e.g., feeding-back some of the output directly back into the source water without using it in the irradiation chamber).

(4) The combined lengths of pipe that deliver the dry fog to the treatment zone in the UVC tunnel must be considered, since condensation could occur, leaving less dry fog for distribution. An analogous situation is found in dry fog nebulizers used for patients. See, e.g., In-vitro Comparison of 4 Large-Volume Nebulizers in 8 Hours of Continuous Nebulization, “We studied 6 units of the following nebulizer brands: AirLife Misty Finity (Cardinal Health), Flo-Mist (Smith's Medical), Heart (WestMed), and Hope (B&B Medical Technologies). All the nebulizers were operated according to the manufacturers' recommendations and connected to 180- cm of flexible corrugated tubing . . . . Raabe et al reported delivery efficiency to the mask of about 90% with the Heart nebulizer.11 In the present study the efficiency was only 77%. We speculate that that difference is due to the difference in tubing length in the studies (30 cm vs 180 cm) and the difference in testing time (5 min vs 60 min and hourly for 8 h). Also, they applied continuous suction at 17 L/min, whereas we had no flow interacting with the nebulizer output.” Now a 180 cm long tube is 70″ long. As a data point, the GermAwayUV Sanitation Conveyor System (SPDI UV, Delray Beach, Fla.) specifies that their UVC tunnel has a “UV Germicidal Area” of 40″×20″, and so if the dry fog manifold was also 40″, that leaves 30″ for plumbing the SM-xxB dry fog generator to the manifold in order to equal the 70″ tubing length in the nebulizer study cited above. Note that the dry fog falling distance though the UVC tunnel treatment zone is comparable to the dry fog travel distance into a person's body to the bottom of their lungs and both systems exhibit high humidity in these regions, so again, the systems are somewhat analogous when considering dry fog evaporation. In addition, the lung temperature is elevated above ambient, as is the interior of a UVC tunnel due to the heat generated by the UVC lamps. Dry fog evaporation and condensation in the dry fog distribution system in the instant invention can be minimized by careful temperature/RH control (and/or additives to water) as cited elsewhere in the instant application (including all family member applications). Note that hose/pipe bends can form traps that act like the traps that plumber's install below a sink. These traps can collect water (which could lead to pathogen breeding) and increase the pressure drop due to the pipe restriction.

(5) In this exemplary embodiment, the manifold is comprised of a 4″ ID type 304L stainless steel pipe (a food-safe material that can withstand UVC irradiation) that extends along the length of the tunnel, with ports on both sides of the pipe extending along the pipe length, high enough up the side of the pipe to allow condensate to collect in the bottom of the pipe and run towards the distal end of the pipe (the pipe is slightly tilted at about ¼″ per foot like in pipe drain lines) outside the UVC tunnel and drain into either the sewer system or plumbed back to the aerosol generator for reuse (as appropriate in light of applicable plumbing codes and best practices). To minimize cost (solid 304L pipe is expensive), given that the pressure in a dry fog system is near that of ambient air, the pipe can be made from 304L sheet metal formed into a cylinder, with an overlapping seam that is riveted and sealed from dry fog leakage with UVC- and food-compatible 304 stainless steel tape available, e.g., from Viadon LLC (Peotone, Ill.). The pipe is placed in the tunnel with the seam facing upwards to minimize the risk of condensate leakage, with holes punched or laser cut along each side for distributing the dry fog down through the tunnel. The hole sizes and spacing can be determined via CFD and verified/optimized via testing in the actual chamber under the normal range of operating conditions (different belt speeds, etc.). See, e.g., the use of CFD and related analyses in Simulation of UV-C Dose Distribution and Inactivation of Mold Spore on Strawberries in a Conveyor System, and Computational fluid dynamics as a technique for the UV-C light dose determination in horticultural products. The input end of the fabricated pipe is connected outside the tunnel to low cost pipe and fittings compatible with potable water (see, e.g., NSF/ANSI 61: Drinking Water System Components—Health Effects). Care must be used to avoid UVC light piping (e.g., through the holes in the manifold) and light leakage outside the UVC tunnel, which can be harmful to people and to incompatible materials. Ultimately this must be measured with UVC radiometers to guide any appropriate remediation, e.g., the use of baffles to make the UVC follow a more tortious path in exiting the tunnel, thereby increasing the loss of intensity with each extra bounce. Of course, the methods chosen should also be chosen to minimize standing water (and shadows) that promotes pathogen growth. The fabrication of the dry fog (and other) features, whether retrofit or forward-fit, must also be compatible with the applicable UVC tunnel cleaning processes (chemicals, temperatures, pressure washers, etc.). Note that the pipe can be covered with UVC reflective material such as Virtek® Reflective PTFE (Porex Corporation, Fairburn, Ga.), and ray trace software such as TracePro (Lambda Research Corporation, Littleton, Mass.) can aid in determining optimal geometries to maximize coupling of UVC from the lamps to the scattering fog to the product. The 4″ ID tube may also be distributed to smaller ID plenums between the lamps located at the top of the tunnel.

(6) In a slightly different embodiment, the manifold is a box built above the top of the UVC tunnel, covering about the same area, with holes drilled in the locations between UVC lamps up through the top of the tunnel and into the manifold box. As before, exact locations and hole sizes are determined by CFD with verification via dosimetric testing at various locations on the conveyor belt. The dry fog is then plumbed between the aerosol generator and the manifold. The box also has a drain that allows any condensate to be captured and run to the sewer or recycled as before. The heat from the lamps must be considered as it can lead to evaporation which can then lead to condensation at saturation, after which the droplet sizes change, see, e.g., The Effect of Relative Humidity on Dropwise Condensation Dynamics. Changes in droplet size distribution will change the scattering profile and can also lead to wetting-sized droplets that would not be suitable for certain products passing through the UVC tunnel, e.g., bread. The perforations in the top of the UVC tunnel can be fitted with insulated tubing to minimize dry fog evaporation in the higher temperatures of the tunnel near the top due to heat rise. One or more tunnel walls can be fitted with heat exchangers to minimize the temperature in the chamber. The manifold box can be thermally isolated from the top of the UVC tunnel by insulative material; see, e.g., such materials from McMaster-Carr (Aurora, Ohio). Alternatively, a heat exchanger can be placed between the bottom of the manifold box and the top of the tunnel, such that ambient (or cooled) air is directed therebetween via one or more fans. In either case, tubing is installed at periodic locations in the manifold box (and between lamp locations in the tunnel) to carry the fog between the bottom of the box and the discharge points in the tunnel.

(7) In yet another embodiment, the fog is injected from ports at the entrance and exit surfaces and directed inside the tunnel. This is especially efficient in retrofit applications.

(8) In still another embodiment, the fog is shaped/positioned to envelop the product with a specific thickness/concentration to generate a desired scattering profile. The fog can be shaped in numerous ways, e.g., one or more of (a) chill the water and/or resultant fog to cause it to sink, (b) use air pressure/velocity and an array of nozzles to direct the fog, where the air pressure/velocity can vary from nozzle to nozzle, and the nozzles in the array can be different sizes and have different dispersal patterns (c) use UVC walls (transparent or reflective depending upon the lamp arrangements) around the product (e.g., forming a container, which may be opened on one or more of top/bottom/side and/or contain support elements to elevate the base of the product) to contain the fog at a specified distance from the product, where the walls can also be shaped to maintain a specified fog thickness around the product and/or the walls can be the windows of the UV lamps that can positioned at various distances and angles relative to the product (d) introduce more laminar flow, (e) introduce more turbulence, (f) use one or more of Taylor vortices, Karmen vortices, Vortex/smoke rings, swirl flow like in cyclones/tornados, the Coand\check{a} effect, the Magnus effect, the Dean effect, continuous and/or pulsed jets, and/or other flow effects, whether created based on the geometry and/or movement of a single product or a geometrically arranged group of products, and/or with the assistance of other stationary/moving objects, (g) introduce entire atomizers, e.g., piezo devices, at one or more locations inside the tunnel, each with one or more fans to selectively direct the fog, (h) Place a bath of water (optionally temperature controlled) below the conveyor belt, add piezo elements along the periphery in the bath to create a fog layer above the water that envelops the product at a desired thickness, and filter/recirculate the water bath, where lamps are placed above the bath, and optionally below the bath depending upon whether the bottom of the bath is transparent or reflective to UVC, (i) float products in the bath of the previous embodiment, either due to natural buoyancy and/or added air bubbles, and rotate the products as they proceed along a length of the tunnel (i.e., change their spatial orientation with respect to the source of wave energy), (j) drag the wire link belt through the bath where the added buoyancy from the water enables the products to more freely rotate, (k) rotate and/or translate the manifold injecting the fog inside the tunnel, e.g., by rotating/translating a round pipe that acts as the manifold with perforations in it, (l) insert a cylinder into the fog pipe/manifold, where the cylinder has geometric apertures that meter the fog through the apertures (or direct the fog to different nozzles in order to create different fog patterns for different products) in the pipe/manifold as it is rotated/telescoped (m) arranging products geometrically (precisely and/or with some degree of randomness) on a conveyor belt to distribute the fog to attain a desired scattering profile, with or without the assistance of other stationary/moving objects adjacent to the products, e.g., like the linear spacing between tall loaves of bread or a hexagonal pattern of lettuce heads (n) creating changes in fog thickness around products as they travel along the tunnel, e.g., traveling waves of fog via incremental deposition of fog and/or perturbation of the fog field using a mechanical device like a paddle or a fluidic device, like puffs of air or waves in the previously cited water bath.

Fog sinking or low-lying fog′ relates to vapor buoyancy (see '806 section 42)—Note that for the instant invention, one embodiment creates the water vapor via an atomizer (e.g., ultrasonic) that is cooled to create a fog layer close to the ground: “The two main factors that affect how low or high your fog will be are the temperature of the fog and the temperature of the surrounding area . . . . The cooler your fog is, the lower it will stay. The cooler you surroundings are, the higher your fog will rise . . . . When designing the chilling area, keep in mind that you want to chill your fog as much as you can . . . I advise adding some obstructions for the fog, so the fog will have to travel around, instead of being able to go straight through the fog chiller. Basically, you want to make it stay in the chiller longer, which will result in colder, lower fog . . . . If your fog machine has a higher wattage, you may want a bigger exit hole. This will help spread the fog and keep it low. If the exit isn't big enough, the fog will be forced out and will rise a few feet . . . . a pretty inexpensive fog chiller setup with the three pieces as described above: A sealed connection from the fog machine to the entrance of the chiller. A chiller the fog must travel around. And a wide exit . . . . Another way to help keep the fog low, if you are inside a building or room where you can control the temperature, turning on the heater before using your fog machine will help keep the fog low. The greater the contrast between the temperature of the surroundings and the fog, the lower your fog will be.” How To Do Low Lying Fog (Ground Fog) FeltMagnet.

The effects of temperature, pressure, etc. on vapor can be found e.g., in the textbook Moisture of Meteorology for Scientists and Engineers (ISBN 978-0-88865-178-5). The physics of fog is discussed in Essentials of Meteorology—An Invitation to the Atmosphere, (ISBN 978-1-305-62845-8).

“The molar mass of water vapor is much less than that of dry air. This makes a moist parcel lighter than a dry parcel of the same temperature and pressure. This effect is known as the vapor buoyancy effect . . . We define the virtual temperature Tᵥ=T[(1+r/ε)/(1+r)] . . . where T is temperature, r is water vapor mixing ratio, and ε=Mᵥ/M_{d}. The molar mass of water vapor Mᵥ is 18 g/mol, significantly lighter than that of dry air M_{d}, which is 29 g/mol. This makes a moist parcel lighter than a dry parcel of the same temperature and pressure (Emanuel 1994). Here we refer to this as the vapor buoyancy effect, though it is also referred to as the virtual effect (Yang 2018a,b).” The Incredible Lightness of Water Vapor

(9) Note that the previous elements can be changed manually, e.g., as part of a machine setup during a production run, and/or a computer/controller can be used to direct actuators to automate changes to the previous elements in temporal/spatial relationships to the products. Open loop and closed loop controls (or combinations thereof) are both contemplated.

(10) In the instant invention, low pressure (LP) UVC lamps (which are essentially fluorescent lamps without the phosphor coating and use instead UVC transmitting glass instead of absorbing glass) are in an enclosed UVC tunnel (to avoid dry fog leakage). In an analogous situation, heat exchangers have been used to remove heat generated by high power density fluorescent backlights for sunlight readable liquid crystal displays (LCDs) as taught in U.S. Pat. No. 6,493,440B2 Thermal management for a thin environmentally-sealed LCD display enclosure. In the instant invention, UVC lamps inside the tunnel generate heat that raise the temperature in the tunnel. Convection currents (from air surrounding the lamps, which may or may not contain dry fog, depending upon whether they are isolated from the dry fog) inside the tunnel couple heat to the outer walls of the tunnels, which are externally cooled like in a heat exchanger. In one embodiment the lamps are isolated via sealed UVGFS windows, and the ambient air inside the lamp cavity does not contain dry fog but filtered ambient air (to avoid contamination). In another embodiment, the lamps are not sealed from the dry fog, and the dry fog is cooled (either before it is circulated in the tunnel or via a heat exchanger inside the tunnel) such that the temperature rise of the dry fog does not lead to excessive evaporation and subsequent large droplet condensation. Thermal simulation software can aid in the design, e.g., Lumerical HEAT 3D Heat Transport Solver from ANSYS, Inc. (Canonsburg, Pa.).

(11) In yet another embodiment, the fog is isolated from the heat generating lamps by injecting it into the tunnel in a vertical plane between the lamps above the conveyor belt and the lamps below the conveyor belt. In fact, if the conveyor belt is porous such as the wire link belt that has been cited, the fog can be injected into the gap between the upper and lower runs of the belt (the belt forms a loop) while minimizing the blocking of UVC light with plenums, tubes, and the like.

(12) In yet another embodiment, a UV tunnel irradiates shopping carts. Aerosol generator discharge ports are positioned around the shopping cart. The center of the cart therefore receives a very dry fog concentration, however, in one embodiment, the concentration in certain locations (e.g., between the shopping cart and the tunnel wall, not in the path of direct light from the lamp to the cart) is so high that the UV rays are redirected back towards the UV source(s) as shown in the Monte Carlo simulation results herein. Since the dry fog droplets essentially do not absorb UVC, the reflection is extremely efficient. Lower concentration fog between the UVC source(s) and the center of the cart are sufficient to efficiently scatter the UVC onto surfaces in shadow.

(13) In another embodiment, a dry fog scanner is constructed, creating, e.g., a six inch wide wall of fog that is passed over lettuce, such that the fog wall is irradiated from both sides, where the light rays from each side travel through about 3″ of fog thickness, which has been shown herein to be an optimal scattering thickness for the HEART® nebulizer-style dry fog generator. Other thicknesses are optimized for other atomizers generating a different droplet distribution and number concentration.

Simulations of dry fog scattering—Monte Carlo simulations shown in FIGS. 3 and 4 were run using Mont Carl. Rays from a pencil-like collimated laser beam are directed through a fog thickness of t_{FOG}. Rays are shown scattered at the inclination angle, θ, in the R-z plane. The scattered rays are equally likely to be at any azimuthal angle, φ, around the z-axis, so only the inclination angle, θ, of rays in the R-z plane are shown. Collimated rays are helpful to use as an input to better understand the scattering effect as it passes through the fog. This way, the scattering angle can be attributed solely to scatter, and not a divergent input angle from a diffuse light source.

Mie scattering for single droplets based on the input ray wavelength of λ=280 nm (vacuum wavelength) were compared for single 1-micron and 10-micron water droplets (n_{w}=1.357) in air on two tools (MiePlot and MontCarl, attributions can be found in Applicant's presentation), not shown. Both tools show essentially the same results. Broader scattering occurred for a 1μ droplet compared to 10μ.

For simulating vast numbers of water droplets, Monte Carlo scattering can be used as shown in FIG. 3. Here a 4.85″ thick cloud of dry fog at a concentration of 100,000/cm³ are simulated separately for droplet sizes of 1, 5, 10, and 25 microns, each at 222 nm (Far UVC, n_{w}=1.4191) and 730 nm (Far-red, n_{w}=1.3278), with similar results for a given droplet size.

In FIG. 4 the simulations were run at the germicidal wavelength of 254 nm for 5-micron droplets. Two fog thicknesses are simulated, 3.85″ and 5.85″, each at four different dry fog concentrations. The differences in these two thicknesses have a small effect, but the differences in concentrations have a large effect. Also note the highlighted box. It will be shown in greater detail in the next slides.

It should be noted that the actual dry fog concentration applied to a given application is a function of many variables. Based on the simulations shown in FIGS. 3 and 4 for the conditions that were presented (wavelength, fog thickness, scattering element size), number concentrations between about 10⁵/cm³ and 10⁷/cm³ appear to be a reasonable range to test in an attempt to optimize. In fact, as cited herein, the HEART® nebulizer that was tested is believed to be within these limits. This appears to be higher than the characterization of atmospheric fog & haze cited herein, disclosing a range of droplet sizes from about 0.1μ to 20μ in diameter, and droplet concentrations from about 10/cm³ to 10⁴/cm³. Note, however, that atmospheric fog & haze can be substantially thicker than a dry fog as proposed herein for use in a UV tunnel, and hence the experience we have of not being able to see through certain fog events. Thus, for a given scattering element size, the combination of scattering field thickness and number concentration must be considered, which is what the Beer—Lambert law is modeled after (to arrive at transmittance), including the correction factors applied thereto as discussed herein. So, in order to roughly compare one scattering field to another, the Beer-Lambert equations can be used to rough-order, but each field must be accurately described by using the appropriate correction factors.

With reference back to FIGS. 3 and 4, there are traces of 1000 rays from dry fog scattering at various concentrations, fog thicknesses, and wavelengths. These renderings are helpful to get an intuitive understanding of the scattering profiles. For each configuration, an additional simulation was done with 1-million rays for statistical significance. The results of these simulations are shown in in both linear and polar forms detailing the relative intensities at the angle, θ, in both the forward(0°) and backscatter (180°) directions, and all angles in between. The % transmitted or forward scattered, vs the % reflected or backscattered is also supplied for each simulation. This provides one metric to compare scattering efficiencies, depending upon whether the application befits from forward scattering, backscattering, or both. Another metric is the angular distribution as it relates to reaching in the shadows.

Note that MontCarl also has the ability to add velocity to the scattering field to simulate temporal changes. Of course, simulations of this type can also be performed for air bubbles in water and other combinations of substances, phases, and electromagnetic wavelengths.

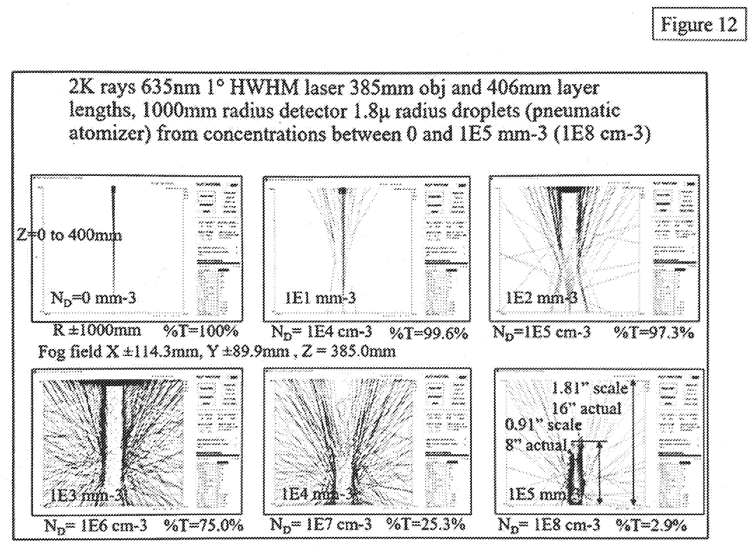

The MontCarl results shown in FIGS. 12 and 13 are based on simulations 2K rays of a 635 nm laser beam with a 1° HWHM divergence based on 3.6μ diameter water droplets at concentrations between 0 and 10⁵/mm³ (10⁸/cm³), with a fog thickness, t_{FoG}=385 mm (15 inches). Note how the percent transmission (% T) decreases with increasing concentration. For N_{d}=10⁸/cm³, the ray trace was scaled, showing the large number of rays that only travel about 8″ (203 mm) before backscattering. In FIG. 13 the concentrations vary from N_{d}=10⁸/cm³ to N_{d}=10⁹/cm³, with the ray travel decreasing with increasing concentration. This simulation is useful to roughly determine fog concentrations (with a 635 nm laser beam as used herein).

Test summary—testing was performed with a 635 nm visible light laser to estimate N_{d}, and with HomeSoap® 254 nm disinfection boxes comparing the performance of dry fog to no-fog.

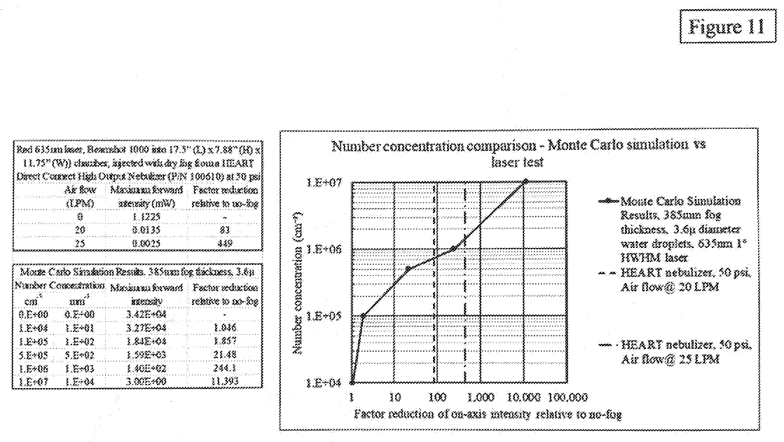

Three dry fog atomizer technologies were evaluated—two pneumatic (035H nozzle from HART Environmental and a HEART® nebulizer) and a collection of three piezoelectric/ultrasonic operating at 1.7 MHz (from Best Modules Corp.). All atomizers used the same local well water. In FIG. 11 the results of a measurements with the 635 nm red laser are shown, used to estimate the concentration of fog from the HEART® nebulizer when comparing with the results of MontCarl simulations, suggesting N_{d} on the order of 10⁶/cm³, which is comparable to the measured concentrations of known nebulizers.

Two identical, commercially available HomeSoap® units were purchased from Amazon. Each stands vertically like a small computer tower and has a front door that opens to a cavity that is 3.6″ wide, 9.2″ tall, and 13.1″ long. There is a tubular UVC lamp along the top that runs most of the length of the cavity, and it is protected by a UVC transparent glass tube. Another UVC lamp runs parallel at the bottom of the unit beneath a UVC transparent glass plate. Depressing the button on the front runs an automatic 10-minute cycle. The front door was modified to allow injection of fog and access to the cables from the two UVC sensor pucks, an upper UVC sensor facing the upper lamp, and a lower UVC sensor facing the lower lamp. The units are not specified to work with dry fog. Both units performed flawlessly, even the one with many dry fog cycles.

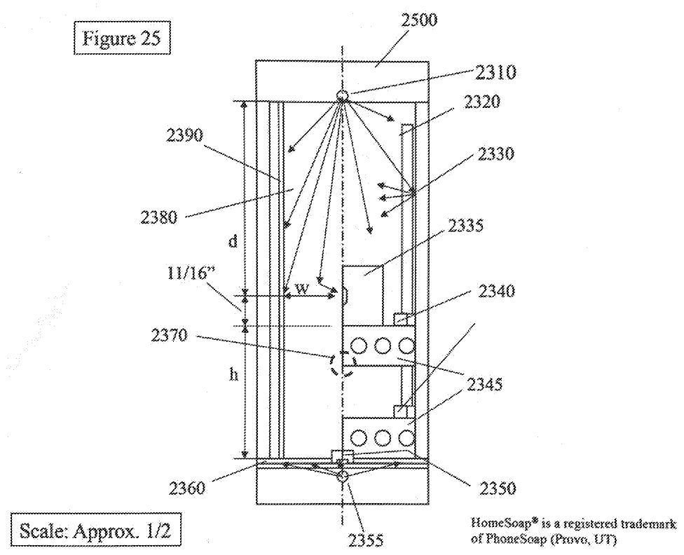

In FIG. 25 a drawing of the modified HomeSoap® unit is provided. As shown, to achieve shadowing, an adjustable height platform supported the upper UVC sensor that faced a UVC absorbing polycarbonate sheet placed in front of the entire left wall of the cavity. The platform could easily be raised and lowered to measure performance for different thicknesses of fog between the upper lamp and the upper UVC sensor. Another polycarbonate sheet covered the entire bottom glass plate, blocking all the UVC from the bottom lamp, except for a hole for receiving the lower UVC sensor that faced the lower lamp. This sensor was pressed against the plate in order to eliminate fog as a variable for the lower lamp measurements. This configuration was purposefully constructed to make it very difficult for UVC rays to reach the upper UVC sensor via dry fog scattering.

In FIG. 27 a chart shows data at five different vertical distances, d, between the upper UVC sensor and the bottom of the upper UVC lamp, with the sensor facing sideways at a UVC absorbing polycarbonate sheet to create a shadow. At d=4.69″, the sensor received 242% more UVC when fog was used, than when no fog was used.

In FIG. 28, a chart also shows data at five different vertical distances, d, between the upper UVC sensor and the bottom of the upper UVC lamp, but here the upper UVC sensor faced upwards to receive direct-light from the upper lamp. The polycarbonate sheet along the left side was removed, but the one on the bottom glass plate was left in place. At d=4.85″, the sensor received 79% of the UVC when fog was used than when no fog was used. This does not mean these UVC rays were lost or absorbed—just scattered, and some available to strike other objects to be disinfected. The measurements also appear consistent with the % transmission numbers from the Monte Carlo simulations.

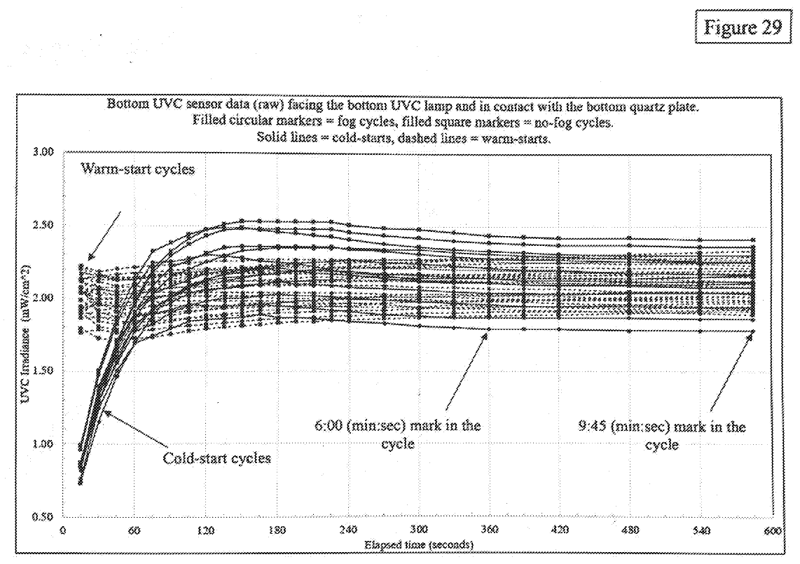

The previous data were taken at the 9:45 mark of each 10-minute cycle. That is because of the temporal effects from the lamps, which appear to be traditional warmup effects of tubular lamps that emit 254 nm. Note that the HomeSoap® documentation does not state the specific lamp chemistry, but it does state 254 nm. The chart in FIG. 29 shows both cold-start and warm-start cycles. For both cases, you can see the measured irradiance is stable after the 6-minute mark.

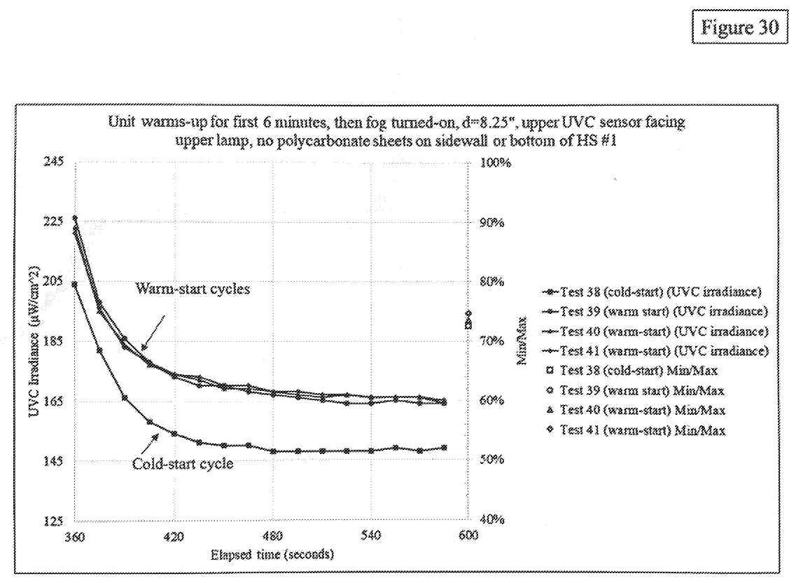

The temporal effects on irradiance as fog filled the HomeSoap® cavity, starting at the 6-minute mark, for one cold-start and three warm-start cycles is shown in FIG. 30. At 8¼″ of fog thickness, the direct view stabilized fog irradiance averaged to 73% of the no-fog irradiance when these cycles started. Note that unlike previous measurements, the 2nd polycarbonate sheet was also removed, allowing the UVC from the lower lamp to play a role. Again, the UVC rays that missed the detector were scattered elsewhere.

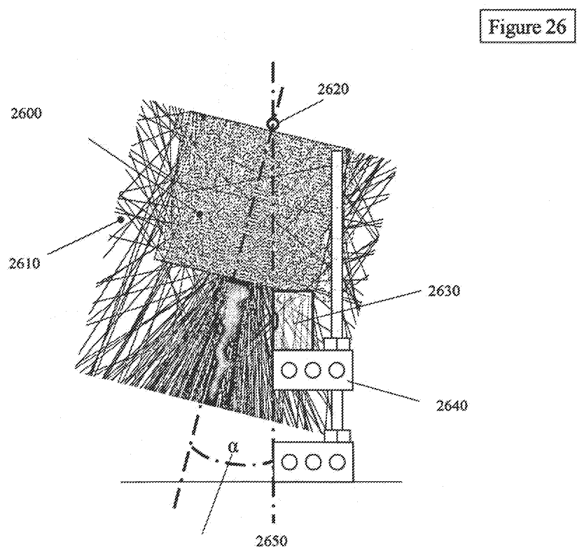

In FIG. 26 the upper sensor support scaffolding inside the HomeSoap® is shown along with an exemplary MontCarl ray trace rendering (Ø5μ droplets at N_{d}=10⁶ cm⁻³, λ=254 nm, t_{FoG}=5.85″) extracted from FIG. 4. The ray trace is canted by an arbitrary angle, α. It describes an understanding of the test, whereby to reach the detector, UVC rays emitted from the lamp need to be offset by some angle, α, which is not a direct ray, satisfying the purpose of the test.

In FIG. 5 a drawing was created to show a microbe in a canyon (not to scale), without fog, having no direct line-of-sight to the rays from any of the UVC lamps that line the top of the drawing.

In FIG. 6 two copies of the exemplary MontCarl ray trace rendering cited earlier are each centered along the extreme rays of the direct field of view of the microbe in the canyon (again, not to scale). This shows that with fog, the field of view of the microbe is extended, such that some rays from the lamps can reach the microbes, hence expanding their field of view. This is valid since the specific light rays in the renderings equally represent light traveling into the fog or out of the fog.

The following is a much more detailed discussion of the testing found in the '139 application.

Shadow testing—There is no standard test by which the effect of shadowing is characterized (see, e.g., Validation Needed for UV Surface Disinfection Applications»UV Solutions, December-2020). The International UV Association (IUVA, Bethesda, Md.) has formed a Food and Beverage Safety Working Group to address this. In the interim, in support of the instant invention, there needed to be techniques by which to measure whether, e.g., dry fog scattering (or any other technology) is able to address the shadowing issue, and some of those devised as part of the instant invention are disclosed, below:

a) Cylinder containing a dosimeter/radiometer—In one embodiment, a radiometric sensor is placed within a cylinder transparent to the incident radiation (e.g., an acrylic or polycarbonate tube for visible light, a UV grade fused silica tube for UVC light). The input aperture of the radiometer can be rotated inside the tube to face any direction of interest, e.g., directly facing the light source and facing away from the light source (e.g., rotated 90 degrees away from the direct line of sight to the light source). On the outside of the cylinder, different shadow inducing structures can be affixed. The approaches disclosed below were devised to be very repeatable, such that anyone could construct the same test easily. The visible light sensor is P/N UT385 from Uni-Trend Technology (Guangdong Province, China). The UVC sensor is P/N UV512C from General Tools & Instruments (New York, N.Y.). The polycarbonate tube was 1″ ID×1¼″ OD and cut to 12″ in length and purchased on Amazon.

i) Vinyl tape (black) loop around the tube to create a shadow—In one experiment using the setup of FIG. 10, ¾″ wide black vinyl electrical tape was wrapped in a single loop around a clear 1¼″ OD (⅛″ wall thickness) polycarbonate tube in a ring-fashion, such that it cast a shadow from a visible white-light semi-collimated (25° Cree spotlight) LED onto a wide FOV sensor embedded within a paddle/wand mounted within the cylinder (the center of the active sensor surface was about 0.27″ from the inside surface along a radial line). See FIG. 10. Four sets of measurements were taken. One set was taken with the radiometer sensor facing the source (but in the shadow of the tape), and second set of measurements were taken with the addition of a dry fog at various thicknesses. A third set was taken with the radiometer rotated 90 degrees within the cylinder about the cylinder's axis (but again, still in the shadow of the tape). A fourth set was like the third set but with the addition of the dry fog at various thicknesses. The purpose of this testing was to determine whether the addition of dry fog scattering caused more light to reach the sensor than without the dry fog when the sensor is occluded by a smooth surface.

ii) Magnetic balls looped around the tube to create more complex shadows—In another experiment using the setup of FIG. 10, 5 mm OD black rare-earth magnetic balls were strung in a single line and then wound tightly around the same polycarbonate cylinder in place of the vinyl tape, with a sufficient number of windings to ensure the sensor was in the shadow of the balls. There are small apertures between adjacent magnets formed by the round surfaces of the magnets. The same four sets of tests were conducted as with the black vinyl tape. The purpose of this testing was to determine whether the addition of dry fog scattering caused more light to reach the sensor than without the dry fog when the sensor is occluded by a textured surface. Black magnetic balls were used in the visible light experiment to more closely emulate the low reflectance of materials to UVC light.

i) Visible Light Testing

Test results for the above two conditions based on a fog from a HEART® Direct Connect High Output Nebulizer (P/N 100610, Westmed, Tucson, Ariz.) at 50 psi air pressure and 20 LPM air flow rate set on a 0-25 LPM Air Click Flowmeter, P/N AF-3021, WT Farley (Ladson, S.C.). Dry fog (using tap water) from the HEART® nebulizer was directed via standard 22 mm corrugated tubing (see, e.g., AirLife® 22 mm Corrugated Tubing, segmented every 6″, available from Care Express Products, Inc, Cary, Ill.) into a chamber (Polypropylene 19 Quart WEATHERTIGHT® heavy-duty storage tote, UPC 762016445380 with interior dimensions 15.75″ (L)×7″ (H)×10.25″ (W)) through a bulkhead connector inserted through the H×L sidewall as shown. The overall hose length was 18″, plus an additional 2″ for the connector to the chamber. The near end exterior H×W face of the tote was illuminated by an external white LED spotlight (Cree P/N SPAR38-1503025TD-12DE26-1, 16.9 watt, 3000K, 25° Spot, approx. 4″ exit aperture) aligned along the central axis of a set of slip-fit PVC tubes (4″ nominal diameter) mounted in a partition within the tote, across the H×W as shown. A clear plastic window was attached and sealed to the far-end of the inner 4″ ID PVC tube, where the outside face of the window could be slid to distances between 0″ and 4″, via a slip fit with the outer PVC tube, from the face of a clear polycarbonate tube (1″ ID×1¼″ OD and cut to 12″ in length, purchased on Amazon from the Small Parts brand, P/N TPC-125/20-24) installed across the width of the tote as shown. The slip-fit PVC can be thought of as a telescopic projector, as the input to the window is always devoid of fog, and thus any light within the tube does not begin to scatter (except for scattering from the inside of the tube surface, the degree to which depends upon whether the tube is in its natural white state or lined with a black flocked absorber) until it exits the window as the distal end of the tube. Within the polycarbonate tube a visible light sensor paddle from a laser power meter was placed, with the sensor aperture facing either the center of the LED beam (in the H×W plane) or 90 degrees rotated therefrom (in the W×L plane). The laser power meter was P/N UT385 from Uni-Trend Technology (Guangdong Province, China). The sensor paddle was pressed against the inside face of the polycarbonate tube by placing a ¼″ diameter wooden dowel encased in a ¼″ ID×⅜″ OD silicone tube (purchased from Amazon) against the backside of the sensor. The sensor paddle was shadowed either by a single loop of ¾″ wide black vinyl tape or 10 windings of close-packed 5 mm diameter black rare-earth magnetic balls. A wide field of view (FOV) source monitor (Light ProbeMeter P/N 403125 from Extech, Waltham, Mass., now part of FLIR Commercial Systems Inc., Nashua, N.H.) was placed as shown such that it caught enough stray light to register a high enough signal in order to catch any pertubations of the raw LED beam, yet did not cast a shadow into the fog). No effort was made to mix/homogenize the dry fog—it entered the far side of the chamber through a custom-made 22 mm bulkhead connector as shown and was allowed to naturally circulate. The flow pattern in the fog chamber was different depending upon the penetration of the telescopic PVC tube into the fog chamber. This could be seen by the movement of the large droplets that were visible (a proportion of dry fogs will have a distribution of droplet sizes, a small percentage which are visible). The humidity inside the chamber was measured separately using a Hygro-Thermometer, P/N 445815 (Extech), and it consistently reached 100% after allowing the dry fog to reach its maximum concentration. The in-chamber humidity measurements were made in the winter in early 2021, with room RH between 20% and 30%. As cited elsewhere herein, the high RH minimizes, to the degree possible, evaporation of the dry fog.

Testing was performed with the white LED spotlight and the HEART® nebulizer dry fog with one wrap of black tape covering the section of the polycarbonate tube within which the sensor paddle was aligned, facing the LED spotlight, such that direct light from the LED spotlight was blocked. See FIG. 10. Data was taken every 15 seconds out to 4 minutes run-time. One set of measurements was made with the telescoping 4″ PVC tube with a black flocked interior liner (FIG. 14) without adhesive backing (see, e.g., Edmund Optics Inc., Barrington, N.J., P/N 60-068). The black liner prevents scattering from the inside of the PVC tube, maintaining the semi-collimated light from the white LED spotlight. The telescoping tube protruded through the dry fog isolation partition as shown (FIG. 10) for fog thicknesses of ¼″, 1″, 2″, 3″, 4″, as before.

In FIG. 14, as mentioned, the test was configured with the 4″ PVC tube having its inside surface lined with black flocking paper. So, as semi-collimated white light from the LED spotlight hits the wall, it does not scatter. There is no fog inside the inner PVC tube, as the window on the distal end is sealed to the end of the tube. The solid lines on the chart are the normalized data from the laser power meter inside the polycarbonate tube, and the dashed lines depict the % change in light relative to the fog-free condition for that fog thickness.

The normalized sensor curves, from highest to lowest are: a tight grouping of 1″, 2″, 3″, 4″ (3″ lagging at the start), with ¼″ distinctly lower.

The % intensity change relative to no fog curves, from highest to lowest are: 3″, 2″, 4″, 1″, ¼″. The % intensity change relative to no fog at stabilization of ˜208% is a maximum at a 3″ fog thickness, followed by 2″ (184%) and then 4″ (152%), suggesting that there is a preferred fog thickness for this configuration. Ray tracing can be used to cross-check these results.

The normalized sensor readings (solid lines) at the end of elapsed time (the ‘stabilized’ values shows ¼″ distinctly lower than the other distances. It is likely that there is not enough fog in the ¼″ gap at the number concentration from the HEART® nebulizer to provide much scattering. It is not known whether the flow dynamics in the tote favor certain gap distances between the tubes, although it is surmised from the data that this effect is minor, as the excursions about a smooth-curve ‘trendline’ (if one was plotted) are not substantial. Said differently, voids in the fog distribution will tend to fill in over-time, as would be expected in consideration of entropy.

Notice on the plots of FIG. 14 that the curves resemble resistor-capacitor (RC) exponential charging curves. In simplistic terms, the fog builds up in the fog cavity like charge in a capacitor, and the scattered light increases the amount of light working its way around the black vinyl tape to the shadowed sensor. The amount of light appears to hit a maximum after about 2 minutes. It is (a) unlikely that by-chance the number concentration is optimized, and that (b) the optimal number concentration is likely higher, rather than lower. The reason it is not lower is because the data was taken over time, and there was no definitive local maximum before the elapsed time, and the number concentration was lower before stabilization. So, this suggests that the dry-fog concentration can be further increased for additional benefit. However, the concentration appears to hit a limit with the single HEART® nebulizer in the fog chamber, which could be due to one or more reasons cited below.

One reason could be that as the fog reaches a certain concentration, there is an equilibrium between the incremental fog added from the continuous feed from the HEART® nebulizer and the incremental fog that evaporates within the chamber.

Another reason could be that there is back-pressure that builds in the fog chamber (also suggested by a review of FIGS. 20 and 21) until the HEART® nebulizer becomes limited in the amount of incremental dry fog it can supply. A 0-60 psi pressure gauge was connected to the fog chamber, but no pressure above ambient is detected on the gauge (even after 5+ minutes), however, the flexible clear film cover on the fog chamber does bulge a bit after fog is first introduced and does not collapse until the chamber is vented to ambient. Also of note, the compressed air continues to be consumed by the nebulizer, and some fog swirling is noticed within the chamber at the 5+ minute mark. Fog does not appear to be leaking out of the chamber (the large droplets are visible and easily seen when leaking). Various leakage tests are shown in FIGS. 20 and 21.

Yet another reason is that the smaller invisible dry fog droplets are leaking, but the larger visible fog is not.

Going back to the RC charging analogy, one can roughly think of the dry fog analogous to an electrical current, and the pressure into the nebulizer analogous to a voltage. Based on the pressure gauge reading 0 psi, it appears all of the pressure is dropped across the nebulizer (and the flow meter in series with it at the input).

This can be also likened to the leakage resistance of a capacitor; see, e.g., Insulation Resistance, DCL Leakage Current and Voltage Breakdown—European Passive Components Institute, that suggests temperature increases capacitor leakage, much like temperature increases dry fog evaporation.

Time constants related to fog charging were made (not shown) based on the white paper System Dynamics—Time Constants. The approach taken was the ‘The Logarithmic Method’, whereby the natural log is taken of the exponential charging function in order to linearize the curve. Comparisons are made by just using the first 45 seconds of the normalized sensor readings during fog charging for each of the fog thicknesses. This type of approach can be used to model fog scattering applications that periodically inject and/or exhaust fog from a volume, where the process is terminated after a desired number of time constants.

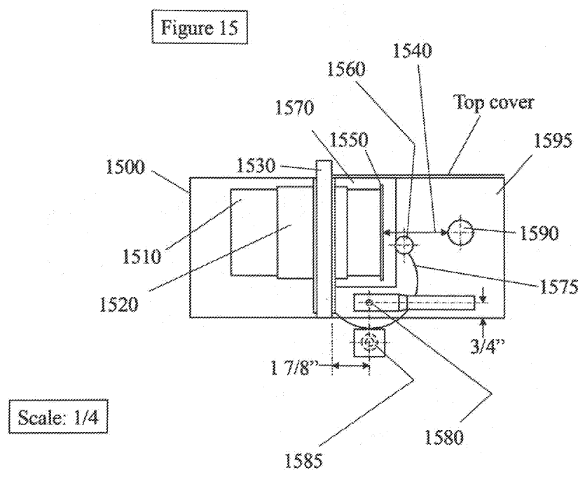

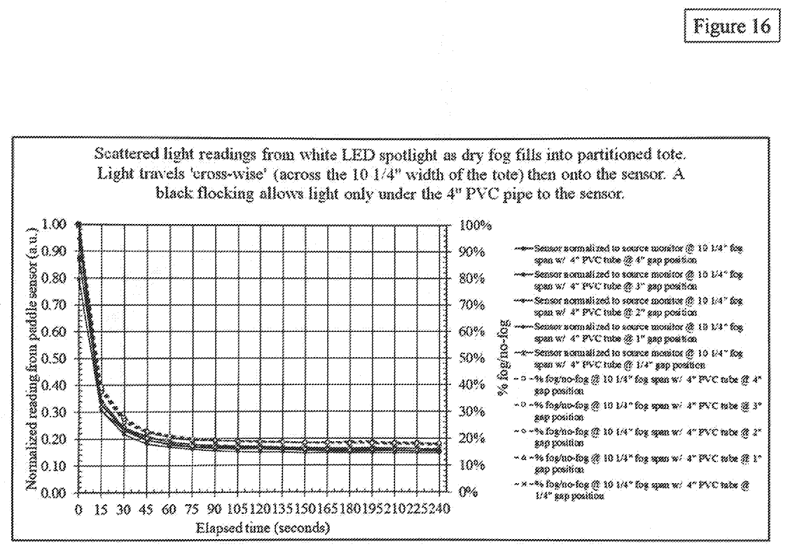

In an effort to understand whether the protrusion of the 4″ PVC tube at different distances into the fog chamber made a difference, the chamber was turned 90 degrees as shown in FIG. 15, where light was introduced ‘cross-wise’ below the level of the 4″ tube, using a black flocking to block light from the spotlight impinging on the PVC tube, but allowing it to travel under the tube. As shown in FIG. 16, the scattering was largely unaffected by the position of the 4″ PVC tube in the chamber. It was theorized that there would be some differences in scattering in the cross-wise setup of FIG. 15 if the fog were sealed within the chamber vs. allowed to leave the chamber in different manners, all while fresh fog was continually injected to the chamber as in the other tests.

Various test cases are shown in FIGS. 20 and 21 by which the fog could exit (or not):

1. Top sealed, brass bulkhead connector (Ø0.72″) in the side of chamber unplugged.

2. Top sealed, brass bulkhead connector (Ø0.72″) in the side of chamber covered with MERV16 filter paper (breathable Non-Woven Polyester Polycarbonate (NWPP)—95 Percent Efficiency, purchased from Biodefensor Filters, City of Orange, CA, via Amazon). MERV16 was used since it is sold as ‘captures particles small as 0.3 microns’, thus allowing air molecules to pass through, but not the bulk of the dry fog droplets.

3. Top covered in MERV16, sealed around its edges to the chamber.

4. Open top.

5. Top opening 1½″×9″.

6. Full cover over top, not sealed.

As shown in FIG. 20, only the test with the top of the chamber removed (‘Open top’) had any substantially different intensity loss relative to the no-fog condition. However, this likely indicates that in this test, a larger amount of the fog was lost because the number concentration was lower—thus less scattering, and therefore a higher cross-wise measurement during the fog cycle. The other configurations did not have an appreciable difference, so as long as the fog were somewhat contained (not necessarily in a totally sealed chamber, which was somewhat surprising, and fortuitous, allowing for simpler containment, e.g., in a UVC tunnel). FIG. 21 shows the same data, but the secondary axis has been narrowed between −80% and −90% to look at the small differences between test cases.

Interestingly, other than case number 4 cited above, case number 5 (Top opening 11/2″×9″) had the highest amount of scatter losses, followed by case numbers 1, 3, 6, and 2, although these were all within about 5% of each other.

Another part of the analyses was to understand the effect on air pressure and flow rate to the scattering from the HEART® nebulizer. See FIG. 17. It shows that higher pressure and higher flow rates increase scattering, with 45 psi @ 15 LPM the lowest scattering, and 55 psi @ 20 LPM the highest scattering. The guideline settings from the HEART® manufacturer (for its use as a nebulizer) is 50 psi, and either 10 LPM or 15 LPM (the latter for ‘higher output’).

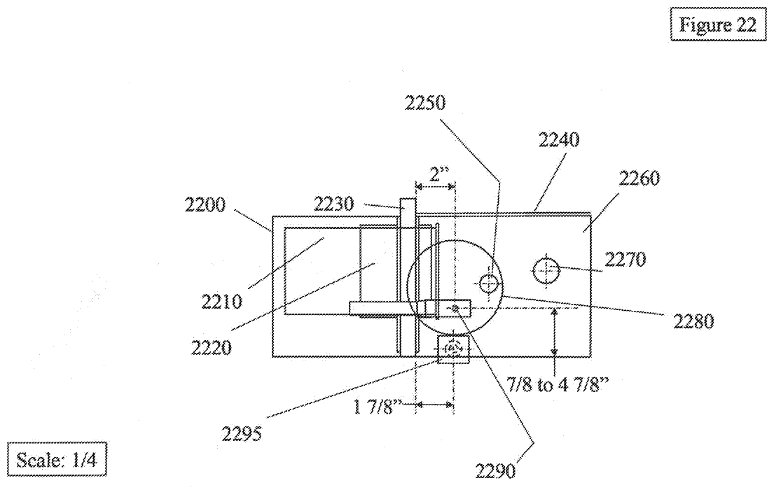

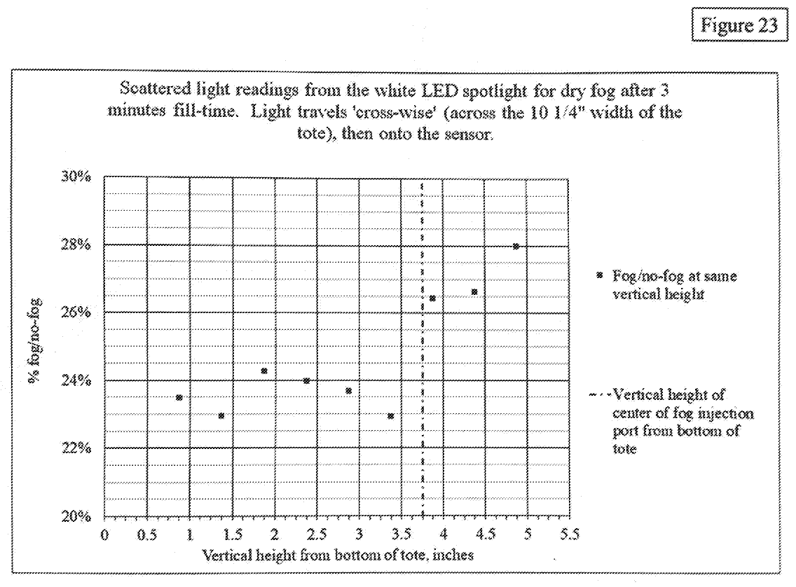

Another phase in the testing was to understand whether gravity and/or flow dynamics made a difference in the number concentration in the vertical direction of the visible light tote-based fog chamber. The sensor was placed at vertical heights on the outside surface of the tote as shown in FIG. 22, from ⅞″ to 4⅞″ in ½″ increments relative to the bottom of the tote. The data is shown in FIG. 23, as normalized (fog/no-fog), where the ‘normalized’ data is the sensor data divided by the source monitor data, the no-fog is the reading at time=0, and the fog is the reading after 3- minutes elapsed time. There is also shown vertical line that depicts the vertical height of the fog injection port. The data shows very little difference with respect to vertical height, except for a bit of a step for heights above the vertical height of the injection port. This suggests that the flow dynamics plays a role in the uniformity of fog concentration, even after stabilization time. CFD analyses can help understand this better, as can testing, see, e.g., Flow visualization of an N95 respirator with and without an exhalation valve using schlieren imaging and light scattering.

It is also important to note that the number concentration of the fog was not quantitatively measured by dedicated instrumentation. Initial testing of the fog (the same HEART® nebulizer) with the tote (without the partition) was performed with a red 635 nm laser, Beamshot 1000 from Quarton, Inc. (New Taipei City, Taiwan). The laser light traversed the fog along the entire length of the tote. The laser power meter was placed at the peak intensity of the beam as it exited the tote. The maximum forward intensity was measured at 0% fog, and airflows of 20 and 25 LPM. The two airflow rates will produce different distributions of dry fog. The ratio of the maximum intensities (without fog/with fog) was calculated as shown in the upper table in FIG. 11. Monte Carlo simulations (MontCarl) were also run using the same wavelength, fog thickness, and monodisperse water droplet diameters, and provided the change in peak intensity of a 635 nm laser versus changes in number concentration (peak intensity will lessen the more the scattering broadens the beam, which is intuitive). This is summarized in the lower table of FIG. 11. By measuring the change in peak intensity from no-fog to maximum fog number concentration, one can (to a rough degree) compare the measured peak intensity reduction data to the Monte Carlo simulations and deduce the number concentration. The data in the lower table is plotted in FIG. 11. Thus, the measured ‘Factor reduction’ in peak intensity (from 20 LPM to 25 LPM air flow at 50 psi) correlates to a number concentration within about 7E5 cm⁻³ to 2E6 cm⁻³, assuming the measured data was taken from a monodisperse water fog of droplet diameter 3.6μ. Again, while not exacting, it shows in fact that the HEART® nebulizer could generate a sufficient number concentration to scatter the beam. Also note that this estimate is fairly consistent with the nebulizer/compressor combinations disclosed in FIG. 9 of Dynamics of aerosol size during inhalation—Hygroscopic growth of commercial nebulizer formulations.

FIGS. 12 and 13 provide Monte Carlo simulation results (via MontCarl) for various water fog (3.6μ diameter droplets) number concentrations from 0 through 1E9 cm⁻³ (using a 635 nm laser, and a fog thickness of 385 mm). Is shows that around 1E6 cm⁻³ about 75% of the rays transmit in a forward direction, with a fair amount of spread from scattering. It also shows that around 2E8 cm⁻³, the forward transmittance is under 1%, with the maximum distance through the fog at just over 4″.

The same 635 nm red laser was tested on a smaller chamber (12 quart polycarbonate, 12.68″ (L)×10.39″ (W)×7.76″ (H), model C10 from Lipavi, Hertfordshire, England) that hosted three ultrasonic Water Atomization Modules, P/N BMZ00040 from Best Modules Corp. (Hsinchu, Taiwan) each with a 10 watt 1.7 MHz, 20 mm diameter piezoelectric ultrasonic transducer. The water height above the transducers was set to about 1 cm. With all three operating at 10 W, the generated fog cloud was about 2 inches thick, riding on top of the surface of the water. The 635 nm laser was aimed into the fog, and it could only progress through a distance of about 4 inches. This indicates that the number concentration was higher than that produced by the HEART® nebulizer, since the Monte Carlo simulations in FIG. 12 show that as the number concentration increases to about 1E8 cm⁻³, the incident radiation, e.g., from a laser, begins to turn back toward the source. In fact, looking at the simulation results in FIG. 13 (only a slightly larger droplet radius), the number concentration (assuming monodisperse droplets as a rough approximation) is between 1E8 cm⁻³ and 1E9 cm⁻³. Since it is easier to dilute a concentration than increase it (entropy), the ultrasonic (piezo type) approach provides a method by which a dry fog field can be tuned to any desired degree of forward scattering (in addition to a portion or none of backward scattering, if desired). Depending on the application and the desired amount of scattering, a (controllable) range of N_{d} values can be selected (using, e.g., a scatterometer or via measurements of the end-effects of the irradiation) for a given range of irradiation wavelengths, scatterer sizes (and shapes), and fog thicknesses (assuming the environmental conditions can support such concentrations vis-à-vis evaporation, wetting, etc.). FIGS. 3, 4, 12 and 13 (and others in the provisional filings) provide examples of the sensitivities to parameter space.

A comparison of scattering via Monte Carlo simulations conducted at a 10° HWHM beam at 280 nm, 405 nm, and 630 nm for 5μ droplets at the same layer thicknesses was performed (not shown). The results are about the same for all.

To understand the reasonableness of the estimate of the HEART® number concentration, see Effect of evaporation on the size distribution of nebulized aerosols. It shows that both compressed air (pneumatic) and ultrasonic nebulizers operate at a number concentration of at least 10⁶/cm³. This is consistent with the measurements made above.

It is noteworthy that the dry fog, at least the visible portion, output from a hose connected to the HEART® nebulizer follows gravity and drops to the bottom of an empty container, indicating it would also drop on to a conveyor belt that carries produce for disinfection. See also the discussion and formulae for sedimentation (and evaporation) in Mechanisms of Airborne Infection via Evaporating and Sedimenting Droplets Produced by Speaking. It shows dry fogs evaporate orders of magnitude faster than their sedimentation time, and it also states, “Solutes in the droplet decrease the water vapor pressure and therefore limit the droplet radius in evaporation equilibrium . . . ”, i.e., adding stuff to pure water may enable the droplet to evaporate at a lower rate. Water vapor pressure decreases with a decrease in temperature, and thus further limits evaporation as can be seen in Vapour pressure of water—Wikipedia.

In a preferred embodiment, an array of nebulizers line either side of a first enclosed portion of a tunnel conveyor system, discharging a layer of fog on top of product to be disinfected. Stationary sidewalls on either side of the conveyor belt prevent the fog from falling away. Airflow is controlled to ensure the fog is not swept away (although enough to ensure good mixing may be suitable). The belt then moves the product into the adjacent second enclosed portion of the tunnel that is configured with UVC lamps that cast their light through the fog onto the product. UVC reflective walls will aid in recycling light back to the product. Very dense dry fog layers at the lowest level can also provide efficient reflection via backscattering (see the Monte Carlo simulation results herein for the number concentrations needed for backscatter). The product can either be rotated in the plane of the belt in this section to ensure full UVC coverage of all product surfaces (see reference to product rotation during irradiation in, e.g., Fruit Preservation, ISBN 978-1-4939-3309-9, Ch. 17 ‘Fruits and Fruit Products Treated by UV light’, The effect of fruit orientation of postharvest commodities following low dose ultraviolet light-C treatment on host induced resistance to decay), or a second section can be installed to first flip the product, then add fog and UVC as previously described. UVC reflective PTFE belting can also be employed to maximize efficacy while providing a cleanable surface suitable for food products. See, e.g., Maine Industrial Corp. (Newcastle, Me.) and Green Belting Industries Ltd. (Mississauga, Ontario, Canada). Any condensation collected on the handling equipment can be evacuated and drained when the belt turns upside-down at the end of its travel.

In preferred embodiments, a system would be tested to determine the optimal fog number concentration and thickness as shown in the above testing. For example, testing may show that strawberries and tall loaves of bread require different settings. In addition, changes in other system settings such as particle size distribution, UVC irradiation patterns, etc., may be necessary to optimize a production line for a given product. Dosimetric avatars as discussed herein will be helpful in that regard.

In another preferred embodiment, fog is injected in the same section of a UVC tunnel as the UVC. Airflow from outside the tunnel system is blocked by one or more of: vinyl strip curtain doors, automated mechanical doors, air curtains; see, e.g., Jamison Door (Hagerstown, Md.), NORDIC door ab (Halmstad, Sweden). Various food conveyors with tunnels can be adapted as well, such as those from Project Services Group, Inc., (Irving, Tex.).

ii) UVC light testing—A HomeSoap® UVC desktop sanitizer was modified to allow injection of dry fog through a pass-through (i.e., ‘bulkhead’) nebulizer connector (P/N 1422, 22 mm OD, 15 mm ID, Hudson RCI, Temecula, Calif.) installed through the lower portion of the front access door, as well as a small notch at the bottom of the front door for the radiometer cable to pass-through. The HomeSoap® unit contains two tubular 254 nm emitting lamps according to their product specifications, one on the top of the unit, and another on the bottom of the unit (beneath a UVC transparent quartz glass sheet). The inside dimensions of the unit are specified as 93.04 mm wide×234.61 mm tall×334.74 mm long.

A scaffolding as shown in FIG. 25 was used to position the upper UVC sensor (UV512C) in the shadow of the upper tubular UVC lamp. A machinist-grade uncoated steel ‘1-2-3 Block’ (measures 1″ thick, 2″ wide, 3″ long) is used as a base weight, and another as a platform for the upper UVC sensor. Corresponding threaded holes in the blocks receive a threaded rod, and thus the upper Block can be spun on the threaded rod to change its vertical height, h, from the UVC absorbing polycarbonate plate (PC) that was placed on the UVC transmitting quartz glass plate the manufacturer supplies at the bottom of the HomeSoap® unit (PC is used to absorb UVC that would otherwise reach the upper UVC sensor). By changing h, the distance, d, from the center of the upper UVC sensor to the bottom of the upper UVC lamp can be modified. A clearance hole drilled in the PC plate near the front door and above the near end of the lower tubular UVC lamp receives the bottom puck-style UVC sensor, which is placed face down and in contact with the quartz plate in order to prevent any substantive fog between this sensor and the lower lamp. For the greatest distances, d, the upper 1-2-3 Block is removed, and the sensor is placed on the lower 1-2-3 Block. Note that the distance, d, of the sensor to the underside of the UVC transparent tube surrounding the upper UVC lamp is such that (d+ 11/16″+h)≈9⅛″ (the puck radius is 11/16″). Also note that the transparent tube (likely UVC transparent quartz) surrounding the upper lamp is part of the HomeSoap® design, presumably to protect the lamp from damage during use since there is no upper quartz plate like that used on the bottom. A separate PC sheet covers the entire left sidewall to prevent UVC reflected from the sidewall to reach the upper UVC sensor, thus creating a ‘shadow’. Note that for simplicity, only the left sidewall and bottom surfaces are covered in PC sheet, so some (minor) reflections from the other surfaces reached the upper UVC sensor without the use of dry fog. There is a gap, w˜1.2″, between the sensor element of the upper UVC sensor and the PC sheet covering the left sidewall. As shown in FIG. 25, the front face of the UVC sensor is approximately in the plane formed between the longitudinal centerlines of the upper and lower UVC lamps.

The scaffolding as shown in FIG. 25 is also used to position the upper UVC sensor in the direct view of the upper tubular UVC lamp by placing the puck-style sensor with the side opposite to the active sensor lying against the upper 1-2-3- Block (not shown). For this case, the height, h, to the top of the upper UVC block is again set as before using the threaded rod, but the distance, d, of the sensor to the underside of the quartz tube surrounding the upper UVC lamp is such that (d+1″+h)≈9⅛″ (the puck is 1″ thick).

For safety purposes, prior to the start of UVC testing, a 0.095″ thick polycarbonate (PC) sheet was placed across the outside of the front door to the unit to block a substantial portion of any stray UVC light from propagating through the fog injection connector or the ‘mouse hole’ for the sensor cables to pass-through. As an aside, the UVC was measured at the fog injection port (without the PC blocking sheet) at about 1 μW/cm². Nonetheless, safety glasses were worn even with the PC sheet in place.

In order to introduce dry fog, a 22 mm corrugated hose was connected from the same HEART® nebulizer onto the bulkhead nebulizer connector that was mounted on the door of the HomeSoap® unit.

It is important to understand that the two UVC lamps in the HomeSoap® are tubular emitters (not point-like LEDs), specified as emitting UVC light at 254 nm, but no reference as to whether they are what they appear to be—low pressure mercury lamps. In some sense it really does not matter, except when trying to make sense of their temporal behaviour. Although not dispositive, according to parent company PhoneSoap's patent filing, U.S. Pat. No. 9,339,576 Portable electronic device sanitizer, “As a non-limiting example, a low-pressure mercury-vapor lamp emits EO radiation at peak wavelengths of approximately 184 nm and 254 nm. While both wavelengths can be used to sanitize a PED, EO radiation of 184 nm will also produce ozone, which may be undesirable. Accordingly, the low-pressure mercury-vapor lamp may be used in conjunction with a filter designed to block 184 nm EO radiation while allowing 254 nm EO radiation to pass through.” None of the HomeSoap® documentation specifically cites the use of ‘mercury’ in the product.

The output radiance of the lamps varies greatly during a cold-start (when the unit has not been used and the lamps start off at room temperature) and the lamp begins to heat up, which is a characteristic of low pressure mercury lamps. See, e.g., Demonstration and evaluation of germicidal UV-LEDs for point-of-use water disinfection.

iii) Discussion re: temporal changes in dry fog number concentration—The visible light testing with the tote allowed inspection inside the tote as the fog was introduced. Such is not the case with the HomeSoap®, as it is opaque owing to the safety precautions in the use of UVC light (and other design-related choices).

The interior volume of the fog chamber portion of the tote is about 575 in³, while that of the HomeSoap® is about 445 in³ (using the interior dimensions specified by the company, neglecting the volume taken up by the modifications). The HomeSoap® is therefore lower in volume than the tote, and so should stabilize in concentration before the tote, and the tote stabilizes in under 3 minutes (180 seconds) based on the time-sequential plots of scattered visible light readings taken (not shown).

iv) HomeSoap® testing—The HomeSoap® unit starts by pressing the power button, and the operates for 10 minutes after which it shuts off automatically. FIG. 29 shows the results of 42 individual 10-minute cycles in the HomeSoap® unit, with 25 data samples taken on the lower lamp per cycle (using the ‘UV Clean’ UVC radiometer from Apprise Technologies, Duluth, Minn.) as evidenced by the circular and square markers. During each cycle, data was manually recorded from the upper and lower UVC sensors, using a stopwatch to gather data at fairly precise time increments. Note, however, that the first data are taken 15 seconds after turn-on (i.e., elapsed time) since it was difficult to manually record data any sooner. Further, the last data was taken at the 9:45 (min:sec) mark to avoid a race condition in taking data precisely at the 10-minute mark. Note the data is stable at about 420 seconds of elapsed time (i.e., 7-minutes into the cycle) due to the temporal effects of lamp temperature (the lower UVC sensor is pressed against the bottom quartz glass, and thus is not affected by the scattering fog). The cold start cycles clearly show a characteristic mercury lamp warmup curve. ‘Cold start’ refers to starting the unit after it was off for at least about 45 minutes. ‘Warm start’ refers to starting within about 45 seconds from the end of the previous cycle. The data at the 9:45 mark will be referenced as ‘stabilized’ for purposes of this discussion. Also note the spread of the stabilized values. Lamp temperature performance, including cold spot reference data is cited in Fundamental Characteristics of Deep-UV Light-Emitting Diodes and Their Application To Control Foodborne Pathogens.

Some observations re: visible and UVC dry fog scattering are discussed below.

(1) Any plotted data showing fast-moving changes on the order of seconds are likely due to rapid changes in dry-fog concentration as the fog swirls in the chamber (nothing was done to move/mix the dry fog within the chamber). In an exemplary embodiment, the chamber can be stirred as necessary to maintain a homogenous fog concentration throughout the chamber.

(2) FIG. 14 suggests there is an optimal fog density and thickness to maximize the intensity of the light onto the shadowed sensor. In fact, the curves do not show a pronounced maximum with a significant downwards slope, indicating that an even higher dry fog concentration would be more efficient. A control system can be implemented to achieve this in many ways, incorporating one or more of: activating a valve to maintain the concentration at maximum efficacy by selectively venting excess fog out of the chamber (passively or actively via a fan), controlling the amount of fog injected into the chamber by changing the flow rate into the chamber (e.g., lowering the power to one or more ultrasonic atomizers or venting a portion of the flow in a manifold), modifying the flow rate of objects (e.g., strawberries) through a chamber (e.g., UVC tunnel), changing the environmental conditions (temperature and/or RH) to alter the rate of fog evaporation, raising/lowering a UVC plate below the conveyor belt to change the volume of the chamber (e.g., if illuminating the objects via UVC lamps above and below the conveyor belt, then the plate would be a UVC transparent plate), etc. Another approach in optimizing the scatter is to use a similar telescopic projector as was done with the visible light testing described herein, where a tube devoid of fog and fitted on its distal end with a window (or other optical component such as lens, diffuser, etc.) telescopes into the fog within the UVC tunnel, such that the fog concentration remains about the same, but the fog thickness changes as the telescope extends & retracts.

(3) Obstructions to the flow/infiltration of dry fog in and around objects can be left to passive means (settling by gravity and natural air currents) or can be retarded/expedited as desired via electric charges, pressure gradients and the like. In one exemplary embodiment, a UVC tunnel is fitted with one or more plenums with nozzles that direct dry fog at objects that move along a conveyor belt within a UVC tunnel. The nozzles are positioned, e.g., based on the profile of the objects, and thus in this exemplary embodiment, one or more of the nozzles are moved (and/or spray profile adjusted) to optimize the fog distribution as desired. This movement can be done manually and/or automatically as defined in a computerized configuration file.

Note that for some applications, all surfaces of an object need not be treated using the dry fog scattering light technique. It may be that, e.g., only high-touch surfaces are disinfected using UVC with dry fog, such as the touch screen area of an automated teller machine (ATM). With respect to food, some food may have smooth surface portions and distinct textured surface portions, wherein the smooth surfaces may be disinfected with UVC without dry fog (and/or minimal/residual dry fog), and the textured surfaces are disinfected with UVC utilizing a healthy concentration of dry fog. With respect to visible/NIR light irradiation of plants, it may be only the top surfaces of the leaves. Of course, handheld operation of a UVC irradiator with fog (e.g., during cleaning of the interior cabin of an airplane) would likely treat only predefined surfaces as established by an airline company. A robotic application may have sensors that determined which surfaces to treat with the combination of light and dry fog, in some instances by automated pathogen detection. See, e.g., Frank Stüpmann—Poster_GermDetect_immediate_detection_of_biotic_contamination_Stuepmann (2021).

Some recommendations re: operating in fog/high-humidity:

1) On the HS unit, the lower UVC lamp is below the fog, which is not a recommended location due to the fog sinking under the effects of gravity. See, e.g., “Do not install beneath a humidifier” BIO-FIGHTER Nomad & Nomad 2 Ultraviolet Light Systems Installation & Operation Manual. This, however, can be overcome as described below.

2) UVC systems have a long history of operation in humid environments (e.g., in certain water treatment systems and food processing facilities), and thus the industry understands how to ensure systems operate in these environments, e.g., by sealing lamps in quartz sleeves: “In the quartz systems, some units are installed which either seal the quartz ends or leave them open. In the open arrangement, convective air currents can carry air (often humid) through the quartz sleeve, causing some deposition on the lamp surface. Additionally, the same air convection will cause the inner surface of the quartz sleeve to become dirty. This may also occur to some degree in sealed systems due to condensation effects, although there is no current information regarding these effects.” Design Manual—Municipal Wastewater Disinfection (1986) . . . “EncapsuLamp™ technology for superior safety . . . Designed for direct water wash-downs . . . FEP, or fluoroethylene (FEP), is a synthetic fluoropolymer used in covering UV Resources' lamps (EncapsuLamp™)” RLM Xtreme Brochure . . . . “The resistance of the FEP/solar cell package to high humidity and temperature, thermal shock, and ultraviolet, proton, and electron irradiation was evaluated. The process was extended to 15-cell flexible modules, which were evaluated under similar environmental conditions. The performance of the FEP-covered cells was encouraging and compared favorably with that of conventional cover glasses.” Investigation of FEP Teflon as a Cover for Silicon Solar Cells.

See also Combined Hurdle Technologies Using UVC Waterproof LED for Inactivating Foodborne Pathogens on Fresh-Cut Fruits (23 Jul. 2021) “There has been no research on UV waterproof LED applied in the food industry . . . UVC Waterproof Lights Emitting Diodes (UVC W-LED)—UV treatments were performed in a stainless-steel case (32.5 cm×17.5 cm×15 cm) equipped with two UVC W-LED (275 nm) modules (BlueLumi Co., Ltd., Gyeonggi-do, Korea), which were placed on each side of a stainless-steel case.”

3) It is known to evacuate dry fog after treatment in chemical dry fogging systems, e.g., “Dry Fogging Systems (DFS) utilize an ultrasonicator or aerosolizer to form very small (1-10 μm) particles of disinfectant that are rapidly dispersed into the air. The result is the creation of a dry fog of disinfectant that both remains airborne to act upon any airborne biological contamination, as well as coating surfaces to act upon deposited contaminants. After an appropriate duration, the fog in the air is evacuated by vacuum or HVAC systems, while the disinfectant continues to act upon surfaces. These systems typically utilize a peracetic acid solution (0.5-6%, with or without hydrogen peroxide and halide ions)2 and claim a number of benefits over manual cleaning methods.” A Roadmap for investigation and validation of Dry Fogging as a decontamination technology.

4) An alternative to engineering solutions related to the effects of humidity on LP mercury lamps (and associated ballasts) would be to use UVC LEDs and their associated drive electronics. Some effects upon LED systems to be considered including early life depreciation (like many lamp technologies), hence the use of seasoning (Preparation of a standard light-emitting diode (LED) for photometric measurements by functional seasoning). Humidity is also a factor (Chapter 17-Ultraviolet Lamp Systems—2020 ASHRAE Handbook—HVAC Systems and Equipment, however, UVC LEDs can be sealed from the environment using UVC transparent encapsulants as cited herein. UVC LEDs, like other LEDs, lose efficacy with increasing temperature (see, e.g., Luminus XBT-3535-UV Surface Mount UVC LED, Luminus, Sunnyvale, Calif.). Additional insights are disclosed in Performance of chip-on-board and surface-mounted high-power LED luminaires at different relative humidities and temperatures. Unlike LP mercury lamps, LEDs are not said to have an optimal cold spot temperature dependence, and their forward voltage varies less than one volt over temperature. LEDs are relatively easy to cool to maintain high efficacy (see, e.g., Thermal Design Using Luxeon Power Light Sources) compared to mercury-based lamps (see, e.g., Maintaining Optimum Fluorescent Lamp Performance Under Elevated Temperature Conditions).

5) Note that any effects on the lamp and/or electronics is separate from the efficacy of UVC scattering with dry fog, i.e., the efficacy testing herein is in effect normalized to whatever the lamp intensity is. Of course, it is desirable for the light source and electronics of the instant invention to be protected from high humidity as appropriate, following good design practices. However, as demonstrated with the test data herein, systems that are not specifically designed for high humidity environments can still work.

vi) UVC scattered light measurements in shadow and in direct-view of the upper HS UVC lamp—The data in FIG. 27 shows the results from shadow-based UVC testing as described earlier. The lower two lines show the consistencies in the measurements of fog and of no-fog conditions at each distance (min/max). Based on this limited sample size, the consistency of both fog and no-fog increases as the distance between the sensor and lamp increases, hits a maximum at 4.69″ and both decrease as the distance continues to increase, with the fog maintaining a higher consistency over the no-fog condition, perhaps due to the homogenization from scattering in the fog.

The dashed lines represent the average irradiance measured as a function of distance in the fog and no-fog conditions, with the highest irradiances at the shorter distances as would be expected. The shape of the curves shows a first slope from minimum distance to 4.69″, then a lesser slope beyond 4.69″. The ‘cross’ markers show the ratio of average fog/no-fog readings, which generally increases from smaller to larger distances, although at 4.69″ there is a local maximum. The ratio of fog/no-fog is a minimum of 1.92 at all distances, i.e., demonstrating a net increase in irradiance with fog. For this setup and dry fog droplet size and number concentration, the absolute value of the UVC irradiance peaks at 37.5 μW/cm² at the smallest distance. It must be said, as before, there is no standard shadow test, so the absolute UVC irradiance values shown below, with fog, are specific to this test setup at the one dry fog number concentration that was used, etc.

The data in FIG. 28 shows the results from the direct-view-based UVC testing as described earlier. The upper two lines show the consistencies in the measurements of fog and of no-fog conditions at each distance (min/max). Based on this limited sample size, the consistency of no-fog hits a minimum at 4.69″, while the fog hits a maximum there. As before, there is a convergence of the two lines as the distances increases towards 4.69″, then both diverge as the distance continues to increase, with the no-fog maintaining a higher consistency over the fog condition.

The dashed lines represent the average irradiance measured as a function of distance in the fog and no-fog conditions, with the highest irradiances at the shorter distances as would be expected. The shape of the curves is smoother than the shadowed configuration above. The ‘cross’ markers show the ratio of average fog/no-fog readings, which is a maximum of 87.9% at the shortest distance measured (for this configuration), and then decreasing as the distance increases, with a marked decline at 7.17″. The ratio of fog/no-fog is much less than the shadow configuration. The absolute value of the UVC irradiance is much higher than the shadowed configuration, as would be expected.

c) Dosage versus log-reduction—For the instant invention, it is useful to understand the incremental log-reduction that can be obtained by an incremental fluence, i.e., if the irradiance is doubled, what is the incremental log-reduction? This varies by microorganism, and thus the desired incremental fluence can be application specific, as some applications are focused on the effects of a small group of pathogens.

In Fluence (UV Dose) Required to Achieve Incremental Log Inactivation of Bacteria, Protozoa, Viruses and Algae (the ‘Source article’) there are tables that “present a summary of published data on the ultraviolet (UV) fluence-response data for various microorganisms that are pathogens, indicators or organisms encountered in the application, testing of performance, and validation of UV disinfection technologies. The tables reflect the state of knowledge but include the variation in technique and biological response that currently exists in the absence of standardized protocols. Users of the data for their own purposes are advised to exercise critical judgment in how they use the data.” Given the caveats, the data is especially useful for understanding general trends.

FIG. 2 is a summary of different types of microorganisms and the ‘fluence multiple’ needed to achieve incremental 1-log and 2-log reductions (for Low Pressure mercury or ‘LP’ lamps) based on the above referenced paper. For example, the fluence for Aspergillus niger (ATCC 32625) for a 1-log reduction in the Source article is 116 mJ/cm², and for a 2-log reduction in 245 mJ/cm², so the ‘fluence multiple’ to go from 1-log to 2-log is 245/116=2.11. The tabular data in the paper specifies “Fluence (UV dose) (mJ/cm²) for a given log reduction without photoreactivation.”

The analysis of the data shows that the incremental LP fluence for a given microorganism to go from 1-log to 2-log is only the same as going from 2-log to 3- log about 25% of the time, based on the 304 microorganisms (aka ‘data points’) in the Source article having LP data for 1, 2, and 3-log reductions out of the 337 having LP data for at least a 1-log reduction.

Note also that the data is based on disinfection in water, whereas surface disinfection requirements may be higher or lower, depending upon microorganism type, and FIG. 2 also captures this data from Table 4.1 of Ultraviolet Germicidal Irradiation Handbook—UVGI for Air and Surface Disinfection (ISBN 978-3-642-01998-2). Of course, these data should also be used to obtain a sense of general direction, as they have their own caveats since they were based on results from different studies, etc.

All the tabular data from the Source article were used except for any LP tabular entries that had qualifiers (e.g., ˜, <, and >). These were excluded since the ‘fluence multiples’ could not be calculated consistently. There are six summary tables on the right. The topmost summarizes all microorganism types, while the tables below that provide a summary for each specific microorganism type (Spore, Bacterium, etc.). The columns show for a given type of microorganism, the average fluence multiple required to go from a 1-log to a 2-log reduction (1->2 log), etc. Table entries of #N/A indicate the data was not available (or calculation was not applicable).

As cited herein, objects to be irradiated comprise complex surfaces, and so there is a big difference between a laboratory collimated light test setup and a UVC tunnel in a strawberry production processing facility. Two excellent articles on the complexities involved are Simulation of UV-C Intensity Distribution and Inactivation of Mold Spores on Strawberries, and their follow-on work Simulation of UV-C Dose Distribution and Inactivation of Mold Spore on Strawberries in a Conveyor System. These will be discussed elsewhere herein.

In shadow measurements, the fog increases the overall irradiance in a ˜monotonic fashion (there may be a local maximum around d=4.69″, which warrants further study), in proportion with distance. The increased fluence re: shadowing, whether visible light in FIG. 14 or the UVC light in FIG. 27, show gains of a factor more than 2 (fog/no-fog) relative to a no-fog condition. As shown in FIG. 2 (citing Fluence (UV Dose) Required to Achieve Incremental Log Inactivation of Bacteria, Protozoa, Viruses and Algae), a factor of 2 increase in fluence corresponds, for many pathogens, to more than 1-log incremental reduction.

d) The effects of humidity on disinfection—It is also important to understand the effects of humidity on disinfection (other than from the dry fog scattering and evaporative effects discussed herein).

See, e.g., “Of the physical factors that might influence UVGI lamp performance, air temperature and flow rate, lamp design, and ballast design were found to be most significant. Isolated changes in humidity had a measurable but very small effect on lamp irradiance . . . It is critical to understand the effect of humidity on the various organisms. The literature is contradictory on the subject. The physical factors work has shown that the lights are not affected. This makes it critical to clarify the impact of humidity on the organisms . . . . Humidity and organic matter were shown in sections 4.1.1 and 4.1.2 to have protective effects that would be difficult to distinguish from natural variation in an environmental organism, and significant variation should be expected. Resistance variations between strains of the same organism have the potential to be substantial. Very little work has been done.” Defining The Effectiveness Of UV Lamps Installed In Circulating Air Ductwork (2002).

“A possible reason for the higher transfer efficiency under high relative humidity observed in our study was that the high humidity prevented the inoculum from drying, resulting in greater transfer efficiencies.” Transfer Efficiency of Bacteria and Viruses from Porous and Nonporous Fomites to Fingers under Different Relative Humidity Conditions. “The effect of relative humidity (RH) on the UV susceptibility of microorganisms has been studied for decades but no general explanation has emerged that applies to all microbes, and no predictive methods have previously been developed. Most bacteria tested tend to experience decreased UV susceptibility at high RH, but some show the opposite effect, or no significant effect at all. Viruses show mixed results, with some experiencing a small increase in UV susceptibility with increasing RH. Webb (1965) found that airborne Pigeon pox virus was extremely hardy and resisted inactivation from variations in RH, while Rous sarcoma virus was largely inactivated at 30% humidity. Both viruses survived well at 80% RH. Spores show little, if any, response to changes in RH, although data is still quite limited.” Ultraviolet Germicidal Irradiation Handbook UVGI for Air and Surface Disinfection (ISBN 978-3-642-01998-2).

e) Benefits to improvements in UVC uniformity—In the direct-view measurements, the fog reduces the overall irradiance in a monotonic fashion, inversely with distance. However, this reduction comes with an increase in fluence uniformity as cited herein. The benefits are cited in Simulation of UV-C Intensity Distribution and Inactivation of Mold Spores on Strawberries: “There are many reasons a uniform irradiation dose is desired for UV-C treatment. Firstly, uniform dose distribution is needed to achieve an even level of inactivation. Secondly, overexposure to UV-C could degrade the quality of the fruits. Thus, the range of dose intensity should be as narrow as possible to avoid applying too much radiation. Potential damage to strawberries under high UV-C dose includes browning of the calyx (Lammertyn et al., 2003). Thirdly, the inactivation effect of UV-C on fruits is found to increase with UV-C dose initially but then begins to diminish after exceeding a certain threshold (Nigro et al., 2000; Stevens et al., 1996). Hence, delivering the optimal dosage with uniform dose distribution is important to successfully implement UV-C treatment of fruits . . . . To determine the optimal horizontal distance which provides the most uniform dose distribution, the coefficient of variation (CV) was calculated. CV is a normalized measure of dispersion of a probability distribution and can be calculated as follows. CV=α/μ [Eq. 9] where a is the standard deviation and μ is the mean intensity of surface incident radiation (W m⁻²).” CV is also discussed in Protocol for Determining Ultraviolet Light Emitting Diode (UV-LED) Fluence for Microbial Inactivation Studies, “a CV of 6.7% was determined to be the maximum CV value to obtain a uniform irradiance distribution”. Note the calculation is based on a finite number of samples since the metrology does not have infinite resolution. Now, in the field of flat panel displays, luminance uniformity requirements are applied to both small areas and large areas of the same display. See, e.g., Human Factors Evaluation of Portable Electronic Devices in Tactical Aircraft, citing a military specification, where “Large area uniformity guidelines are as follows: “The difference in luminance between any point and the average within any circle whose diameter is one-fourth the display's minimum dimension shall not exceed ±20% of the average value. Total variation across the display shall not exceed ±40% . . . . Small area uniformity guidelines are as follows: The difference in luminance between any point and the average within any 10 mm circle shall not exceed ±10%.”

Note also that CV is applied in the application of a flat Petri dish, and the small area and large area uniformities for flat panel displays are obviously applied to flat surfaces as well. What about a complex surface like a strawberry under UV irradiation? How about a random assortment of strawberries in a UV tunnel?

Previous work in the food industry have established baseline configurations that can be further enhanced by the instant invention, as cited in Simulation of UV-C Dose Distribution and Inactivation of Mold Spore on Strawberries in a Conveyor System: “(2) Uniformity evaluation—Uniformity of UV-C dose distribution on the surface of strawberries was evaluated using the coefficient of variation (CV), which was a normalized index of dispersion of a probability distribution. Results and Discussion— (1) Uniformity evaluation—In order to evaluate the uniformity of UV-C dose distribution on the surface of strawberries, the radiation simulations were carried out using four configuration models. The UV-C treatment time was fixed at 7 s, the conveying speed and mesh sliding steps were fixed at 0.1 m s_1 and seven, respectively. This meant that the incident UV-C intensity was calculated independently at seven time-dependent positions with 0.1 m sliding distances, and the irradiation time for each position was 1 s. The total irradiated UV-C dose distribution was estimated by accumulating incident UV-C dose on the surface of strawberries at seven time-dependent positions. The results of the simulation are presented in FIG. 5. The frequency polygons of incident radiation dose on the surface of strawberries can be recognized visually.” This, of course, is a simulation. Actual measurements, e.g., in the field of UVC surface disinfection, would best use actual inoculation, irradiation, stomaching, etc. as described, e.g., in Ultraviolet-C light inactivation of Escherichia coli O157:H7 and Listeria monocytogenes on organic fruit surfaces. However, a system with good uniformity may also have small spikes in a beam outside of the sample points that over-irradiate and damage the quality of a strawberry. Other wave energy sources, e.g., applied to non-disinfection applications may also have nuances that require careful consideration when determining a meaningful uniformity number. Note that an approach using metrology that could catch these spikes and provide high fluence resolution is taught herein using the inventive dosimetric avatar. These avatars could be constructed for all wave energy sources (EM, EL, QP) with appropriate selection of relevant dosimetric materials.

With respect to a scattering field, note that the distribution of scattering elements tails-off and can be altered by air currents during the testing, and so this adds another layer of complexity to the uniformity determination. Further, the beam profile of the wave energy source and the geometry of the test setup would influence the determination, and thus standard test setups must be defined like they are in the UVC disinfection and flat panel display industries. Generally, these determinations are made by organizational expert committees to ensure all stakeholders have a voice and the appropriate amount of confirmatory testing has been completed.

It is important to note that in both the shadow and direct-view measurements, scattered light that misses the upper UVC sensor is not absorbed, but simply redirected in other forward trajectories that may strike another surface to disinfect it (or for visible/NIR light in a greenhouse, light may strike another leaf portion to enhance photosynthetic growth).

By optimizing (testing, CFD, etc.) the number concentration (e.g., with a larger piezo/ultrasonic dry fog atomizer system), the number of UVC sources and their locations and beam profiles, etc., the instant invention can improve the efficacy in a variety of applications across the electromagnetic spectrum.

As an aside, more information is available in the incorporated-by-reference provisional filings on EM, EL, and QP wave energy sources, scattering characterization, as well as dosimetry and dosimeters, including commercially available devices.

Dosimetry and Actinometry for use on a conveyor belt traveling through a UVC tunnel—Correlations between dosimetry and log-reduction can be seen, e.g., in Inactivation Characteristics and Modeling of Mold Spores by UV-C Radiation Based on Irradiation Dose. Fluence/dosage can be measured in a number of ways, e.g., via traditional electrooptical radiometers, photochromic and radiochromic indicators, and 3D volumetric dosimeters, all citied previously. These are well understood and their use in the instant invention, in addition to the use of newly proposed approaches are discussed below. Note that some approaches are reusable such as electrooptical and those based on reversible photochromic pigments/dyes. The reuse is a benefit; however, the data must be captured quickly as it is effectively erased over time. Thus, the advantage, e.g., of dosimeter cards that use irreversible photochromic pigments/dyes, however, there is the expense of continually purchasing new devices. As an aside, the specific photochromic chemical(s) used by the makers of dosimeter cards have not been found in the literature. The instant invention also proposes non-traditional/new methods of dosimetry.

Non-traditional chemical pigments/dyes—Irreversible photochromic pigment that changes from colorless to purple is available from New Color Chemical Co., Limited (Xiamen, China), see Irreversible Photochromic Pigment Technical Data Sheet (New Color Chemical Co.). See also US20140038305 Articles and methods for the detection and quantification of ultraviolet light. Cyanotype and SolarFast dyes are known to change with UV exposure: Cyanotype changes from clear to ‘Prussian blue’ after UV exposure, and SolarFast dye is available in a wide variety of colors with varying color changes upon UV exposure. These are available from Rupert, Gibbon & Spider, Inc., manufacturers of Jacquard Products, (Healdsburg, Calif.). Both Cyanotype and SolarFast dyes are marketed for use on natural fibers, however they can be used with nylon “Nylon performs a lot like silk and they both hold really tightly to the fiber. That means you really need to wash properly and thoroughly after exposure.” (private communication with Jacquard Products 15 Mar. 2021) even though its use on nylon is not mentioned publicly by Jacquard Products, and numerous sources say to avoid fibers that are not natural.

Glow phosphors—Also known as long-persistence phosphors, these include commercially available material such as SrA1204:Eu,Dy, and are excitable across the UV spectrum, including by UVC. They are commercially available in encapsulated and unencapsulated form, see e.g., Techno Glow (Ennis, Tex.), the former offering protection from the environment albeit at a slight loss in performance. The brightest phosphor powder from Techno Glow is their green unencapsulated Strontium Aluminate Europium Dysprosium SKU P02-GRN-M, with stated emission intensities (excitation conditions not specified) as follows: Immediate: 93,000 mcd/m², 1 Minute: 6,000 mcd/m², 10 Minutes: 940 mcd/m², 60 Minutes: 207 mcd/m². The particle size is said to be <100 microns, and thus provides a high resolution coating.

A challenge with using these phosphors is the brightness decay, comprising a very rapid initial decay, i.e., once an object is irradiated with UVC, the peak intensity emission from the phosphor decays rapidly, and so is difficult to capture by a measurement device if the object must be moved from the irradiation tunnel to a measurement area. In addition, the phosphors must be attached-to or incorporated within an object without negatively affecting the UVC transmittance to the phosphor from the UVC source, and from the phosphor to the measurement device.

One simple method is to coat phosphors on an object using a spray adhesive and then add a protective encapsulant/overcoat. In some instances, it may be desirable to include some absorbing material (e.g., neutral density carbon black) in the overcoat to enable use in very-high UVC irradiances such that the phosphors are not saturated, although the optical density should be consistent across the object's surface (requires a homogeneous dispersion of carbon black and being consistent in the coating thickness).

Another would be to disperse the phosphors in a UVC encapsulant that is then coated on the object (the encapsulant can be loaded with carbon black as cited previously).

Note that the emission brightness of these phosphors changes with “Glow Crystal Particle Size, Loading Content, Transparency of Resin, Excitation Intensity, Exposure Time” (Source: FAQs— GlowStop.com, GloTech International, Auckland, New Zealand). A deeper, technical perspective can be found, e.g., in Long persistent phosphors—from fundamentals to applications. Note that the combination of excitation intensity and time can be consider a dosage, and so thus the prospect of using glow phosphors as a reversible/reusable dosimeter.

To use these phosphors, the decay curves at various excitation intensities can be characterized by sending a phosphor-coated test coupon through a UVC tunnel along with the objects to be disinfected (or their avatars). A circular coupon would be placed below gradient neutral density filter such as Circular Linear Variable Metallic Neutral Density Filters from Newport Corporation (Franklin, Mass.), available in optical densities from 0 to 1, 2, or 4. Further, a puck-style UVC radiometer is placed adjacent to the coupon to measure the raw intensity from the UVC lamp(s), representing the intensity at the phosphor coating. Intensities are measured from the object (e.g., a phosphor coated strawberry or its avatar) and at the same time from various locations across the coupon and the time-history from the radiometer puck as it too traversed the tunnel. One can then correlate an intensity measurement on the surface of the object to a dosage, thus compensating for the decay curves of the excited phosphors. Even without the radiometer, the approach can still provide information on the relative irradiation across the surface topology of the object which can be captured via one or more visible light sensors, e.g., via one or more cameras using photogrammetry.

In one preferred embodiment, as mentioned previously, glow phosphors (Green (#1 Choice), SKU P02-GRN-M0001Z from Techno Glow, Ennis, Tex.) were sprinkled on a fake plastic strawberry after applying E6000 spray adhesive and smoothing with an acid/flux brush. Excess was removed by gentle tapping, and after curing the coated strawberry was placed in a HomeSoap® UVC chamber, and after 1 minute, the door was opened, and an obvious glow was emanating from the phosphor coating. For further protection, a low viscosity UVC encapsulant such as MasterSil 151 can then be conformally coated in a thin layer to avoid excess UVC absorption. Exemplary excitation, emission, and decay curves are shown in Roles of Eu2+, Dy3+ Ions in Persistent Luminescence of Strontium Aluminates Phosphors.

Lightfastness—“Lightfastness is a property of a colourant such as dye or pigment that describes how resistant to fading it is when exposed to light.[1][2][3] Dyes and pigments are used for example for dyeing of fabrics, plastics or other materials and manufacturing paints or printing inks. The bleaching of the color is caused by the impact of ultraviolet radiation in the chemical structure of the molecules giving the color of the subject. The part of a molecule responsible for its color is called the chromophore.[4][5] Light encountering a painted surface can either alter or break the chemical bonds of the pigment, causing the colors to bleach or change in a process known as photodegradation.[6] Materials that resist this effect are said to be lightfast.” Lightfastness—Wikipedia.

A well-known standard tester for measuring lightfastness is the Fade-Ometer, e.g., see the brochure Atlas Ci3000+ Weather-Ometer and Fade-Ometer. Lightfastness of inks—see, e.g., Light fastness of printing inks—A review. The general lightfastness of inks and dyes are described in Materials Information and Technical Resources For Artists—ASTM and Lightfastness of Media. Since the need is to quickly show chromic variations in response, e.g., to UVC light, materials with poor or very poor lightfastness (Lightfastness categories IV and V, respectively) are favored for the instant application. See, e.g., Technical Pigments and Preparations for Plastics (Sun Chemical), especially pigments with poor colorfastness and high temperature stability (e.g., suitable for incorporating in 3D printing filaments) such as Sunbrite® Orange 46 with light stability of 2 (1 being the poorest) and heat stability of 300° C., and FDA approved pigment for cosmetics, SunCROMA™ FD&C Yellow 6 AI Lake with a light stability of 2 and a temperature range up to 275° C. It is important to note that FDA food grade colorants should be considered for use on food production lines, see, e.g., How Safe are Color Additives FDA. Color additives are also available from IFC Solutions (Linden, N.J.). Graphs showing rapid photodegradation of commercial inks in response to a carbon-arc lamp can be found in FIGS. 9 & 31 of Study of the Photodegradation of Commercial Dyes.

Tnemec (Kansas City, Mo.) makes a “ . . . colorant which fades from purple to clear . . . The fugitive colorant, Series 44-500 Skip-Saf™ . . . Added in the field to Tnemecs clear urethane topcoats, Skip-Saf is a translucent-colored tint that “dyes” the urethane topcoat purple, allowing the applicator to clearly see the work in progress. This helps prevent skipping of areas, aids in the application of correct film thickness and makes apparent any runs or sags. Within four to 72 hours? exposure to direct and indirect sunlight, the purple tint disappears . . . “. Fugitive Dye Helps Contractors Apply Coatings Evenly WaterWorld. The data sheet cited U.S. Pat. No. 5,548,010 Color dissipatable paint. It describes various chemistries that comprise a “color-dissipatable paint additive that, because it has a light unstable dye therein, when mixed with paint, provides a second color that dissipates within a reasonable time frame, generally from hours to a few days . . . it is well known that some dyes have poor light stability characteristics. Two typical dyes of this category are, FD&C#2 blue (indigotene), and Basonyl® green NB-832 (triarylmethane) . . . .” Note that this of course reference to normal sunlight, not, e.g., the intense UVC in a disinfection tunnel. It is contemplated that such a fugitive colorant can be added to a UVC transparent encapsulant, a thin mildly UVC-absorptive encapsulant, molded component or a 3D printed filament.

Photopolymers—“3D printers of this type use a UV photo cured resin for the build material. At the completion of the 3D printer's build cycle, the parts need to be post-cured with UV light to finish the part” as cited in the brochure for the Helix Cure 120™ UV Curing Chamber, 2018-06-10-helix-cure-120, from Strategic 3D Solutions, Inc. (Raleigh, N.C.). Thus, for the instant invention, e.g., a strawberry can be 3D printed, and then placed in a UV tunnel, and the degree of UV post-cure is an indication of the dosimetry. Insufficient UV post curing manifests itself, e.g., in shape distortions as discussed Mechanics of shape distortion of DLP 3D printed structures during UV post—curing. Such distortions can be sensed by 3D scanning, e.g., photogrammetry. Note that a common wavelength for UV photo curing is 405 nm, and thus this approach is most easily suitable for use in systems that utilize 405 nm violet-blue light, e.g., for pathogen reduction, see, e.g., 405 nm light technology for the inactivation of pathogens and its potential role for environmental disinfection and infection control, Disease Suppression in Greenhouse Tomato by Supplementary Lighting with 405 nm LED.

Food safety—food contact with dosimeters—Food safe coatings—certain photochromic materials, like many inks, may not be listed with FDA (or equiv.) as food safe. First note, however, that a dosimeter need not be deployed when food is running through a production line UVC tunnel, so concerns regarding FDA compatibility of dosimeter materials can capitalize on this flexibility. Second, if running alongside food, there are analogous applications where food safe protective coatings are used: “Inks and coatings that do not have direct food contact are not regulated; as long as there is a “functional barrier” between the food contact side and the ink or coating, and the inks and coatings do not migrate to the food contact side during various steps in the process. It is the responsibility of the packaging manufacturer to determine if the construction meets the definition of a functional barrier.” Food Packaging—A Guide to Best Practices for Print. “Incidental contact substances are those where contact is not intended nor is it continuous, such as involving food processing equipment. Food packaging printing inks and coatings may be indirect food additives as they could have direct, indirect or incidental contact with food. 3. Barrier Coatings Stop Migration FFDCA recognizes that a functional barrier can prevent a substance from migrating into and becoming a component of food. Under 21 CFR 170.3(e) “If there is no migration of a packaging component from the package to the food, it does not become a component of the food and thus is not a food additive.” Under these criteria the substance is not subject to regulation, however, packaging end-users are responsible for extraction testing to assure compliance.” 7 Essentials of FDA Food Contact Coatings Cork Industries.

FEP (fluorinated ethylene propylene copolymer)— 856G-200 is a 2 mil thick FDA compliant coating as disclosed in Teflon FEP Coatings (Intech Services, Inc., Newark, Del.). FEP is well known for a high degree of UVC transparency, often used to encase LP mercury bulbs in UVC disinfection systems. Intech claims FEP coating thicknesses down to 0.5 mil in thickness. FEP coating cure temperatures are fairly high, between 575° F.-700° F. (301° C. to 370° C.). “FEP heat shrink tubing requires approximately 420° F.±50° F. (215° C.±10° C.) to initiate shrinkage” with shrink ratios of 1.3:1 and 1.6:1 and standard minimum wall thickness starting at 8 mils. Zeus-Catalog-G V1R1, Zeus Industrial Products, Inc. (Orangeburg, S.C.)

Parylene C— “a food contact approved substance and is registered through the FCN nr 001777 at the US Food and Drug Administration.” Comelec SA (La Chaux-de-Fonds, Switzerland). Much higher absorption in UVC than FEP; details can be found in Parylene Optical Properties Why Your Competitors See Parylene in a New Light—VSi Parylene. Note however that Parylene C is deposited at room temperature (see e.g., Parylene Deposition Process Specialty Coating Systems, Specialty Coating Systems Inc., Indianapolis, Ind.), and thus if the UVC intensity is high enough whereby the Parylene C UVC absorption still allows sufficient exposure of photochromic materials, then this becomes an option for UVC dosimetry.

Addition of absorbers to enable use in higher intensity (UVC) fields—In some applications, the desire is only to ensure the UVC dosage meets a minimum level across the surface of an object. In such cases, additional absorption (e.g., carbon black additives, neutral density filters, etc.) can be used to ensure a dosimeter is not saturated before it can register the appropriate dosage level. Thus, if the natural state of, e.g., a chemical actinometer is too sensitive for indicating the minimum dosage, additional absorption can be added. Simple detectors may then surround the object after exposure, set to trigger if a threshold chromatic response (depending on the type of actinometer material) is reached, indicating less than the minimal dosage after irradiation, after which an alarm causes one or more remediating operations (e.g., increase in UV intensity, slowdown in belt speed in a UVC tunnel, change to dry fog flow rate, etc.).

Carbon black and others are cited in UV Degradation Effects in Materials—An Elementary Overview. UV absorbing carbon black materials for use in manufacturing are cited in Specialty Carbon Blacks For Plastics from Cabot Corporation (Billerica, Mass.). A technical analysis of carbon black loading vs absorbance in the UVC wavelength range is disclosed in Spectroscopic Studies of Polyester—Carbon Black Composites. D&C Black No. 2— “ . . . high-purity carbon blacks approved by FDA, including . . . high-purity furnace black, which is approved for use in food-contact polymers (§ 178.3297 (21 CFR 178.3297)).” Federal Register—Vol. 83, No. 110-Thursday, Jun. 7, 2018—Rules and Regulations. Suitable commercially available FDA-approved carbon blacks are manufactured by Cabot Corporation (Billerica, Mass.), Specialty Carbon Blacks for Food Contact Applications in Plastics (Cabot). These carbon blacks can thus be used in dosimeters on food processing lines. Certain food colorants exhibit absorption in the UV, enabling their use on/within dosimeters on food processing lines. See, e.g., Characterization and Measurement of Anthocyanins by UV-Visible Spectroscopy comprising a representative spectrum therein.

Dosimetric avatars—A dosimetric avatar is a 3D object constructed to record surface irradiation that correlates with how a predetermined second object would react (e.g., a strawberry's surface being disinfected by UVC). This is different than a 3D volumetric dosimeter as previously cited, which are meant to record the dosage throughout the volume of an object (e.g., mimicking a patient's organ to record the volumetric distribution of therapeutic x-rays).

In one embodiment, these novel dosimeters can use non-living materials to indicate fluence (e.g., the chemicals, phosphors, etc., as cited herein). In another embodiment, they are inoculated with pathogens as well comprising the non-living material. In this case, the avatar provides the shadowing function as well as an indication of the fluence around the pathogens.

In one embodiment, a dosimetric avatar is constructed such that a first surface portion creates a shadow on a second surface portion when irradiated from a source of wave energy external to the dosimetric avatar (e.g., a UVC, Visible/NIR, e-beam, etc.), the shadow geometry modeled after a shadow geometry on the second object (e.g., the achenes on a strawberry), and the shadowed surface portion constructed of a material that changes its properties when irradiated such that the changed properties correlates to a dose (e.g., using dyes that are used in dosimeter cards). The correlation of the changed properties is constructed in the form of one or more of algorithms, mathematical formulae, and lookup tables. For example, dosimetry cards react to fluences by a change in color/tone. This change can be correlated to a fluence by characterizing the cards with a calibrated setup and known fluences in a controlled fashion.

Note that the dosimetric avatar is not the same as attaching an off-the-shelf dosimetric decal to an N95 mask, and then irradiating the mask with its decals as the decals do not capture micro-shadows that would be created, e.g., by the fibers of the mask. The avatar provides an additional level of fidelity. This approach may or may not use the original object as part of the avatar.

As background, see, e.g., “ . . . Radiochromic films were attached to various surface locations on 12 apples (“Fuji”) to study the uniformity of UV-C exposure.” Radiochromic film dosimetry for UV-C treatments of apple fruit and “We exposed PCI1 indicators located on exterior and interior N95 surfaces to sub-saturating UV-C treatments (FIG. 3B-3D).” Quantitative UV-C dose validation with photochromic indicators for informed N95 emergency decontamination. In these approached, paper dosimeters are placed on 3D objects, providing the irradiance around the outside surface of the object, although not likely conforming exactly to any sharp curvatures of the original surface. Also, the texturing of the original object is not replicated in the decals, nor were decals placed just below the surface to indicate canyon wall effects.

Manufactured objects can be made to act as avatars for real objects (made via 3D printing, machining, etc.). Note that in any of the approaches disclosed below, the avatar and/or the sensors can be moved to temporally sample the fluence as the dosimeter traverses, e.g., through a UVC tunnel. While the Dosimetric Avatars have been disclosed for use, e.g., with the dry fog scattering also disclosed in the instant invention, such avatars can be used with any irradiation system, including more traditional non-fog UV systems.

UVC material compatibility must be understood before selected a host material. A number of references have been previously cited in the instant invention. More recent publications include Damage to Common Healthcare Polymer Surfaces from UV-C Exposure and Interactions and damage of surfaces by light. Note that the fluence received by the host material of the avatar may or may-not be sufficient to bias the dosimetry (unless the degradative effects, in-full or in-part, are being used for dosimetry), but should be considered. Note that an avatar need not react to irradiation with the same time constant as how the real object reacts to the irradiation. However, it is important that there is a method by which the two can be correlated, e.g., by use of a scaling factor/function derived from actual test trials accompanied by a separate radiometer. Similar time constants can be useful, however, in some cases like real time mock production trials.

Shadow Resolution:

a) A photomicrograph of a strawberry (see ID number SS2259206 at Science Source, New York, N.Y.) shows that the achenes (contains the seed) on the surface of the strawberry is roughly on the order of 500μ×1000μ and sits 1000μ below the outer surface of the strawberry. Thus, any dosimetric feature added to a strawberry (or an avatar thereof as discussed herein, which for example is a realistic copy of a strawberry that has been dyed with an ink that has dosimetric properties) should capture this natural shadowing or at least the aspect ratio defining the canyon wall effect (also discussed herein). Further, a strawberry avatar created, e.g., by 3D printing, should be made on a printer having resolution in x, y, and z, sufficient to preserve natural shadowing for portions of the avatar that will be examined for dosage. A discussion of 3D printer resolutions from 2015 can be found in What Resolution Can 3D Printers Print.

b) 3D printing (or any additive/subtractive manufacturing process or combinations thereof) of objects must also consider the surface roughness of the target in order to understand threshold feature sizes that tend to trap microbes. In Surface modifications for antimicrobial effects in the healthcare setting—a critical overview, it states in part “However, the assumption ‘the rougher the surface, the worse the hygienic status’ is somewhat simplistic, although many publications make this type of claim. Cells are easily removed from ‘smooth’ surfaces, but they may be retained within features approximating in size to that of the cells. In larger features, the cells may again be relatively easily removed. Typically, surface topography is measured by the Ra-value, defined as ‘the average departure of the surface profile from a center line’. Other parameters are also used, but the Ra-value is the most popular in the microbiology literature. An Ra-value of 0.8 μm is often deemed indicative of a hygienic surface.” So, if the intent is to be wholly faithful, e.g., to a real strawberry, then the Ra-value of a strawberry avatar should mimic that of the real strawberry. Note that UVC wavelengths are about 0.25 μm, so they are much smaller than the smallest strawberry feature size and therefore are not fundamentally limited in their ability to reach into the shadowed areas. Should smaller wavelengths be required, VUV, x-rays, gamma rays, and even electrons or ions (whose de Broglie wavelength, a function of accelerating voltage, can be on the order of nanometers) and other particles can be used. “ . . . the momentum of a photon can be expressed as p=h/λ. This equation shows that the photon wavelength can be specified by its momentum: λ=h/p. De Broglie suggested that material particles of momentum p have a characteristic wavelength that is given by the same expression, λ=h/p. Because the magnitude of the momentum of a particle of mass m and speed u is p=mu, the de Broglie wavelength of that particle is 5λ=h/p=h/mu . . . 5 The de Broglie wavelength for a particle moving at any speed u is λ==h/γmu, where γ=[1−(u2/c2)]−1/2.” The velocity created by acceleration in a voltage potential, ΔV, between two parallel plates is given by the formula u=[2qΔV/m]1/2, where q is the charge, m is the mass of the particle, and u is the velocity. The above extracted from PHYSICS for Scientists and Engineers with Modern Physics (ISBN 978-0-495-11245-7)

c) 3D models—models are available for various foods and other objects, such as the Strawberry 3D model (Model ID #976725 from Humster3D) via the portal CGTrader (Vilnius, Lithuania and New York, N.Y.). A one-time (royalty free) upfront license of $49, downloadable in the following formats: *.max (3ds Max 2008 scanline), *.max (3ds Max 2008 vray), *.fbx, (Multi Format), *.obj (Multi Format), *.3ds (Multi Format), *.mb (Maya 8.5), *.lwo (Lightwave 6), *.c4d (Cinema 4D 11). The polygon mesh model has 358,220 polygons and 360,125 vertices, providing a very-detailed surface texture, where surface texture is very-important for high fidelity dosimetric avatars. Note that not all models on the portal have this level of detail, yet some of these lower resolution models may be suitable for gross testing.

d) A 3D model may be modified to add surface roughness as described in Intentional Design of Surface Roughness for Orthopedic Parts nTopology. A 3D printed strawberry may also be further post-processed to add surface roughness features smaller than the resolution available on the printer. Some techniques used to add micro roughness to materials (e.g., painting, coating, acid-baths) is discussed, e.g., in Influence of topographical features on the surface appearance measurement of injection moulded components. In Combination of laser surface texturing and DLC coating on PEEK for enhanced tribological properties, the authors state in part “ . . . PEEK surfaces modified via laser surface texturing (LST) combined with DLC coating. An ultrashort-pulse laser was used in order to pattern a hexagonal array of 33 μm in diameter dimples onto the PEEK surface. The depth of dimples was varying (2, 12 and 21 μm) as well as the dimple density (10, 30 and 48%).” See also Effect of surface roughness on the ultrashort pulsed laser ablation fluence threshold of zinc and steel, which starts “Laser ablation is a subtractive micromachining technique, which can be employed to improve the surface functionality of a product by applying a laser-induced texture to the surface [1]. It is a flexible and precise manufacturing process compared to other techniques, such as electric discharge texturing, chemical etching, shot blasting and electron beam texturing [2].” Companies that provide texturing equipment/services include: Comco Inc (Burbank, Calif.)—MicroBlasting; Lightmotif (Enschede, Netherlands)—laser microtexturing, Standex Engraving Mold-Tech (Salem, N.H.)— chemical and laser texturing. The impacts of surface roughness in UVC irradiation systems for a variety of foods is discussed, e.g., in Ultraviolet-C light inactivation of Escherichia coli O157-H7 and Listeria monocytogenes on organic fruit surfaces, Pulsed light processing of foods for microbial safety, Applications of Pulsed Light Decontamination Technology in Food Processing—An Overview, Understanding The Factors Affecting Microbiological Quality Of Wheat Milled Products—From Wheat Fields To Milling Operations, Bactericidal effect of intense pulsed light on seeds without loss of viability, Feasibility Study Of Surface Applications For Flashblast Radiation In The Food Industry, as well as include the shadowing due to the food container as discussed in Aseptic Processing and Packaging of Particulate Foods.

e) Another surface feature nuance to be considered (in accurately emulating the microbial retention on object avatars) is the effect of object feature size on microbial movement, e.g., in The Effect of Topography on Surface Behavior of Pseudomonas aeruginosa, it states in part “We found that there was a threshold feature size of 1-2 μm at which bacterial surface motility is drastically impacted. This suggests that bacteria in the shadow of a strawberry achenes may find it difficult to move. See also The Effect of Surface Topography on the Retention of Microorganisms. Note that mean diameters of airborne microbes are shown in MERV Filter Models National Air Filtration Association and can be roughly summarized as follows—viruses: 0.02˜0.22 bacteria: 0.17˜3.1 fungi: 1.4˜17.3 μm.

f) In an exemplary embodiment, lower resolution dosimetric/printed features are employed to fabricate object avatars to ascertain first order effects, which in fact may be wholly sufficient for certain applications (in addition to being more cost effective to produce).

g) Note that a non-limiting, wide variety of objects (fruits, vegetables, whole plants with exposed parts (one or more of leaves/roots/flowers/fruits/etc.), bottles, packaging materials, N95 masks, etc.) are contemplated for use with the instant invention.

(1) 3D printing (an example of additive manufacturing)—Replication of natural surface textures so that the surrogate does not add more shadowed areas, thereby making the test results overly conservative. The matter of 3D printer resolution is discussed in What Does Resolution Mean in 3D Printing Formlabs.

(2) Multi-axis CNC (an example of subtractive manufacturing)—The fabrication of dosimetric avatars can be made via 5-axis CNC machines in a wide variety of materials, including wood that can be dyed with dosimetric material. See, e.g., 5axisworks Ltd. (London, England), with their SAXISMAKER having working volumes 400 mm on a side and larger, mechanical resolution of 36 microns (XYZ) and 0.034 degrees (BC-axis), electronic resolution of 4.5 microns (XYZ) and 0.0041 degrees (BC-axis), and mechanical repeatability of 50 microns (XYZ) and 0.017 degrees (BC-axis). See also the Desktop 5-axis CNC Mill from RobotDigg (Zhejiang, China). Note that the material can be removed via traditional machine tools such as drills and/or custom-cutters like those available from Vexor Custom Woodworking Tools (Denver, Colo.), etc. Laser cutting (and other approaches) are also contemplated, as disclosed below. Several exemplary embodiments follow.

A CNC drilled polycarbonate (PC) plate is an interesting option since it is very absorbing in UVC, and thus holes made in a PC plate allow UVC to pass only if it is on or near the hole's axis and aligned-with or tilted slightly about the axis (the amount dependent upon the hole size and plate thickness) which can be determined with simple geometry. This effectively eliminates any biases due to the plate's UVC reflective/scattering properties. By selecting the PC plate thickness, hole size, hole taper (and other geometric features such as a countersink, etc.) if any, and hole axis angle relative to the surface-normal of the plate, only light from predetermined directions is allowed to pass through the plate. On the underside of the PC plate a dosimeter is placed, either a (permanent) card-type or one or more optoelectronic UVC sensors. The hole pattern in the PC plate can be made to maximize the available sensing surfaces of an existing card or optoelectronic sensor(s), although custom cards/sensors can of course be made. One method of making holes in PC plates is via laser drilling, available, e.g., from Laser Light Technologies (Hermann, Mo.). Laser micromachining systems are available, e.g., from AMADA WELD TECH INC. (Monrovia, Calif.). Consistent dosimetry requires consistent hole sizes and surface finish. Note that the holes can be filled with a UVC transparent encapsulant to provide an environmental seal. An alternative environmental seal would be to use be a thin piece of UV grade fused silica (UVGFS) or FEP, followed by the PC plate, followed by the card/sensor(s). An environmental seal around the edges of the backside of the UVGFS for compressing against the enclosure would then prevent FOD from entering the dosimeter and allowing the UVGFS to be wiped clean after each use.

An alternative to a PC plate would be a PC tube, or even a custom molded part (e.g., in the shape of a strawberry or any other edible/non-edible object). For example, PC strawberry halves can be fabricated, with each half having a flat back-surface to accommodate a dosimeter card/sensor(s) facing strategically placed holes in the PC that pass from the back-surface through to its 3D shaped/textured front-surface. Alternatively, a PC tube is made with strategically placed holes, where the tube is covered in FEP much like the (heat shrink) FEP that is used to encapsulate LP mercury bulbs. Dosimetric card(s)/sensor(s) are placed on the inside of the PC tube, either adjacent to the inside surface of the tube (e.g., curving the card around an inner mandrel that is placed in the tube), at a plane in/near the center of the tube, or at some other location in the tube.

Also, in any of the above, 3D modeling software can be used to determine a functional equivalence between holes in a gross approximation to, e.g., a strawberry. Since there is a randomness to strawberry surfaces and the geometric path by which the points on the surface transit the UVC tunnel, a tube, for example, can be configured with holes relative to the surface normal of the tube that create a functionally equivalent shadow as a real strawberry. In fact, the achenes of a strawberry can be approximated by a countersunk hole drilled into the outer surface of the PC, and then one or more through-holes drilled to sample the UVC from predefined directions. Note that the 3D modeling approach can be used with any applicable dosimeter disclosed herein.

(3) Laminated Object Manufacturing—Fine scale laser cut wood sheets are laminated to form a 3D object, see e.g., An Additive Manufacturing Method Using Large-Scale Wood Inspired by Laminated Object Manufacturing and Plywood Technology. This assembly technique can also be made via a CNC router, e.g., Snapmaker 2.0 from Shenzhen Snapmaker Technologies Co., Ltd. (Shenzhen, Guangdong, China); note the modular device can also be fitted to perform 3D printing and laser engraving.

(4) Molded part manufacturing—Molded parts are available from many 3rd parties, such as fruits/vegetables/plants from Yiwu New Funny Crafts Co., Ltd. (Zhejiang, China), and custom injected molded thermoplastic resin parts as small as “grain of rice” with wall thicknesses down to wall sections as thin as 0.010″ from Piller Aimmco (Washougal, Wash.). Many more can be found via Thomasnet from the Thomas Publishing Company (New York, N.Y.), which also is a source for any other materials and manufacturing services herein.

(5) Shadow pins—Yet another approach to obtaining a high degree of dosimetric fidelity is to construct a pin-like dosimeter that presses into the real object in order to capture real-life shadowing. The head of the pin can be flat to receive a small adhesive-backed dosimeter decal. The pin can be pressed into, e.g., a strawberry such that the decal is below the surface and in the shadow of surrounding flesh. Alternatively, the head of the pin can be manufactured from a dyeable material and resembling, e.g., the achenes of a strawberry, which is then dyed with a dye-based dosimetry chemical (or can be electro-optical). The strawberry provides the general shape that generates gross shadows due to the convexity of the fruit. The pin provides an additional ‘micro-shadow’ as would an achene.

In yet another alternative, the head of the pin can be made flat, and a micro-shadow-inducing feature can be attached to the top of the pin via a magnet, adhesive, screw threads, interference fit, Velcro, etc.

Pins like these can be made with heads having various canyon-wall aspect ratios that can be selected as appropriate for a given food article (or other).

The pin-like feature allows attachment of the dosimeter to objects that may be wet and thus not amenable to adhesives. However, adhesives and other fastening devices can be used instead of pins as desired. For example, it may be difficult to attach a pin to hard objects.

(6) Host/matrix materials that can be dyed—Note that one needs to consider many aspects when manufacturing such objects to ensure the desired level of fidelity to the actual object (e.g., a strawberry), e.g., temperature/humidity and their effect on the photochromic and host/matrix materials, the transparency/reflectance/scatter of the host/matrix material to the incident radiation, the coefficient of friction, dimensional stability, overall weight, density distribution, center of gravity, moments of inertia, brittleness, coefficient of elasticity, surface hardness, porosity, color fastness, etc., both before and after irradiation (with and without dry fog).

(a) Plastics—

(i) Nylon—“Nylon a Polyamide . . . Acid, metal complexes, disperse reactive and disperse dyes are the important classes of dyes used in dyeing of nylon.” Dyeing of Polyamide Fibres. See also FAQ: How to dye nylon or polyamide.

“Polyamide (PA) . . . The FDA approved PA 12 (PA 2200), supplied by EOS GmbH, was used in this study . . . . PA and fillers were first dry-mixed by shaking in a plastic bag for 5 min prior to feeding into the hopper. The temperature profiles in the barrel were set at 180-200° C. from the hopper to the die, with screw rotating speed of 150 r/min. The extruded strands were immediately quenched after extrusion in a water bath, and were then pelletized. Fabrication of composite filament. A desktop single screw extruder (Extruder Version 1.3, Filastruder) was used to fabricate the filament from the composite mixture. The pellet was dried in the oven at 80° C. for 24 h. The nozzle temperature was set at 185±5° C. until 1.75±0.1 mm of filament was obtained. The filament was spooled to the winder as it extruded . . . . The processing temperature was set at 180-200 C and 185 C via a twin screw extruder and a filament extruder, respectively. These temperature settings were only slightly higher than the melting temperature of the materials, which is a common practice in determining the processing temperature. Nevertheless, the printing temperature was set a bit higher, at 230° C. In fact, PA can be extruded down to as low as 190° C. However, the thread bonding of layered parts was not sufficient at temperatures below 230° C. From DSC and TGA results, PA displayed wide processing windows (temperature range from melting to decomposition), therefore, a printing temperature at 230° C. was still acceptable.” Preparation and characterization of a newly developed polyamide composite utilising an affordable 3D printer.

Thus, colorants (dyes, pigments) that can withstand these temperatures can be introduced to the process and extruded as photochromic filaments for 3D printing.

(ii) Polymer clays—see dyeing and coloring polymer clays e.g., in Polymer clay coloring from glassattic.com, How to Color Polymer Clay The Very Best Methods. Many experts recommend that water-based dyes should be avoided in polymer clays since the baking process would cause voids due to the water. One process around that would be to roll out the polymer clay to a very thin layer, and provide sufficient heat to evaporate the water (but below the curing temperature), and then form the dyed polymer clay into the shape of the desired object and bake. The baking temperature of the polymer clay (275° F. for Sculpey from Polyform Products Company (Elk Grove Village, Ill.)) must be considered in order to avoid the temperature at which the dye breaks down and no longer functions as intended.

Note that “Prussian blue does not begin to decompose thermally until the temperature exceeds 200° C.” Cyanomicon—History, Science and Art of Cyanotype—Photographic Printing in Prussian Blue, citing Characterization of Prussian blue and its thermal decomposition products. Note that 200° C. is 392° F. Many other brands of polymer clay are available from the Polymer Clay Superstore (Wernersville, Pa.). Irreversible Photochromic pigment from New Color Chemical Co. Limited (Xiamen, China) has a maximum specified temperature of 220° C.

(b) Metals—As an example, anodized aluminum can be dyed—“During the type II anodizing process a porous anodic coating is formed when the aluminum part is processed in a sulfuric bath. The newly formed pores create a space for the dye to be absorbed into the surface of the aluminum. The anodized coloration process works through direct pigment injection into the empty pores of the part. Once the colored pigment reaches the surface, it's sealed off to preserve the selected color.” Arrow Cryogenics Inc. (Blaine, Minn.). UVC encapsulants can be considered for sealing as well.

(c) Ceramics—“The use of cyanotype on ceramic substrates evokes reminiscences of the attractive and celebrated blue Delftware. Regrettably this procedure is limited by the fact that if Prussian blue is fired under a glaze it will decompose thermally around 200° C., with the evolution of poisonous cyanogen and hydrogen cyanide gases, destroying the blue and leaving only weak brown ‘iron earth’ coloured images (iron oxides). However, the sensitizer is easily imbibed into a bisque-fired ceramic surface, such as possessed by unglazed tile bodies. This is still very absorbent and needs its porosity to be restricted with a sizing agent, such as gelatin.” Cyanomicon. Note that this comprehensive text on cyanotype also describes other formulations. The author, Mike Ware, would surely be considered a subject matter expert in the chemistry and photochemistry of cyanotype and related.

(d) Natural Fibers—

(i) Wood flour—is graded in size by ‘mesh’, which correlates to the diameters as shown in the table, below (e.g., 200 mesh is a particle 75 microns in diameter). Wood flour is sold in “20-100 mesh, with 100-200 mesh sieve's available” from Lignetics Brands (Louisville, Colo.) and in 100 & 200 mesh from PJ Murphy—Forest Products Corp. (Montville, N.J.). See Table 15.1 of Functional Fillers for Plastics, Ch. 15 Wood Flour, ISBN: 978-3-527-32361-6 for the “Conversion between US standard mesh and particle diameter”.

Other natural fibers include cotton and wood-based Cellulose Nanofibrils (CNF) that are tens of nanometers in width and under 3 microns in length and Cellulose NanoCrystals (CNC) that are tens of nanometers in width and under 300 nanometers in length from Cellulose Lab (Fredericton, New Brunswick, Canada).

(e) 3D printable materials—While there may be overlap with the previous categories, only certain materials can be 3D printed, and thus it makes sense to give a summary of some of these. See, e.g., Polymers for 3D Printing and Customized Additive Manufacturing, for a detailed summary of the deposition techniques and materials used. See also 3D Printing Temperatures & Printing Guidelines_Filaments.ca for a long list of 3D printable filament extrusion temperatures.

Wood—“Just like real wood, objects 3D printed with wood filament are porous, meaning they easily absorb different dyes and stains . . . . If you have access to a CNC laser machine, an engraver, or even a pyrography set, you can add features or drawings to your finished piece of work.” Wood 3D Printing Guide How to 3D Print Wood All3DP. See also The Complete Wood 3D Printing Filament Guide 3DSourced. Current technology uses a PLA (polylactic acid) filament, with 20% to 40% wood content. See, e.g., 3D Printing Materials—Feels, Smells Like Wood. The earlier referenced list shows Laywoo-D3 (Orbi-Tech GmbH, Leichlingen, Germany) is specified from 165° C.-250° C., with 165° C.-180° C. for bright/light color wood effect. MatterHackers Inc. (Lake Forest, Calif.) recommends “190° C. to 250° C. Printing at lower temperatures will produce a brighter color while printing at higher temperatures will create a darker print”, see Light Cherry Wood Flexible LAYWOO-D3 Filament—1.75 mm (0.25 kg) MatterHackers In Laywoo-D3 review (Ian Hisocks), it states “This printed nicely between 190° C. and 255° C. with varying colour as the temperature increases, if you print up to approximately 225° C. the colour will be a lighter tone than 225° C. to 255° C. . . . ”

Recall stock cyanotype dye is limited to 200° C. and New Color's pigment at 220° C., and thus these photochromic materials can be incorporated within the base filament such that avatars can be printed without requiring a postprinting coating step. See also Effect of Extrusion Temperature on the Physico-Mechanical Properties of Unidirectional Wood Fiber-Reinforced Polylactic Acid Composite (WFRPC) Components Using Fused Deposition Modeling. In Fabrication of PLA Filaments and its Printable Performance, filaments were manufactured via extrusion from raw PLA particles at temperatures as low as 190° C. Natural fiber composite PLA manufacturing is discussed in Natural fibre reinforced polylactic acid composites—A review. These natural fibers include wood and other fibrous materials that are known to accept cyanotype dye. A manufacturing process for a PLA/wood composite is disclosed in Effect of wood content in FDM filament on properties of 3D printed parts. “Regarding filler content, the objective was to maximize biomass content while ensuring that the printer does not have many flow problems when printing hundreds of samples. This value for ball-milled poplar turned out to be 20 wt. %. 210° C. was the most suitable filament extrusion temperature for 20% ball-milled poplar and 80% PLA after testing in the range of 190-230° C. . . . Extruder temperature of 190° C. and extrusion at the highest speed at 15% fibrillated poplar content were found to be the best conditions for the fibrillated poplar containing filaments, which were then used for printing and characterization . . . . Based on the tensile stress—strain curves, it was decided that ball milling was the preferred choice for size reduction over friction grinding (fibrillation).” Tensile properties of 3D-printed wood-filled PLA materials using poplar trees. Hence, fibrillated poplar fibers provide lower processing temperatures necessary for certain photochromic materials, wherein the use, e.g., in 3D printing avatars for dosimetry, are not subjugated to high tensile loads.

Foam—“LW-PLA is the first filament of its kind using an active foaming technology to achieve lightweight, low density PLA parts. At around 230C this material will start foaming, increasing its volume by nearly 3 times.” colorFabb BV(Belfeld, The Netherlands) Foam has a very high surface area, enabling dyes more contact area for bonding. Foam also provides a texture akin to bread and other bakery products.

(f) Paper dosimeters used in novel ways—First note some published uses of such dosimeters. In Ultraviolet-C decontamination of a hospital room—Amount of UV light needed, co-authored by paper-dosimetry manufacturer Intellego Technologies AB (Sweden), is states in part: “Indicators (surfaces) in the direct line of sight and vertical to the UVC device showed a more distinct change of colour, thus indicating that the UVC dose received was higher than that received by indicators (surfaces) placed horizontally, or shadowed by equipment or furniture, or both (FIG. 2A).” More recently, in UV dosimeter Badges—An Emerging Tool for Monitoring Delivered Dose (UV Solutions magazine, Q1, 2021), paper dosimeters (′UVC 100 Dosimeters by Intellego Technologies' and ‘UV Intensity Labels by UV Process Supply’) were affixed to various ‘complicated’ objects—“Four objects were selected to evaluate the usefulness of the dosimeter badges as an identifier for UV dose on varying complicated geometries in a typical commercial UV-based disinfection device (i.e., the Lumin™) The four objects were a razor, comb, sunglasses and keys . . . . Six dosimeter badges were attached to each object individually. Each badge placement was documented by photographing the object in two positions, one displaying the side of the object that would face the lamp and the other showing the opposite. The lamp-facing side of the object was named Side-1, and the bottom-facing side was named Side-2 . . . . dosimeter badges can be used to generally assess where UV light has touched a surface. This can help researchers in identifying areas that are shadowed from light and have not received any dose at all.”

In an exemplary embodiment, the dosimetric avatar integrates paper dosimeters. For example, a 3D printed strawberry (although it can be fabricated by any process, such as those cited herein) is made with slots and hinged surface portions for acceptance of an optionally textured paper dosimeter (or portion of one depending upon the size of the avatar). In one embodiment, the paper is used to capture the UVC received by the general surface profile of the strawberry. In another embodiment, apertures are formed in the 3D printed part such that the paper dosimeter is located behind the apertures and is shadowed by the walls forming the apertures (mimicking, e.g., the achenes of a strawberry). Thus, the shadowing features can come from a textured paper/cardboard dosimeter, features in a (3D printed) carrier (microscopic and/or macroscopic shadowing surfaces including shadowing due to the overall convexity of the avatar), or both. In one embodiment, commercially available paper/cardboard dosimeters are embossed (by a supplier or the customer) with a pattern representative of the texturing of a target object. These may be cut into small shapes (using, e.g., optional dashed lines on the dosimeter) and then inserted into a 3D printed ‘carrier’ shaped like a strawberry. The carrier may also be a generic one, enough to provide some convexity like the Platonic solids (the five regular polyhedra—tetrahedron (or pyramid), cube, octahedron, dodecahedron, and icosahedron). A more exact geometry can be developed by importing a 3D strawberry model (as cited herein), simulating the UVC irradiation system and its effects on the strawberry via a ray tracing program (e.g., such as TracePro from Lambda Research Corporation, Littleton, Mass.), then constructing an avatar design with (near) equivalent performance.

Design methodology of features in 3D printed parts suitable for capturing paper dosimeters include 3D printed hinges (see, e.g., How to design living hinges for 3D printing 3D Hubs), snap closures (see, e.g., How to design snap-fit joints for 3D printing 3D Hubs), slots behind and parallel to the surface—see, e.g., 3D Print captured nuts without pausing your print, which are used to capture nut-fasteners, and for the instant invention, the slots can be adapted to capture dosimetric paper, including optional features to prevent the paper from sliding out, such as by pinning using a fastener, or making the slot gap not much bigger than the thickness of the paper, and placing a lip at the entrance to the slot to ensure the paper doesn't slide out.

Note that textured materials such as beads and fibers can be deposited/affixed on paper dosimeters to provide shadowing, either with a degree of transmissibility or not. These textured papers can then be inserted in an avatar. In fact, 3D printed strawberries can be printed on top of a scaffolding supporting paper dosimeters to create an integrated dosimetric avatar, so long as the printing temperatures (and other effects) do not cause the paper dosimeter to degrade to an unusable state in the process.

Less accurate avatars may be constructed to gather first order effects; for example, a cylinder of about the diameter of a strawberry can be constructed, a dosimetric paper wrapped around it, and then a mesh surface wrapped around the cylinder to emulate shadow-inducing textures. Faceted shapes (e.g., truncated pyramids) lend themselves well to paper dosimeters. Any object can be constructed from a low-res mesh-model that can inherently provide such faceted shapes by limiting the number of nodes. These shapes can take advantage of the adhesive backing on paper dosimeters, which can be simply stuck to the facets. Once irradiated and the dosimetric patterns are captured (e.g., via photogrammetry), the faceted avatars can be bathed in a solution to aid in removal of the adhesive from the paper dosimeters so that the objects can be reused with new paper dosimeters.

(g) Paper forming techniques used to build avatars—The following all provide additional background on design and fabrication techniques. As mentioned herein, weights can be added to provide a closer inertial copy of the actual object.

(i) Origami techniques (see, e.g., Origami Strawberry) can be used to construct avatars directly from paper dosimeters. Once irradiated, they can be unfolded and simply scanned on a flatbed scanner. Each facet can be numbered to have geometric references when viewing the scanned image. The avatars would always be folded in the same way, so the references always relate to the same surface feature on the avatar. The folding lines can also be printed on the dosimeter paper.

(ii) Tissue paper honeycomb construction—see, e.g., Large Tissue Paper fruit and vegetable decorations. This approach naturally forms a texture-like depth that generates shadows.

(iii) Other paper construction—see the faceted construction, e.g., Paper Fruit—Mr Printables, folded construction, e.g., HANDMADE. 3D fruits and vegetables from paper (original work)—Steemit.

(iv) Cardboard construction—“The following techniques require no glue to attach cardboard together: Interlocking Slots Interlocking slots are thin slots cut into two pieces of cardboard that intersect each other at an angle to allow the two pieces to hold themselves together. The slots must be cut slightly thinner than the thickness of the cardboard so the friction of the mating piece in the slot will help hold the pieces together. Tab-n-Slot A tab-n-slot is a tapered tab that has slots cut on either side of it. The slots allow the end of the tab to be folded in on itself from both sides. The tab is then inserted into a slot cut into the mating part. The slot must be just wide enough for the folded tab to squeeze through, but narrow enough that when the ends of the tab are folded back out they retain the tab locking it into the mating part.” Cardboard 101. Note that folding can be used without tab-n-slot as well, either with another method to stabilize the shape (magnets, adhesives, hook-and-loop, etc.) or without any such mechanisms if the material is stiff enough to hold its shape (e.g., cardboard laminated to metal, or even hand-bendable metal sheet instead of cardboard). These constructions can use textured sheet material surfaces or not, depending on the application. 3D printed sheets with integral hinges can be deployed as well, with or without texturing.

This type of construction is interesting in that after irradiation, the pieces can be pulled apart (or splayed back to planar-form, and optionally held flat by a fixture) and then placed on a flatbed scanner (or equivalent) for extracting information to feed into a dosimetric analysis. As mentioned herein, metal interlocking plates each can be overlayed with adhesive-backed paper dosimeters to provide an avatar with inertia more similar to the real object. One can also construct pieces using a jigsaw-puzzle type arrangement, either a traditional 2D arrangement, or a 3D jigsaw puzzle as can be found on website of the Puzzle Warehouse (St. Louis, Mo.). See also GB2499381A 3D puzzle formed using CAD and CAM processes.

(v) Molded wood/paper pulp—see, e.g., U.S. Ser. No. 10/377,547 Methods and apparatus for in-line die cutting of vacuum formed molded pulp containers, also citing the use of dyes and coatings. Molded pulp is well known for its use in egg cartons (U.S. Pat. No. 4,088,259 Die-dried molded pulp egg carton) and cup carriers (U.S. Pat. No. 7,762,396 Cup carrier).

(7) Surface texturing—A recent publication on the issue of surface textures in UVC disinfection systems is Surface Textures and Implications for Needed Standards.

As cited herein, a strawberry surface texture is on the order of 1000μ (1 mm) in feature size (relief). This creates a ‘micro-shadow’, unlike the shadows created by the general curvature of the strawberry's gross convex geometric shape. A micro-shadow does not need to be tiny—it results from a finer undulation within the gross shape of an object. Another example would be an N95 mask that has a general curvature that will create shadows, but it also has a fibrous texture that creates micro-shadows.

One method, especially suited to paper/cardboard dosimeters (but applicable to any material that can be deformed), is to use embossing to create a textured surface. See, e.g., 4 Ways to Emboss Like a Boss_The Paper Blog (“Debossing is basically the opposite of embossing. Instead of creating a raised pattern, debossing creates an indented pattern.”) The Graphic Designer's Guide to Embossing—ZevenDesign (states in part, “Although embossing seems to be quite deep visually, it is commonly no more than 15 microns and at most, 25 microns.”), Performance evaluation of paper embossing tools produced by fused deposition modelling additive manufacturing technology (“Results show that paper characteristics determine the embossing force required for achieving a good embossing result . . . with the right amount of embossing force, letters and borderlines can be equally well formed by the embossing process regardless of paper weight, surface characteristics, etc.”). “ . . . the “blind emboss,” which involves only the raising or lowering of the image on the paper (and not printing or foiling anything). This creates a subtle, sophisticated effect. You may have seen the results of blind embossing on a notarized document or even a “This book is the property of . . . ” stamp inside a print book you have borrowed. (You can get such personal embossing stamps online for your own library with your own name on the die. If you look closely, you will see the two interlocking elements of the die)” Embossing Printing Industry Blog.

High relief blind embossing is available, e.g., from Eisenhardt Printing Company (Frankfurt, Germany), cited in Design Inspiring Distinct Blind Embossed Business Cards where the “emboss itself is 3 mm high on Gmund Cotton Linen Cream 222 lb. Cover.” High relief is also discussed in US20070062658 Absorbent paper product having high definition embossments at [0061]: “The embossed paper product of the present invention comprises one or more plies of paper. At least one of the plies is embossed so it comprises a plurality of embossments. In one embodiment, the embossments of the product of the present invention have an embossment height, h, of greater than about 800 microns. In another embodiment, the embossments have an embossment height of from about 800 microns to about 2500 microns. In other embodiments, the embossments have an embossment height of from about 1000 microns to about 2000 microns. In other embodiments still, the embossments have an embossment height of from about 1250 microns to about 1750 microns. The embossment height, h, is measured using the Embossment Structure Measurement Method described in the test methods section herein. Referring to FIG. 5, the embossment height, h, is a measure from the top of the unembossed structure to the bottom of the embossment as described in the test methods section. In an embodiment, the embossments have an emboss impression angle of less than about 150 degrees. In another embodiment, the embossments have an emboss impression angle of from about 90 degrees to about 150 degrees.”

Paper product dosimeters can be embossed either before or after the paper is treated with the photochromic chemical(s). An advantage of embossing before treatment is that the paper can be embossed as far back in the process as when it exists in a slurry form, allowing greater relief depths without tearing.

A list of embossing machines can be found in Top 13 Best Embossing Machine on The Market with Reviews 2021.

Multi-level or sculptured embossing can create more sophisticated profiles (like a more realistic strawberry texture, given the surface profile cited herein), see, e.g., Multi-Level Embossing Kicks It Up a Notch, Reaches New Depths»PostPress. Multi-level and sculptured embossing dies in brass are available, e.g., from E.C. Schultz & Company (Elk Grove Village, Ill.). In a preferred embodiment, a paper dosimeter like UVC 100 dots would be embossed using a custom sculpted embossing die suitable for a handheld or tabletop embossing tool, such as those used by notary publics, e.g., from Indiana Stamp (Fort Wayne, Ind.).

As a simple test, the corporate seal from Luminated Glazings was embossed onto standard 20 lb. Hammermill copy paper (International Paper Company, Memphis, Tenn.), measuring 0.003″ thick. After embossing with the corporate seal, the thickness of the seal area measured 0.015″. Similar embossing is used for notary publics. A simple test platform would be to purchase a notary public seal or a custom embosser, e.g., from Ideal Impressions, Inc. (Monsey, N.Y.) dba Ideal Stamp Shop.

A UVC Dosimeter Card, SKU 201188 (two-colors, 50 mJ/cm² to 100 mJ/cm²) was purchased from CureUV (Delray Beach, Fla.). The stock paper measured 0.019″ thick (about 6 times thicker than the 20 lb. copy paper). The Luminated Glazings corporate seal was embossed onto a portion of the card, and the maximum thickness after embossing was 0.034″, or 0.015″ thicker than the stock paper. The label was marked ‘www.americanultraviolet.com’ on the back, and the same two-color card can be seen on the American Ultraviolet website as SKU UVC-TAB-F-25-1. A similar card is the UVC100-DUO from Intellego Technologies (Stockholm, Sweden), and note that American Ultraviolet is a ‘partner’ of Intellego Technologies as per the Intellego website.

In order to understand whether an embossing can create the depth of profile of a real strawberry, an epoxy cast of a portion of the surface of a large strawberry was made, and the dimensions of the surface texture was measured to rough order (3D models are available as previously cited, from which a high fidelity surface texture dimensions can be captured). The oblong shaped achenes are roughly 7/64″ apart within each row, with adjacent rows about 5/64″ apart. The achenes are roughly 1. 5/64″ wide× 7/64″ long× 1/64″ deep, and each sit in a well that is about 3/64″ wide× 4/64″ long× 2/64″ deep. So, the depth of this texture, to rough order is about 2/64″=0.0312″=0.79 mm. Thus, the texture of this particular strawberry was about twice as deep as the depth of an embossed piece of 201b copy paper. However, a smaller strawberry would have a similar texture but on a smaller scale. An in terms of shadowing, the dimensionless aspect ratio (e.g., width/depth or length/depth) effectively defines the ‘canyon wall effect’ (see, e.g., UV-C Effectiveness and the ‘Canyon Wall Effect’ of Textured Healthcare Environment Surfaces»UV Solutions, although ‘aspect ratio’, per se, is not cited). Of course, the ‘wall’ structure of the canyon (slope angle(s), any texturing on it, reflectance, etc.) will also affect the shadowing, but to first order, replicating the gross features of the ‘canyon’ can be very-helpful. Now, the aspect ratio of the measured strawberry is roughly ( 3/64″)/( 2/64″) or 3/2 in width/depth or ( 4/64″)/( 2/64″) or 2/1 in length/depth. If the maximum depth of embossing a dosimeter paper is the same as 201b copy paper, the depth is 0.015″, and therefore the feature width could be set to (x0.015″=3/2, so x=0.022″) and the feature length set to (y/0.015″=2/1, so y=0.030″). This can be used for an embossing depression having an ellipsoidal cross section, or these can be averaged (0.026″) for a circular cross section. Specific sidewall slopes can be added, but for a first order effect, the standard low cost, single-level embossing die fabrication method can be used (e.g., via etching) yielding its characteristic sidewall slope.

In an exemplary embodiment, a 0.019″ thick UVC Dosimeter card from CureUV (SKU 201188, or the equivalent from American Ultraviolet, Lebanon, Ind.) is purchased, and then embossed with a texture similar to that of a strawberry, with maximum depth of texture 0.015″, representing the depth to the bottom of the achenes of a certain sized strawberry. Based on the previous analysis, the aspect ratio W/D=3/2, and L/D=2/1, and so each embossed achene feature starts as an oval shape (3/2)(0.015″)=0.022″ wide by (2/1)(0.015″)=0.030″ long, with a depth of 0.015″ below the indicating surface of the stock Dosimetric card. These cards (or the just the central photochromic section) can be placed on the sides of a faceted strawberry dosimetric avatar.

(8) UVC surface reflectance—One aspect in producing dosimetric avatars of a given fidelity is to understand the significance of the UVC surface reflectance of the targeted objects (e.g., strawberries). A reference to the issue of UVC absorbance of fruits, in addition to shadowing/shielding is cited here: “In inoculated fresh fruits, a greater UV shielding efficiency was observed, because microorganisms may reside in crevices or in irregularities (injuries) present on the fruit surface or may penetrate under the fruit's epidermis. This shadowing effect of coherent PUV photon sources used in these experiments is illustrated in FIG. 2. Therefore, a larger UV exposure is required, because many chemical components in plant tissues are capable of absorbing the UV energy, thus becoming effective chemical absorbers of UV light.” Development of Pulsed UV Light Processes for Surface Fungal Disinfection of Fresh Fruits. Note that this reference promotes rotation of fruits for better UVC coverage.

In order to better quantify the significance of UVC reflectance of fruits (low reflectances require a direct hit on the pathogen with the UVC, as the portion reflected from an adjacent surface would be of very low intensity). Published data for UVC reflectance of some fruits are disclosed below.

The UVC reflectance of blueberries are shown in FIGS. 2 & 3 of Classification of blueberry fruit and leaves based on spectral signatures. The y-axis in the plots below is specified as ‘Absorbance (log(1/R)’. Rearranging, R=10^{-A}, where R is % reflectance and A is absorbance. As shown in the plots, in the UVC range, both leaves and fruit have absorbance values between about 0.8 and 0.85, thus reflectance values of 10^{(-0.8})=15.8% and 10^{(-0.85)}=14.1%. Note the differences as the fruit matures and between varieties. This provides a template for testing other fruits/vegetables/etc.

It should be noted that ‘hyperspectral’ data has been collected by various groups for many fruits, serving as an indicator of fruit quality, ripeness, etc. However, very-little is collected in the UVC range (mostly Vis/NIR); see e.g., Table 1 of Extraction of Spectral Information from Hyperspectral Data and Application of Hyperspectral Imaging for Food and Agricultural Products, Table 1 of Optical non-destructive techniques for small berry fruits—A review.

When making a dosimetric avatar of a fruit, the UVC reflectance (254 nm) of nonfruit should ideally match that of the actual fruit. The UVC reflectance of some common materials are available in UV Disinfection—Application Information (Philips brochure). It includes a wealth of other data (including papers) useful in constructing UVC reactors. As an aside, the UVC reflectance of paper dosimeters is not specified by the manufacturers (although it can be measured).

Published information of UVC reflectivity down to 250 nm of exemplary 3D printable materials (colored and colorless PLA) are shown in The Optical and Thermal Properties of PLA Filament in a Context of Material Colour and 3D Printing Temperature. See also Characterization of the Reflectivity of Various Black Materials II.

(9) UVC degradation of 3D printable materials as a dosimeter—

Photodegradation-induced property changes such as weight and coloration can be used for dosimetry as discussed for PLA in The Effect of UV Treatment on the Degradation of Compostable Polylactic Acid. Changes to water contact angle and mechanical strength for PLA under UV exposure is discussed in Mechanical Properties of 3D Printed Polylactic Acid Parts under Different Testing Conditions. Note that much of the available data is for UV wavelengths other than UVC, but correlations are reasonably expected. The time constants of PLA filament aging must be understood if used as an avatar. See Effects of Ultraviolet Aging on Properties of Wood Flour—Poly(Lactic Acid) 3D Printing Filaments. Other polymeric materials are disclosed in Effect of UVC Exposure on Non-Metallic Materials in HVAC Systems.

(10) Weight and inertia of avatars—For fidelity to an actual object, the weight and inertia should be the same in order to mimic, e.g., the natural tumbling/movements of an object carried by a conveyor belt through a UVC tunnel, which can also be impacted by the friction between the object and the tunnel belt.

One analogous technique is to add specially shaped weighted blocks within an object to change its inertia, such as that done with the manufacturing of bowling balls—see e.g., The insides of pro bowling balls will make your head spin Popular Science, A Look at the USBC's Bowling Technology Study, and What makes bowling balls hook, also citing the effects of friction on rolling.

Other analogous techniques can be seen in the weights added to tires for balancing, and selective removal of material room high speed shaft assemblies for balancing. Of course, weight changes can be used to induce imbalance conditions.

In the case of 3D printed (or machined) parts, one or more inner cavities can be defined for acceptance of a material of different density (or it can remain empty) to better emulate, e.g., the natural tumbling of a strawberry along a conveyor belt. In the case of paper/cardboard parts, weights can be added to a central core, or a frame can be made from metal, with paper dosimeters adhesively attached.

Surface textures (including surface hardness & firmness) can affect the friction/dynamics between a dosimetric avatar and, e.g., the transport belt in a UVC tunnel, and therefore impact whether sliding/tumbling of an avatar is similar to a real object. Thus, for high fidelity dosimetry, surface textures should be considered.

(11) Adhesion of photochromic materials

Dye additives—see, e.g., U.S. Pat. No. 6,942,705 Method of dyeing thermoplastic resin article and colored plastic lens obtainable by that method, claiming the use of a monocyclic monoterpene with the dye.

Primers—See, e.g., products such as Leather World Plastic Primer—“Excellent water-based plastic primer for most automotive plastics and hard vinyl panels. This makes an excellent base for Dye Colorant to adhere to the hard plastic or vinyl trim.” Leather World Technologies (Roanoke, Va.). See also Water Base Plastic Primer—“used when dying plastic with water base colors” from Superior Restoration, Inc. (Sacramento, Calif.).

Watercolor Grounds—a brush-on porous surface coating suitable for application on plastics and other surface materials. Traditionally used for covering-over mistakes in watercolor paintings, allowing the surface to be repainted with watercolors. Manufactured, e.g., by art supply company Daniel Smith (Seattle, Wash.). Similar ‘primers’ for dyes are discussed in How to Use Anti Spread Techniques and Products—How to (Wiki)—Silk Painters International.

(12) Adhesives and coatings

Fine sprays—see, e.g., 3M Spray Adhesives Brochure. See material compatibility chart for use on plastics, metals, etc. See also adhesives with “mist” spray patterns. See also E6000 Spray Adhesive (Eclectic Products, Inc., Eugene, Oreg.), Glue for Glitter (DESIGN MASTER color tool, inc., Boulder, Colo.). Note that in one experiment, E6000 spray adhesive was sprayed on a fake plastic strawberry, then brushed smooth with an acid/flux brush to maintain the surface profile of the strawberry. Glow phosphor was then sprinkled on, followed by tapping the coated strawberry to shake off loose particles. The technique worked well. Note that the coated strawberries could then be placed in an air pressure chamber to further aid in embedding the particles into the adhesive to the degree desired. A UVC encapsulant could then be used to provide a food-safe seal around the particles while still providing UVC and visible light transmissibility to/from the particles. The E6000 Safety Data Sheet states it is made from Styrene, 1,3- butadiene polymer and tetrachloroethylene. UV absorbance is given for styrene-butadiene in Analysis of the Absorption Spectra of Styrene-butadiene in Toluene.

Brush/Vapor—In an analogous art, cyanoacrylate (instant) adhesives are used to adhere powders in the manicure industry, see, e.g., All About Dip Nails!. Note that the cited use of any overcoats may not be suitable if it should block UVC from reaching photochromic powders, and thus the simple cyanoacrylate adhesive base layer may be sufficient in such applications, although a UVC transparent encapsulant (such as one or more of those cited herein) can be used as an overcoat (and food safe as applicable). Also note that cyanoacrylate adhesives easily vaporize, providing another high resolution application method. In another analogous art, such vapors are used to detect fingerprints, see, e.g., The Cyanoacrylate Fuming Method and Superglue Fuming For The Chemical Enhancement Of Latent Fingerprints, for the processes used to vaporize the adhesive and condense onto object avatars (e.g., a fake strawberry), after which photochromic powders can be applied (and encapsulants, if desired, as cited previously).

UVC transmitting adhesives, coatings, and encapsulants—for paper-based avatars to work in the fog field, they must receive UVC light and cannot degrade due to the high RH during operation (true for any other materials for use with the instant invention, such as UVC LEDs). One method of protection is to laminate a protective window using a UVC transmitting adhesive/tape. Another method is to encapsulate or conformally coat the sensitive device.

(i) Tapes—see, e.g., 3M P/N OCA8146-2 and OCA8146-3, available from Thorlabs (Oak Ridge, N.J.). See Thorlabs.com—Optically Clear Double-Sided Adhesive Tape. Best suited for planar surfaces.

(ii) Coatings/encapsulants/adhesives—see, for example 1. SCHOTT (Duryea, Pa.) Deep UV-200 Silicone Adhesive as cited in Heterostructure design and epitaxial growth of AlGaN-based light emitting diodes emitting in the UVC wavelength range; 2. Dow (Midland, Mich.) Silastic™ Moldable Optical Silicone; 3. Dupont (Wilmington, Del.) Fortasun 6212, see DuPont_Fortasun_Launch_Tech Sheets_PV-6212 Cell Encapsulant 4. KF-96-50CS dimethylpolysiloxane silicone oil (Shin-Etsu Chemical Co., Ltd, Tokyo, Japan) as cited in A Novel Liquid Packaging Structure of Deep-Ultraviolet Light-Emitting Diodes to Enhance the Light-Extraction Efficiency; 5. Master Bond Inc. (Hackensack, N.J.) UV LED Encapsulant, see e.g., Optical Transmission Properties of Adhesives MasterBond.com, with their MasterSil 151 (a ‘two component, low viscosity silicone compound for high performance potting and encapsulation’ that ‘cures at room or elevated temperatures’) and MB600 (a ‘low viscosity’ ‘sodium silicate adhesive/coating’ with a ‘widely used cure schedule is 45 minutes at 200° F. followed by another 60 minutes at 300-400° F.’) products well suited for UVC (and visible) light applications.

Other means by which photochromic materials can be attached—Many other processes are contemplated for attachment of photochromic materials such as vacuum coating, electrostatic powder coating, etc., given that they are compatible with the temperatures and other aspects of the respective coating process(es).

Calibration images/targets—In order to accurately discern a dosage on a dosimeter, calibration colors have been used historically for comparison purposes. This can be seen, e.g., on the commercially available UVC 100 Dosimeter Cards from Intellego Technologies (Stockholm, Sweden), that “feature a yellow indicator, surrounded by two reference colors (orange and pink) to indicate UVGI doses of 50 and 100 mJ/cm².” In a similar fashion, dosimetric avatars can be used with calibration features, either on the avatar itself, on a card near where the avatar will be sensed after exposure, or relative to a computerized data file that was derived from the same photochromic material, which is exposed in a quality control lab, e.g., on a daily basis, along with one or more dosimetric avatars to ensure proper dosimetric sensing. Note that ambient light conditions must be considered when correlating an in-line dosimetric avatar to the calibration target. For example, a visible light calibration card (to sense ambient light) would be placed near the camera(s) used to measure the dosimetric avatar. Open source software for camera calibration is referenced in Camera Calibration Toolbox for Matlab from the California Institute of Technology (Pasadena, Calif.). A comprehensive discussion of issues encountered in correlating image capture to calibration images for fruit (bananas) Assessment of banana fruit maturity by image processing technique. This paper was cited in later paper looking at both bananas and strawberries, Monitoring the Change Process of Banana Freshness by GoogLeNet. The paper also discloses a recently developed technique called ‘transfer learning’: “Transfer learning is a new machine learning method that uses existing knowledge to solve different but related problems . . . A total of 104 strawberries were collected, and 312 photos of strawberries were taken as a data set. After the same operation steps and 2100 iterations, the recognition accuracy of the model is 92.47%. The accuracy and loss curves in training are shown in FIG. 11. The strawberry change is more challenging to recognize than the banana because the strawberry itself is red. When it goes bad, the color changes to a deep red, so the back and forth changes are less obvious. However, our model can still achieve high accuracy. The results show that the model has good adaptability and can be used for various fruit identification.” For the instant invention, instead of real strawberries, they could be dosimetric avatars, and in fact, transfer learning (e.g., via the internet through a secure network to the cloud administered by the Assignee and/or its delegates) allows access, e.g., to updated dosimetric avatar data for different types of objects. This also enables a business model comprising maintenance fees for access to the trade secrets hosted in such a transfer learning database. Of course, this business method can be extended to any business, especially those that use machine vision, from fixed camera embedded systems to portable cameras like a GoPro (San Mateo, Calif.) or those on iOS and Android smartphones. Note that the transfer learning database can also hold additional data related to objects, and so for the example of a UVC tunnel, such data includes one or more of: model number of the UVC irradiation system and its operating parameters like beltspeed/temperature/humidity/dry-fog data, camera calibration data (including ambient lighting radiometry), UVC radiometry for correlation to the type of UVC lamps being used (LP/MP/Xenon/LED), date codes of equipment and avatars, dosage levels necessary for a given object (be it for UVC to kill certain pathogens or VIS/NIR to accelerate the growth of certain greenhouse fruit/vegetable varieties), etc.

Photogrammetry for measuring visual changes of irradiated objects—Qlone (Yokneam, Israel) is an Android/iOS smartphone app that can generate a 3D model of an object (include surface colors) by placing the object atop of a paper calibration grid and guiding the user to move the smartphone's camera in azimuth and elevation (as directed by the app's hemispherical grid). The app exports (for a fee) objects in 3D formats such as OBJ, STL, USDZ, GLB, FBX, PLY and X3D. A discussion of the data within 3D file formats can be found in An Overview of 3D Data Content, File Formats and Viewers. Using this information, one can extract (or pay for an expert service to extract) the color/intensity information from the 3D rendering on the irradiated object automatically and provide data (including statistics) that can be interpreted to characterize the quality of the irradiation, quantitatively and/or qualitatively, where the former, e.g., can determine whether the irradiation is inadequate, and the latter, e.g., can provide a sense of how the irradiation varies over the object. A simple az/el fixture for use with apps like Qlone can be found in For Better Photogrammetry, Just Add A Donut Hackaday and automated configurations are described in Automating Photogrammetry with Foldio360 Smart Turntable (Update 2018). Other applications and hardware platforms can be found in, e.g., Photogrammetry: Step-by-Step Guide and Software Comparison. Consultants can assist in developing a photogrammetry solution, e.g., Nick Lievendag (Amsterdam, North Holland, Netherlands) is a consultant in the area of photogrammetry, and his vlog 3Dscanexpert.com provides reviews of hardware and software, including professional grade equipment such as those from 3D scanning manufacturer Artec Europe (Rue des Peupliers, Luxembourg).

See also A new, open standard for 3D imaging data for other point cloud scanning technologies (LIDAR, etc.) and file formats. The holding structure (and other features not associated with the desired object) can be automatically eliminated in photogrammetry by constructing it in a manner much like a ‘green screen’ is eliminated in video production. Features of the holding structure include color, pattern, transparency, thinness, temporal changes, temperature, absolute coordinates, special coating that causes the holding structure to change its (optical) characteristics without causing a change in the object's characteristics, etc. See, e.g., Using Prior Knowledge for Verification and Elimination of Stationary and Variable Objects in Real-time Images, A background subtraction algorithm for detecting and tracking vehicles. “Subtraction, masks . . . A binary image is called a mask. It may be used to cut specific content off other images . . . ” Digital Photogrammetry—A Practical Course (ISBN 978-3-662-50462-8).

“The image of the strawberry was obtained by a 3D laser scanner (Next Engine, USA). The equipment consisted of a calibrated camera, a rotation table, a laser source and a computer with ScanStudio HD software (Next Engine, USA). Scanning, aligning, trimming, filling holes and fusing are the main processing features used to produce a single surface mesh. The image acquisition process and the strawberry surface obtained are shown in FIGS. 3a and 3b. The distance from the lamp surface to the base of the strawberry was 150 mm. Three geometries were created with the strawberry calyx on its side, top, and bottom (FIG. 4a).” Simulation of UV-C Intensity Distribution and Inactivation of Mold Spores on Strawberries

Close-up and macro photography—Discerning the photochromic differences of an exposed dosimetric avatar from an object with a textured surface can be challenging. Close-up or ‘macro’ photography is used for imaging at very close distances. See, e.g., Close Up And Macro Food Photography Ideas You Should Try, and How To Take Great Macro Photos With Your iPhone. Note the add-on lenses that can be attached to smartphones. Also note the trend of more sophisticated camera/imaging technologies in smartphones. See, e.g., Recent trends in smartphone-based detection for biomedical applications—a review, citing such uses as Routine diagnosis, Bacterial detection, Virus detection, Food quality control, Deep learning for smartphone-based imaging devices (SIDs). It is anticipated that this trend will continue, aiding the functionality/productivity of the instant invention. See also New Imaging Options for Conservators, Restorers, Curators, Forensics, Document and Material Examiners LinkedIn, describing “Z-stacking”, where “in-focus images from different levels are electronically combined into a single ‘all-in-focus’ image.” Z-stacking (aka focus stacking, focal plane merging, and focus blending) is described further in Focus stacking—Wikipedia, “ . . . a digital image processing technique which combines multiple images taken at different focus distances to give a resulting image with a greater depth of field (DOF) than any of the individual source images. Focus stacking can be used in any situation where individual images have a very shallow depth of field; macro photography and optical microscopy are two typical examples . . . ” 3D models can be constructed from such images, see, e.g., An automated device for the digitization and 3D modelling of insects, combining extended-depth-of-field and all-side multi-view imaging. See also U.S. Pat. No. 9,224,193 Focus stacking image processing apparatus, imaging system, and image processing system, U.S. Pat. No. 8,287,195 Motor controlled macro rail for close-up focus-stacking photography. Focus stacking software for macro photography is available, e.g., from Zerene Systems LLC (Richland, Wash.). Exemplary high quality close up images can be seen from the works of Rob Kesseler, e.g., a co-author in Fruit: Edible, Inedible, Incredible (ISBN 978-1608872817). Extensive teachings in the art of close-up and macro photography can be found, e.g., in Close-up and macro photography: its art and fieldcraft techniques (ISBN 978-1315620800). These techniques can be combined with photogrammetry/automation as cited in co-pending U.S. Patent Application No. 63/190,139 (the '139).

Alternative approaches (or in combination with close-up and macro photography)—Certain avatar constructions, some examples disclosed in the '139, can have their 3D geometries transformed into a plane that is more suitable for imaging. This can be done by one or more operations including flattening, unfolding, disassembling, stretching, sectioning etc. (i.e., their geometries modified) in order to facilitate the dosimetric imaging. For example, the ‘origami’ like avatars cited in the '139 can be unfolded. A 3D printed avatar can also be sectioned to better reveal the photochromic gradations on the (textured) surface, such that the profile of a section can be imaged normal to the cutting plane. A tab-type 3D construction can be disassembled. A molded 3D avatar made, e.g., out of a stretchable material can be stretched taught around a planar form.

Mapping—Note that mapping imagery back to a 3D model may provide diagnostic information enabling better optimization of the instant invention by adjusting N_{d}, t_{FOG}, light sources, etc., and other parameters based on understanding how the differences in fluences map to the actual product. See, e.g., Fold Mapping—Parametric Design of Origami Surfaces with Periodic Tessellations. Each fold can be numbered to allow recombination back to the 3D shape such that the dosimetry can be understood on a 3D object. See also the references to 3D models of fluence on strawberries cited in the '139, namely Simulation of UV-C Intensity Distribution and Inactivation of Mold Spores on Strawberries, and Simulation of UV-C Dose Distribution and Inactivation of Mold Spore on Strawberries in a Conveyor System.

Visual inspection—Simple visual inspection of irradiated objects provides photochromic feedback and can be used to quickly determine the uniformity of irradiation (a hallmark of the inventive dry fog approach), and the coloration can be correlated to a calibrated dosimeter that travels adjacent to the object through the irradiation chamber. The readings on these devices can be correlated to the surface portions in an adjacent photochromic object facing the same direction as the sensor in the pucks.

Avatar quality control checks—The surface of the avatars can be read automatically as it leaves the UVC tunnel (using photogrammetry if using photochromic materials or using a wireless link if the avatar is electrooptical). An analogous method is used in the detection of undesirable objects in a high speed manufacturing line (reject systems). “Spray is an optical sorting machine with the highest resolution cameras to examine the product on the conveyor belt. The system is used to check whole or cut agro-food products: Fruit and Vegetables. Spray can dispose of colour defects, marked produce and foreign bodies also the same colour as the good product . . . . Spray is equipped with an air reject system with 176 electrically controlled ejection valves . . . that differentiate unusable produce from defects considered second choice . . . . Automatic capture of images of rejected products and their filing for post-production analysis . . . ” Raytec Vision Bluelight Technology, Raytec Vision S.p.A. (Parma—Italy), and available in customized configurations. Such systems can also identify and remove avatars into a separate bin as they exit the production line. Another analogous system is described in U.S. Pat. No. 9,462,749 Selectively harvesting fruits, but for the instant invention, instead of looking for colors pertaining to ripeness, the system would look to colors (or gray scales) related to threshold dosages on the surface of a dosimetric avatar. For example, a gray scale (shade of cyan in the case of cyanotype) that corresponds to an under-dosed portion of an avatar (or an area-weighted portion that is under-dosed) would trigger an alarm, slow the speed of a conveyor via a control system, etc. Excessive over-dosing (again, could be area-weighted) could also trigger an alarm, lower the UVC lamp power via a control system, etc. Similarly, there can be other thresholds or mathematical functions that trigger suitable responses.

Mechanical transformations—Radiometer pucks and avatars can be mechanized to morph into a variety of shapes. For example, a radiometer can extend and retract orthogonal surfaces each run through the tunnel to estimate dosages for a range of sizes of strawberries.

Feedback from the dosimetry—Feedback can be used to adjust irradiation and fog patterns, as well as alert the operator of any failures thereof. If the manufacturing process causes the release of debris that can affect the dosimetry, then measures can be taken to counter this. For example, the dosimeters can be placed within UVC grade fused silica (or the PTFE derivative FEP) that can be washed off prior to each pass through the tunnel.

Other approaches in food surface disinfection—Food surfaces have complex surface topologies that shades a percentage of pathogens from direct UVC light. A fog of scattering particles can be directed at the surfaces along with UVC. The flow rate can be adjusted to get under flaps, etc.

In an exemplary embodiment, a food product on a production line enters a disinfection station on a first conveyor belt. A second conveyor belt is spaced a short distance from the end of the first conveyor belt (either at the same vertical height or slightly below, see e.g., the metal chain conveyors from Dorner Mfg. Corp., Hartland, Wis.).

The surfaces of the food product are then charged, e.g., to a positive potential, e.g., by dip coating. Preferably, the local humidity is controlled given its effects on particle size as taught in Atmospheric humidity and particle charging state on agglomeration of aerosol particles, Industrial Sprays and Atomization (ISBN 978-1-84996-875-1), and Food Powders, Physical Properties, Processing, and Functionality (ISBN 0-306-47806-4).

As the food product extends over the gap between the conveyor belts, a system adaptively directs a cloud of electrostatically negatively charged food safe liquid droplets of a predetermined size distribution over a predetermined scattering thickness layer(s) on all sides of the food.

At the same time an algorithm calculates the appropriate UVC irradiation spatial/angular/temporal patterns which is directed at the cloud to achieve the necessary dosage(s). The UVC scatters through the cloud and irradiates the food surfaces, including those in shadow, to achieve the appropriate dosage. Background and algorithms for adaptively calculating UVC irradiation levels (and avoiding overdosing) are taught e.g., in U.S. Pat. No. 6,656,424 Ultraviolet area sterilizer and method of area sterilization using ultraviolet radiation, Guidance for Implementing Action Spectra Correction With Medium Pressure UV Disinfection, Understanding UV Monitoring for Air and Water UV Treatments.

Discussion of overdosing (damaging effects of exceeding the necessary threshold) includes Use of UV-C light to reduce Botrytis storage rot of table grapes.

An exemplary UV monitor with programmable (tunable) PID controller is Model Q46UV UV254 Turbidity Monitor, from Analytical Technology, Inc. (Collegeville, Pa.).

Exemplary systems include Trojan UV3000Plus Reference Documents—City of Healdsburg, Installation Instructions and Operating Manual for Ultraviolet Water Treatment System—Series B-160 (Wedeco), UV Planning and Design Principles for DWT.

A textbook discussing a PID controller design for germicidal UVC systems Water and Wastewater Infrastructure—Energy Efficiency and Sustainability (ISBN 978-1-4665-1786-8); see Appendix E, citing Olsson, G., Instrumentation, Monitoring, Control and Automation in Water and Wastewater Operations, Lund University, Sweden, 2010; Araki, M., Control Systems Robotics, and Automation. Vol II. PID Control, Kyoto University, Japan, 2010.

PID Controllers are available e.g., from OMEGA Engineering, Inc. (Norwalk, Conn.), West Control Solutions (Gurnee, Ill.). Consulting services for PID controllers include Wescott Design Services (Oregon City, Oreg.), and for multivariable controllers via Advanced Process Control (Red Lodge, Mont.).

Textbooks on control systems include Control and Instrumentation For Wastewater Treatment Plants (ISBN 1-85233-054-6), Advanced process control—beyond single loop control (ISBN 978-0-470-38197-7), Advanced Process Engineering Control (ISBN 978-3-11-030662-0).

A food-grade roller conveyor table can also be used, with irradiation between rollers. Such systems are available from Vande Berg Scales (Sioux Center, Iowa). The UVC radiation sources are strategically placed to optimize illumination of the shadows given the geometrical design constraints of the production line. Note that care is required not to overdose the food and thereby degrade its desirable qualities. See citations in the Background, e.g., Effect of Emerging Processing Methods on the Food Quality: Advantages and Challenges, ISBN 978-3-030-18190-1, and Electronic Irradiation Of Foods—An Introduction to the Technology, ISBN 0-387-23784-4.

An advantage of vertically offset belt conveyors is that the disinfection zone can disinfect both the food article as well as the upper conveyor at the same time and is easily adaptable for the instant invention.

After irradiation, a puff of a neutralizing medium can be directed at the food surfaces to minimize electrostatic attraction from pathogens and detritus. The food can then be packaged (e.g., in plastic wrap, a vacuum sealed bag, a sealed bag with a predefined atmosphere, etc.), to avoid further contamination. An exemplary neutralizer is MSP Model 1090 Electrical Ionizer from MSP Corporation (Shoreview, Minn., a division of TSI Incorporated).

Other arrangements are contemplated in order to irradiate all surfaces of the food product. For example, the product can be briefly levitated from underneath (like in an air hockey table) with the scatterers while it is enveloped with scatterers on the remaining sides, during which the food product is irradiated. Such air levitation is found in air tables/conveyors, e.g., available from Pack Air, Inc. (Neenah, Wis.).

Alternatively, the product can be held in a grill basket like that used on a barbeque. The grill basket can also be rotated through the scattering field. An example would be the Char-Broil NonStick Grill Basket (Columbus, Ga.).

After irradiation, the remaining aerosolized droplets can be vented/evacuated, and neutral-charged clean dry air can be blown across the food item at a distance downstream from the irradiation zone so that the dry air does not interfere with the scattering particles.

If liquid droplets are unacceptable for contacting certain food items, then e.g., CO2 droplets from a dry ice fog can be used, as long as the CO2 is safely vented after processing.

Alternatively, charged food-safe powders can be used for the scattering field. After irradiation, the powder residue can be washed-off (if desired) in a liquid solution that also neutralizes the surface charge(s). The powder can also form a desirable coating that is left on the food article.

Service businesses—data and analytics can be coalesced at a facility or via cloud services and monetized. For example, the machine setting parameters for a given food object may be best provided by an expert service, e.g., t_{FOG} and N_{d}, lamp positioning, conveyor belt speed, chamber temperatures, fog velocity, etc. for optimizing the processing of strawberries vs blueberries vs bread. Analysis of dosimetry, including the dosimetric avatars cited herein can also be provided as a service. The data can be gathered from offsite laboratories and uploaded from data captured during machine operation at customers' sites. Monetization can be one-off or based on tiered subscription services. See, e.g., Integrated and Intelligent Manufacturing—Perspectives and Enablers also citing Cloud manufacturing—a new manufacturing paradigm. See also Towards an Automated Optimization-as-a-Service Concept, Streaming Machine Generated Data to Enable a Third-Party Ecosystem of Digital Manufacturing Apps. See also U.S. Ser. No. 10/618,137 Automated constructing method of cloud manufacturing service and cloud manufacturing system.

In an exemplary embodiment, a cloud service provides a hub by which clients manually (or automatically) download optimal UV tunnel machine settings (or other devices based on the instant invention) based on the products being processed at the factory. Dosimetry data is uploaded to the cloud for analysis and machine optimization. The contractual arrangement with members can be constructed such that the data from the clients can be used in aggregate for further optimizations. The analytics are refined over time, such that the factory continues to make incremental productivity/quality improvements. Of course, suitable backup systems must be in place when the cloud connection is down, hackers attempt to subvert the process, etc.

A suitable software platform is available from MachineMetrics (Northampton, Mass.), “Any equipment provider, OEM or distributor, can install MachineMetrics Edge device on a new machine sold to a customer or retrofit any machine currently in the field. MachineMetrics Edge has the ability to connect to the machine's PLC and any additional sensors into the electrical cabinet of the machine and allows for the data to be visible to the customer and shared with the equipment provider . . . . Encrypted data is then streamed to the secure MachineMetrics cloud where the data is structured and aggregated to enable visualizations and analytics for service teams to monitor. Access to the historical and real-time data is available through open APIs. Real-time dashboards, historical analysis, and integrations with other systems can be built with these APIs.” The Machine Builders' Guide to Remote Machine Monitoring.

Application—disinfecting boxes/crates of food, food trays & containers—In CFD model development and validation of a thermonebulisation fungicide fogging system for postharvest storage of fruit, CFD simulations were generated to understand how a fogging disinfectant reached stacked fruits in a box/bin. This approach can be leverage in a group of embodiments of the instant invention.

As an example, a box of known contents (either via QR code, image processing of the contents, etc.) is engaged by a system that temporarily seals the openings, evacuates the air via the sealed openings to a predetermined pressure or over a predetermined time, fills the interior of the box via the openings with electrostatically charged puffs of water spray having a predetermined droplet distribution size in the submicron and micron range, inserts UVC wands and irradiates the targets with UVC using an array of UVC LEDs until reaching a predetermined dosage based on time or feedback, then evacuates the droplets, and finally filling the interior with dry air to complete the process.

Many options are possible. For example, the contents of the box can be imaged (e.g., inserting cameras or via penetrating radiation such as THz, x-rays, etc) to determine an optimum irradiation process that includes adapting one or more of the following parameters: distribution size of the scatterers, the fluid pressure/timing/distribution of the spray, the number/timing of evacuation/filling/irradiation cycles, the UVC intensity/spatial/angular/timing characteristics of the individual radiators, mechanical movement of the product by effectors, etc. UV-grade optical fibers can telescope in-and-around the target to enhance irradiation coverage. In fact, UV grade optical fibers/rods (e.g., end-emitting or side-emitting depending upon the application) can be formed in a thin sheet interspersed with manifolds fitted with nozzles/perforations to emit scattering elements as shown in the complementary views of FIGS. 9a and 9b. Note that light rays emitted from the side emitting fibers, while somewhat diffuse, are still vulnerable to surfaces in shadow adjacent to the plane of the fiber/manifold array without additional scattering spaced apart from the fibers.

Side emitting fibers for use with UV are discussed in Photocuring in Areas Where You Typically Cannot Get Light, Design and Modelling of Novel Waveguide and Light-Emitting-Diode-Based Photoreactors, Photocatalytic activity on TiO2-coated side-glowing optical fiber reactor under solar light. UVC grade side-emitting fibers can be made from fused silica fibers (or rods) with a special surface treatment, see Performance Assessment of Novel Side Firing Flexible Optical Fibers for Dental Applications. Fused silica rods are available Heraeus Quarzglas GmbH & Co. KG, Heraeus Conamic (Kleinostheim, Germany), and fused silica fibers are available from LEONI Fiber Optics Inc. (Williamsburg, Va.).

A plenum can be constructed within the box that directs air underneath each target so as to lift the target temporarily off its resting surface within the box in order to irradiate the target's surfaces that normally contact the box and therefore would be in shadow. The same (or additional) puff of air can also be used to move the surfaces of leafy vegetables to better illuminate target surfaces in shadow.

Of course, other processes can be added, such as injecting into the boxes (or the targets themselves) any other agents needed for disinfection or other purposes (e.g., ripening). Other sensors can be used to optimize the efficacy of a given process as is known in the art, including the art cited herein.

An exemplary high throughput fogging system with—1 micron particle size is the Sanomist from Sanitech Innovations (Juinagar, Navi Mumbai, India).

Food trays & containers are also considered, where the tray or container holds e.g., prepared liquid and/or solid food, and the desire is to stop the progression of microbial growth by using low dosages of UV/visible light, e.g., as cited in Applications of Light-Emitting Diodes (LEDs) in Food Processing and Water Treatment. Because the food was originally prepared with low microbial counts, the dosage strategy is not the same as that used, e.g., to reduce pathogens by 4- or 5-log in water. In fact, with prepared foods, the cited article suggests that some foods are degraded by high doses of light. The article suggests that wavelengths closer to blue may be sufficient to control microbial growth. In that case, existing clear PET or PETE (polyethylene terephthalate) containers have suitable light transmission (see e.g., FIG. 2 in PTS 2014 27 437-448 Quality Changes of Extra Virgin Olive Oil Packaged in Coloured Polyethylene Terephthalate Bottles Stored Under Different Lighting Condition). These containers can have holes by which scattering vapor can be injected (periodically) in order to scatter the light incident on the clear packaging.

Trays used for food contact, whether disposable or not, are generally open to the air. In an exemplary configuration, these trays are stored in a refrigerated case, and periodically illuminated with germicidal light while they are fogged with a food-safe vapor of the appropriate scattering size.

Whether box, crate, tray, or container, in one embodiment, the geometry is such that the food is supported by point contacts (e.g., triangular corrugations) such that some of the vapor and light is guided between the corrugations in order to contact the backside of the food (in addition to contacting the front side of the food article) and allow draw-through of the vapor from one side to the other. Specially fabricated refrigerated cases can be designed to periodically direct vapor and light through the corrugated channels, while also directing the vapor and light onto the top surface. In some instances, there is no need for vapor to contact the top of the food article, only germicidal light (for those food articles where sufficient light contacts the top surface of the food without requiring scattering).

In any of the configurations, the vapor can also contain a small amount of food-safe biocide so that moisture from the vapor does not cause microbial growth.

Application—agriculture via wave energy scattering to enhance kinetic processes (process intensification) such as germicidal, photosynthetic, fruit ripening, etc. (on any unicellular/multicellular eukaryote that responds to wave energy, plant or animal) grown for food, aesthetic value, soil conditioning, filtration, toxin reduction, climate control, shade, enhanced gaseous (e.g., CO₂, O₂) exchange, as well as for providing medicines, fuel/energy, and other residential/commercial/industrial/military products and purposes—

Germicidal—“Gadoury's vineyard setup uses an array of 75 to 100 lamps—glass tubes similar to fluorescent lamps but without the coating that household lamps use to shift the wavelength into the safe zone—combined with reflectors, inside a shield that carries the lamps over the canopy. “It's not a death ray, but it will give you the mother of all sunburns, and if you look directly at it, it could blind you,” Gadoury said, adding that the vineyard array is designed to prevent worker exposure to UV with shields, so only the glow is visible. “When you see these things going through the vineyard at night, glowing in the dark, it's sort of otherworldly.” Inside the array, there are enough reflectors to create a fog of light particles that bounce around and hit every canopy surface. Engineers at the Lighting Research Center have worked on how to optimize that light spray and how to size it for delivery, Gadoury said. If you want to pull an array behind a tractor at 2 miles an hour, you have to make it long enough and bright enough to get sufficient exposure at that rate. A robot array that crawls through a strawberry field, on the other hand, can be much smaller, since it also moves much slower” A shot in the dark—Nighttime applications of ultraviolet light show promise for powdery mildew control. In an exemplary embodiment, such a system is fitted with a scattering generator to increase the fluence to surfaces in shadow. Using the example in the article about vineyards, scattered UVC (or other) can be directed at any part of a grape plant, including vines, leaves, fruit, etc. that are susceptible to grapevine downy and powdery mildew. See also US20200134741 Controlled Agricultural Systems and Methods of Managing Agricultural Systems, U.S. Pat. No. 8,299,445 Lighting apparatus for controlling plant disease, U.S. Pat. No. 9,867,894 Germicidal apparatuses with configurations to selectively conduct different disinfection modes interior and exterior to the apparatus.

Photosynthetic—this has been discussed elsewhere herein.

Fruit ripening/other—“The positive effect of LED lighting on the acceleration of ripening in bananas was greatest for blue, followed by red and green. Under the irradiation of LED lights, faster peel de-greening and flesh softening, and increased ethylene production and respiration rate in bananas were observed during storage. Furthermore, the accumulations of ascorbic acid, total phenols, and total sugars in banana fruit were enhanced by LED light exposure.” Effect of LED irradiation on the ripening and nutritional quality of postharvest banana fruit. “Researches have shown that UV-C could induce resistance of fruit and vegetables to postharvest spoilage as well as delayed the ripening process for extending the shelf life [32]. Further UV can induce bioactive compound production (polyphenols, anthocyanin) in fruits [33]. Moreover, when used at an ideal level, UV-C light induces systemic acquired resistance or buildup of phytoalexins to prevent further invasion [34]. Most likely, that play a major role in the disease resistance of many plant systems and activates genes encoding to produce pathogenesisrelated proteins [35, 36].” Postharvest Ultraviolet Light Treatment of Fresh Berries for Improving Quality and Safety.

There may be some applications where a spatial intensity gradient is desirable. For example, when illuminating the undersides of leaves in a vineyard at night, from an energy perspective, it only makes sense to cast the illumination at leaves and not the open areas adjacent to the leaves. Thus, in one exemplary embodiment, an array of LED illuminators is mounted on a robot, where a camera is used to turn on only those LEDs in the array that will illuminate a leaf. The LEDs can be statically mounted in a flood-type arrangement, or groups of LEDs can each be mounted on a computer controlled gimbal. In another exemplary embodiment, multiple LED groups direct their beams towards one target, while single LED groups each irradiate unique targets.

Note that the source of wave energy (e.g., UV source) and the source of scattering particles can be collocated, or they can be separated, and their deployment can be coordinated or not. Coordination can be tightly controlled or quite loosely controlled via wire-based links (e.g., USB, ethernet, etc.) and/or wireless links (Bluetooth, WiFi, LiFi, etc.), i.e., communications channels. For example, on a farm, prevailing winds may make it difficult to precisely direct the scattering field, and in such circumstances the scattering field may simply ‘flood’ the target zone. In another embodiment, if winds are too strong, a more tightly controlled system may employ denser scatterers whose scattering performance is adapted by adjusting the wave energy beam(s) and/or relative locations between the sources of illumination and scattering. The projecting elements for the wave energy and the scatterers each may be gimballed for best coordination. The system may also deploy one or more reflectors in the far field to redirect wave energy that misses the target back towards the target(s). Alternatively, some wave energy may be focused at a reflector in the far field such that the scattering field is illuminated from such a vantage point (in addition-to or instead-of illumination without the use of the reflector). A target may also include a reflector (diffuse and/or specular) to aid in the backscatter of wave energy. Multiple systems can be deployed with their efforts coordinated by communication with each other and/or through a common agent. An exemplary agent can be one or more computers adapted/programmed for such purposes (local or cloud-based), and/or one or more human technicians.

Now, the geometry of surfaces in shadow can be predictable (e.g., HVAC coils) or unpredictable (e.g., the undersides of leaves in a vineyard fluttering in the wind, the daily changes to leaf arrangements in a greenhouse, or a random arrangement of equipment in a hospital room). The aerodynamics of a given application may allow for a static setup or may require robotic/human articulation for the dispensing of scattering particles and/or the UVC. The scattering angles required for a given application may suggest a single-sized collection of scattering particles or multiple sizes (either together or via consecutive applications), or even a pass without any particles, where the application of particles is only used for specific locations (and specific conditions). The size of the particles (their distribution in space, etc.) will determine the degree of forward/side/backscattering. The desired amount of each can be determined for a given application. Also, the proportions between one or more of forward/side/backscattering can also be used as part of the feedback system for determining dosage and/or adjusting the application conditions. These proportions can also determine the shapes of scattering particles (e.g., if they are deforming from spherical due to local conditions). Spherical beads can be used to calibrate the system. So, if the system is designed/characterized based on spherical scatterers, the change to non-spherical shapes will impact the dosages, as the proportion of forward/side/backscatter will change.

A preferred simulation strategy would start first with simple geometric embodiments. For example, parallel surfaces, then various parametrically-defined curved and polygonal surfaces, pinched surfaces—all of various aspect ratios (depth/gap). This is similar to how turbulence and pressure drop are characterized for various plumbing elements. In fact, turbulence and pressure drop are calculations that are helpful in the instant invention in order to understand how the media and scattering particles flow around the target surfaces. Similarly, data used for insecticide foggers (including electrostatic versions), e.g., application variables as a function of crosswinds, serve as one of the baselines for inputs to the simulations and real world tests. Ultimately, for surfaces in shadow, the goal is to get scattering particles near the surfaces so that the UVC rays can find a path to the surfaces which would be impossible (or of such low dosage) otherwise. Note that the above approach is applicable to both gaseous and liquid media, e.g., water-bubbles-in-air and air-bubbles-in-water. The simulations should be run based first on spherical particles, and then on various degrees of non-sphericity based on characterization during testing (or simulation). Also, key to the approach is determining whether the appropriate dosage has been delivered, which includes selecting the type of feedback elements and their location for use in a control system. For example, COMSOL simulations may show that over the range of input conditions, one or more (important) locations may receive the lowest dosage compared to all other locations. Therefore, placing feedback elements at these locations (e.g., a wireless UVC sensor in a vineyard supplied power by a solar panel and battery system) ensures that once this sensor meets the dosage requirements, all the other surfaces meet the requirements as well. In another embodiment, the system has an attached wand element that is used to sense dosage in the far field. Other feedback elements, such to measure atmospherics (wind speed, humidity, temperature, etc.) can also be wirelessly located (indicating the best conditions for application and/or aiding in the configuration of adaptive systems) or attached to the illumination or scattering system(s). The scattering field also needs to be statistically predictable so that dosages can be reasonably assured by providing a consistent range of angles from the scattering field. While an appropriate amount of scattering can be obtained with a very narrow depth of a given concentration, it may also be appropriate to use a deeper field with an adjusted concentration to result in about the same level of performance (which may also require an adjustment to the illumination conditions). From a physics perspective, a deeper field would have higher entropy than a narrower field, and so the deeper field would have more available microstates and so be a more favorable (stable) configuration. Note that the above methodical approach is much different than simply injecting CO2 bubbles (water medium) based on the hope that e.g., within a range of bubble diameters from 1 to 100 microns some level of performance will be met.

In an exemplary embodiment, the fog field is modified after its emission into space (e.g., a room, a greenhouse, a vineyard, etc.), e.g., via one or more streams (e.g., fan-shaped streams, cylindrical streams, etc.) of clean, dry compressed air, so that there is one or more clear paths through the fog to allow the UV beam to travel farther into a room before reaching the scattering fog, thereby increasing the UV intensity at select locations in the far field. Alternatively, the fog field can be generated with gaps, e.g., linear stripes, or circular rings. These fields can also be scanned across the targeted surfaces in various patterns, e.g., zig-zag, epicyclic, random, etc. As an aside, note that different aerosols can be utilized at the same time (or in some temporal order) e.g., one with more forward, side, and/or backscattering than another. Air streams can also be used to increase the stochastic nature of the process, increasing the chances of irradiating surfaces in shadow that were previously missed. Note that flow changes are contemplated based on positive pressure, negative pressure, and alternating positive/negative pressures.

As mentioned, the scattering approach can also be used in other horticultural applications, such as in stimulating incremental photosynthesis.

In a simple embodiment, a single UVC LED (˜280 nm) or array thereof and a single ultrasonic mesh atomizer are combined to form a modular unit to disinfect surfaces in shadow. In a second simple embodiment, red (˜660 nm) and blue (˜450 nm) LEDs (see e.g., the Horticulture Reference Designs from Cree, Durham, N.C.) are used with a small array of ultrasonic mesh atomizers (and the necessary aerosol shapers/mixers/directors) to stimulate plant growth including leaves in shadow. Note that to help the penetration of light into surfaces of shadow, the aerosol can be directed in a strong puff to move the surfaces (or the hood can be equipped with an evacuation feature that first evacuates some of the air adjacent to surfaces in shadow after which the evacuation is stopped and the aerosol is then directed into the shadowed surfaces, somewhat akin of what is discussed in the evacuation/filling cycles of steam sterilization (CFD investigations of steam penetration, air-removal and condensation inside hollow loads and cavities, CFD simulation of the inactivation of Geobacillus stearothermophilus on dental handpieces), also contemplated for the instant invention with respect to multiple dry fog scattering cycles). A strong puff of air can be used to separate surfaces before the application of the aerosol. For example, in the case of plant leaves shading each other, the effects (positive like increased light interception and mass transport, and negative like leaf/branch damage) of air flow (e.g., from a leaf blower) to separate leaves must be considered. See e.g., Review—Wind Impacts on Plant Growth, Mechanics and Damage and Foliage motion under wind, from leaf flutter to branch buffeting. Note that the aerosolized water can be a mixture of ‘dry’ and ‘wet’ particle diameters depending upon how much wetness (if any) needs to be transferred to the plants. The scattering of light is more strongly influenced by the smaller diameter ‘dry’ aerosols, and so much larger diameter ‘wet’ aerosols can be present without a significant change to the scattering characteristics (see the single particle Mie scattering of the 0.5μ and 5.0μ water droplets herein). Of course, using the smaller diameter wet particles, it may be possible to sufficiently scatter light depending upon its wavelength without resorting to aerosolizing dry particles as well. Certain aspects of these concepts, as applicable, can be scaled to larger sizes (e.g., crates, rooms, tunnels, greenhouses, vineyards, etc.).

Purging aerosols before/after irradiation/disinfection—In an exemplary aerosolizing system, a first air mover is used to aerosolize e.g., distilled, or deionized water (that may be treated with surfactants, disinfectants, etc.). The source air (e.g., from a compressor) may or may not be filtered depending upon the system requirements. Exemplary reasons for filtering include (a) the degree to which UVC is more efficiently coupled to the aerosol with pre-filtered air, (b) the degree to which the aerosol particles have less absorption with pre-filtered air, (c) the degree to which the aerosolizing generator works more efficiently with pre-filtered air, and (d) dust removal to avoid clogging the fine particle filtering used for evacuation after irradiation/disinfection as described below.

Prior to aerosolization/irradiation, the air may be evacuated/filtered to a predefined degree to enable particles to better penetrate cracks and crevices. Also, after the irradiation/disinfection, any remaining aerosolized liquids may be evacuated (similar to that cited in Altapure AP-4 specification sheet for a standalone system, by pulling through one or more fine particle HEPA-type air filters by a (high volume) secondary air mover (e.g.,) to remove aerosolized particles within a desired range of sizes, which is a function of the filter's size rating (similar to what is found in an HVAC system in a building or on an airplane). The air mover must be sized for the flow rate required in accordance with the evacuation time requirements, accounting for the filter's pressure drop that increases as more particulates are trapped. In order to reach the desired filter efficiency, the air in a given room may need to be turned over a number of times. See the overall discussion of air filtering re: COVID-19, including MERV, HEPA, and ISO 16890 ratings, e.g., in Evaluating and Reducing the Risk of Airborne COVID-19 Infection Indoors. The article discusses in detail the effect of particle sizes in the transmission of the SARS-CoV-2 Coronavirus (or any similarly-sized pathogen), including the effects of vortices and eddies in air movement.

It is also important to note that e.g., a surface disinfection system according to the instant invention will also have a remedial effect on airborne pathogens since UVC travels through the air (more generally, travels through the media, be it a gas like air, or a liquid like water). According to the above-referenced article, aerosolized SARS-CoV-2 Coronavirus within droplets having aerodynamic diameters between about 1μ and 10μ are the most effective for transmission (the virus itself is <1μ).

Particles (aerosolized droplets contain the virus) between 1μ and 10μ in diameter are larger than the ˜0.28μ wavelength of UVC light, and this is important for multiphysics simulation purposes to understand how an entrained virus (or collection thereof) is irradiated within the droplet. Certainly, a more homogeneous irradiation field (resulting from a scattering field of the instant invention) has a greater likelihood of intercepting a virus-laden droplet, especially for those droplets buoyed for long times, e.g., by eddies created by vortices from an HVAC system in a room or on an airplane (see FIG. 1 of Evaluating and Reducing the Risk of Airborne COVID-19 Infection Indoors).

The evacuation system cited above can also be fitted with a UVC irradiation system to further reduce the number of aerosolized pathogens (in addition to trapping by the fine particle filtering). Such a system can be enclosed within a chamber of the device, e.g., using PTFE, a diffuse reflector material known to be very highly reflective of UVC, such as Gore DRP material (DRP Literature (Gore), W. L. Gore & Associates, Inc., Electronic Products Division, Newark, Del.). Of course, such a highly reflective surface must be kept clean to maintain its high reflectivity. In fact, maintenance is a necessary element to ensuring consistent process intensification, thus the need e.g., for periodic filter and lamp replacements used to treat gases and liquids. See e.g., An Evaluation Of Ultraviolet Germicidal Irradiation (UVGI) Technology In Health Care Facilities for a discussion on maintenance of an UVGI air filtration system. “Fixtures need to be designed to allow easy cleaning and maintenance of louvers, lamp, ballast, and reflector” (Maintenance Of Upper-Room Germicidal Ultraviolet (GUV) Air Disinfection Systems For TB Transmission Control)

Note that the purging/evacuation of aerosols via filtering also helps filter the air of pathogens/toxins that have been aerosolized. Filters, like N95 masks, can be irradiated to disinfect so long as the filter material does not quickly degrade under the necessary irradiation.

“The challenge to effectively sterilize dental handpieces lies in their construction with geared or turbine drive mechanisms and lumens (0.9-2.3 mm diameter) carrying air and water that restrict access for cleaning and steam ingress for sterilization. The European standard for benchtop (tabletop) steam sterilizers (4) describes three different processes by which these benchtop machines can remove air to allow direct access of saturated steam to the surfaces of surgical instruments. Type N, which is a non-vacuum and passive air displacement process, type B and S, which achieve air removal using fractionated pre/post-vacuum phases and special cycles, respectively. Manufacturers of both sterilizers and dental handpieces recommend that this equipment be sterilized using a vacuum process, (for example, instructions for handpiece sterilization (5) and benchtop steam sterilizers (6)). Non-vacuum sterilizers are still widely used Worldwide (7,8) and in the UK (9,10)” Failure of non-vacuum steam sterilization processes for dental handpieces. By analogy, in one exemplary embodiment of the instant invention, a vacuum is used to remove air prior to the injection of the dry fog scattering droplets. The dry fog thus fills the micro/macro-sized voids, and thus enables the dry fog to be in the field of view of microbes, providing a path for scattered light to travel between source and target. As in some steam sterilization systems, the evacuation/filling cycles can be performed multiple times to increase the disinfection of a given set of objects. See also the steam sterilization references cited herein (includes CFD simulations). Note that the optimal amount of air removed (the degree of the vacuum) in one exemplary embodiment is determined via one or more of simulation and testing. Lesser vacuums result in shorter evacuation times that lead to higher factory throughputs. Deeper vacuums may lead to increased dry fog droplet impingement velocities, which must be balanced vs deeper penetration into the voids.

Applications—photodissociation, photocatalysis, and dosing

With respect to the photodissociation (also known as photolysis, photodecomposition, and photodegradation) of chemical pollutants, instead of citing UV dosage, the UV intensity is related to a chemical reaction (degradation) rate (Calculating photolysis rates and estimating photolysis lifetimes, Rates of Direct Photolysis in Aquatic Environment). The reaction rate can be linear or non-linear with intensity (Decomposition of Inorganic Fulminates).

In the case of photocatalysis, in otherwise favorable conditions, the conversion rate is linear with intensity to a threshold value, after which the rate varies as the square root of the intensity (Basic Principles, Mechanism, and Challenges of Photocatalysis).

Proxy illumination and light sources—Given the citation of the light proxy above, it should be noted that the scattering field can be illuminated by a proxy visible light so that the operator has a sense of how well the targets are illuminated by the functional irradiation source(s), which are often invisible, such as a UVC light, ultrasonic waves, or electron beams. Of course, the scattering angles are dependent upon wavelength, so this must be considered when using proxy illumination, i.e., 532 nm green laser light scatters differently than 445 nm blue laser light and 280 nm UVC light.

In an exemplary, a proxy illumination feature is added to the UVC scattering system of the instant invention. Two visible light laser pointers serve to inform the operator of the distribution of scattered UVC rays (since UVC is invisible). In one embodiment, the laser turns off prior to the generation of the scattering field if (a) backscatter would be dangerous to the operator, (b) the scattered laser light would not be visible, (c) to conserve power. In another embodiment, the lasers are fitted with holographic/diffractive alignment pattern generators to project markings on the target(s). In yet another embodiment, each UVC source is paired with a visible source of the same beam geometry in order to provide feedback more accurately to the operator (human and/or robotic).

The system comprises a computer controlled scattering field generator that emits a field of appropriately sized scatterers. The field is projected based on certain spatial/temporal limits. The reference beams are laser pointers.

The brightest laser pointers are said to be green, operating at 532 nm (Laser Pointer Color Differences—Brightest Burning) and are available e.g., from Berlin Lasers (dba Berlin Optic (HK) INT'L Group Limited, Kowloon, Hong Kong; see 532 nm Green DPSS Laser Diode Module, Green Laser Modules Berlinlasers) and with predefined alignment patterns from Laserglow Technologies (Toronto, ON, Canada; see Laserglow Technologies Industrial & Scientific Lasers Laserglow). Note that 445 nm blue lasers are available in higher powers, but the eye is less sensitive to blue than green, and safety is an issue with higher power (Laser Pointer Safety—Different lasers' hazards compared).

In one embodiment, the laser pointer and UVC sources are set at fixed angles relative to the large scattering field. This is suitable for a handheld device. Other embodiments can be constructed for operation over a range of angles, available via mechanically turning a knob or via an adaptive motorized solution. See e.g., U.S. Pat. No. 8,025,428 Assembly of light emitting diodes for lighting applications. Note that the LEDs can be rotated as a group, or a rotatable mirror can be inserted in the optical path. Given that UVC mirrors are somewhat lossy, the rotation of the LED array is a preferred embodiment with the proviso that the LED heatsinking is not compromised.

Various source configurations are contemplated to aid in uniform illumination and shadow minimization/elimination via multiple light sources, ring lights, projectors, under leaf lighting, LEDs, and adaptable LED arrays.

Windows—The window protecting the LEDs (or other sources) must maximize transmittance (to the extent practical) for the relevant wavelengths and must have the appropriate hardness and environmental qualities (temperature range, sealing, etc.) as needed for the application. Further, for some applications, the window must remain clear of foreign objects and debris (FOD) and fog. An example of such for EM waves is an airstream as discussed in US20160166138 Image pick-up window defogging function-equipped built-in camera hand piece. In other exemplary embodiments, the window is ‘coupled’ to the system to ensure maximum throughput.

Continuous steady illumination, temporal/spatial gradients—In some instances, there may be an advantage of pulsed illumination over continuous (Enhanced inactivation of E. coli by pulsed UV-LED irradiation during water disinfection, Comparative disinfection efficiency of pulsed and continuous-wave UV irradiation technologies, An Approach to Standardize Methods for Fluence Determination in Bench-Scale Pulsed Light Experiments).

Also, there may be some applications where a spatial intensity gradient is desirable. For example, when illuminating the undersides of leaves in a vineyard at night (Robots Armed with UV Light Fight Grape Mildew), from an energy perspective, it only makes sense to cast the illumination at leaves and not the open areas adjacent to the leaves. Thus, in one exemplary embodiment, an array of LED illuminators is mounted on a robot, where a camera is used to turn on only those LEDs in the array that will illuminate a leaf. The LEDs can be statically mounted in a flood-type arrangement, or groups of LEDs can each be mounted on a computer controlled gimbal. Such gimbals (including systems with gyro stabilization) are available e.g., from Merio (Saint-Restitut, France).

In another exemplary embodiment, multiple LED groups direct their beams towards one target, while single LED groups each irradiate unique targets.

Beamforming—In various embodiments, the irradiation beam(s) is/are constructed to scatter light most effectively through the scattering field to the target(s). As cited, exemplary embodiments include the formation of beams into streams (narrow beams), showers (wide beams), rings (annular beams), sheets (linear beams), etc. Beamforming optics include lenses, lens arrays, lenticular arrays, reflectors, holographic/diffractive elements, etc. Such devices are available, e.g., from Edmund Optics Inc. (Barrington, N.J.) and Thorlabs (Newton, N.J.), including custom designs via their application staff. Off the shelf and custom UVC reflectors are available from uv-technik international ltd (Luton, Bedfordshire, United Kingdom). Custom UVC lamp/reflector systems are available e.g., from American Air & Water®, Inc. (Hilton Head Island, S.C.). Molded LED reflectors are available from OSA Opto Light GmbH (Berlin, Germany; see Research realizes innovation in fabricating reflective coatings for high-power UV optics (MAGAZINE) LEDs Magazine). More on wave energy sources and beamforming can be found in the '071, section 16.1.10. Illumination sources and beam forming.

Feedback re: light sources—Other embodiments use sensor feedback to determine distance to the targeted surface and then automatically adjust the angles. For the distance measurement portion, see e.g., the use of a laser pointer in U.S. Pat. No. 8,138,938 Hand-held positioning interface for spatial query, and simply a camera in U.S. Pat. No. 8,467,579 Apparatus and method for estimating distance and position of object based on image of single camera. The fields of laser trackers, ballistic targeting systems, and drone camera gimbals are well known in the art and can be adapted for use in the instant invention. Processed data then controls custom computer controlled gimbals (including systems with gyro stabilization) that are available e.g., from Merio (Saint-Restitut, France) and top-tier drone manufacturer DJI (Nanshan District, Shenzhen, China). Laser trackers and object scanners are available from Automated Precision, Inc (Rockville, Md.), “API's RAPIDSCAN ultra-high dynamic range, 3.2 mega-pixel, stereo imaging, hybrid optical sensor captures a 3D point cloud of the part within its large field of view.”

An exemplary feedback approach for the operator is to visibly illuminate the scattering field so that the operator can see the extent of the 3D field, thus providing an understanding of what is being illuminated with the invisible UVC field, and then adjusting the position of the scattering UVC system accordingly. In one exemplary embodiment, each UVC emitter can be mechanically coupled with a visible emitter of similar beam characteristics.

The use of cameras to detect particle/fog uniformity, including use of tracer particles are discussed in Development of a High Irradiance LED Configuration for Small Field of View Motion Estimation of Fertilizer Particles, The effect of spray volume and quality on handgun delivery of pesticides to greehouse plants, Analysis Of Optical Density Of Electrostatic Spray On Apple In Winter And Summer Season, Optimization of spray application technology in ornamental crops, Tracer techniques for the comparison of sprayer performance. Tracer particles (e.g., fluorescent) can be used as is known in the art of fogging systems as in order to understand the distribution of aerosols at a target site (e.g., a crop plant).

Automated arm-mounted UV disinfection robots are available from Enabled Robotics ApS (Odense, Denmark), “UVx1 is an automatic UVC light solution designed for disinfection of bacteria and virus hotspots . . . . The UVx1 is supplied as an application kit for direct and easy fit on your ER-LITE or ER-FLEX robot . . . . The ER-FLEX is a robot series which is optimized for easy changing of applications on the robot. You can easily change hardware and fixtures to customize it for almost any application in your environment . . . . The ER-ONE Dynamic Position System enables easy calibration between the robot and markers in the environment.” In an embodiment, the above system is also fitted with a dry fogger, or if desired, coordinates with a dry fogging robot (water-only or with disinfectants) such as the Sherpa-BD and Sherpa-W from Sherpa Mobile Robotics (Haguenau, France), “SHERPA MOBILE ROBOTICS joined forces with DEVEA and developed an autonomous and certified disinfection system. Resulting from a collaboration between two renowned industrialists, . . . Based on the virucidal process certified NFT 72-281, this disinfection robot combines the advantages of SHERPA® robots (autonomy, safety, versatility) and the proven DEVEA disinfection process (centrifugation, DRY fog diffusion, microbiological disinfection).” DEVEA (Saint-Étienne-de-Montluc, France). Custom integration and software development for mobile robotics is available from Fresh Consulting (Bellevue, Wash.), “Autonomous mobile systems come in all shapes and sizes, from wheeled to walking robots, drones, and even large industrial vehicles. The robotics team at Fresh has worked with them all. Whether you are building something custom, looking to modify something for autonomous activities, or need an engineering audit of your existing system, our team can help.”

Geometric relationships between nozzle/illuminator/sensor, feedback and dosage control—A fluid scattering field can be thought of as a stochastic system, and therefore determining that minimum dosages are achieved without overdosing is important. For example, scattering clouds can be affected by environmental factors like ambient airflow/wind.

An exemplary feedback approach would be to extend sensor-stalks out a distance from the nozzle, where each stalk measures the intensity at a given angle in a location close to the target(s). Ideally the number of sensors is minimized to meet dosage/throughput requirements at minimal cost and maximum reliability.

Alternatively, a wireframe structure made of reflective material (e.g., Teflon for use with UVC) can be extended out a distance from the nozzle, and a sensor array adjacent to the nozzle can estimate the intensity in the far field. The size of the structures extending from the nozzle should be minimized to ensure sufficient flow of particles and adequate irradiation.

Another exemplary approach measures backscatter as a proxy for the forward scatter component.

In yet another exemplary approach, the system is designed for close operation to the target(s). If handheld, a wand-like structure (like that used on some fogging systems found in the references herein) can propel the scatterers close to the targets, and the illuminators can be mounted at predefined locations between the handgrip and the end of the wand. One version would have the illuminators at the end of the wand surrounding the nozzle(s), and in another version a light guide (e.g., UV grade fused silica rod) would transmit the light (UVC and any visible proxy light) to the end of the wand where an optical arrangement is attached to distribute the light as desired. Different optical attachments can be used for predefined beam patterns, just as different nozzles can be used for predefined scattering field geometries, forming a modular device.

In all instances, the feedback can be used to adjust the illuminator(s) and/or the flow characteristics of scattering particles to ensure proper dosage. Further, the device can provide feedback to the user as to the relative speed between the system and the target(s) since dosage is the product of intensity and time. A display on the system can depict the nozzle in the center, and an annular zone (for radial movement) or rectangular zone (for lateral movement) around the nozzle that indicates whether the relative speed is appropriate in the direction of movement. For example, consider an electronic version of a ‘Bull's Eye Circular Level’, where the bubble shows radial velocity relative to zero when the bubble is centered. To ensure proper dosage, the radial velocity indicator must be within a certain annular region. Another analogous display would be a helicopter's hover indicator such as that disclosed in US20060238377 Integrated hover display with radar altitude predictor for indicating height above ground. Audio and/or haptic feedback can also be provided in addition to visual indicators. See e.g., Audio-Haptic Feedback in Mobile Phones.

In any event, the intensity can be adapted for motion that is too slow (by dimming the irradiation) but cannot adapt to movement that is so fast that the highest irradiation power cannot provide adequate dosages.

Determining relative speeds between a stationary irradiation source and a food article on a conveyor belt is trivial, but in order to determine the relative speed in a portable arrangement is more complex.

On mobile phones, GPS is often used to determine speeds, although its positional accuracy has been measured between 7 and 13 meters in an iPhone 6 in an urban environment (Smartphone GPS accuracy study in an urban environment), and since speed is distance divided-by time inaccuracies in position lead to inaccuracies in speed. One can also use range sensing (Active and Passive Range Sensing for Robotics) to determine distance and then calculate speed from changes in distance over time. A number of other methods can be used to estimate speed (velocity), e.g., signal strength (Vehicular Speed Estimation using Received Signal Strength from Mobile Phones), transit time (Grain Velocity Measurement with Optical Sensors and U.S. Pat. No. 4,685,093 Speed measurement device), inertial sensors (Bat Swing Analysis in Cricket, Low Cost Inertial Sensors for the Motion Tracking and Orientation Estimation of Human Upper Limbs in Neurological Rehabilitation) and others like cameras, LIDAR, and radar (A New Velocity Meter based on Hall Effect Sensors for UAV Indoor Navigation)

Target power received at a given location—The power received at a target location when transmitted from a UVC source a distance away through a scattering path data can be modeled by using the Non-Line-Of-Sight (NLOS) algorithms, e.g., the multiple scattering Monte Carlo mathematics found in Modeling and Characterization of Ultraviolet Scattering Communication Channels. See also the MontCarl scattering program cited previously. In UVC NLOS, as cited earlier, a transmitter sends UVC rays at certain angles through a scattering media (e.g., fog), and the receiver monitors a certain range of angles outside of the line of sight direction with the transmitter. The rays from the transmitter will be redirected by one or more scattering particles, with some amount of transmitted energy finding the receiver. The parameters that affect the amount of power received include the transmit ray angles, the receiver's field of view, and the scattering and absorbing properties of the thickness of the intervening media. The Monte Carlo mathematical modeling is based on the probabilities of rays from the transmitter finding the receiver's field of view. The media is modeled using extinction coefficient comprising absorption and scattering losses. Now while the NLOS data in the citation is based on datalink-type distances of 10 meters or more, the instant application of UVC disinfection would generally be less than 30 cm (0.3 meters). Over such distances, UVC absorption losses in air, water, and UV-grade quartz are used for the simulations. Note that air absorbance is negligible, and water greatly depends on its purity, where ultrapure water absorbance is also negligible. Scattering losses (rays never reaching a target) of course, will be a function of the geometry between source and target and scattering particle size(s)/density. Note that for UVC disinfection, the scattering losses can be minimized by using a collimated source and illuminating an array of closely-packed targets.

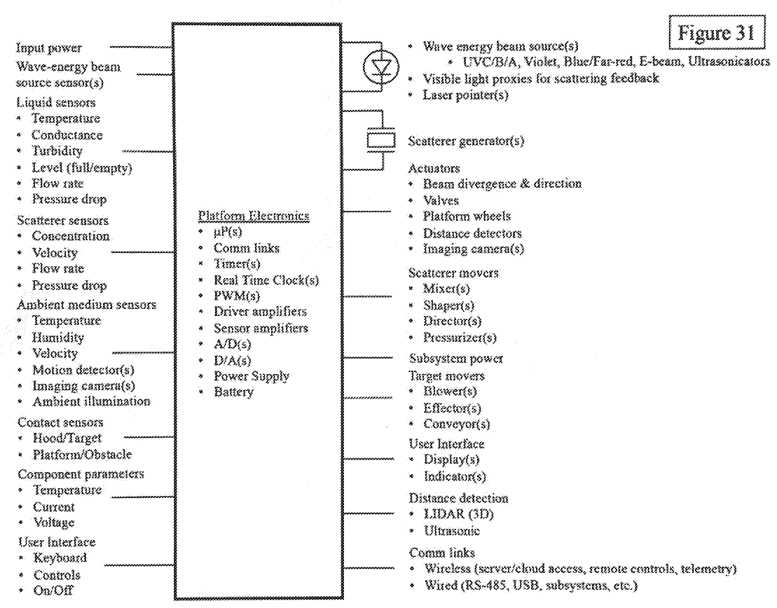

Functional elements of the block diagram—the block diagram in FIG. 31 only cites the major functional elements necessary for operation. Note that some input parameters may be inferred from other parameters, thereby removing the need for one or more inputs. Similarly, some output peripherals may be unnecessary given the effects/capabilities of other peripherals. As is tradition, inputs are shown on the left, outputs on the right. However, note that some inputs require outputs for measurement, e.g., a keyboard matrix is typically scanned using digital outputs to activate one row or column at a time that is then measured by digital inputs. Similarly, some output peripherals employ feedback elements that are not referenced on the block diagram, e.g., a platform wheel for a robotic system will typically use one or more sensors to determine wheel speed. Thus, arrows are not used to avoid confusion.

Inputs to the block diagram:

Input power—wall plug power (US and/or international power)

Wave-energy beam source sensor(s)—used to detect intensity of the beam source(s) at the output of the platform and/or in the far field. Used also to measure the scattering properties (using e.g., on-axis/off-axis techniques described e.g., in Gustav Mie and the fundamental concept of electromagnetic scattering by particles—A perspective and Light and Photosynthesis in Aquatic Ecosystems, ISBN 978-0-521-15175-7).

Liquid sensors—the liquid is either the feedstock for aerosols or the medium e.g., in water disinfection.

Temperature e.g., determine its influence on particle size in aerosols.

Conductance (electrical) to determine the quality of deionized water when used as the source of the aerosol or e.g., if electric fields are used as a complementary treatment non-photochemical/photophysical modality with kinetic effects for water disinfection.

Level (full/empty) to inform the operator if filling is required or must cease for aerosols, or if there is water flowing for water disinfection applications.

Turbidity “is a measure of the degree to which the water loses its transparency due to the presence of suspended particulates. The more total suspended solids in the water, the murkier it seems and the higher the turbidity. Turbidity is considered as a good measure of the quality of water” (Turbidity (Lenntech)). For aerosols turbidity can effect particle size, and in both surface and water disinfection turbidity adds absorption and therefore affects fluence/dosage.

Flow rate sensors e.g., for aerosols can help indicate the conversion rate of liquid into aerosol and pressure drop sensors can help determine whether there are potential clogs in the system. For water disinfection, these sensors provide a necessary input to determine dosage. Scatterer sensors—concentration is a key parameter for estimating scattering, and multiple measurements of concentration can be used to determine the uniformity of the scattering field.

Velocity measures the speed and direction of the scattering field, whether due to the influence of gravity/buoyancy or added scatterer movers. All of these sensors can be measured in the near field where they are generated and the far field adjacent the target(s).

Flow rate and pressure drop e.g., assist in the control of pressurizer(s) that are used to force aerosols into surface depressions. Note scatterers include air bubbles in water, water droplets in air, powders in air/water/oil, etc.

Ambient medium sensors—temperature and humidity to determine the effects e.g., on an aerosol scattering field; motion detector(s) can be deployed as a safety to stop operation if a person/animal is detected in the irradiation zone; imaging camera(s) e.g., to detect targets and obstacles or in support of characterizing the scattering field, ambient illumination e.g., if illuminating foliage in the dark as cited e.g., in A shot in the dark_Good Fruit Grower.

Velocity is especially important in outdoor applications like on vineyards (i.e., wind speed) and can be measured in the near field and at different locations between the near field and the target. This will assist in control of the aerosol movers, e.g., measured before aerosolization.

Contact sensors—the Hood/Target to determine e.g., if a surface disinfection platform's hood (if used) has contacted the target if required as an interlock, and Platform/Obstacle for a robotic application that senses movement cannot continue along the current path.

Component parameters—sensors to measure temperature, current, voltage as needed to control the light beam source(s) and/or Droplet/bubble generator(s) at their highest efficacy and prevent exceeding their targeted values. Also used during self-test and factory-testing of circuit and component compliance with requirements.

User interface—keyboard for inputting information, controls for manual operation (e.g., joystick for positioning effectors), and an on/off button.

Outputs on the Block Diagram:

Wave-energy beam source(s)—the target illuminators are those that effect change e.g., UVC, Ebeam and/or cavitation source (ultrasonic and/or hydrodynamic) for disinfection applications, blue and red light for horticulture applications, the visible proxies for scattering feedback (e.g., visible light with about the same beam profile using visible light sensors that may be more cost effective than e.g., UVC sensors). The laser pointer(s) is/are also a type of visible proxy (e.g., 405 nm violet from Arbor Scientific, Ann Arbor, Mich.), but due to its collimation it can provide feedback of the general direction of the irradiation. Note that the scattering of the target field is also characterized before injecting the scatterers in order to help characterize the scattering effect within the medium. Note also that the symbol on the block diagram is shown as a LED or laser diode, but it is meant to represent any applicable light source, e.g., including LPHO mercury and excimer lamps.

Scatterer generator(s)—the device(s) that convert either the liquid into aerosol (e.g., surface disinfection), inject bubbles into the liquid (e.g., water disinfection), or disperse powders. Note that the symbol on the block diagram is shown as an ultrasonic generator, but it is meant to represent any applicable scatterer generator technology (e.g., one or more pumps for a jet nebulizer).

Actuators—mechanical movers as required e.g., to change the beam direction and divergence, open and close valves for aerosols and liquids, provide platform locomotion via wheels for a robotic application, and pan/tip/tilt motion for distance detectors and/or imaging cameras.

Scatterer movers—devices to mix, shape, direct and/or pressurize the scatterers (e.g., the latter to push scatterers through an N95 mask).

Subsystem power—provide input power to a subsystem, e.g., a complete LIDAR device Target movers—blowers and effectors to move targets, e.g., to better illuminate surfaces in shadow like leaves on a grapevine or a fold in an N95 mask.

User interface— LCDs for complex information conveyance, and indicators for simple information like power availability, and caution/warning signaling.

Distance detection—determination of the objects/walls surrounding the platform to better control the illumination. Also enabling for robotic movement.

Comm links—wireless and wired links as needed to communicate within the platform (e.g., to a LIDAR subsystem such as the Intel® RealSense™ LiDAR Camera L515. See the Intel_RealSense_LiDAR_L515_Datasheet_Rev003, Intel, Santa Clara, Calif.) and to agents outside of the platform such as technicians, cloud services, etc.

The platform electronics includes the following main functional items (see the ‘Systems design and product development section’ for sources of supply):

Microprocessors/controllers—one or more μPs/microcontrollers/FPGAs to coordinate platform activity. It is contemplated that for complex systems, a combination of intercommunicating μPs and microcontrollers will be needed, whereas for simple systems a single microcontroller is anticipated.

Comm links—wired (e.g., RS-485, USB, ethernet, etc. to connect to the Carel systems, as well as other subsystems or a technician's console) and wireless (e.g., Bluetooth, Wi-Fi, etc. for connection to a technician's mobile device, an onsite server to coordinate activities of multiple platforms, the cloud for telemetry and/or control, etc.)

Timers and Real Time Clocks (RTCs)— typically found within μPs and microcontrollers, although may be external devices such as watchdog timers that are used in real time systems to ensure the system services tasks at the appropriate time and interrupt the system if it does not.

Pulse Width Modulators (PWMs)— also found within microcontrollers, useful for varying power levels to certain components, e.g., LED drivers.

Driver amplifiers—devices sourcing higher power than available from the small signal output of an analog or digital device. In many instances, these devices are specifically engineered to meet the unique voltage/current requirements of a peripheral and may include feedback and control loops, e.g., LED drivers, LPHO mercury lamp drivers, excimer deep UV lamp drivers, ultrasonic atomizer drivers, motor drivers, valve solenoid drivers, etc.

Sensor amplifiers—circuitry for conditioning/filtering the signal from a sensor and add gain to maximize S/N based on the full scale input voltage of the A/D.

A/D— analog to digital converters, often found in microcontrollers, of sufficient resolution to meet the system requirements.

D/A— digital to analog converters, often found in microcontrollers, of sufficient resolution to meet the system requirements.

Power Supply—filters input wall/battery power (and provides energy storage for short-term demands) and converts to the DC and AC voltages required by the platform components. Also used to create subsystem power feeds, if needed.

Battery—generally rechargeable (e.g., lithium ion) to provide sufficient energy storage for operation of one or more components over a prescribed period of time. For simple portable devices, the battery can provide all necessary power for the platform for a period of time before requiring recharging. A recharging system is also required and may be integrated within the power supply or provided, e.g., via a wall charger.

Note that most electronic, electromechanical and electrooptical components are available from one or more of Digi-Key Electronics (Thief River Falls, Minn.), Mouser Electronics (Mansfield, Tex.), and Arrow Electronics (Centennial, Colo.). Liquid and aerosol handling devices are generally recommended by the atomizer manufacturer or provided in consultation with their applications engineers.

This exemplary Block Diagram of FIG. 31 serves also as a template for other applications and sources of EM/EL/QP wave energy.

Control systems are also referenced in Feedback Control of Dynamic Systems (ISBN 978-0-13-349659-8), Sealpump Spray Technology for the Food & Bakery Industries (brochure), Carel humiSonic Compact Manual. Many other examples can be found in the provisional filings.

Overall Construction—As an exemplary application, the overall construction can be modeled e.g., after portable foggers. See e.g., U.S. Pat. No. 9,414,580 Heatless and cordless fogging/misting apparatus having a low CFM DC-powered blower motor and a mixing chamber for ultra-low volume atomized fog, US20190154406 Cold fogger, and U.S. Pat. No. 9,061,325 Automatic portable fluid dispersal device, U.S. Ser. No. 10/322,424 Electrostatic fluid delivery backpack system. These references show motors, blowers, case construction, battery systems, etc. Due to the irradiation involved, care must be taken when selecting materials vis-à-vis compatibility/degradation.

Applications (generically)—Note that applications span kinetic processes within/upon organisms and their parts (e.g., bacteria, viruses, fungi, and other microorganisms, whole plants, leaves, roots, flowers, fruits, even certain animals, etc.) and inanimate objects (e.g., chemical toxins, adhesives, etc.). Note that the term ‘organism’ will be used as defined in Organism—Wikipedia, “any organic living system that functions as an individual entity” where “Organisms are classified by taxonomy into groups such as multicellular animals, plants, and fungi; or unicellular microorganisms such as protists, bacteria, and archaea.” Improvements to the kinetic process may be the enhanced reduction in microorganisms on a surface portion of an object, the enhanced growth of a plant, enhanced material properties under e-beam irradiation, enhanced curing of a photopolymer-based 3D printed object, etc.

Bubbles in liquids—Bubbles can be generated in water in a number of ways, the most common being boiling, cavitation, and aeration. “Vaporous cavitation is an ebullition process that takes place if the bubble grows explosively in an unbounded manner as liquid rapidly changes into vapor. This situation occurs when the pressure level goes below the vapor pressure of the liquid. Gaseous cavitation is a diffusion process that occurs whenever the pressure falls below the saturation pressure of the noncondensable gas dissolved in the liquid. While vaporous cavitation is extremely rapid, occurring in microseconds, gaseous cavitation is much slower; the time it takes depends upon the degree of convection (fluid circulation) present. Cavitation wear occurs only under vaporous cavitation conditions—where the shock waves and microjets can erode the surfaces. Gaseous cavitation does not cause surface material to erode. It only creates noise, generates high (even molecular level cracking) temperatures and degrades the chemical composition of the fluid through oxidation. Cavitation wear is also known as cavitation erosion, vaporous cavitation, cavitation pitting, cavitation fatigue, liquid impact erosion and wire-drawing.” (Cavitation Explained and Illustrated).

The generation of micron and submicron diameter bubbles can occur via both cavitation and aeration. Cavitation introduces both benefits (advanced oxidation) and risks (erosion), depending upon the needs of a given application. Aeration has certain benefits as well “Nanobubbles are often defined as bubbles less than 200 nm in diameter. At this size, bubbles behave very differently than larger bubbles because they don't rise to the surface and burst. Rather, they remain in suspension and disperse, elevating oxygen levels throughout the waterbody. Nanobubbles also provide a mild-oxidant effect that has been shown to destroy algae cells and reduce algae toxin levels. These unique properties provide effective, chemical-free treatment for algae mitigation.” (Xcaret Case Study web (Moleaer))

“Moleaer's gas-injection technology produces trillions of neutrally buoyant, negatively charged nanobubbles approximately 100 nm in diameter. At that size, bubbles stay suspended in water for long periods of time, efficiently mixing throughout the entire water column. This enables the nanobubbles to transfer oxygen with greater than 90% efficiency while also increasing the oxidation reduction potential (ORP). The nanobubbles effectively oxygenate the entire body of water in warm temperatures independent of depth, providing a distinct advantage over other aeration methods.” (AWASA Case Study (Moleaer))

The advanced oxidation effects of aeration appears to be much less than via cavitation “The current study demonstrated free-radical generation from the collapse of microbubbles in the absence of a dynamic stimulus, such as ultrasound or large pressure differentials. The shrinking rate of the collapsing microbubbles was extremely slow compared with that of ultrasound-induced cavitation bubbles: the microbubbles collapsed completely over a time course of tens of seconds, whereas the cavitation bubbles collapsed within microseconds. The result of test 3 indicates that PFOS was not decomposed by the collapse of microbubbles, suggesting that neither pump movement nor microbubble collapse leads to substantial increases in temperature. Further, the shrinking speed of the collapsing microbubble is not sufficiently rapid to generate an adiabatic compression. It was therefore unlikely that the mechanism of free-radical generation by microbubbles was similar to that in cavitation bubbles—the latter being related to the extremely high temperatures caused by adiabatic compression during violent collapse. It is generally accepted that radical generation requires extreme conditions, such as high temperature. Here we offer an alternate theory, based on the accumulation of ions, to explain radical generation from collapsing microbubbles.” (Free-Radical Generation from Collapsing Microbubbles in the Absence of a Dynamic Stimulus, 2007)

Also as cited previously, aeration can be introduced in a liquid to affect cavitation. Aeration can form macro-, micro-, and nano-bubbles, with bubble diameters ranging from millimeters to nanometers, respectively. Thus, like fine water bubbles in air (e.g., fog), there exists the opportunity to scatter energy waves using fine air/gas/vapor bubbles in liquids.

Exemplary applications would be for cleaning the interior of pipes and vessels. In one exemplary configuration, the cleaning is performed without having to drain the pipe/vessel. For example, a plumber's snake-like device can be inserted into a system with a directional nozzle that forces bubbles onto the inner surfaces of a pipe or vessel in combination with UVC. Such a system would be useful e.g., to disinfect Dental Unit Water Lines (DUWLs). See e.g., Bacterial adhesion and biofilms on surfaces, Influence of material and tube size on DUWLs contamination in a pilot plant.

Ideally a system is configured with a permanent fitting in place of a cleanout plug so that a system need not be drained during cleaning. Such a fitting could be as simple as a gate or ball valve that is normally closed, and then opened for passage of the inventive system during cleanouts. Before opening the gate, the system attaches to a threaded section connected to the gate, where the fluid is prevented from spilling out of the pipe or vessel. The system retains the backflow of pressurized fluid within which the snake is retained. Once the snake is retrieved, the valve is closed, and the system is disconnected from the threaded section. A system for allowing cables to snake through pressurized pipes is taught in U.S. Pat. No. 6,736,156 Method and system for installing cable in pressurized pipelines.

At the end of the snake, micron-sized bubbles would be discharged while a UVC source irradiated the pipe/vessel. Since bubbles rise against gravity, a nozzle is required to jet the bubbles against all interior surfaces, however “Bubbles less than 1 μm diameter rise so slowly that the rate is not determinable. This is due to their random Brownian motion and their low buoyancy” (Nanobubbles (ultrafine bubbles)) “Submicron size bubbles or nanobubbles are gas bubbles of several hundred nanometers in diameter [14,18,23-26], usually a mixture of water vapor and naturally or intentionally dissolved gases [23,27]. It has been reported that such bubbles have a negligible buoyancy and would remain suspended in solutions for a considerably long period of time [14,18,24,25,28-30]. Najafi et al. [14] were able to generate nanobubbles which remained stable for several minutes, while Ushikubo et al. [31] reported that submicron size air bubbles and oxygen bubbles could be made stable for 1 h to 15 days. Zhang et al. [30] produced nano carbon dioxide bubbles and air bubbles which lasted for several hours and days, respectively. Other studies also showed bubbles stable in aqueous solutions for up to a few months [24].” (Generation and characterization of submicron size bubbles)

In another exemplary configuration, the pipe/vessel is depressurized and drained, and there may or may-not be some residual liquid along the bottom that does not drain. For fully drained systems, a low pressure fog can be used with a nozzle that directs the fog against all surfaces. If locations do not fully drain, a low pressure fog approach may not be able to penetrate the residual wetted surfaces. In such cases the inventive fogging system can be used by pressuring the fog (or other gas or liquid) to push-away any residual fluids, at least for a time sufficient to perform the cleaning operation. An alternative would be to use what is called a pipeline pigging system, wherein UVC and bubbling nozzles are arranged around the outer circumference of the pig.

Pigging systems with electrical cables are taught in U.S. Pat. No. 8,813,770 Pig assembly and method for maintaining a functional line for conveying fluid, U.S. Pat. No. 8,805,579 Submersible robotically operable vehicle system for infrastructure maintenance and inspection. Pigging and cable-pulling systems with batteries are taught in U.S. Pat. No. 7,360,752 Apparatus and method for installing lines in conduits, U.S. Ser. No. 10/567,090 Use of high speed radio frequency protocols for communication with pipeline pigs and inspection tools. UVC disinfection systems for use within a pipes and vessels are taught in WO2019178624A1 Device for disinfecting pipelines, containers and structures (comprising a fogging feature in addition to UV), U.S. Pat. No. 9,044,521 UV sterilization of containers (citing UV scattering due to water droplets).

Application—photobioreactors—By introducing bubbles of the appropriate diameter, more even illumination conditions can be created, especially for the initial growth phase of photosynthetic eukaryotic organisms like algae. Algae themselves scatter light, and so as the concentration increases, their own contribution to scattering must be considered. One exemplary approach is to change the bubble sizes as the bloom matures, so that the illumination uniformity can always be at the best possible level for a given tank geometry. For example, in the beginning, a smaller bubble size is used to provide a higher degree of scattering, and as the bloom matures, larger bubbles are introduced that have more directional scattering. In order to optimize the growth phases, e.g., COMSOL simulations and testing must be used to balance the scattering within the tank to achieve the proper illumination conditions. It may also be suitable for the organisms to be ported to a different tank geometry (or features inserted-into and/or removed-from the existing tank) as their contributions to scattering increases.

Application—disinfecting the surfaces of medical devices using UVC+bubbles—bubbles and UVC are injected into tubes, lines, drains, catheters, etc.

Application—submicron bubbles—Below find the non-obvious observation that “Bubbles less than 1 μm diameter rise so slowly that the rate is not determinable . . . . ” This suggests that such bubbles can conformally coat and/or surround objects that are in the path of wave energy, maximizing the scattering into the shadows on the surfaces of these objects. The same can be said for dry fog aerosols as they envelop fruits/vegetables, a plastic-wrapped food item, medical devices and other objects that cause hospital acquired infections, restaurant/airplane tables that may harbor pathogens such as SARS-CoV-2 that could lead to COVID-19, leaves on greenhouse plants to aid in photosynthesis, etc. The enveloping scattering field for dry fog (with some analogous effects for bubbles in liquids) is in part due to gravity and in part due to aerosol movers (fans), fluid shaping surfaces (swirl plates, Coand\check{a} effect), ambient air movements (crosswinds), static charges, etc. as disclosed herein. Note that applicant's MontCarl simulations show different levels of germicidal/visible scattering for 1 μm diameter water droplets of various N_{d}. This suggests similar performance of air/gas bubbles in water can be obtained.

With respect to gaseous bubbles in liquids, an initial bubble radius, Ro, tends to increase in size to a final radius, R, and thus the ratio R/Ro is used in a number of references. Once achieving the maximum bubble radius, R, the bubble may collapse/implode, break-up/split, etc. See e.g., Physics of bubble oscillations, and Handbook of Ultrasonics and Sonochemistry (ISBN 978-981-287-277-7) Much more information on bubbles can be found in the provisional filings.

Below find submicron bubble/droplet information:

Moleaer's gas-injection technology produces trillions of neutrally buoyant, negatively charged nanobubbles approximately 100 nm in diameter. At that size, bubbles stay suspended in water for long periods of time, efficiently mixing throughout the entire water column. (Moleaer, Carson, Calif.)

“Bubbles less than 1 μm diameter rise so slowly that the rate is not determinable. This is due to their random Brownian motion and their low buoyancy” (Nanobubbles (ultrafine bubbles)) “Submicron size bubbles or nanobubbles are gas bubbles of several hundred nanometers in diameter [14,18,23-26], usually a mixture of water vapor and naturally or intentionally dissolved gases [23,27].”” (Generation and characterization of submicron size bubbles).

Below find sources of supply for submicron droplets and bubbles.

“A Hand-Held Point and Spray Misting Disinfection Unit . . . 0.5-3 micron particle disinfects hard to reach areas” (Products—TOMI™ Environmental Solutions SteraMist™), TOMI™ Environmental Solutions, Inc (Frederick, Md.). “ . . . iONIZED HYDROGEN PEROXIDE (iHP™) The atmospheric cold plasma arc converts the H2O2 molecules into iHP . . . iHP kills the pathogens achieving high efficacy and leaves behind only oxygen and humidity in treated spaces.” (TOMI Steramist Binary Ionization Technology (BIT) using Cold Plasma Ionized Hydrogen Peroxide (Food Safety Brochure))

Submicron droplet generators are available from TSI Incorporated (Shoreview, Minn.), such as their Constant Output Atomizer, Model 3076, “The number median diameter of the droplets the Atomizer generates is about 0.3 micrometer and the geometric standard deviation is less than 2.0. The mean particle size of the generated aerosol can be varied between 0.02 and 0.3 micrometer by atomizing a solution and evaporating the solvent.”

See Table 1 from Aerosol-assisted synthesis of submicron particles at room temperature using ultra-fine liquid atomization which provides ‘Typical diameters of droplets and particles, and production capacities of some aerosol-assisted particle synthesis processes . . . ’ and a number of products that generate submicron droplets/particles.

Dry Vapor Systems45 (DVS45) from OMI Industries (Palatine, Ill.) ‘disperses submicron size Fresh Wave IAQ molecules into the air’

Spray vector products—Vortex Air, from C.C. Steven & Associates (Ventura, Calif.). “Sprayvectors are compressed air operated liquid atomizing devices capable of producing sub-micron sized spray droplets. Sprayvectors use the airflow amplification principle to produce a defined spray pattern. Spray patterns can be either widely diffused or directed. The spray characteristics are superior to conventional hydraulic nozzles (high pressure liquid forced through a tiny hole), and even exceed those of piezoelectric nozzles. Sprayvectors produce very small droplet size which results in more surface coverage. As droplet size decreases, the total number of droplets increases at a higher rate. The result is that the combined surface area of droplets in the spray is increased exponentially. Increased surface contact provided by Sprayvectors produce: accelerated liquid-air interaction, more effective evaporative cooling, economical use of liquid, controlled, efficient humidification, and effective dust control.”

Sub-micron fuel atomizers are discussed in US20040124259 Liquid atomization system for automotive applications.

Micron and submicron droplet generators are available, e.g., from BUCHI Corporation (New Castle County, Delaware), such as their Nano Spray Dryer B-90 HP.

“Submicron size bubbles or nanobubbles are gas bubbles of several hundred nanometers in diameter [14,18,23-26], usually a mixture of water vapor and naturally or intentionally dissolved gases [23,27]. It has been reported that such bubbles have a negligible buoyancy and would remain suspended in solutions for a considerably long period of time [14,18,24,25,28-30]. Najafi et al. [14] were able to generate nanobubbles which remained stable for several minutes, while Ushikubo et al. [31] reported that submicron size air bubbles and oxygen bubbles could be made stable for 1 h to 15 days. Zhang et al. [30] produced nano carbon dioxide bubbles and air bubbles which lasted for several hours and days, respectively. Other studies also showed bubbles stable in aqueous solutions for up to a few months [24].” Generation and characterization of submicron size bubbles. Nano-bubbles can be created by high-energy beams as well as ultrasonic/hydrodynamic cavitation, vaporous/gaseous cavitation, sparks, and lasers. Note that aerators and multiple hole orifice plates are also used for bubble generation.

Data for larger bubble dynamics can be found in The stability of a large gas bubble rising through liquid, Dynamics of an initially spherical bubble rising in quiescent liquid, Principles and applications of dissolved air flotation.

Bubble generation via spargers is cited in The Effects of the Properties of Gases on the Design of Bubble Columns Equipped with a Fine Pore Sparger, An Introduction to Micro Nano-Bubbles and their Applications. Multiple hole orifice plates are also used for bubble generation. Spargers are manufactured, e.g., by Mott (Farmington, Conn.), “spargers introduce gases into liquids through thousands of tiny pores, creating bubbles far smaller and more numerous than with drilled pipe” (per their website).

Much like aerosol droplets evaporating, bubbles in water will collapse, and this is a key characteristic to the very high pressures in temperatures in cavitation. Bubble collapse is discussed in Free-Radical Generation from Collapsing Microbubbles in the Absence of a Dynamic Stimulus.

Application—non-UVC EM wavelengths+bubbles—References to information/figures/tables/charts in this section can be found in section 18.13 of the '071 provisional application. In Improved extraction of vegetable oils under high-intensity ultrasound and or microwaves, microwave irradiation at 2.45 GHz is combined with sonication, performed both sequentially (sonication at 19, 25, 40, and 300 kHz) and simultaneously (sonication at 21 kHz). In Microwave energy potential for biodiesel production, it cites the industrial use of 915 MHz microwave power (in addition to the traditional 2.45 GHz). The chart and table were created to show the penetration depths, Dₚ, (and refractive indices) in air and water vs frequency, with lower frequencies having greater Dₚ for both. As an aside, 410-470 MHz is not listed as a restricted band in FCC 47 CFR § 15.205 and has greater penetration than even 915 MHz. Data is also shown related to various electromagnetic (EM) frequencies used to irradiate water for heating (microwave and RF), photocatalysis (specifically for TiO₂), and germicidal (UVC) applications. These data were input to MiePlot, and the approximate bubble diameters required to scatter incident EM waves between about 15° and 20° (at the intensity level of 10% of maximum). Exemplary MiePlot (single bubble scattering) outputs are, respectively: 915 MHz with 100 mm air bubbles, where the scattering angle at the intensity down 1/e from its maximum ˜7°, 915 MHz with 10 mm bubbles, where the 1/e intensity is ˜55°, and 915 MHz with 1 mm bubbles, where the 1/e intensity is never reached, dipping to ˜50% of maximum intensity at 90°. A summary table is also provided. From the table, 25˜100 mm bubble radii are needed for highly forward scattering single-bubble scattering in the cited RF/microwave region. Bubbles this size are larger than what is shown for generation via ultrasound cavitation, although such bubble sizes can be generated in water via other means (The stability of a large gas bubble rising through liquid). Also note that large bubbles also deform from spherical in shape (Dynamics of an initially spherical bubble rising in quiescent liquid), which of course leads to a different scattering profile than spherical bubbles (Light Scattering by Nonspherical Particles, ISBN 0-12-498660-9). Note that ˜400 nm radii is needed for highly forward scattering in the UVA-UVC region and can be generated via ultrasound.

It is important to note that the MiePlot charts at 915 MHz show anisotropic scattering for bubble radii of 1 mm and 10 mm, although there is noticeable backscatter, however there may be applications where this is suitable. Data is provided showing the penetration depth in air (at relative humidities of 0% and 99%, respectively) and water covering the UV spectrum. Note that the data appears to assume˜pure media. In the water treatment industry, UV transmittance (UVT) at 254 nm (UVT254) is the metric used.

A cavitation bubble radii plot is shown in SONOSYS Image brochure english 2015, identifying bubble radii down below 10 nm. Note that the plot shows that bubble radii are, in a general sense inversely proportional to frequency, but are also affected by the intensity of the sonification. EM wavelengths at 10 nm transition from EUV to X-rays. Thus, low energy ‘soft’ X-ray scattering is also feasible (10 nm equates to ˜123 eV). Scattering calculations (e.g., MiePlot) requires as an input the refractive index of both air and water. The trend of refractive indices versus EM wavelength is shown, as well as the description for soft x-rays. References are also provided for the refractive index water below 100 nm. MiePlot charts are also shown for a 10 nm air bubble in water, irradiated at 10 nm, with the first using the refractive index of 0.988 and a second 9.3% lower than the 0.988 from above, or 0.904. The shape of the curves is about the same, although the peaks are slightly different.

From the above, it can be seen that directional EM scattering in ultrasonic cavitation applications covers the range of wavelengths from low energy X-rays to UV, Visible, Infrared, and RF into the microwave region. As cited herein, ultrasonic cavitation has been previously combined with other modalities with kinetic effects. Generally, there are optimum ultrasonic cavitation frequencies for a given application.

Process Intensification can be found where synergies can be generated by the combination of an efficient cavitation conversion process and the simultaneous use the bubbles for efficiently scattering irradiation of a secondary process. As shown in the above referenced chart, the bubble radii can be altered by frequency and intensity.

In one exemplary configuration, cavitation is used in a sonochemical process, wherein the cavitation bubbles are also used by an RF/microwave beam to uniformly elevate the temperature of the reactants to accelerate the reaction rate.

In another exemplary configuration, cavitation is used to generate hydrogen and hydroxyls within a contaminated water source, wherein the cavitation bubbles are also used to uniformly irradiate the contaminated water source with UVC.

Additional bubbles (of the same and/or different size than the cavitation bubbles) can be added, e.g., via aeration, to further enhance the uniformity of radiation.

Another exemplary approach would be the use of hydrodynamic cavitation orifices distributed across the face(s) of a mixing wheel paddle (constructed of sufficiently hardened material to minimize cavitation erosion) in order to distribute the cavitation bubbles throughout the volume of a vessel, while simultaneously irradiating the bubble field with a secondary EL, EM, and/or QP source of irradiation. One secondary irradiation geometry would be positioned across the face of the top and/or bottom of the vessel. Another would be positioned along the central axis radiating outward and/or around the circumferential surface of the vessel irradiating inward towards the central axis. Irradiators can also be placed adjacent to the orifices on the paddle(s).

Application—light (e.g., UV-B, UV-C, and red light) for plant pathogen (e.g., fungus and mites) suppression and an advantage to its application in the dark—In addition to UVC, visible light and UVB can be used to aid in plant health, whether by reducing fungi or mites, where the latter are known to reside on the underside of leaves since these surfaces tend to be shielded from UV. The use of the inventive scattering particles improves the coverage of leaf surfaces vs what is traditionally available via direct illumination. As cited herein, recent research has shown that there is a benefit to disinfecting plants at night.

Application—improving the efficacy of irradiation in dental applications Exemplary applications would be the use of light to cure adhesives and whiten teeth in dentistry. “Restoration characteristics are factors that can affect light-curing a composite resin—Patient access (mouth opening) can limit light guide positioning. The size and angulation of some light guides may make proper surface positioning and orientation in the posterior areas impossible. Increased curing times may be necessary. Access limitation can result in sub-optimally light tip orientation, resulting in light reflection, refraction and shadowing issues.” (Successful Light Curing—Not As Easy As It Looks—Oral Health Group)

“Physics of light curing—LED curing lights have been a positive development for photopolymerization of composites. Considerations to light cure composites must include: knowing the disaggregated irradiance-light spectrum values of the curing light; the light spectrum of the LED(s); and how the distance, angulation, diameter, and use of barriers of the light guide tip impact on polymerization of the restorative. Most adhesives and composites are cured in the spectrum of 450 nm to 480 nm, but some have photoinitiators below 420 nm; clinicians should ask the manufacturer about which photoinitiator(s) are being used.11 It would be useful to know the disaggregated irradiance values (knowing the specific wavelengths in the ranges of 380 nm to 540 nm).12 Understanding that irradiance multiplied by the duration of light curing equals total energy in joules/cm² that a composite would need for curing provides information on what additional light-curing energy (increased times for curing) is necessary for very light shades (bleaching shades), very dark shades of composite resin, flowable composite resin, and microfill composite resins.13,14 Light guide tip placement, stabilization, and orientation are very important when light curing restorative materials. While many preparations provide for excellent clinical access for curing lights, hard-to-reach areas of the oral cavity can compromise the energy delivered.15,16” (The Physics of Light Curing and its Clinical Implications Compendium). The kinetic process for such curing is called photocuring or photopolymerization.

To aid in light curing, water vapor (have scattering particles suitable in size for the close-in curing at the wavelengths of 420 nm˜480 nm as cited above) can be used in the oral cavity to minimize shadowing issues. Note that the water vapor can be generated by the appropriate nozzle and/or nebulizer attachment that is connected to the dental unit water line (DUWL). A combination light and aerosol delivery device for a dental application is U.S. Pat. No. 8,485,818 Fluid controller. For the instant application, a 420 nm˜480 nm light source would be substituted for the laser in the '818. Exemplary beam forming optic are taught in U.S. Pat. No. 7,410,283 Dental light guide and U.S. Pat. No. 9,662,191 Dental light curing device.

Similarly, the use of light scattering in the instant invention can also be used to improve the illumination in a tooth whitening device. “Devices for use in light/heat-activated tooth whitening procedures include the commercially available Union Broach Illuminator System, from Union Broach, a Health\Chem Company, New York, N.Y. This device, as described by the manufacturer, provides direct, full spectrum illumination to all of the teeth found in the front of the average adult's mouth. However, this device does not uniformly illuminate all sixteen central teeth in the front upper and lower arches because of the curvature of the dentition. This potentially gives rise to uneven results. In addition, the Union Broach device generates a great deal of heat which is both uncomfortable for the patient and potentially damaging to the teeth.” (U.S. Pat. No. 7,572,124 Apparatus for simultaneous illumination of teeth). See also U.S. Pat. No. 8,562,955 Light-activated tooth whitening method and U.S. Ser. No. 10/046,173 Tooth-whitening device. Further information on tooth whitening can be found in Tooth whitening techniques (ISBN 978-1-84214-530-2) and Tooth Whitening An Evidence-Based Perspective (ISBN 978-3-319-38847-2).

For examples of DUWLs and attachments, see e.g., Johnson-Promident complete catalog 2016.

Application—bubbles+photocatalytic conversion in liquids—Photocatalytic conversion, such as UV-B irradiating TiO₂, has been shown to be of use in remediation applications (see Background for more information). However, it is well known that it is a process that requires large surface to volume ratios since the reaction rate is proportional to the irradiated surface area of the catalyst. The two basic categories of photocatalytic reactors are suspensions of photocatalysts (slurries of photocatalyst particles) and immobilized photocatalysts (photocatalysts coated on a stationary surface). Foundational information on photocatalytic conversion can be found in Photocatalysis and Water Purification (ISBN 978-3-527-33187-1) and Photocatalysis—Fundamentals, Materials and Applications (ISBN 978-981-13-2112-2).

A Review of Physiochemical and Photocatalytic Properties of Metal Oxides Against Escherichia Coli cites the use of nanobubbles in photocatalysis and aid in damaging microorganisms. Such a process can be optimized using computational fluid dynamics (CFD) as taught in Development Of A CFD-Based Model For The Simulation Of Immobilized Photocatalytic Reactors For Water Treatment, also citing other photocatalytic CFD analyses, including Computational fluid dynamic (CFD) simulation of a pilot-scale annular bubble column photocatalytic reactor.

Application—photocatalysts employing bubbles—The examples in the instant invention below will also cite aeration as source of bubbles, but any suitably sized bubbles generated from the examples and references cited herein (cavitation, boiling, etc.) would be applicable. Of course, if using imploding bubbles, like those generated by cavitation, one must consider the effects of erosion and also any sonochemical reactions competing with the photocatalytic reactions.

Bubble sizes, whether air bubbles in water or water vapor in air, must be optimized for both the UV scattering effects and the fluid flow characteristics adjacent to the photocatalyst. Again, see the CFD references above and the scattering simulation tools cited herein.

Photocatalytic reactors employing bubbles include, e.g., Modeling and experimentation of a novel labyrinth bubble photoreactor for degradation of organic pollutant.

In the exemplary configurations below, the photocatalyst is TiO₂ (e.g., Degussa P25, Evonik Corporation, Parsippany, N.J.) with illumination from an array of 365 nm LED light sources, e.g., Luminus P/N SST-10-UV(Luminus, Inc., Sunnyvale, Calif.). Note that 365 nm satisfies the minimum energy for activation of both anatase TiO2 (at 384 nm, min) and rutile TiO2 (at 411 nm, min). The maximum wavelength of the 365 nm LED is specified at 370 nm, also within the minimum wavelength bounds for both crystalline phases of P25 TiO2. Shorter wavelengths can be used, but LED wall plug efficiency (WPE) tends to be lower for shorter wavelengths. However, if a shorter wavelength length has more output power per LED die without a big hit to WPE, then it might be an equitable trade, e.g., to make the system more compact.

The vessels cited below can be covered/coated (except for the apertures for the illumination, plumbing, sensors, etc.) with material such as aluminum and PTFE (and others cited herein) that is highly reflective in the range around 365 nm. This provides a boost in efficacy by redirecting illumination that would exit the system back towards the photocatalysts. Sensors and control systems are constructed in accordance with the general teachings cited herein in order to maximize efficacy, flow rate, operator safety, etc.

Application—anti-fouling—“Fouling is the accumulation of unwanted material on solid surfaces to the detriment of function.” (Fouling Versus Availability, Fouling—Wikipedia). “A number of factors contribute to fouling and are strongly interlinked. Organic, inorganic, particulate, and biological fouling are some of the main fouling categories.” (Fouling of Nanofiltration Membranes)

Fouling is a large concern in direct photolysis. See e.g., Fouling Of UV Lamp Sleeves—Exploring Inconsistencies In The Role Of Iron. Fouling is also prevalent in photocatalytic systems. See e.g., Fouling and inactivation of titanium dioxide-based photocatalytic systems. Fouling can also be found in bioreactors. See e.g., Fundamentals of Membrane Bioreactors Materials, Systems and Membrane Fouling (ISBN 978-981-10-2013-1)

Fouling can be addressed by pre-treatment (filtration, UVC irradiation, ozonation, ultrasonic, etc.), and in-situ treatment such as chemical, biologic, physical (ultrasonics, mechanical scrubbing, backwashing, high-pressure cleaning jet, cross-flow and bubble movement).

Given the above, in exemplary embodiments cited directly below, bubbles are simultaneously used in anti-fouling applications for two separate purposes—one using gas as the medium, the other using liquid as the medium.

UV is known to degrade biofilm growth amongst cooling coils where “Reflective aluminum is sometimes added around such systems to remove shadowed areas” (Ultraviolet Germicidal Irradiation Handbook UVGI for Air and Surface Disinfection, ISBN 978-3-642-01998-2). Liquids are also used “In chemical cleaning techniques biocides are employed such as chlorine, chlorine dioxide, bromine, ozone and surfactants. A more usual practice, however, is by continuous or intermittent “shock” chlorination which kills off the responsible organisms. Other cleaning techniques that can be effective in controlling biological fouling include thermal shock treatment by application of heat or deslugging with steam or hot water, and some less well-known techniques like ultraviolet radiation [23].” (Fouling in Heat Exchangers). For this first exemplary embodiment, a biocide liquid is sprayed at the fouling, while the scattering properties of the spray enables UV to irradiate cooling coil surfaces in shadow. Thus, the spray provides a dual purpose.

Air/gas bubbles are also known to dislodge biofilms: Analysis of Bacterial Detachment from Substratum Surfaces by the Passage of Air-Liquid Interfaces. Also, UVC and UVB are known to degrade biofilms: Inactivation of Pseudomonas aeruginosa biofilm after ultraviolet light-emitting diode treatment—a comparative study between ultraviolet C and ultraviolet B. Thus, in this second exemplary embodiment, UVC/UVB can be introduced simultaneously with air/gas bubbles as an anti-fouling strategy, with the UVC/UVB also scattered by the bubbles to reach areas in shadow.

Scattering paths and nodes—The paths along which wave energy travel from the source of irradiation to a targeted surface (portion) in shadow (those not in direct line of sight of the source as it is irradiating) includes at least one scatterer (e.g., one water droplet in air or an air bubble in a liquid like water) dispersed in a medium (i.e. in air for water vapor or liquid for air bubbles). The path, called herein a scattering path, may also comprise what can be considered ‘relay’ elements that act to relay at least a portion of the wave energy between adjacent nodes via such effects as e.g., reflection, refraction, diffraction, and the like (which may also include scattering effects). These relays may have losses, e.g., due to absorption and scattering effects, i.e. some portion of the energy incident at a relay element may not be transferred to the next element in the scattering path. The relay node receives wave energy from a transmitting node (e.g., a source node or a scattering node), and transfers some or all of the received energy to a receiving node (e.g., the target node). Relay nodes can be external to the target node, or on-or-in the object of the target node. For example, a relay node can be a surface portion of a photosynthetic plant that transfers wave energy to a target node—a chlorophyll molecule.

Due to the statistical cloud-like nature of scattering particles (e.g., from tens to thousands of scatterers per mm³) or simply as a result of open spaces, some wave energy may arrive at the target without interacting with relay elements, while other wave energy may interact with one or more relay elements (e.g., UV reflecting surface portions). Still other wave energy may simply not reach the desired targeted surface(s). Some wave energy will arrive at different times due to multipath.

Each connection along the scattering path is called a node herein (and each scattering path can be numbered to distinguish between them, e.g., a first scattering path, etc.): a) the source of wave energy radiation establishes the source node b) a scattering element in the scattering path, establishes a scattering node (nodes can be numbered if multiple scatterers are in the same scattering path, e.g., a first scattering node, etc.) c) a surface portion for receiving the irradiation, establishes the target node.

A relay, as cited above, if applicable, establishes a relay node (again, numbered as necessary if more than one, e.g., a first relay, etc.).

One method by which the existence of scattering paths may be validated is to run the same test with and without the scattering particles, during which the irradiance is measured at targeted surface (portions) in shadow via the measurement devices/techniques described herein. These tests should be repeated to gain statistical significance (cf. Design and Analysis of Experiments, ISBN 978-3-319-52248-7) given the statistical cloud-like nature in the generation of scattering particles, flow dynamics of the scatterers and any foreign objects and debris (FOD), movement of surfaces including targeted surfaces (e.g., leaves blowing in the wind), background noise in the detector(s), etc.

Since some surface (positions) in shadow are within crevices, one can use e.g., paper-thin ‘UV FASTCHECK STRIPS’ from UV Process Supply (Chicago, Ill.) to test irradiation dosage in a room (for example). A ‘standard’ test regime can also be constructed with UV radiometers buried within the walls of the test article, with only the detector area(s) exposed. Artificial ‘crevices’ can be constructed of various shapes, depths, materials, etc. in order to understand the effects of fluid dynamics, object UV reflectance, etc. Holes of different sizes and depths (i.e. aspect ratios), different angles relative to the surface normal, different hole-to-hole spacings, through-holes vs closed cavities, as well as different shapes (cylindrical, conical, etc.), materials (e.g., of different UVC reflectivity), surface roughness, etc. can be used as part of a test coupon to objectively compare design variations. Standards are being generated for surface disinfection, see e.g., Workshop on Ultraviolet Disinfection Technologies & Healthcare Associated Infections—Defining Standards and Metrology Needs (January-2020) for a list of stakeholders.

Such test articles also include one or more wave energy sources (and source monitors) to ensure consistent geometry between source and targeted surface (portions). These test articles can sit on a tabletop, comprise an entire room or even an outdoor location. Care must be used to ensure the atmospheric conditions (temperature, humidity, air currents, etc.) and surface reflectivities are consistent from run-to-run, or sufficient runs must be compiled to plot their effects. Also, scatterers must be removed before each test to ensure establishing consistent baselines.

Further, the radii, concentration, and spatial/temporal distribution of scattering particles must be consistent from run-to-run, or enough runs in different conditions in order to plot their effects and yield a statistically significant result. This is especially critical when performing outdoor testing, e.g., in a vineyard where the application of scattering UVC is being considered to counter powdery mildew and so the effects of random air currents must be understood. Another application would be a greenhouse where it is desired to scatter selected wavelengths of visible light from LEDs (see products e.g., from Fluence, Austin, Tex., an Osram company) to enhance photosynthesis by illuminating leaf areas that are in shadow and so the effect of the randomness of leaf locations must be understood (also true for the vineyard application).

Note that if the end application is UVC, a visible light proxy can be tested beforehand to give better access to diagnostics. If this is done, one must understand the different in scattering due to the relationship between the size of the scatterers and the wavelength as described herein. This, of course, is easily modeled in a program like MontCarl. If the size of the scatterers is modified to maintain the same scattering profile, then any fluid dynamic effects on particles of a different size must also be understood.

In one embodiment, violet or blue light is used as a proxy in order to use the real scatterers while minimizing wavelength effects on scattering for the embodiment where the end application uses UVC. Of course, the differences in the irradiating beam (beam width, angle, uniformity, wavelength spread, etc.) between the UVC source and the visible proxy must be minimized as well. In some embodiments, spherical solid particles can be used as a proxy, available e.g., from Polysciences, Inc. (Warrington, Pa.). Particle analyzers are available e.g., from Malvern Panalytical Ltd (Malvern, United Kingdom) and CH Technologies (USA), Inc (Westwood, N.J.). See also a very detailed summary of analyzers and analysis techniques in ‘Appendix B: PDI Supporting Documentation’ in Measuring and Modeling Aerosols in Carbon Dioxide Capture by Aqueous Amines.

Fluorescent imbued diagnostic materials, called ‘markers’, are used as a visible diagnostic for determining the efficacy of a surface cleaning regime, see e.g., ATP Bioluminescence and Fluorescent Markers. See also Dos and don'ts for hospital cleaning, An overview of automated room disinfection systems—When to use them and how to choose them. In these applications, clear fluorescent markers are placed around a room to evaluate how well surfaces are cleaned with disinfectants by inspecting after cleaning with a UV light and looking for fluorescence (indicating missed spots). For the instant application, fluorescent markers can be used e.g., to determine whether surfaces in shadow are irradiated with UV (with and without scatterers). As an aside, bioluminescence is another diagnostic that is used and is discussed e.g., in No-Touch Automated Disinfection System for Decontamination of Surfaces in Hospitals.

Exemplary fluorescent markers are cited in Ultraviolet Powder versus Ultraviolet Gel for Assessing Environmental Cleaning, such as the GlitterBug brand of UVA fluorescent products from Brevis Corporation (St. Lake City, Utah) and DAZO® Fluorescent Marking Gel from Ecolab (St. Paul, Minn.). The fluorophores (light emitting fluorescent molecules) may be constructed for use with UVA excitation “with a range of from 365 to about 395 nm. For example, the UV light source in the kit can be a 12 LED bulb UV flashlight (e.g., Abco Tech 12 LED UV 375 nm 3 AAA flashlight), that emits light having a wavelength of 375 nm.” (Ecolab's patent filing US20200085986 Use of fluorescent polymers in marking compositions for the diagnostic determination of cleaning performance). Fluorophores have minimum excitation wavelengths (Fluorescent Probes Thermo Fisher Scientific— US), suggesting that a UVC source may not effectively illuminate a fluorophore designed for use with a UVA source. Such fluorophores, however, allow diagnostics of the scattering performance using UVA that is closer to the desired UVC light than blue or violet, thus more closely simulating true system performance when using the scatterers planned for the final scattering UVC application.

Polarization—as mentioned in section 12.9 of the '071, “polarization in both air and water is produced by scattering . . . ” (Patterns and properties of polarized light in air and water). “With polarization filters it is possible to separate diffuse from specular reflections . . . since polarization is changed at each scattering event.” (Backscattering elimination in fog for advanced driver assistance systems with LED matrix headlights). See also Seeing Through Fog—Polarized Light Persistence in Scattering Environments (degree of polarization, DOP, was calculated to compare linear vs circular polarization as a function of wavelength, optical thickness, and particle size distributions, with circular polarization performing for most visible/1R wavelengths) and Superior signal persistence of circularly polarized light in polydisperse, real-world fog environments, having many common authors. See also Polarized light propagation through scattering media—time-resolved Monte Carlo simulations and experiments, Depolarization of multiply scattered waves by spherical diffusers—Influence of the size parameter and Monte-Carlo Simulation of Light Scattering in Turbid Media: (Frits. F. M. de Mul, author of MontCarl cited herein). A very quick way to see the differences in polarization through single fog droplets is to use the MiePlot app, define the wavelength and droplet size, and set ‘Polarisation’ to ‘both’. Polarization effects should be measured when using scatterometers with the instant invention to ensure accurate inferences. Also note that Fresnel reflections are polarization sensitive and thus the absorption of wave energy at a surface (important in disinfection) can vary with the polarization state of the beam, which is dependent upon the polarization of the source itself, different polarization effects due to the interactions with other objects, and due to the scattering fog. For example, “Brewster's angle is an angle of incidence at which light with a particular polarization is perfectly transmitted through a transparent dielectric surface, with no reflection. When unpolarized light is incident at this angle, the light that is reflected from the surface is therefore perfectly polarized” (from the Wikipedia for Brewster's angle). For rough surfaces see, e.g., Light scattering from a random rough interface with total internal reflection. For general information on polarization transmittance and reflections under various conditions for different materials, see, e.g., Optics (Fifth Edition, Hecht, ISBN 978-1-292-09693-3), which stated in part “linear light reflected from a metal surfaced mirror will have phase shifts introduced that cause it to emerge as elliptical light.”

Polarization is also affected by the shape and alignment of the scatterers. See, e.g., Particle shape determination from polarization fluctuations of scattered radiation (citing scatterers that are prolate or shaped like a rugby ball, spherical, and oblate shaped like a flattened pumpkin). This should be considered when working with non-spherical scatterers as well as when disinfecting powders and the like, which may exhibit some degree of polarization anisotropy. Particle alignment is also to be considered: “We present radiative transfer calculations showing the polarization effects of scattering and absorption by aligned grains. The grain model consists of a size distribution of oblate or spinning prolate particles with varying degrees of alignment. To develop an understanding of the radiative transfer effects, we begin with the simple case of a spherical envelope illuminated by a central source with constant grain alignment axis throughout the envelope. Nonaligned grains produce no net polarization in such envelopes, while aligned grains produce substantial linear and circular polarization. The linear polarization results from the competing effects of differential extinction and scattering. The polarization varies strongly with optical depth, with scattering dominating at low optical depth and differential extinction dominating at high optical depth.” Scattering And Absorption By Aligned Grains In Circumstellar Environments.

### LISTING OF REFERENCE NUMERALS IN FIGURES

FIG. 1

100—UV Tunnel system (Here strawberries ride along a conveyor belt inside a ‘UV tunnel’ that contains many UVC lamps illuminating them from above and below. Dry fog has been injected into the tunnel, and the resultant scattering illuminates the strawberries from a wider range of angles than if without fog. This can be seen by looking at the final angle of the two light rays that strike the strawberry on the left. The dashed lines trace back to locations that could not have come from a lamp directly, and that is how this technology reaches the shadows. Direct rays are available both with and without dry fog.)

110—UVC tunnel entrance wall

120—UVC lamp surrounded by aluminum cusp specular reflector covered by UV quartz glass plate

130—Fog Plenum

135—Fog is directed downward to treatment zone by 1-of-n diffusers and/or (directional) injectors

140—Dry Fog

150—Wire-link conveyor belt allowing UVC to pass through

160— UVC lamps with reflectors

165—UVC tunnel exit wall (in some embodiments Strip-type curtains (not shown) substantially contain the dry fog within the UVC tunnel)

170—Optional vacuum hood & dryer for removal of residual fog & excess moisture on exit side

175—Exemplary UVC rays scattered by dry fog

180—Fog continues to drop due to gravity and condensate is collected in drain at bottom

190—The final angle of the light ray reaching the strawberry could not have come from a direct-view ray

195—Direct Ray

FIG. 5

500—UVC lamps/rays

510—Microbe

520—‘canyon walls’ of a crack/crevice at some height:width aspect ratio

530—Direct field of view of the microbe—no lamps in sight

FIG. 6

500—UVC lamps/rays

510—Microbe

520—‘canyon walls’ of a crack/crevice at some height:width aspect ratio

530—Direct field of view of the microbe—no lamps in sight

540—Expanded field of view with some lamps in sight

550—Exemplary MontCarl ray trace renderings (Ø5μ droplets at N_{d}=10⁶ cm⁻³, λ=254 nm, t_{FOG}=5.85″) from this presentation

560—Fog field

FIGS. 7

700—

710—Conveyor belt

720— UV Tunnel

730—UVC Lamp cassettes

740—Tunnel Guarding

750—Box (pushed, e.g., by a U-shaped paddle that is attached to the belt, will also prevent box from skewing and jamming travel). Wet/dry washable HEPA filter allows air to pass (but not fog) during fog-fill and vacuum exhaust. Optional desiccant.

760 HEPA

765— Water

770—Tables (prevents box & hose from falling to floor, tabletop heights same as conveyor belt)

775 3-way valve Secured to tabletop

780—Dry fog generator

785—Hose (UV resistant) with slack laying flat on smooth-topped table to minimize the weight of the hose from pulling on the box. Also avoids creating a water trap that would block flow. Hose has enough slack for the box to travel from table to table. Hose guided, e.g., by U-channels that are zip-tied to the belt to keep hose from kinking when pushed & pulled, especially when being pushed through the UV protection slats at the entrance/exit of the guarding.

790—Exhaust

FIG. 8

800— Modular Unit for powder treatment with UVC

810—Every point on the circumference of the UV transmissive inner cylinder receives scattered rays from the dry fog over a wide range of angles, effectively creating a larger diffuse emitter surface that directs UVC into the powder. Rays that miss the powder are reflected by the UVC reflector and either strike the powder on the return-trip or pass through the powder again and re-scatter in the fog only to reach the powder again at another location. The odds of reflected UVC rays getting re-absorbed by the lamp plasma* are lower than if the lamp was closely surrounded by the powder.

820—Powder (e.g., flour) within a gap between a UV transmissive inner cylinder and an outer cylinder that is either (a) UVC reflective, or (b) a UVC transmissive cylinder covered in a UVC reflector. Gap size is chosen based on the needs of the application, weighting such factors as (a) low pressure drop, (b) high dosage uniformity, (c) power efficacy, (d) product throughput, etc. Air flow of the appropriate humidity (to prevent clumping) can be introduced to swirl the flour for better dosage uniformity, much as is done by swirling water in UVC water treatment systems.

830—Dry fog within a UV transmissive cylinder whose radius is determined by the distance necessary for efficient UV forward scattering with good UV homogenization.

840—UVC LP Lamp

850—Highly reflective diffuse UVC Reflector

860—Fog in this area

870—Powder in this area

880—Exemplary UVC rays

FIG. 10

1000—Polypropylene tote (interior size)

1010—Inner, telescoping 4.3″ OD PVC tube, open to the air in the left side of tote, which is devoid of fog. Optional black flocking paper liner installed against interior surface.

1020—Outer, fixed 4.6″ OD PVC tube fixed/sealed to partition stiffeners to prevent fog leakage. ID allows slip fit to inner tube.

1030—Partition—black ¾″ thick foam with 4 mm plastic plate stiffeners shown on either side, sealed to tote interior walls to prevent fog leakage to left side of tote.

1040—Gap that defines the dry fog thickness

1050—Square window (sealed to tube)

1060—22 mm OD fog bulkhead connector on far side of chamber

1070—Clear window, sealed to tote to prevent fog leakage

1080—Sensor paddle/wand, facing spotlight, isolated from the fog within a transparent PC tube.

1085—Wide FOV source monitor, facing spotlight

1090—Polycarbonate (PC) tube suspended by sealed bulkhead connectors through the sidewalls of the tote (interior of tube is devoid of fog, open to ambient air on both ends). Optional shadow-inducing black vinyl tape and magnetic balls not shown around the outside of the tube.

1095—Fog chamber portion (10.25″ W into the page)

FIG. 15

1500—Polypropylene tote (interior size)

1510—Inner, telescoping 4.3″ OD PVC tube

1520—Outer, fixed 4.6″ OD PVC tube

1530—Partition

1540—Gap between window and polycarbonate tube

1550— Window

1560—22 mm OD fog bulkhead connector on far side of chamber

1570—Black flocking paper on far side of tote, absorbing side facing spotlight

1575—White LED spotlight (source), 9.5″ from far side of tote facing paddle/wand

1580—Active sensor on far side of paddle/wand that is pressed against tote, facing spotlight.

1585—Wide FOV source monitor, facing spotlight (same relative position to spotlight as in other drawing)

1590—Polycarbonate tube (empty)

1595 Fog chamber portion (right side of partition)

FIG. 22

2200—Polypropylene tote (interior size)

2210—Inner, telescoping 4.3″ OD PVC tube, fully retracted

2220—Outer, fixed 4.6″ OD PVC tube

2230— Partition

2240—Top cover

2250—22 mm OD fog bulkhead connector on far side of chamber

2260—Fog chamber portion (right side of partition)

2270—Polycarbonate tube (empty)

2280—White LED spotlight (source), 9.5″ from far side of tote facing paddle/wand

2290—Active sensor on far side of paddle/wand that is pressed against tote, facing spotlight.

2295—Wide FOV source monitor, facing spotlight (same relative position to spotlight as in other drawings)

FIG. 23

2300—HomeSoap®, cross section (view through door)

2310—Upper tubular UVC lamp

2320—Threaded rod inside corresponding threaded holes in 1-2-3 blocks

2330—UVC reflection from right sidewall (also from inside of door and far wall, not shown)

2335—Upper ‘UV512C’ UVC sensor puck facing the PC sidewall sheet, aligned to the inside surface of the 1-2-3 Block

2340—Nuts, locking the 1-2-3 blocks to the threaded rod via flat washer (not shown)

2345—1-2-3 Blocks, positioned along right sidewall (partially occluded in this view),—4″ from inside face of the front door, with inside face approx. along centerline of lamps

2350—Lower ‘UV Clean’ UVC sensor puck, facing the lower LP UVC lamp, in clearance hole of PC bottom sheet

2355—Lower tubular UVC lamp, blocked by PC bottom sheet

2360—PC bottom sheet, absorbing UVC from upper and lower tubular UVC lamps

2370—Dashed circle is the approx. vertical location of the dry fog injection connector added to the front door

2380—Dry fog

2390—Polycarbonate (PC) sheet (UVC absorbing), blocking left sidewall reflections, w˜1.2″, where (d+11/16″+h)≈9⅛″)

FIG. 26

2600—Fog field, thickness shortened in order to see scattered rays reach the detector

2610—Exemplary MontCarl ray trace rendering (Ø5m droplets at N_{d}=10⁶ cm⁻³, 1=254 nm, t_{FOG}=5.85″) from this presentation

2620—Upper UVC lamp in the HomeSoap® unit

2630—Upper UVC sensor (shown partially transparent to follow the rays), facing the UVC-absorbing polycarbonate (PC) sheet covering left wall (not shown) inside the HomeSoap® cavity

2640—Adjustable height platform inside the HomeSoap® cavity supporting the upper UVC sensor

2650—To reach the detector, UVC rays emitted from the lamp need to be offset by some angle, a

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

We claim:

1. A method of irradiating a target surface with wave energy, comprising:
creating a field of scattering elements within a medium;
establishing a flow of at least some of the scattering elements towards the vicinity of a target; and
casting wave energy onto at least a portion of the field such that at least some of the wave energy is scattered by at least some of the scattering elements and impinges on a surface of the target in the shadow of direct rays of wave energy.

2. The method of claim 1, wherein the wave energy includes at least one of electromagnetic energy, elastic energy, and quantum particle de Broglie wave energy.

3. The method of claim 1, wherein at least a portion of the wave energy induces chemical changes on or in the target via one or more of photolysis, photosynthesis, radiolysis, ultrasonication, and an advanced oxidation process (AOP).

4. The method of claim 1 wherein at least some of the scattering elements are selected from inert and reactive with one or more substances on or in the target.

5. The method of claim 1, further comprising:
adjusting one or more of the intensity, spatial distribution, temporal distribution, and spectral distribution of the wave energy.

6. The method of claim 1, further comprising:
adjusting one or more of the composition, number concentration, temperature, and velocity of the scattering elements.

7. The method of claim 1, further comprising:
adjusting at least one parameter that influences the size distribution of the scattering elements.

8. The method of claim 1, further comprising:
adjusting one or more of the composition, temperature, and pressure of the medium.

9. The method of claim 1, further comprising:
controlling one or more of the spatial and temporal distribution of the scattering elements.

10. The method of claim 1, further comprising:
modifying the electrostatic charge of one or more of the target and at least some of the scattering elements.

11. The method of claim 1, further comprising:
adding at least one other modality to induce chemical changes on or in the target.

12. The method of claim 1, further comprising:
estimating the number concentration of the scattering elements in a region of space; and
using the estimated number concentration to control one or more properties of one or more of the wave energy, the scattering element field, and the medium.

13. The method of claim 1, further comprising:
removing scattering elements or portions thereof from on or around the target selected from one or more of while the target is irradiated with wave energy and after the target is irradiated with wave energy.

14. The method of claim 1, further comprising:
isolating at least some of the scattering elements from at least some of the influence of the fluid motion of the medium adjacent to the scattering field.

15. The method of claim 1, further comprising:
isolating at least some of the scattering elements from impinging the target.

16. The method of claim 1, further comprising:
adjusting the spatial orientation of the target during at least a portion of time under irradiation from the wave energy source.

17. The method of claim 1, further comprising:
Adjusting the amount of time the target is irradiated with wave energy.

18. The method of claim 1, wherein the scattering elements include dry fog from an atomizer.

19. A device for irradiating a target surface with wave energy, comprising:
a generator emitting scattering elements within a medium to create a scattering field;
a flow director to direct at least some of the scattering elements towards the vicinity of a target; and
a source of wave energy casting wave energy onto at least a portion of the field of scattering elements such that at least some of the wave energy is scattered by at least some of the scattering elements and at least some of the scattered wave energy impinges on a surface of the target in the shadow of direct rays of a source of wave energy.

20. A dosimeter, comprising:
a first surface portion of the dosimeter constructed to create a shadow on a second surface portion of the dosimeter from incident external wave energy irradiation, and thereby establishing a shadow geometry; and
the shadow geometry correlating to a shadow geometry on the target object, wherein the shadowed surface portion on the dosimeter is constructed with a non-living material having at least one measurable property that changes in response to the fluence such that the at least one measurable property correlates to the fluence received from the source of wave energy.
